(19) United States
(12) Patent Application Publication
(10) Pub. No.: US 2026/0226794 A1
(43) Pub. Date: Aug. 6, 2026

(54) SOLAR-POWERED MOTORIZED WINDOW TREATMENT

(71) Applicant: Lutron Technology Company LLC, Coopersburg, PA (US)

(72) Inventors: Christopher Ballard, North Wales, PA (US); Edward J. Blair, Telford, PA (US); John H. Bull, Slatington, PA (US); Stuart W. DeJonge, Riegelsville, PA (US); Jeremy M. Fallis, JR., Bethlehem, PA (US); Alan Fernandez, Philadelphia, PA (US); Charles Fiebig, Frenchtown, NJ (US); Dylan Kenny, Bellmawr, PA (US); David A. Kirby, Zionsville, PA (US); Galen Edgar Knode, Macungie, PA (US); John B. Nill, North Wales, PA (US); Christopher J. Oster, Langhorne, PA (US); Brent Protzman, Easton, PA (US); Scott E. Shaw, Macungie, PA (US); Mailing Ren Wu, Lansdale, PA (US)

(73) Assignee: Lutron Technology Company LLC, Coopersburg, PA (US)

(21) Appl. No.: 19/319,450

(22) Filed: Sep. 4, 2025

Related U.S. Application Data
(60) Provisional application No. 63/690,753, filed on Sep. 4, 2024.
(60) Provisional application No. 63/693,674, filed on Sep. 11, 2024.
(60) Provisional application No. 63/839,868, filed on Jul. 7, 2025.
(60) Provisional application No. 63/875,155, filed on Sep. 3, 2025.

(51) Int. Cl. E06B 9/72; E06B 9/24; E06B 9/68; H02S 30/20

(52) U.S. Cl. CPC E06B 9/72; H02S 30/20; E06B 2009/2476; E06B 2009/6809

(57) ABSTRACT

The motorized window treatment may include a motor drive unit comprising a motor configured to rotate to adjust the covering material to the plurality of positions. The motorized window treatment may include a control circuit. The control circuit may be configured to control the bottom bar to each of the plurality of positions at a plurality of times, determine a magnitude of power collected by the solar cell of the bottom bar of the motorized window treatment at each of the plurality of times, and/or to store the magnitude of power with an associated position of the plurality of positions and with an associated time of the plurality of times. The control circuit may control the position of the bottom bar to a position of the plurality of positions based on the magnitude of power and/or associated times stored with the associated position of the plurality of positions.

### CROSS-REFERENCE TO RELATED APPLICATIONS

This application claims the benefit of Provisional U.S. Patent Application No. 63/690,753, filed Sep. 4, 2024, Provisional U.S. Patent Application No. 63/693,674, filed Sep. 11, 2024, Provisional U.S. Patent Application No. 63/839,868, filed Jul. 7, 2025, and Provisional U.S. Patent Application No. 63/875,155, filed Sep. 3, 2025, the entire disclosures of which are hereby incorporated by reference herein in their entireties.

### BACKGROUND

A user environment, such as a residence or an office building for example, may be configured using various types of load control systems. A lighting control system may be used to control the lighting loads in the user environment. A motorized window treatment system may be used to control the natural light provided to the user environment. A heating, ventilation, and cooling (HVAC) system may be used to control the temperature in the user environment. Each load control system may include various control devices, including control-source devices and control-target devices. The control-target devices may receive messages (e.g., digital messages), which may include load control instructions, for controlling an electrical load from one or more of the control-source devices. The control-target devices may be capable of directly controlling an electrical load. The control-source devices may be capable of indirectly controlling the electrical load via the control-target device. Examples of control-target devices may include lighting control devices (e.g., a dimmer switch, an electronic switch, a ballast, or a light-emitting diode (LED) driver), a motorized window treatment, a temperature control device (e.g., a thermostat), a plug-in load control device, and/or the like. Examples of control-source devices may include remote control devices, occupancy sensors, daylight sensors, temperature sensors, and/or the like.

A window treatment may be mounted in front of one or more windows, for example to prevent sunlight from entering a space and/or to provide privacy. Window treatments may include, for example, roller shades, roman shades, venetian blinds, or draperies. A roller shade may include a flexible shade fabric wound onto an elongated roller tube. Such a roller shade may include a weighted hembar located at a lower end of the shade fabric. The hembar may cause the shade fabric to hang in front of one or more windows over which the roller shade is mounted.

A window treatment may be mounted to a structure surrounding a window, such as a window frame. Such a window treatment may include at least one bracket, for example two brackets at opposed ends thereof. The brackets may be configured to operably support a roller tube, such that the flexible material may be raised and lowered. For example, the brackets may be configured to support respective ends of the roller tube. The brackets may be attached to a structure, such as a wall, ceiling, window frame, or other structure. Such a window treatment may be motorized.

### SUMMARY

A motorized window treatment may be configured to be mounted to a structure. The motorized window treatment may include a window treatment assembly including a covering material that extends from a top end to a bottom end and is operable between a plurality of positions. The window treatment assembly may include a bottom bar attached to the bottom end of the covering material. The bottom bar may include a solar cell.

The motorized window treatment may include a motor drive unit including a motor configured to rotate to adjust the covering material to the plurality of positions. The motorized window treatment may include at least one control circuit. For example, the motor drive unit may include the at least one control circuit. The at least one control circuit may include two control circuits, for example where the motor drive unit comprises one control circuit and the second control circuit is comprised within a system controller that is external to the motorized window treatment.

The at least one control circuit may be configured to control the bottom bar to each of the plurality of positions at a plurality of times. The at least one control circuit may be configured to determine a magnitude of power collected by a solar cell of the bottom bar of the motorized window treatment at each of the plurality of times. The at least one control circuit may be configured to store the magnitude of power with an associated position of the plurality of positions and with an associated time of the plurality of times. The at least one control circuit may be configured to configure the at least one control circuit to control the position of the bottom bar to a position of the plurality of positions based on the magnitude of power stored with the associated position of the plurality of positions and with the associated time of the plurality of times. The plurality of times may include any combination of a time of day, a day of a week, a month of a year, or a year.

The at least one control circuit may include, in memory, a solar data structure that includes a plurality of records. For example, the at least one control circuit may generate the solar data structure. Each record may include a time of the plurality of times, a position of the plurality of positions, and/or a magnitude of power associated with the time and the position. The at least one control circuit may be configured to control the position of the bottom bar to a position associated with a record of the solar data structure. The at least one control circuit may be configured to determine a time range for a movement of the covering material, for example based on a month of the year and/or on weather information. The at least one control circuit may be configured to select a record of the solar data structure that comprises a time within the time range based on the magnitude of power of one or more records that are within the time range. The at least one control circuit may be configured to control the position of the bottom bar to a position associated with the selected record.

The time range may be associated with two or more records of the solar data structure. The selected record may include a magnitude of power that is larger than the magnitude of power of the other records of the two or more records that are associated with the time range. The at least one control circuit may be configured to sort the solar data structure based on the time and/or select a time range based on a present time of day, for example where the time range is associated with two or more records in the solar data structure. The at least one control circuit may be configured to select a magnitude of power based on the time range, for example where the selected magnitude of power is characterized by a highest magnitude of power of the two or more records that are associated with the time range. The at least one control circuit may be configured to control the position of the bottom bar to a position associated with the selected magnitude of power.

The motorized window treatment may include a dock. The dock may include a first pair of electrical contacts, for example configured to connect to a second pair of electrical contacts of the bottom bar. The at least one control circuit may control the position of the bottom bar to a docking position, for example where the docking position includes the first pair of electrical contacts of the dock being electrically connected to the second pair of electrical contacts of the bottom bar. The at least one control circuit may retrieve solar data from the bottom bar. The at least one control circuit may determine a time of a last dock event, for example where the last dock event is characterized by a most recent time of the plurality of times within the solar data structure. The at least one control circuit may generate a new record in the solar data structure based on the time of the last dock event, for example where the new record in the solar data structure may include a first time, a first position, and/or a first magnitude of power associated with the solar data.

The solar data may include the first magnitude of power. The at least one control circuit may be configured to associate the first position and the first time with the first magnitude of power. The at least one control circuit may be configured to generate a second new record in the solar data structure based on the time of the last dock event, for example where the second new record in the solar data structure may include a second time, a second position, and/or a second magnitude of power associated with the solar data. The at least one control circuit may be configured to determine that the solar data does not include additional magnitudes of power that postdate the time of the last dock event, and/or store the solar data structure in a memory. The docking position may be associated with a first timestamp. The at least one control circuit may be configured to control the position of the bottom bar to a second docking position, for example where the second docking position may be associated with a second timestamp that postdates the first timestamp. The at least one control circuit may be configured to retrieve second solar data from the bottom bar associated with a time period between the first timestamp and the second timestamp and/or generate one or more additional records based on the second solar data.

The motor drive unit may include an energy storage element. The at least one control circuit may be configured to determine a movement power consumption caused by movements of the bottom bar, determine a communication power consumption caused by a communication circuit of motor drive unit, and/or determine a total power consumption based on the movement power consumption and the communication power consumption. The at least one control circuit may be configured to determine a first communication power consumption based on a number of first events and a first power consumption value, for example where the first number of events may be associated with a number of times the communication circuit of the motor drive unit enters a wake up state and does not receive a message. The at least one control circuit may be configured to determine a second communication power consumption based on a number of second events and a second power consumption value, for example where the second number of events may be associated with a number of times the communication circuit of the motor drive unit enters the wake up state and does receive a message. The second power consumption value may be greater than the first power consumption value. The at least one control circuit may be configured to determine the communication power consumption based on the first communication power consumption and the second communication power consumption.

The at least one control circuit may be configured to determine a magnitude of a current drawn from the energy storage element during the movements of the bottom bar, determine a magnitude of a storage voltage of the energy storage element, and/or determine the movement power consumption based on the magnitude of the current drawn from the energy storage element during the movements of the bottom bar and a storage voltage associated with the energy storage element. The at least one control may be configured to determine the movement power consumption caused by movements of the bottom bar based on a power profile, for example where the power profile may indicate a respective amount of power consumed by movements of the bottom bar to each of a plurality of different positions. For example, the at least one control circuit may be configured to determine a first movement power consumption caused by movements where the bottom bar is being lowered, determine a second movement power consumption caused by movements where the bottom bar is being raised, and/or determine the movement power consumption based on the first movement power consumption and the second movement power consumption.

The at least one control circuit may be configured to determine an estimated end of life of the energy storage element, for example based on an amount of charge remaining in the energy storage element and the total power consumption of the motorized window treatment and/or based on a trend of the amount of charge remaining in the energy storage element over time. The estimated end of life of the energy storage element may indicate a time when the storage voltage of the energy storage element will fall below a threshold storage level that results in unreliable operation of the motorized window treatment. The motor drive unit may include the energy storage element and a second energy storage element. The at least one control circuit may be configured to determine a first storage voltage of the energy storage element, determine a second storage voltage of the second energy storage element, and/or determine whether to control the position of the bottom bar using the first storage voltage of the energy storage element or the second storage voltage of the second energy storage element.

The at least one control circuit may be configured to generate, for example during a calibration mode, the solar data structure. For example, the at least one control circuit may receive a message that places that motorized window treatment into the calibration mode. In the calibration mode, the at least one control circuit may be configured to, without further user interaction, control the bottom bar to each of the plurality of positions at a plurality of times, determine a magnitude of power collected by a solar cell of the bottom bar of the motorized window treatment at each of the plurality of times, and/or store the magnitude of power with an associated position of the plurality of positions and with an associated time of the plurality of times.

The solar data structure may indicate one or more dead-bands of the plurality of positions. The at least one control circuit may be configured to control the position of the bottom bar to a position of the plurality of positions based on the one or more dead-bands. The at least one control circuit may be configured to compare the magnitude of power associated with the position of the plurality of positions with a magnitude of power associated with an adjacent position with the plurality of positions to determine the one or more dead-bands. Each of the one or more dead-bands may be associated with a position of the plurality of positions and a time of the plurality of times. The at least one control circuit may be configured to determine the one or more dead-bands based on weather information.

A system may include at least one control circuit and a plurality of motorized window treatments. Each motorized window treatment of the plurality of motorized window treatments may include a window treatment assembly including a covering material that extends from a top end to a bottom end and is operable between a plurality of positions. The window treatment assembly may include a bottom bar attached to the bottom end of the covering material, for example where the bottom bar may include a solar cell. The window treatment assembly may include a motor drive unit including an energy storage element and a motor. The motor may be configured to rotate to adjust the covering material to the plurality of positions. The at least one control circuit may be configured to determine an amount of charge of the energy storage element, determine a data update interval based on the amount of charge of the energy storage element, and/or transmit a message comprising the data update interval to one or more of the plurality of motorized window treatments.

The at least one control circuit may be configured to increase the data update interval, for example based on the amount of charge of the energy storage element being less than a threshold. The at least one control circuit may be configured to decrease the data update interval, for example based on the amount of charge of the energy storage element being greater than a threshold.

Each motorized window treatment of the plurality of motorized window treatments may include the solar data structure. The at least one control circuit may be configured to determine that respective solar data structures associated with each motorized window treatment of the plurality of motorized window treatments comprise magnitudes of power that are within a threshold range for one or more associated times and positions and/or set a motorized window treatment of the plurality of motorized window treatments as a data transmission manager motorized window treatment. The data transmission manager motorized window treatment may be configured to send solar data to the at least one control circuit at a lesser data update interval than other motorized window treatments of the plurality of motorized window treatments.

The at least one control circuit may be configured to cause the other motorized window treatments of the plurality of motorized window treatments to cease sending of their respective solar data. The at least one control circuit may be configured to generate a group solar data structure that is used to control each of the plurality of motorized window treatments. The group solar data structure may include solar data, for example associated with the data transmission manager motorized window treatment. The at least one control circuit may be configured to generate a group solar data structure based on solar data from each of the plurality of motorized window treatments. The at least one control circuit may be configured to update the group solar data structure based on solar data of the data transmission manager motorized window treatment and not from the other motorized window treatments. A system controller may include the at least one control circuit.

A motorized treatment may include a treatment assembly. The treatment assembly may include a covering material that extends from a top end to a bottom end and is operable between a plurality of positions. The treatment assembly may include a bottom bar attached to the bottom end of the covering material. The treatment assembly may include at least one solar cell. The treatment assembly may include a motor drive unit comprising a motor and an energy storage element, where the motor is configured to adjust the covering material to the plurality of positions. The treatment assembly may include an energy storage element configured to power the motor drive unit. The treatment assembly (e.g., and/or other apparatuses, such as a system controller) may include at least one control circuit that is configured to perform any combination of the following. The at least one control circuit may determine an average charge or an average solar energy captured by the at least one solar cell over a time period, determine an average consumed charge or an average consumed energy that is consumed from the energy storage element over the time period, and generate an indication of a problem with a lifetime of the motorized treatment based on (i) a comparison between the average charge captured by the at least one solar cell to the average consumed charge that is consumed from the energy storage element or (ii) a comparison between the average solar energy captured by the at least one solar cell to the average consumed energy that is consumed from the energy storage element.

The average consumed charge that is consumed from the energy storage element may indicate an average of a total consumed charge that is consumed from the energy storage element during each of a plurality of different accumulation intervals. The average consumed energy that is consumed from the energy storage element may indicate an average of a total consumed energy that is consumed from the energy storage element during each of the plurality of different accumulation intervals. Each accumulation interval of the plurality of accumulation intervals may be a day or a week. The total consumed charge that is consumed from the energy storage element during each accumulation interval may include an average consumed charge that is consumed by the motor and a motor drive circuit of the motor drive unit, and/or an average consumed charge that is consumed by a power supply of the motor drive unit and one or more low-voltage electrical loads that are powered by the power supply of the motor drive unit. The total consumed energy that is consumed from the energy storage element during each accumulation interval may include an average consumed energy that is consumed by the motor and the motor drive circuit of the motor drive unit, and/or the average consumed energy that is consumed by the power supply of the motor drive unit and the one or more low-voltage electrical loads that are powered by the power supply of the motor drive unit.

The time period may be at least nine months in duration. The at least one control circuit may be configured to generate the indication of the problem with the lifetime of the motorized treatment when the comparison indicates that that motorized treatment is consuming more charge or energy than is captured by the at least one solar cell. The at least one control circuit may be configured to generate the indication of the problem with the lifetime of the motorized treatment when the comparison indicates that a trend has a negative slope, wherein the trend is between (i) the average charge captured by the at least one solar cell and the average consumed charge that is consumed from the energy storage element and/or (ii) the average solar energy captured by the at least one solar cell and the average consumed energy that is consumed from the energy storage element.

The at least one control circuit may be configured to generate the indication of the problem with the lifetime of the motorized treatment when the comparison indicates that the lifetime of the motorized treatment is less than a number of years or less than a number of months.

The indication of the problem with the lifetime of the motorized treatment may include an alert that indicates that the motorized treatment should be serviced.

The indication of the problem with the lifetime of the motorized treatment may include a message that is sent by the motorized treatment to a user device or a system controller separate from the motorized treatment that indicates that the motorized treatment should be serviced.

The indication of the problem with the lifetime of the motorized treatment may include a message that indicates a recommended docking schedule or a recommended position for the covering material that will resolve the problem.

The at least one control circuit may be configured to illuminate an LED of the motorized treatment to generate the indication of the problem with the lifetime of the motorized treatment.

The at least one control circuit may be configured to cause the motor to adjust the covering material at a set speed or move the covering material up and down to generate the indication of the problem with the lifetime of the motorized treatment.

The one or more control circuits may be configured to apply an updated docking schedule to resolve the problem.

A motorized treatment may include a treatment assembly. The treatment assembly may include a covering material that extends from a top end to a bottom end and is operable between a plurality of positions. The treatment assembly may include a bottom bar attached to the bottom end of the covering material. The treatment assembly may include at least one solar cell. The treatment assembly may include a motor drive unit comprising a motor that is configured to adjust the covering material to the plurality of positions. The treatment assembly may include an energy storage element that is configured to power the motor drive unit and/or configured to be charged from the energy storage element of the bottom bar. The motorized treatment may include solar cell management circuit that is configured to control charging of the energy storage element of the bottom bar from a photovoltaic output voltage generated by the at least one solar cell. The solar cell management circuit comprises a first semiconductor switch and/or a second semiconductor switch. The treatment assembly (e.g., and/or other apparatuses, such as a system controller) may include at least one control circuit that is configured to perform any combination of the following. The at least one control circuit may render the first semiconductor switch of the solar cell management circuit conductive for a discharge time period, render the first semiconductor switch of the solar cell management circuit non-conductive at the end of the discharge time period, determine a time period from when the first semiconductor switch is rendered non-conductive until a magnitude of the photovoltaic output voltage generated by the at least one solar cell exceeds a threshold voltage, determine a short-circuit current of the at least one solar cell based on the time period, and/or determine a present light level of sunlight shining onto the at least one solar cell of the motorized treatment based on the short-circuit current.

The solar cell management circuit may be configured to control the charging of the energy storage element of the bottom bar from the photovoltaic output voltage of the at least one solar cell using a maximum power point tracking (MPPT) control technique.

The solar cell management circuit may be configured to generate one or more MPPT drive signals to render the first and second semiconductor switches conductive and non-conductive to control the charging of the energy storage element of the bottom bar from the photovoltaic output voltage of the at least one solar cell using the MPPT control technique

The at least one control circuit may be configured to determine the present light level of sunlight shining onto the at least one solar cell of the motorized treatment based on the short-circuit current using a look-up table, where the look-up table may include a plurality of present light level values and a respective, plurality of short-circuit current values.

The solar cell management circuit may include an input capacitor across which the photovoltaic output voltage of the at least one solar cell is coupled. During the discharge time period, the first semiconductor switch may be configured to conduct a current until a magnitude of the photovoltaic output voltage generated across the input capacitor drops to approximately zero volts. When the first semiconductor switch is rendered non-conductive at the end of the discharge time period, the at least one solar cell may be configured to conduct the photovoltaic output current into the input capacitor. The time period may indicate a time duration that it takes for the magnitude of the photovoltaic output voltage across the input capacitor to exceed the threshold voltage. The at least one control circuit may be configured to determine the short-circuit current of the at least one solar cell based on the time period, the threshold voltage, and/or a capacitance of the input capacitor.

The at least one control circuit may be configured to determine the time period based on a comparison between the magnitude of the photovoltaic output voltage generated by the at least one solar cell and the threshold voltage. The at least one control circuit may be configured to perform the comparison of the photovoltaic output voltage and the threshold voltage using computer executable instructions that are stored on a computer-readable storage medium of the motorized treatment. The at least one control circuit may be configured to perform the comparison of the photovoltaic output voltage and the threshold voltage using a comparator that receives as inputs the photovoltaic output voltage and the threshold voltage.

The at least one control circuit may be configured to determine a plurality of time periods, wherein each time period is based on a different, respective threshold voltage, determine an average value of the short-circuit current based on the plurality of time periods, and/or determine the present light level of the sunlight shining onto the solar cell based on the average value of the short-circuit current.

A motorized treatment may include a treatment assembly. The treatment assembly may include a covering material that extends from a top end to a bottom end and is operable between a plurality of positions. The treatment assembly may include a bottom bar attached to the bottom end of the covering material. The bottom bar may include a first power supply that is configured to generate a low-voltage supply voltage for powering one or more low-voltage electrical loads of the bottom bar, and a second power supply that is configured to receive a photovoltaic output voltage from the at least one solar cell and/or generate the low-voltage supply voltage for powering the one or more low-voltage electrical loads of the bottom bar. The treatment assembly may include at least one solar cell. The treatment assembly may include a motor drive unit comprising a motor that is configured to adjust the covering material to the plurality of positions. The treatment assembly may include an energy storage element that is configured to power the motor drive unit and/or configured to be charged from the energy storage element of the bottom bar. The treatment assembly (e.g., and/or other apparatuses, such as a system controller) may include at least one control circuit that is configured to perform any combination of the following. The at least one control circuit may determine whether to control the first power supply or the second power supply to generate the low-voltage supply voltage for powering the one or more low-voltage electrical loads of the bottom bar.

The at least one control circuit may be configured to determine whether a low-voltage flag is set in memory of the bottom bar and/or determine whether to control the first power supply or the second power supply to generate the low-voltage supply based on the low-voltage flag. The bottom bar may include a first switching circuit coupled in series between the first power supply and the one or more low-voltage electrical loads of the bottom bar, and/or a second switching circuit coupled in series between the second power supply and the one or more low-voltage electrical loads of the bottom bar. The low-voltage flag may include whether the first switching circuit or the second switching circuit is conductive. The at least one control circuit may be configured to set the low-voltage flag when the low-voltage supply voltage is less than a first low-voltage threshold voltage and/or render the first switching circuit non-conductive and the second switching circuit conductive based on the low-voltage flag being set. The at least one control circuit may be configured to clear the low-voltage flag when the low-voltage supply voltage is greater than a second low-voltage threshold voltage, and/or render the first switching circuit conductive and the second switching circuit non-conductive based on the low-voltage flag being cleared.

The low-voltage flag may include whether the first power supply or the second power supply is generating the low-voltage supply voltage. The low-voltage flag may be set when a control circuit of the bottom bar is initially powered up.

The at least one control circuit may be configured to control the first power supply to generate the low-voltage supply voltage when the low-voltage supply voltage is less than a first low-voltage threshold voltage, and/or control the second power supply to generate the low-voltage supply voltage when the low-voltage supply voltage is greater than a second low-voltage threshold voltage.

The at least one control circuit may be configured to determine whether to control the first power supply or the second power supply to generate the low-voltage supply voltage based on a magnitude of the low-voltage supply voltage. The at least one control circuit may be configured to generate the low-voltage supply voltage from the photovoltaic output voltage until the magnitude of the low-voltage supply voltage becomes greater than a low-voltage threshold voltage.

The low-voltage electrical loads of the bottom bar may include any combination of a control circuit, memory, a communication circuit, or a sensor circuit of the bottom bar.

A motorized treatment may include a treatment assembly. The treatment assembly may include a covering material that extends from a top end to a bottom end and is operable between a plurality of positions. The treatment assembly may include a bottom bar attached to the bottom end of the covering material. The treatment assembly may include at least one solar cell. The treatment assembly may include a motor drive unit comprising a motor and an energy storage element, where the motor is configured to adjust the covering material to the plurality of positions. The treatment assembly may include an energy storage element configured to power the motor drive unit. The treatment assembly (e.g., and/or other apparatuses, such as a system controller) may include at least one control circuit that is configured to perform any combination of the following. The at least one control circuit may collect solar data associated with the at least one solar cell, determine a transmission interval for transmitting the solar data via the communication circuit based on a magnitude of a supply voltage generated across the one or more energy storage elements of the bottom bar, and transmit the solar data via the communication circuit based on the transmission interval.

The at least one control circuit may be configured to adjust the transmission interval of the solar data transmitted via the communication circuit between two predetermined transmission intervals based on the magnitude of the supply voltage generated across the one or more energy storage elements of the bottom bar.

The at least one control circuit may be configured to decrease the transmission interval of the solar data transmitted via the communication circuit when a magnitude of a storage voltage of the one or more energy storage elements is greater than a transmission voltage threshold, and increase the transmission interval of the storage data transmitted via the communication circuit when the magnitude of the storage voltage is less than the transmission voltage threshold.

The at least one control circuit may be configured to transmit the solar data at a lower rate when the storage voltage is less than a transmission voltage threshold.

The at least one control circuit may be configured to collect the solar data at a timing interval and/or adjust the timing interval based on whether a present position of the covering material is being adjusted. The at least one control circuit may be configured to determine whether the present position of the covering material is being adjusted based on an output of a sensor circuit of the bottom bar. The sensor circuit may include an accelerometer or a gyroscope. The at least one control circuit may be configured to set the timing interval to an active interval value when a present position of the covering material is being adjusted, and/or set the timing interval to an inactive interval value when the present position of the covering material is not being adjusted, wherein the inactive interval value is longer than the active interval value.

The solar data may include performance values, where the performance values comprise any combination of a magnitude of a photovoltaic output voltage of the at least one solar cell, a magnitude of a storage voltage stored in the energy storage element configured to power the motor drive unit, a magnitude of a storage voltage stored in the energy storage element of the bottom bar, and/or a present light level of sunlight shining onto the at least one solar cell. The solar data may include operational characteristics, where the operational characteristics comprise any combination of an operating frequency, an operating period, an on-time, an off-time, or a duty cycle of a drive signal for controlling a semiconductor switch of the bottom bar. The solar data may include tracking information associated with the performance values or the operational characteristics, wherein the tracking information comprises any combination of timing information and/or position information of the covering material.

The at least one control circuit may be configured to determine a data update interval associated with the transmission of the solar data to a system controller based on a magnitude of a supply voltage generated across the energy storage element configured to power the motor drive unit. The at least one control circuit may be configured to determine a trend in the storage voltage over time of the energy storage element configured to power the motor drive unit, and/or determine the data update interval associated with the transmission of the solar data to the system controller based on the trend in the storage voltage.

The motorized treatment may operate as a data transmission manager for a plurality of motorized treatments.

A motorized treatment may include a treatment assembly. The treatment assembly may include a covering material that extends from a top end to a bottom end and is operable between a plurality of positions. The treatment assembly may include a bottom bar attached to the bottom end of the covering material. The treatment assembly may include at least one solar cell. The treatment assembly may include a motor drive unit comprising a motor and an energy storage element, where the motor is configured to adjust the covering material to the plurality of positions. The treatment assembly may include an energy storage element configured to power the motor drive unit. The treatment assembly (e.g., and/or other apparatuses, such as a system controller) may include at least one control circuit that is configured to perform any combination of the following. The at least one control circuit may collect solar data associated with the at least one solar cell, and determine a transmission interval of the solar data based on a magnitude of a supply voltage generated across the one or more storage elements of the bottom bar.

The at least one control circuit may be configured to receive additional solar data from one or more additional motorized treatments, and/or determine the transmission interval based on the solar data and the additional solar data.

One or more of the at least one control circuits may be comprised in a system controller that is physically separate from the motorized treatment.

A system may include a plurality of treatment assemblies, where each treatment assembly comprises a respective covering material that extends from a top end to a bottom end and is operable between a plurality of positions, and wherein each the treatment assembly comprises a respective bottom bar attached to the bottom end of the covering material, and where each the treatment assembly comprises at least one solar cell. The system may include at least one control circuit that is configured to perform any combination of the following. The at least one control circuit may collect respective solar data from each treatment assembly of the plurality of treatment assemblies, and assign one treatment assembly of the plurality of treatment assemblies as a data transmission manager, wherein subsequent solar data received from the data transmission manager is associated with the plurality of treatment assemblies.

The at least one control circuit may be configured to determine that the respective solar data for each treatment assembly of the plurality of treatment assemblies is within a threshold range, and assign the one treatment assembly of the plurality of treatment assemblies as the data transmission manager based on the respective solar data for each treatment assembly of the plurality of treatment assemblies being within the threshold range. The at least one control circuit may be configured to assign the one treatment assembly of the plurality of treatment assemblies as the data transmission manager based on proximity to a system controller.

The at least one control circuit may be configured to send a message to the one treatment assembly of the plurality of treatment assemblies to assign the one treatment assembly of the plurality of treatment assemblies as the data transmission manager.

The at least one control circuit may be configured to send a message that disables the transmission of solar data from all treatment assemblies of the plurality of treatment assemblies other than the one treatment assembly that is assigned as the data transmission manager.

The at least one control circuit may be configured to send a message that decreases a transmission rate of solar data from all treatment assemblies of the plurality of treatment assemblies other than the one treatment assembly that is assigned as the data transmission manager.

A motorized treatment may include a treatment assembly. The treatment assembly may include a covering material that extends from a top end to a bottom end and is operable between a plurality of positions. The treatment assembly may include a bottom bar attached to the bottom end of the covering material. The treatment assembly may include a motor drive unit comprising a motor and an energy storage element, where the motor is configured to adjust the covering material to the plurality of positions. The treatment assembly may include a communication circuit. The treatment assembly (e.g., and/or other apparatuses, such as a system controller) may include at least one control circuit that is configured to perform any combination of the following. The at least one control circuit may determine a movement power consumption caused by movements of the bottom bar by the motor, determine a communication power consumption caused by the communication circuit, and determine a total power consumption based on the movement power consumption and the communication power consumption.

The at least one control circuit may be configured to determine a first communication power consumption based on a number of first events and a first power consumption value, wherein the number of first events is associated with a number of times the communication circuit enters a wake up state and does not receive a message, determine a second communication power consumption based on a number of second events and a second power consumption value, wherein the number of second events is associated with a number of times the communication circuit enters the wake up state and does receive a message, wherein the second power consumption value is greater than the first power consumption value, and/or determine the communication power consumption based on the first communication power consumption and the second communication power consumption.

The at least one control circuit may be configured to determine a magnitude of a current drawn from the energy storage element during the movements of the bottom bar, determine a magnitude of a storage voltage of the energy storage element, and/or determine the movement power consumption based on the magnitude of the current drawn from the energy storage element during the movements of the bottom bar and the storage voltage associated with the energy storage element.

The at least one control may be configured to determine the movement power consumption caused by movements of the bottom bar based on a power profile, wherein the power profile indicates a respective amount of power consumed by movements of the bottom bar to each of a plurality of different positions.

The at least one control may be configured to determine a first movement power consumption caused by movements where the bottom bar is being lowered, determine a second movement power consumption caused by movements where the bottom bar is being raised, and determine the movement power consumption based on the first movement power consumption and the second movement power consumption.

The at least one control circuit may be configured to determine an estimated end of life of the energy storage element based on an amount of charge remaining in the energy storage element and the total power consumption of the motorized treatment. The at least one control circuit may be configured to determine the estimated end of life of the energy storage element based on a trend of the amount of charge remaining in the energy storage element over time. The estimated end of life of the energy storage element may indicate a time when the storage voltage of the energy storage element will fall below a threshold storage level. The energy storage element may be a first energy storage element, the motorized treatment may include a second energy storage element configured to power the motor drive unit, and where the at least one control circuit is configured to determine a first storage voltage of the first energy storage element, determine a second storage voltage of the second energy storage element, and/or determine whether to control the position of the bottom bar using the first storage voltage of the first energy storage element or the second storage voltage of the second energy storage element.

The at least one control circuit may be configured to determine a total low-voltage energy consumption caused by one or more low-voltage electrical loads of the motor drive unit and the communication circuit, and/or determine the total power consumption based on the movement power consumption and the total low-voltage energy consumption. The at least one control circuit may be configured to sense a magnitude of load current conducted by a power supply that supplies power to the one or more low-voltage electrical loads and the communication circuit during a timing interval, and/or determine the total low-voltage energy consumption caused by the one or more low-voltage electrical loads and the communication circuit during the timing interval based on the magnitude of load current conducted by the power supply during the timing interval. The at least one control circuit may be configured to determine an average of the total low-voltage energy consumption over multiple instances of the timing interval.

A motorized treatment may include a treatment assembly that includes a covering material that extends from a top end to a bottom end and is operable between a plurality of positions, the treatment assembly further comprising a bottom bar attached to the bottom end of the covering material. The treatment assembly may include at least one solar cell. The treatment assembly may include a motor drive unit comprising a motor, a communication circuit, where the motor is configured to adjust the covering material to the plurality of positions. The treatment assembly may include an energy storage element configured to power the motor drive unit. The treatment assembly (e.g., and/or other apparatuses, such as a system controller) may include at least one control circuit that is configured to perform any combination of the following. The at least one control circuit may generate a solar data structure that comprises a plurality of records, where each record comprises a magnitude of power collected by the at least one solar cell, a time when the magnitude of power is collected, and a position of the bottom bar when the magnitude of power is collected.

The motorized treatment may include a dock comprising a first pair of electrical contacts, where the bottom bar comprises a second pair of electrical contacts. The at least one control circuit may be configured to control the position of the bottom bar to a docking position, the docking position comprising the first pair of electrical contacts of the dock electrically connected to the second pair of electrical contacts of the bottom bar, retrieve solar data from the bottom bar, determine a time of a last dock event, the last dock event being characterized by a most recent time of the plurality of times within the solar data structure, and generate a new record in the solar data structure based on the time of the last dock event, wherein the new record in the solar data structure comprises a first time, a first position, and a first magnitude of power collected by the at least one solar cell. The solar data may include the first magnitude of power, and the at least one control circuit may be configured to associate the first position and the first time with the first magnitude of power. The at least one control circuit may be configured to generate a second new record in the solar data structure based on a time of the last dock event, where the second new record in the solar data structure comprises a second time, a second position, and a second magnitude of power collected by the at least one solar cell. The at least one control circuit may be configured to determine that the solar data does not comprise additional magnitudes of power that postdate the time of the last dock event, and store the solar data structure in a memory.

The docking position may be associated with a first timestamp. The at least one control circuit may be configured to control the position of the bottom bar to a second docking position, wherein the second docking position is associated with a second timestamp that postdates the first timestamp, retrieve second solar data from the bottom bar associated with a time period between the first timestamp and the second timestamp, and generate one or more additional records based on the second solar data.

The plurality of times of the solar data structure may include any combination of a time of day, a day of a week, a month of a year, or a year.

The at least one control circuit may be configured to control a present position of the covering material to a plurality of intermediate positions of the covering material between a raised position and a lowered position, determine a maximum-solar-power position between the raised position and the lowered position at which the at least solar cell will receive a maximum magnitude of solar power based on the solar data structure, and control the present position of the covering material to the maximum-solar-power position.

The at least one control circuit may be configured to determine an average charge or an average solar energy captured by the at least one solar cell over a time period, determine an average consumed charge or an average consumed energy that is consumed from the energy storage element over the time period, and generate an indication of a problem with a lifetime of the motorized treatment based on at least one of (i) a comparison between the average charge captured by the at least one solar cell to the average consumed charge that is consumed from the energy storage element or (ii) a comparison between the average solar energy captured by the at least one solar cell to the average consumed energy that is consumed from the energy storage element. The average consumed charge that is consumed from the energy storage element may indicate an average of a total consumed charge that is consumed from the energy storage element during each of a plurality of different accumulation intervals. The average consumed energy that is consumed from the energy storage element may indicate an average of a total consumed energy that is consumed from the energy storage element during each of the plurality of different accumulation intervals. Each accumulation interval of the plurality of accumulation intervals may be the same time duration, such as a day or a week. The total consumed charge that is consumed from the energy storage element during each accumulation interval may include an average consumed charge that is consumed by a motor drive circuit of the motor drive unit and the motor, and/or an average consumed charge that is consumed by a power supply of the motor drive unit and one or more low-voltage electrical loads that are powered by the power supply of the motor drive unit. The total consumed energy that is consumed by the energy storage element during each accumulation interval may include an average consumed energy that is consumed by the motor drive circuit of the motor drive unit and the motor, and/or an average consumed energy that is consumed by the power supply of the motor drive unit and the one or more low-voltage electrical loads that are powered by the power supply of the motor drive unit.

The time period may be at least nine months in duration.

The at least one control circuit may be configured to generate the indication of the problem with the lifetime of the motorized treatment when the comparison indicates that that motorized treatment is consuming more charge or energy than is being captured by the at least one solar cell.

The at least one control circuit may be configured to generate the indication of the problem with the lifetime of the motorized treatment when the comparison indicates that a trend has a negative slope, where for example, the trend may be between at least one of (i) the average charge captured by the at least one solar cell and the average consumed charge that is consumed from the energy storage element and/or (ii) the average solar energy captured by the at least one solar cell and the average consumed energy that is consumed from the energy storage element.

The at least one control circuit may be configured to generate the indication of the problem with the lifetime of the motorized treatment when the comparison indicates that the lifetime of the motorized treatment is less than a number of years or less than a number of months.

The indication of the problem with the lifetime of the motorized treatment may include an alert that indicates that the motorized treatment should be serviced.

The indication of the problem with the lifetime of the motorized treatment may include a message that is sent by the motorized treatment to a use device or a system controller that indicates that the motorized treatment should be serviced.

The indication of the problem with the lifetime of the motorized treatment may include a message that indicates a recommended docking schedule or a recommended position for the covering material that will resolve the problem.

The at least one control circuit may be configured to illuminate an LED of the motorized treatment to generate the indication of the problem with the lifetime of the motorized treatment.

The at least one control circuit may be configured to cause the motor to adjust the covering material at a set speed or move the covering material up and down to generate the indication of the problem with the lifetime of the motorized treatment.

The at least control circuit may be configured to apply an updating docking schedule to resolve the problem.

Finally, although the Summary is drafted from the perspective of an apparatus, such as a motorized treatment (e.g., a motorized window treatment) and/or a system controller, the concepts described herein may be captured as a method that is performed by one or more apparatuses and/or as one or more computer-readable storage medium that are located on one or more apparatuses.

### BRIEF DESCRIPTION OF THE DRAWINGS

FIG. 1 is a diagram of an example load control system.

FIG. 2 is a perspective view of an example motorized window treatment.

FIG. 3 is a rear perspective view of the motorized window treatment of FIG. 2.

FIG. 4 is a front perspective view of a window treatment assembly of FIG. 2.

FIG. 5 is a rear perspective view of the window treatment assembly of FIG. 4.

FIG. 6 is a left-side view of the window treatment assembly of FIG. 4.

FIG. 7 is a perspective view of a motor drive unit of the window treatment assembly of FIG. 4.

FIG. 8 is a partial enlarged perspective view of the motor drive unit of FIG. 7.

FIG. 9 is a front view of the motor drive unit of FIG. 7.

FIG. 10 is a top view of the motor drive unit of FIG. 7.

FIG. 11 is a left-side view of the motor drive unit of FIG. 7.

FIG. 12 is a partial enlarged rear perspective view of a bottom bar of the window treatment assembly of FIG. 4.

FIG. 13 is a left-side cross section view of the bottom bar of FIG. 12.

FIG. 14 is a partial enlarged perspective view of another example motor drive unit for use in a motorized window treatment.

FIG. 15A is a rear perspective view of another example motorized window treatment.

FIG. 15B is a partial enlarged perspective view of a motor drive unit of the motorized window treatment of FIG. 15A.

FIG. 16A is a block diagram of an example motor drive unit of a motorized window treatment.

FIG. 16B is a block diagram of an example motor drive unit of a motorized window treatment.

FIG. 16C is a block diagram of an example motorized window treatment.

FIG. 17A is a schematic view of an example of a solar power system of a motorized window treatment.

FIG. 17B is a schematic view of a portion of an example motor drive unit of a motorized window treatment.

FIG. 18A is an example solar data structure that may be used by and/or generated by a motorized window treatment.

FIGS. 18B-18E illustrate example plots of solar energy with respect to time for a number of different motorized window treatments installed in a building.

FIG. 19 is a sequence flow diagram illustrating an example sequence flow of a system that includes a motorized window treatment, a system controller, and a network device.

FIG. 20A is a flowchart of an example procedure for adjusting a present position of a covering material of a motorized window treatment.

FIG. 20B is a flowchart of an example procedure for adjusting a present position of a covering material of a motorized window treatment.

FIG. 20C is a flowchart of an example procedure for adjusting a present position of a covering material of a motorized window treatment.

FIG. 21 is a flowchart of an example procedure for determining when to dock a bottom bar of a motorized window treatment.

FIGS. 22A-22G are flowcharts of example procedures for determining when to dock a bottom bar of a motorized window treatment.

FIG. 23A is a flowchart of an example procedure for docking a bottom bar of a motorized window treatment.

FIG. 23B is a flowchart of an example procedure for docking a bottom bar of a motorized window treatment.

FIG. 23C is a flowchart of an example procedure for docking a bottom bar of a motorized window treatment.

FIG. 24 is a flowchart of an example procedure for adjusting a present position of a covering material of a motorized window treatment in response to a solar power being received by one or more solar cells of the motorized window treatment.

FIG. 25A is a flowchart of an example procedure for configuring a motorized window treatment.

FIG. 25B is a flowchart of an example procedure for configuring a motorized window treatment.

FIGS. 26A and 26B are flowcharts of example procedures for collecting solar data for a motorized window treatment when a motor drive unit is configured to communicate with a bottom bar module via a wireless communication link.

FIGS. 27A-27B are flowcharts of example procedures for collecting solar data for a motorized window treatment when a motor drive unit is configured to communicate with a bottom bar module via a wired communication link when a bottom bar of the motorized window treatment is docked.

FIGS. 28A and 28B are example procedures for controlling a solar power system of a bottom bar module of a bottom bar of a motorized window treatment.

FIG. 29A is an example procedure for controlling a solar power system of a bottom bar module of a bottom bar of a motorized window treatment.

FIG. 29B is an example procedure for collecting solar data for a solar power system of a motorized window.

FIG. 30A is an example procedure for collecting solar data for a motorized window treatment.

FIG. 30B is an example procedure for charging an energy storage element of a solar power system of a motorized window treatment.

FIG. 31 is an example procedure for collecting solar data for a motorized window treatment.

FIGS. 32A-32D are flowcharts of example procedures for configuring a motorized window treatment.

FIGS. 33 and 34 are flowcharts of example procedures for configuring a motorized window treatment.

FIGS. 35 and 36 are flowcharts of example procedures for adjusting a present position P_{PRES} of a covering material of a motorized window treatment.

FIG. 37 is a flowchart of an example procedure that may be executed by a control circuit of a motor drive unit of the motorized window treatment.

FIGS. 38A-38B are flowcharts of example procedures that may be executed by a control circuit of a motor drive unit of the motorized window treatment.

FIG. 39 is a flowchart of an example procedure that may be executed by a control circuit of a motor drive unit of the motorized window treatment.

FIG. 40 is an example procedure for generating a solar data structure based on solar data for a motorized window treatment.

FIG. 41A is a flowchart of an example procedure for controlling a motorized window treatment based on solar data.

FIG. 41B is a flowchart of an example procedure for controlling a motorized window treatment based on solar data.

FIG. 42A is a flowchart of an example procedure that may be executed to determine a data update interval for transmitting updated solar data from a motor drive unit of a motorized window treatment.

FIG. 42B is a flowchart of an example procedure that may be executed to determine a data transmission manager from motor drive units of a plurality of motorized window treatments.

FIG. 43 is a flowchart of an example procedure to calculate a total power consumption of the motor drive unit.

FIG. 44 is a flowchart of an example procedure that may be executed to determine a state of charge and/or an end of life indication of one or more energy storage elements of a motorized window treatment.

FIG. 45 is a flowchart of an example procedure for determining a total low-voltage energy consumed from an energy storage element by electrical loads of a motor drive unit.

FIG. 46 is a flowchart of an example procedure for determining a total energy consumed from an energy storage element by electrical loads of the motor drive unit.

FIG. 47 is a flowchart of an example procedure for predicting whether a motorized window treatment having solar cells for powering a motor drive unit will run into a problem related to the ability to charge the energy storage elements of the motorized window treatment based on the solar cells.

FIG. 48 is a flowchart of an example procedure for controlling a plurality of power supplies of a solar power system of a motorized window treatment.

FIG. 49 is a flowchart of an example procedure for determining a present light level of the sunlight shining onto the solar cells of a motorized window treatment based on a short-circuit current of the solar cells of a motorized window treatment.

FIG. 50 is a flowchart of an example procedure for determining a present light level of the sunlight shining onto the solar cells of a motorized window treatment based on a short-circuit current of the solar cells of a motorized window treatment.

### DETAILED DESCRIPTION

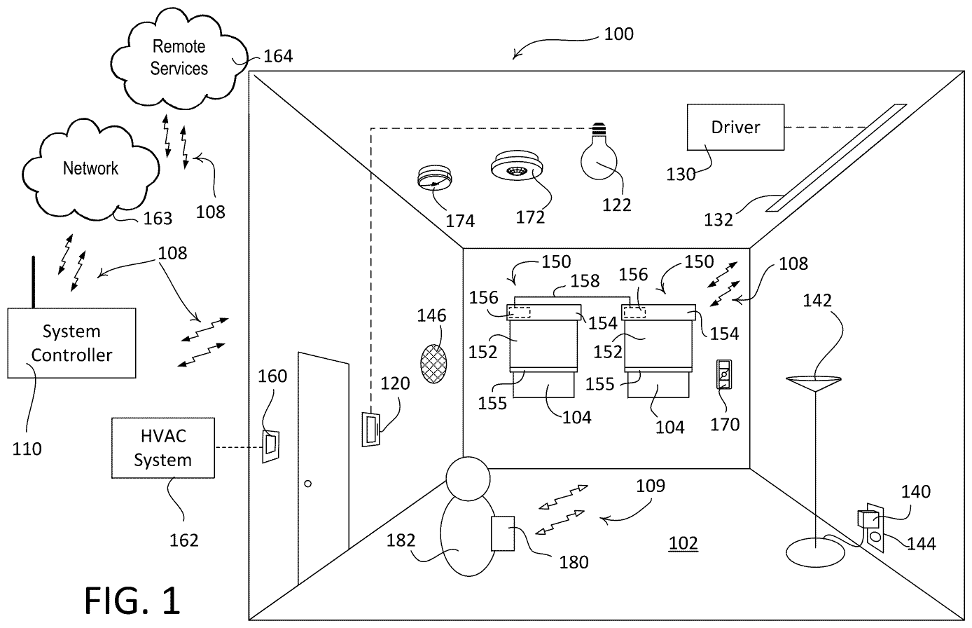

FIG. 1 is a diagram of an example load control system 100 for controlling an amount of power delivered from a power source (not shown), such as an alternating-current (AC) power source or a direct-current (DC) power source, to one or more electrical loads. The load control system 100 may be installed in a room 102 of a building. The load control system 100 may comprise a plurality of control devices configured to communicate with each other by transmitting and receiving messages (e.g., digital messages) via wireless signals, e.g., radio-frequency (RF) signals 108. Alternatively or additionally, the load control system 100 may comprise a wired digital communication link coupled to one or more of the control devices to provide for communication between the control devices. The control devices of the load control system 100 may comprise a number of control-source devices (e.g., input devices operable to transmit messages in response to user inputs, occupancy and/or vacancy conditions, changes in measured light intensity, etc.) and a number of control-target devices (e.g., load control devices operable to receive messages and control respective electrical loads in response to the received messages). A single control device of the load control system 100 may operate as both a control-source and a control-target device.

The control-source devices may be configured to transmit messages directly to the control-target devices. In addition, the load control system 100 may comprise a system controller 110 (e.g., a central processor or load controller) configured to communicate messages to and from the control devices (e.g., the control-source devices and/or the control-target devices). For example, the system controller 110 may be configured to receive messages from the control-source devices and transmit messages to the control-target devices in response to the messages received from the control-source devices.

The load control system 100 may comprise one or more load control devices, such as a dimmer switch 120 (e.g., a control-target device) for controlling a lighting load 122. The dimmer switch 120 may be configured to control an amount of power delivered from the AC power source to the lighting load to adjust an intensity level and/or a color (e.g., a color temperature) of the lighting load. The dimmer switch 120 may be adapted to be wall-mounted in a standard electrical wallbox. The dimmer switch 120 also comprise a tabletop or plug-in load control device. The dimmer switch 120 may comprise a toggle actuator (e.g., a button) and an intensity adjustment actuator (e.g., a rocker switch). Actuations (e.g., successive actuations) of the toggle actuator may toggle (e.g., turn off and on) the lighting load 122. Actuations of an upper portion or a lower portion of the intensity adjustment actuator may respectively increase or decrease the amount of power delivered to the lighting load 122 and thus increase or decrease the intensity of the receptive lighting load from a minimum intensity (e.g., approximately 1%) to a maximum intensity (e.g., approximately 100%). The dimmer switch 120 may comprise a plurality of visual indicators, e.g., light-emitting diodes (LEDs), which are arranged in a linear array and are illuminated to provide feedback of the intensity of the lighting load 122. Examples of wall-mounted dimmer switches are described in greater detail in U.S. Pat. No. 9,679,696, issue Jun. 13, 2017, entitled WIRELESS LOAD CONTROL DEVICE, the entire disclosure of which is hereby incorporated by reference.

The dimmer switch 120 may be configured to wirelessly receive messages via the RF signals 108 (e.g., from the system controller 110) and to control the lighting load 122 in response to the received messages. Examples of dimmer switches and other control devices configured to transmit and receive messages are described in greater detail in U.S. Pat. No. 10,041,292, issued Aug. 7, 2018, entitled LOW-POWER RADIO-FREQUENCY RECEIVER, and U.S. Pat. No. 10,271,407, issued Apr. 23, 2019, entitled LOAD CONTROL DEVICE HAVING INTERNET CONNECTIVITY, the entire disclosures of which are hereby incorporated by reference.

The load control system 100 may comprise one or more remotely-located load control devices, such as a light-emitting diode (LED) driver 130 (e.g., a control-target device) for driving an LED light source 132 (e.g., an LED light engine). The LED driver 130 may be located remotely, for example, in or adjacent to the lighting fixture of the LED light source 132. The LED driver 130 may be configured to receive messages via the RF signals 108 (e.g., from the system controller 110) and to control the LED light source 132 in response to the received messages. The LED driver 130 may be configured to adjust the color temperature of the LED light source 132 in response to the received messages. The load control system 100 may further comprise other types of remotely-located load control devices, such as, for example, electronic dimming ballasts for driving fluorescent lamps.

The load control system 100 may comprise a plug-in load control device 140 (e.g., a control-target device) for controlling a plug-in electrical load, e.g., a plug-in lighting load (e.g., such as a floor lamp 142 or a table lamp) and/or an appliance (e.g., such as a television or a computer monitor). For example, the floor lamp 142 may be plugged into the plug-in load control device 140. The plug-in load control device 140 may be plugged into a standard electrical outlet 144 and thus may be coupled in series between the AC power source and the plug-in lighting load. The plug-in load control device 140 may be configured to receive messages via the RF signals 108 (e.g., from the system controller 110) and to turn on and off or adjust the intensity of the floor lamp 142 in response to the received messages. Alternatively or additionally, the load control system 100 may comprise controllable receptacles (e.g., control-target devices) for controlling plug-in electrical loads plugged into the receptacles. The load control system 100 may comprise one or more load control devices or appliances that are able to directly receive the RF signals 108 from the system controller 110, such as a speaker 146 (e.g., part of an audio/visual or intercom system), which is able to generate audible sounds, such as alarms, music, intercom functionality, etc.

The load control system 100 may comprise one or more daylight control devices, e.g., motorized window treatments 150 (e.g., control-target devices), such as motorized roller shades, for controlling the amount of daylight entering the room 102. Each motorized window treatment 150 may comprise a covering material 152 (e.g., a window treatment fabric) hanging from a roller tube 154 in front of a respective window 104 with a respective bottom bar 155 connected to a bottom end of the respective covering material 152. The covering material 152 may be wound around and unwound from the roller tube 154 for respectively raising and lowering the covering material 152. Each motorized window treatment 150 may further comprise a motor drive unit 156 located inside of the roller tube 154 and having a motor for rotating the roller tube 154 to raise and lower the covering material 152 for controlling the amount of daylight entering the room 102. The motor drive units 156 may be configured to adjust a present position P_{PRES} of the respective covering material 152 between a raised position P_{RAISED} (e.g., a fully-raised position and/or a fully-open position) and a lowered position P_{LOWERED} (e.g., a fully-lowered position and/or a fully-closed position).

The motor drive units 156 of the motorized window treatments 150 may each be configured to communicate (e.g., transmit and/or receive) messages via the RF signals 108. For example, the motor drive units 156 of the motorized window treatments 150 may each be configured to receive messages (e.g., from the system controller 110) and adjust the present position P_{PRES} of the respective covering material 152 in response to the received messages. The motor drive unit 156 of each of the motorized window treatments 150 may be battery-powered or may be coupled to an external alternating-current (AC) or direct-current (DC) power source. The load control system 100 may comprise other types of daylight control devices, such as, for example, a cellular shade, a drapery, a Roman shade, a Venetian blind, a Persian blind, a pleated blind, a tensioned roller shade system, an electrochromic or smart window, and/or other suitable daylight control device. Examples of battery-powered motorized window treatments are described in greater detail in U.S. Pat. No. 10,494,864, issued Dec. 3, 2019, entitled MOTORIZED WINDOW TREATMENT, the entire disclosure of which is hereby incorporated by reference.

The motor drive units 156 of the respective motorized window treatments 150 may be configured to rotate the respective roller tubes 154 at a respective rotational speed to move the covering materials 152 (e.g., bottom ends of the covering materials) at the same linear speed, such that the positions of the covering materials 152 may remained aligned even when the diameters of the respective roller tubes 154 are different (e.g., particularly when the motorized window treatment 150 are mounted adjacent to each other as shown in FIG. 1). For example, if the diameters of the respective roller tubes 154 are the same, the motor drive units 156 of the respective motorized window treatments 150 may rotate their respective roller tubes 154 at the same rotational speed to move the covering materials 152 (e.g., bottom ends of the covering materials) at the same linear speed. However, if diameters of the respective roller tubes 154 are different, the motor drive units 156 may rotate their respective roller tubes 154 at a rotational speed that is based on the diameter of their respective roller tube 154 to move the respective covering materials 152 (e.g., bottom ends of the covering materials) at the same linear speed. The linear speed of the covering material 152 of a motorized window treatments 150 may refer to the speed at which the bottom end of the covering material moves (e.g., vertically) toward or away from the roller tube 154. The linear speed v of the covering material 152 each of the motorized window treatments 150 may be a function of the rotational speed ω and the diameter d of the roller tube 154, e.g.,

$$v = 1 / 2 \cdot d \cdot ω .$$

Each of the motor drive units 156 of the motorized window treatments 150 may take into account the diameter d of the respective roller tube 154 and control the rotational speed @ of the respective motor, such that the linear speed v of the covering material 152 of each of the motorized window treatments 150 may be the same.

Each of the motor drive units 156 may also take into account an amount of the respective covering material 152 wrapped around each of the roller tubes 154 when determining the rotational speed ω at which to rotate the respective motor such that the linear speed v of the covering material 152 of each of the motorized window treatments 150 may be the same. For example, the linear speed v of the covering material 152 each of the motorized window treatments 150 may be a function of the rotational speed ω, the diameter d of the roller tube 154, a thickness t of the covering material 152, and a number N of full rotations of the covering material 152 that are presently wound around the roller tube 154, e.g.,

$$v = 1 / 2 \cdot [ d + ( 2 \cdot t \cdot N ) ] \cdot ω .$$

Each of the motor drive units 156 may update the number N of full rotations of the covering material 152 that are wound around the roller tube 154 as the roller tube 154 is rotated to move the covering material 152 between the raised position P_{RAISED} and the lowered position P_{LOWERED}. Each of the motor drive units 156 may adjust the rotational speed @ of the respective roller tube 156 such that the linear speed v of the covering material may be constant between the raised position P_{RAISED} and the lowered position P_{LOWERED} (e.g., the rotational speed ω is not constant between the raised position P_{RAISED} and the lowered position P_{LOWERED} and is a function of the number N of full rotations of the covering material 152 that are presently wound around the roller tube 154). Examples of motor drive units configured to the rotational speed of a motor while taking into account the diameter of the roller tube 154 and the amount of the covering material 152 wrapped around each of the roller tube 154 are described in greater detail in U.S. Pat. No. 7,281,565, issue Oct. 16, 2007, entitled SYSTEM FOR CONTROLLING ROLLER TUBE ROTATIONAL SPEED FOR CONSTANT LINEAR SHADE SPEED, the entire disclosure of which is hereby incorporated by reference.

Each of the motorized window treatments 150 may comprise one or more solar cells (e.g., photovoltaic cells) (not shown). For example, the one or more solar cells may be located on the bottom bars 155 of the motorized window treatments 150. The bottom bars 155 may each comprise an energy storage element configured to charge from the one or more solar cells. The motor drive units 156 may be configured to control the respective covering materials 152 to the raised position P_{RAISED} to allow the energy storage element in the bottom bar to discharge into an energy storage element of the respective motor drive unit 156 for producing a storage voltage across the energy storage element. The motor drive units 156 may each be configured to drive the respective motor from the storage voltage produced across the energy storage element in the respective motor drive unit.

The motor drive unit 156 of the motorized window treatments 150 may be coupled together via a power bus 158 (e.g., a DC power bus). The motor drive units 156 of one or more of the motorized window treatments 150 may be configured to charge the energy storage elements of the motor drive unit 156 of one or more of the other motorized window treatments 150 via the power bus 158. The power bus 158 may be electrically coupled to the motor drive units 156 in a daisy-chain configuration (e.g., with the motor drive units 156 coupled in parallel). The power bus 158 may comprise two electrical conductors (e.g., wires) across which the storage voltage of the energy storage element of the motor drive unit 156 of one or more of the motorized window treatments 150 may be coupled for charging the energy storage elements of the motor drive units 156 of the one or more other motorized window treatments 150.

The motor drive units 156 of the motorized window treatments 150 may each be configured to learn the magnitudes of the storage voltages of the energy storage elements of the other motor drive units 156. For example, the motor drive units 156 may each periodically transmit a message including an indication of the magnitude of the storage voltage of the respective energy storage element (e.g., via the RF signals 108). Each of the motor drive units 156 may be configured to determine whether or not to charge the respective energy storage elements of the other motorized window treatments 150 in response to the magnitude of the storage voltage of its energy storage element as well as the magnitudes of the storage voltages of the energy storages elements of the other motorized window treatments 150 received in the messages (e.g., via the RF signals 108).

When the one or more solar cells of a particular motorized window treatment 150 (e.g., the one or more solar cells on the respective bottom bar 155) are not able to receive solar power as efficiently as the solar cells of the other motorized window treatments 150, the motor drive unit 156 of that motorized window treatment 150 may not be able to properly drive its motor to move the covering material 152. The motor drive units 156 of the one or more motorized window treatments 150 may each be configured to charge the energy storage elements of one or more of the other motorized window treatments 150 in response to determining that the one or more of the other motorized window treatments needs to be charged.

The load control system 100 may comprise one or more temperature control devices, e.g., a thermostat 160 (e.g., a control-target device) for controlling a room temperature in the room 102. The thermostat 160 may be coupled to a heating, ventilation, and air conditioning (HVAC) system 162 via a control link (e.g., an analog control link or a wired digital communication link). The thermostat 160 may be configured to wirelessly communicate messages with a controller of the HVAC system 162. The thermostat 160 may comprise a temperature sensor for measuring the room temperature of the room 102 and may control the HVAC system 162 to adjust the temperature in the room to a setpoint temperature. The load control system 100 may comprise one or more wireless temperature sensors (not shown) located in the room 102 for measuring the room temperatures. For example, the thermostat 160 and the wireless temperature sensors may be battery-powered. The HVAC system 162 may be configured to turn a compressor on and off for cooling the room 102 and to turn a heating source on and off for heating the rooms in response to the control signals received from the thermostat 160. The HVAC system 162 may be configured to turn a fan of the HVAC system on and off in response to the control signals received from the thermostat 160. The thermostat 160 and/or the HVAC system 162 may be configured to control one or more controllable dampers to control the air flow in the room 102.

The load control system 100 may comprise one or more input devices (e.g., control-source devices), such as a remote control device 170, an occupancy sensor 172, and/or a daylight sensor 174. The input devices may be fixed or movable input devices. The remote control device 170, the occupancy sensor 172, and/or the daylight sensor 174 may be wireless control devices (e.g., RF transmitters) configured to transmit messages via the RF signals 108 to the system controller 110 (e.g., directly to the system controller). The system controller 110 may be configured to transmit one or more messages to the load control devices (e.g., the dimmer switch 120, the LED driver 130, the plug-in load control device 140, the motorized window treatments 150, and/or the thermostat 160) in response to the messages received from the remote control device 170, the occupancy sensor 172, and/or the daylight sensor 174. The remote control device 170, the occupancy sensor 172, and/or the daylight sensor 174 may also and/or alternatively be configured to transmit messages directly to the dimmer switch 120, the LED driver 130, the plug-in load control device 140, the motorized window treatments 150, and the temperature control device 160.

The remote control device 170 may be configured to transmit messages to the system controller 110 and/or a control-target device via the RF signals 108 in response to an actuation of one or more buttons of the remote control device. For example, the remote control device 170 may be battery-powered. Examples of remote control devices are described in greater detail in U.S. Pat. No. 9,361,790, issued Jun. 7, 2016, entitled REMOTE CONTROL FOR A WIRELESS LOAD CONTROL SYSTEM, and U.S. Pat. No. 9,633,557, issued Apr. 25, 2017, entitled BATTERY-POWERED RETROFIT REMOTE CONTROL DEVICE, the entire disclosures of which are hereby incorporated by reference.

The occupancy sensor 172 may be configured to detect occupancy and vacancy conditions in the room 102 (e.g., the room in which the occupancy sensors are mounted). For example, the occupancy sensor 172 may be battery-powered. The occupancy sensor 172 may transmit digital messages to the system controller 110 and/or a control-target device via the RF signals 108 in response to detecting the occupancy or vacancy conditions. The system controller 110 may be configured to control load control devices (e.g., the dimmer switch 120, the LED driver 130, and/or the motorized window treatments 150) in response to receiving an occupied command and a vacant command from the occupancy sensor 172. In addition, the load control devices may be responsive to an occupied command and a vacant command received directly from the occupancy sensor 172. Examples of RF load control systems having occupancy and vacancy sensors are described in greater detail in U.S. Pat. No. 8,009,042, issued Aug. 30, 2011, entitled RADIO-FREQUENCY LIGHTING CONTROL SYSTEM WITH OCCUPANCY SENSING, the entire disclosure of which is hereby incorporated by reference.

The daylight sensor 174 may be configured to measure a total light intensity in the room 102 (e.g., the room in which the daylight sensor is installed). For example, the daylight sensor 174 may be battery-powered. The daylight sensor 174 may transmit digital messages (e.g., including the measured light intensity) to the system controller 110 via the RF signals 108 for controlling the intensities of the lighting load 122 and/or the LED light source 132 in response to the measured light intensity. The system controller 110 may be configured to control the load control devices (e.g., the dimmer switch 120, the LED driver 130, and/or the motorized window treatments 150) in response to receiving a message including the measured light intensity from the daylight sensor 174. In addition, the load control devices may be responsive to a message including the measured light intensity received directly from the daylight sensor 174. Examples of RF load control systems having daylight sensors are described in greater detail in U.S. Pat. No. 8,451,116, issued May 28, 2013, entitled WIRELESS BATTERY-POWERED DAYLIGHT SENSOR, the entire disclosure of which is hereby incorporated by reference.

Each of the input devices (e.g., the system controller 110, the remote control device 170, the occupancy sensor 172, and/or the daylight sensor 174) may be configured to transmit a message to the load control devices (e.g., the dimmer switch 120, the LED driver 130, the plug-in load control device 140, the motorized window treatments 150, and/or the thermostat 160) multiple times during a transmission event. For example, each of the messages of a transmission event may include the same command for controlling one or more of the load control devices. The input devices may be configured to transmit the messages periodically (e.g., at a transmission interval TIX) during the transmission event. The load control devices that are battery-powered (e.g., the motorized window treatments 150) may be configured to periodically wake up from a sleep state (e.g., at a wake-up interval T_{WAKE-UP}) to determine if one of the multiple messages of the transmission event is being transmitted (e.g., during a wake-up event). The transmission interval TIX and the wake-up interval T_{WAKE-UP} may be sized such that each of the load control devices (e.g., the motorized window treatments 150) may not receive each of the multiple messages of the transmission event, but such that most of the load control devices may have received at least one of the messages when a predetermined number of the multiple messages of the transmission event have been transmitted. Each of the motorized window treatments may wait until the predetermined number of the multiple messages of the transmission event have been transmitted before responding to the command. For example, the motorized window treatments may begin adjusting the present positions P_{PRES} of the respective covering materials at a time (e.g., a coordinated action time) that is based on the time at which the predetermined number of the multiple messages of the transmission event have been transmitted (e.g., immediately following when the predetermined number of the multiple messages of the transmission event have been transmitted).

The system controller 110 may be configured to be coupled to a network, such as a wireless or wired local area network (LAN), e.g., for access to the Internet. The system controller 110 may be wirelessly connected to the network. The system controller 110 may be coupled to the network via a network communication bus (e.g., an Ethernet communication link). The system controller 110 may be configured to communicate via the network with one or more network devices, e.g., a mobile device 180, such as, a mobile personal computing device and/or a wearable wireless device. The mobile device 180 may be located on an occupant 182, for example, may be attached to the occupant's body or clothing or may be held by the occupant. The mobile device 180 may be characterized by a unique identifier (e.g., a serial number or address stored in memory) that uniquely identifies the mobile device 180 and thus the occupant 182. Examples of mobile personal computing devices may include a smart phone, a laptop, and/or a tablet device. Examples of wearable wireless devices may include an activity tracking device, a smart watch, smart clothing, and/or smart glasses. The system controller 110 may be configured to communicate via the network with one or more other network devices, e.g., a stationary computing device, such as a stationary personal computing device (e.g., a personal computer) and/or a server. In addition, the system controller 110 may be configured to communicate via the network with one or more other control systems (e.g., a building management system, a security system, etc.).

The mobile device 180 may be configured to transmit digital messages via RF signals 109 to the system controller 110 and/or the load control devices, for example, in one or more Internet Protocol packets. For example, the mobile device 180 may be configured to transmit digital messages to the system controller 110 over the LAN and/or via the Internet. The mobile device 180 may be configured to transmit digital messages over the internet to an external service, and then the digital messages may be received by the system controller 110. The load control system 100 may comprise other types of network devices coupled to the network, such as a desktop personal computer (PC), a wireless-communication-capable television, or any other suitable Internet-Protocol-enabled device.

The operation of the load control system 100 may be programmed and configured using, for example, the mobile device 180 or other network device (e.g., when the mobile device is a personal computing device). The mobile device 180 may execute a graphical user interface (GUI) configuration software for allowing a user to program how the load control system 100 will operate. For example, the configuration software may run as a PC application or a web interface. The configuration software and/or the system controller 110 (e.g., via instructions from the configuration software) may generate a load control database that defines the operation of the load control system 100. For example, the load control database may include information regarding the operational settings of different load control devices of the load control system (e.g., the dimmer switch 120, the LED driver 130, the plug-in load control device 140, the motorized window treatments 150, and/or the thermostat 160). The load control database may comprise information regarding associations between the load control devices and the input devices (e.g., the remote control device 170, the occupancy sensor 172, and/or the daylight sensor 174). The load control database may comprise information regarding how the load control devices respond to inputs received from the input devices. Examples of configuration procedures for load control systems are described in greater detail in U.S. Pat. No. 10,027,127, issued Jul. 17, 2018, entitled COMMISSIONING LOAD CONTROL SYSTEMS, the entire disclosure of which is hereby incorporated by reference.

The load control system 100 may be in communication with remote services 164 that may be provided on one or more remote computing devices, such as one or more cloud servers or other remote servers with which the local processor devices and/or the mobile device 180 may be configured to communicate via a network 163. For example, the remote server operating the remote services 164 may communicate with load control devices and/or the mobile device 180 via the network 163 and/or the RF signals 109. For example, the mobile device 180 may communicate with the load control devices and/or the control devices may communicate with the mobile device 180 and/or the load control devices using RF signals 109 that may be configured on a first wireless communication link (e.g., configured using a first wireless spectrum and/or protocol, such as BLUETOOTH, BLUETOOTH LOW ENERGY (BLE), ZIGBEE, Z-WAVE, THREAD, KNX-RF, MATTER, ENOCEAN RADIO protocols, or a proprietary protocol, such as CLEAR CONNECT OR CLEAR CONNECT X), while the load control devices and/or the mobile device 180 may communicate, via the network 163, with the remote computing devices on which the remote services 164 are provided using a second wireless communication link (e.g., configured using a first wireless spectrum and/or protocol, such as WIFI, cellular, and/or another wireless communication protocol).

The remote services 164 may include or have access to one or more portions of the system configuration data generated by users of the remote services 164 and stored in the remote server(s) from which the remote services 164 are offered. For example, one or more portions of the system configuration data may be generated at the mobile device 180 or the load control devices and may be transmitted to the remote server on which the remote services 164 are operating for enabling configuration and/or control of the load control system 100. Additionally, or alternatively, one or more portions of the system configuration data may be generated by users of the remote services 164 and stored in the remote server(s) from which the remote services 164 are offered and may be transmitted to the load control devices, the system controller 110, and/or the mobile device 180 for performing configuration and/or control of the load control system 100. The remote services 164 may be operated by a server or may be serverless.

The system controller 110 may communicate with the network 163, such that the system controller 110 may access the remote services 164 for enabling configuration and/or control of the load control system 100 and/or the load control devices. Additionally, or alternatively, the system controller may send data, for example configuration data, via the network 163 to the remote services 164, such that the remote services 164 may use the data to determine a configuration and/or control (e.g., information) for the load control system 100 and/or the load control devices.

In some examples, the motor drive unit 156 or the bottom bar 155 of a motorized window treatment 150 and/or one or more of the input devices (e.g., the system controller 110 and/or a remote control device 170) may include a light-emitting diode (LED) that operates as an indicator to provide feedback to a user. For example, as described in more detail herein, the motorized window treatment 150 may be configured to determine that it is likely that a problem with the lifetime of the motor drive unit will occur, and in response, may be configured to cause the LED of one or more devices of the load control system 100 to illuminate (e.g., illuminate in a particular color, such as red, and/or according to a particular pattern, such as flashing) to, for example, indicate the problem (e.g., indicate that the motorized window treatment should be serviced). Alternatively or additionally, the motorized window treatment 150 may move the covering material 152 slowly or wiggle the covering material 152 up and down (e.g., repeatedly move the bottom bar 155 up and down) to indicate the problem, for example, in situations where the motorized window treatment 150 cannot communicate with the system controller 110 and/or where no system controller exists.

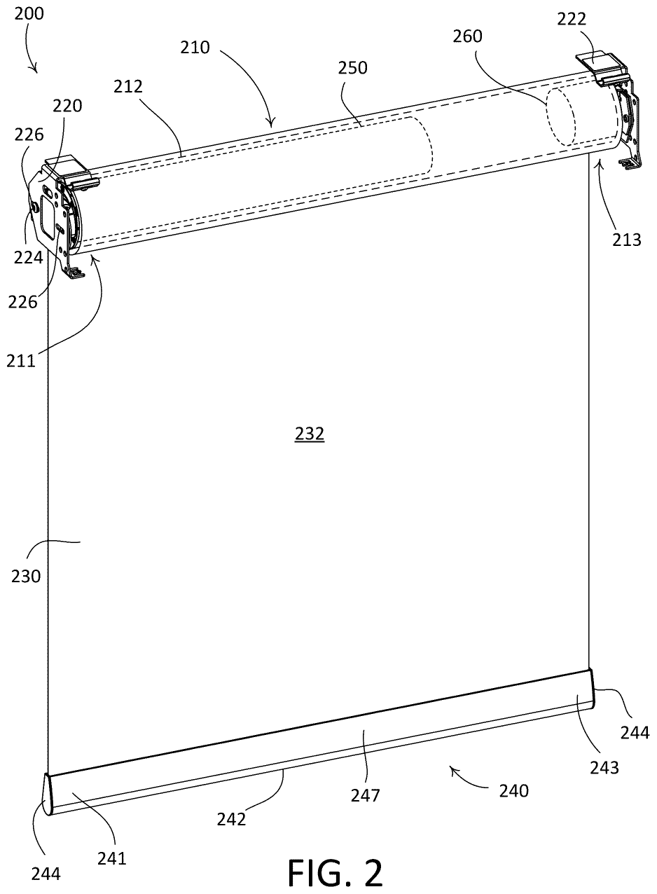

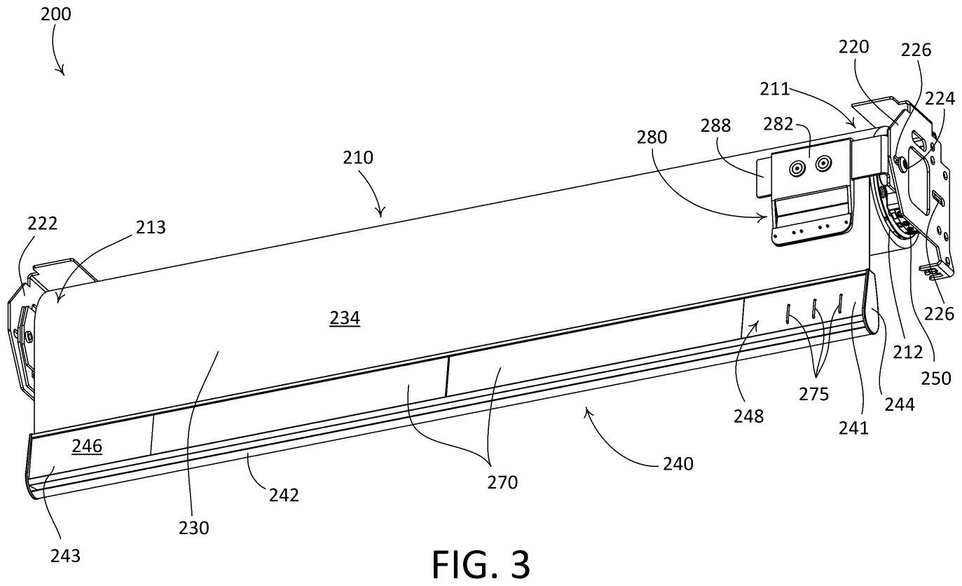

FIG. 2 is a front perspective view and FIG. 3 is a rear perspective view of an example motorized window treatment 200, which may be deployed as one or more of the motorized window treatments 150 of the load control system 100. The motorized window treatment 200 may comprise a window treatment assembly 210 and one or more mounting brackets, such as first and second mounting brackets 220, 222. The first and second mounting brackets 220, 222 may be configured to be coupled to or otherwise mounted to a structure. For example, each of the first and second mounting brackets 220, 222 may be configured to be mounted to (e.g., attached to) a window frame, a wall, or other structure of a building, such that the motorized window treatment 200 may be mounted proximate to an opening (e.g., over the opening or in the opening), such as a window for example. The first and second mounting brackets 220, 222 may be configured to be mounted to a vertical structure (e.g., wall-mounted to a wall) and/or mounted to a horizontal structure (e.g., ceiling-mounted to a ceiling).

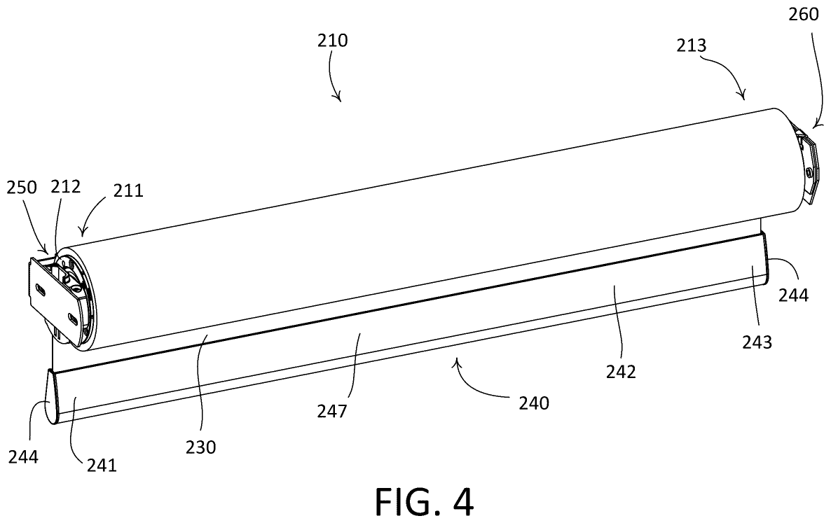

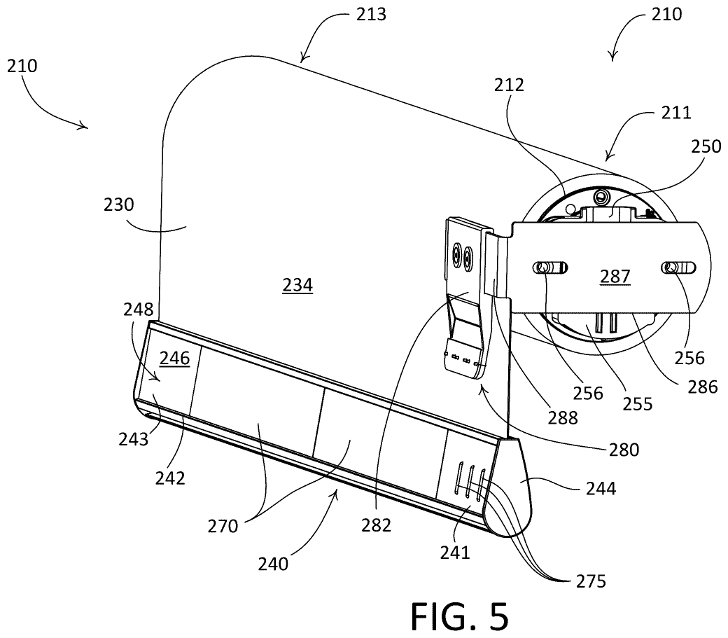

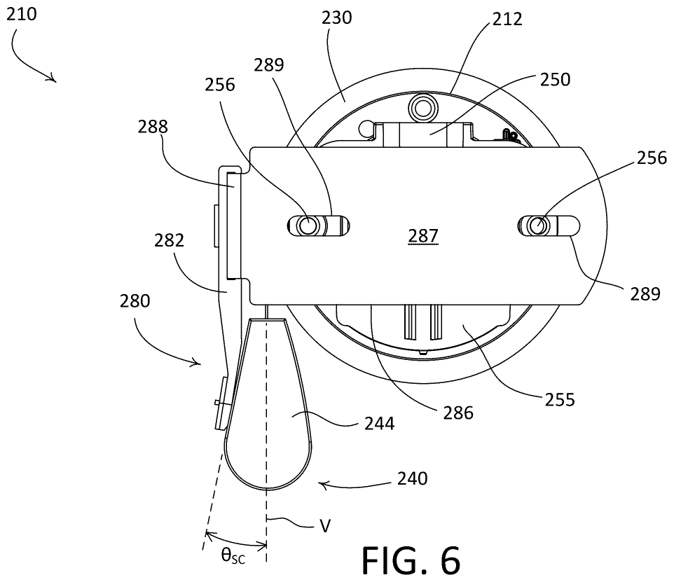

The window treatment assembly 210 may be coupled to (e.g., supported by) the first and second mounting bracket 220, 222. FIG. 4 is a front perspective view, FIG. 5 is a rear perspective view, and FIG. 6 is a left-side view of the window treatment assembly 210 detached from the first and second mounting brackets 220, 222. The window treatment assembly 210 may include a roller tube 212, a covering material 230 (e.g., a flexible material), a bottom bar 240 (e.g., a hembar), a motor drive unit 250 at a first end 211 of the roller tube 212, and an idler 260 at a second end 213 of the roller tube 212. The motor drive unit 250 may be coupled to (e.g., fixedly coupled to) the first mounting bracket 220 and be rotatably coupled to the roller tube 212 at the first end 211 of the roller tube 212. The idler 260 (FIG. 2) may be coupled to (e.g., fixedly coupled to) the second mounting bracket 222 and rotatably coupled to the roller tube 212 at the second end 213 of the roller tube 212. Other configurations of the motor drive unit 250 and idler 260 are possible. For example, the motor drive unit 250 may be located at the second end 213 of the roller tube 212 and the idler 260 may be located at the first end 211 of the roller tube 212.

The covering material 230 may be windingly attached to the roller tube 212. The covering material 230 may comprise a top end (not shown) attached to the roller tube 212 and a bottom end (not shown) attached to the bottom bar 240. The bottom bar 240 may comprise a housing 242 having first and second ends 241, 243. In some examples, the bottom end of the covering material 230 may be received within the housing 242 and secured to the bottom bar 240 inside the housing 242. The bottom bar 240 may also comprise, for example, end caps 244 connected to the first and second ends 241, 243 of the bottom bar 240. In addition, the bottom bar 240 (e.g., the housing 242) may be configured, for example weighted, to cause the covering material 230 to hang vertically. For example, the covering material 230 may be configured to cover the window that is proximate to the motorized window treatment 200. The covering material 230 may comprise a front surface 232 that faces the space in which the motorized window treatment 200 is mounted and a rear surface 234 that faces the window.

The roller tube 212 of the window treatment assembly 210 may operate as a rotational element of the motorized window treatment 200. The roller tube 212 of the window treatment assembly 210 may be rotatably mounted to (e.g., rotatably supported by) the first and second mounting brackets 220, 222. The first and second mounting brackets 220, 222 may extend from the structure to which the motorized window treatment 200 is mounted. The covering material 230 may be windingly attached to the roller tube 212, such that rotation of the roller tube 212 causes the covering material 230 to wind around or unwind from the roller tube 212. For example, rotation of the roller tube 212 may cause the covering material 230 (e.g., the bottom bar 240) to move between a raised position P_{RAISED} (e.g., a fully-raised position and/or a fully-open position as shown in FIG. 3) and a lowered position P_{LOWERED} (e.g., a fully-lowered position and/or a fully-closed position as shown in FIG. 2). The covering material 230 may be fully wound around the roller tube 212 in the raised position P_{RAISED} and fully extended in the lowered position P_{LOWERED}.

The covering material 230 may be any suitable material, or form any combination of materials. For example, the covering material 230 may be “scrim,” woven cloth, non-woven material, light-control film, screen, and/or mesh. The motorized window treatment 200 may be any type of window treatment. For example, the motorized window treatment 200 may be a roller shade as illustrated, a soft sheer shade, a drapery, a cellular shade, a Roman shade, or a Venetian blind. As shown, the covering material 230 may be a material suitable for use as a shade fabric, and may be alternatively referred to as a flexible material. The covering material 230 is not limited to shade fabric. For example, in accordance with an alternative implementation of the motorized window treatment 200 as a retractable projection screen, the covering material 230 may be a material suitable for displaying images projected onto the covering material. With all types of covering materials, the covering material 230 may have a bottom bar attached at a bottom end of the covering material 230. Further, in some examples, the covering material 230 may be a screen, for instance, such that the window treatment assembly 210 may operate as a screen for outdoor patios. Although described throughout as a window treatment for a window, the other examples, the window treatment assembly 210 may be configured to operate in other environments, such as a screen for outdoor patios.

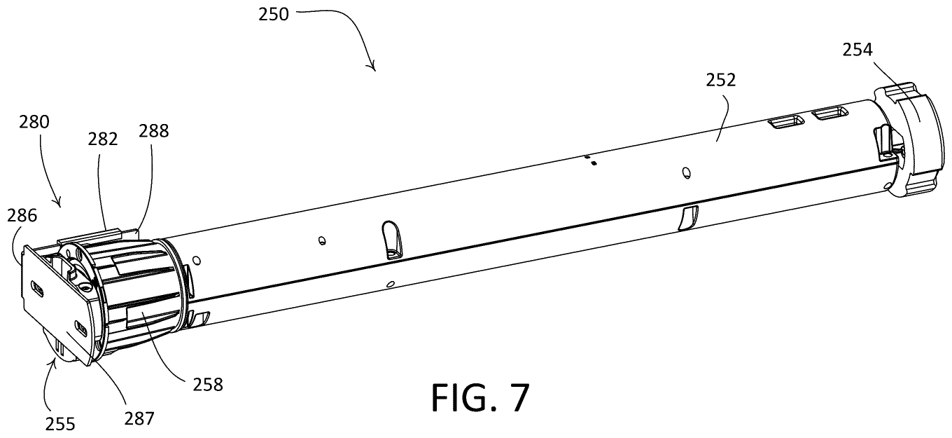

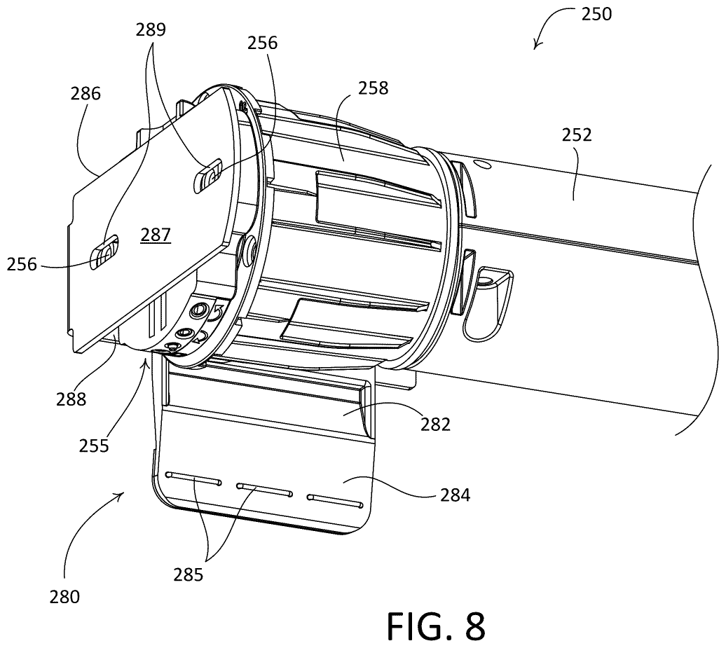

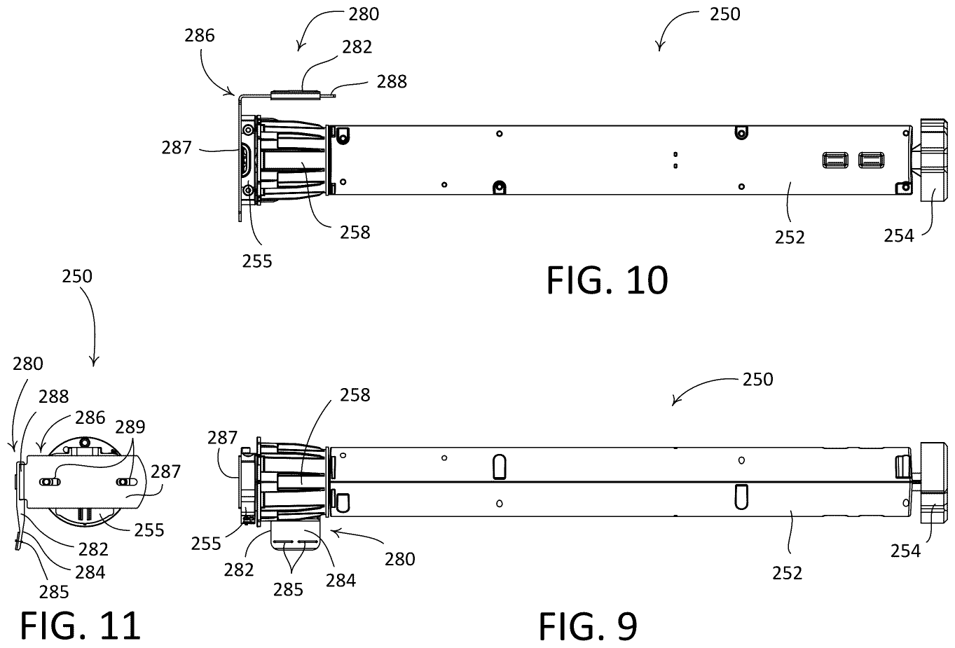

FIG. 7 is a perspective view of an example of the motor drive unit 250. FIG. 8 is a partial enlarged perspective view of the motor drive unit 250. FIG. 9 is a front view, FIG. 10 is a top view, and FIG. 11 is a left-side view of the motor drive unit 250. The motor drive unit 250 may include an enclosure 252 for housing an internal motor (not shown) that may be coupled to a drive coupler 254. The drive coupler 254 may be notched about its outer periphery to facilitate engagement between the drive coupler 254 and an interior surface of the roller tube 212 in which the motor drive unit 250 is received. The motor drive unit 250 may be configured to rotate the drive coupler 254 for rotatably driving the roller tube 212. The motor drive unit 250 may further comprise an end portion 255 that may be coupled to (e.g., supported by) the first mounting bracket 220. For example, the end portion 255 may comprise one or more openings 256 that are configured to receive respective fasteners 224 (e.g., screws as shown in FIGS. 2 and 3). The fasteners 224 may also be received though respective openings 226 in the first and second mounting brackets 220, 222. In some examples, the end portion 255 of the motor drive unit 250 may comprise additional openings (not shown) configured to allow the window treatment assembly 210 to be mounted to other mounting brackets (e.g., other than the first and second mounting brackets 220, 222. The openings 256 and the additional openings may be sized and/or located to allow the window treatment assembly 210 to be mounted to multiple types of mounting brackets (e.g., the first and second mounting brackets 220, 222 as well as other mounting brackets). The motor drive unit 250 may comprise a bearing assembly 258, which may be located adjacent to the end portion 255 and may be rotatably coupled to the roller tube 212 at the first end 211 of the roller tube 212.

The motor drive unit 250 may be responsive to messages (e.g., digital messages) transmitted by an external device, such as a remote control device, via wireless signals, such as radio-frequency (RF) signals. The motor drive unit 250 may comprise a communication circuit, such as a wireless communication circuit (e.g., an RF transceiver coupled to an antenna, an infrared (IR) receiver, etc.) and/or a wired communication circuit. For example, the antenna may be wrapped around the enclosure 252 of the motor drive unit 250 underneath the bearing assembly 258. The motor drive unit 250 may be configured to control the movement of the covering material 230 in response to a shade movement command received in messages from the remote control device. During a configuration procedure (e.g., an association procedure), the motor drive unit 250 may be associated with the remote control device, such that the motor drive unit 250 may be responsive to the messages transmitted by the remote control device (e.g., via wireless signals). Similarly, as described in more detail herein, the bottom bar 240 may include a communication circuit, such as a wireless communication circuit (e.g., an RF transceiver coupled to an antenna, an infrared (IR) receiver, etc.) and/or a wired communication circuit so that the bottom bar 240 may be configured to communicate with the motor drive unit 250.

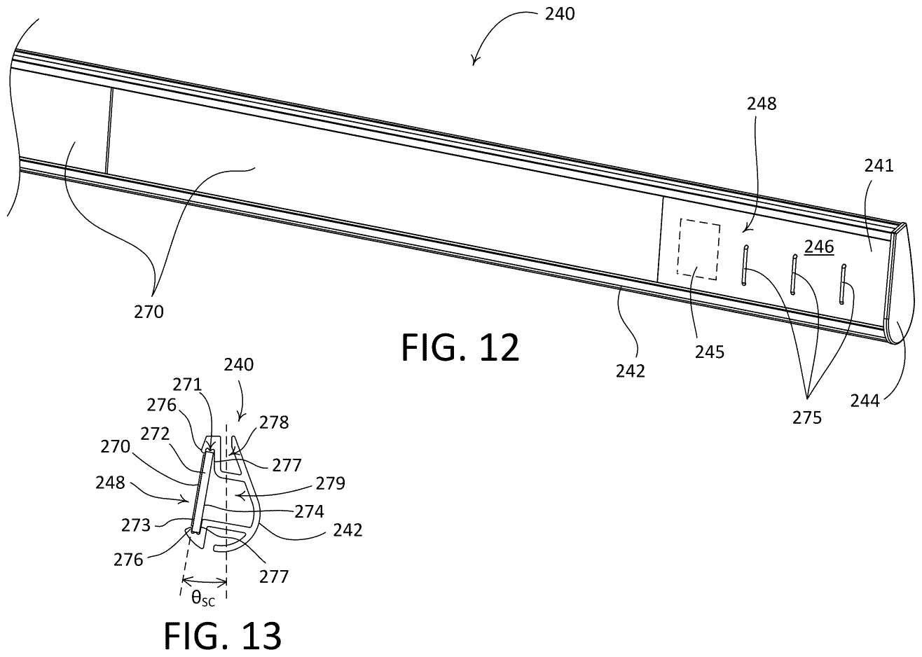

As shown in FIGS. 3 and 5, the bottom bar 240 may comprise one or more solar cells 270 (e.g., photovoltaic cells). FIG. 12 is an enlarged rear perspective view of the first end 241 of the bottom bar 240. The solar cells 270 may be attached to a rear surface 246 of the housing 242 of the bottom bar 240, such that the solar cells 270 face the window (e.g., that the covering material 230 is configured to cover) and are able to receive solar energy from outside the building (e.g., from the sun). For example, the solar cells 270 may be located within a recess 248 in the housing 242. The rear surface 246 of the housing 242 of the bottom bar 240 may be oriented at an angle θ_{SC} from a vertical axis V (e.g., with respect to the covering material 230 as shown in FIG. 6), such that the solar cells 270 may be angled up (e.g., towards the sky to maximize the amount of sunlight that may shine on the solar cells 270). The housing 242 and the end caps 244 may define, for example, a teardrop shape as shown in FIG. 6, but could define other shapes, such as a triangular shape or a polygon shape having an angled rear surface. For example, the angle θ_{SC} at which the solar cells 270 are oriented may be in the range of approximately 5° to 75° (e.g., approximately 30°). The solar cells 270 may be oriented horizontally across the rear surface 246 of the housing 242 of the bottom bar 240. However, in some examples, the solar cells 270 may be oriented vertically (e.g., in parallel with the shade fabric), for instance, across the rear surface 246 of the housing 242 of the bottom bar 240. Further, in some examples, the motorized window treatment 200 may include one or more solar cells 270 attached to an interior surface 247 of the housing 242 of the bottom bar 240 (e.g., receive solar energy from outside the building), for instance, in addition to one or more solar cells 270 being attached to the rear surface 246 of the housing 242 of the bottom bar 240. Finally, in some examples, the one or more solar cells 270 may be attached to covering material 230, for instance, such as at a location that is proximate to the bottom bar 240.

FIG. 13 is a left-side cross section view of the bottom bar 240. The bottom bar 240 may comprise a printed circuit board 272 configured to be located in a channel 271, such that an outer surface 273 of the printed circuit board 272 forms at least a portion of the rear surface 246 of the bottom bar 240. The channel 271 in the bottom bar 240 may be formed by flange portions 276 adjacent to the outer surface 273 of the printed circuit board 272 and inner surfaces 277 of the bottom bar 240 adjacent to an inner surface 274 of the printed circuit board 272. For example, the printed circuit board 272 may be configured to be slid into the channel 271 from either the first end 241 or the second end 243 of the bottom bar 240 (e.g., when at least one of the end caps 244 is removed). The solar cells 270 may be located on (e.g., mounted to) the outer surface 273 of the printed circuit board 272. For example, the printed circuit board 272 (e.g., and thus the solar cells 270) may be mounted at the angle θ_{SC} from the vertical axis V.

The body 242 of the bottom bar 240 may define a first cavity 278 that may be configured to receive the bottom end of the covering material 230. For example, the bottom end of the covering material 230 may be attached to an elongated member (not shown) that may extend through the first cavity 278 (e.g., the from the first end 241 to the second end 243 of the body 242) and may prevent the bottom end of the covering material 230 from being removed from the first cavity 278. In addition, the bottom bar 240 may comprise a second cavity 279 that may also extend from the first end 241 to the second end 243 of the body 242. The second cavity 279 may be configured to receive a weighting member (not shown) for weighting the bottom bar 240 to cause the covering material 230 to hang vertically.

The solar cells 270 of the bottom bar 240 may be electrically connected to one or more energy storage elements 245 contained within the housing 242 of the bottom bar 240. The energy storage elements 245 of the bottom bar 240 may comprise, for example, one or more of rechargeable batteries and/or supercapacitors. For example, the energy storage element 245 of the bottom bar 240 may be located in the second cavity 279. The solar cells 270 may be configured to convert the received solar energy into a photovoltaic output voltage, which may be used to charge the energy storage elements 245 located within the housing 242 of the bottom bar 240 (e.g., to generate a storage voltage across the energy storage element). The energy stored in the energy storage elements 245 of the bottom bar 240 may be discharged into the motor drive unit 250 when the bottom bar 240 is close to the motor drive unit 250, for example, when the bottom bar 240 in the raised position P_{RAISED} (e.g., the fully-raised position). For example, the motor drive unit 250 may comprise one or more energy storage elements (not shown) configured to charge from the energy storage elements 245 of the bottom bar 240 when the covering material 230 is in the raised position P_{RAISED}. For example, the energy storage elements of the motor drive unit 250 may comprise one or more of rechargeable batteries and/or supercapacitors.

The motorized window treatment 200 (e.g., the motor drive unit 250) may comprise a dock 280 that is configured to facilitate discharging of the energy storage elements of the bottom bar 240 into the energy storage elements of the motor drive unit 250, for example, when the covering material 230 is in the raised position P_{RAISED} (e.g., when the bottom bar 240 is docked). The motor drive unit 250 and the dock 280 may be collectively referred to as a base assembly of the motorized window treatment 200. In some examples, the base assembly of the motorized window treatment 200 may be supported by and/or integral with at least one of the first and second mounting brackets 220, 222. The dock 280 may comprise a base portion 282 that may be located adjacent to the rear surface 234 of the covering material 230 (e.g., adjacent to the window) at the first end 211 of the roller tube 212. The bottom bar 240 may be configured to be positioned adjacent to the base portion 282 of the dock 280 when the covering material 230 is in the raised position P_{RAISED}, such that the energy storage elements of the bottom bar 240 may discharge through the base portion 282 of the dock 280 into the energy storage elements of the motor drive unit 250. The base portion 282 of the dock 280 may define a contact surface 284 that may be configured to abut against the rear surface 246 of the bottom bar 240 when the bottom bar 240 is docked (e.g., when the covering material 230 is in the raised position P_{RAISED}). The contact surface 284 of the base portion 282 may be oriented at approximately the angle θ_{SC} from the vertical axis V (e.g., to match the rear surface 246 of the bottom bar 240).

The dock 280 may also comprise two or more electrical contacts 285 (e.g., two horizontally-oriented electrical contacts) located on the contact surface 284 of the base portion 282. The base portion 282 of the dock 280 (e.g., the electrical contacts 285) may be electrically coupled to the motor drive unit 250. For example, the base portion 282 of the dock 280 may be electrically coupled to the motor drive unit 250 via two or more electrical conductors (e.g., wires) extending between the base portion 282 of the dock 280 and the end portion 255 of the motor drive unit 250. The dock 280 may further comprise an attachment member 286 that extends from the end portion 255 of the motor drive unit 250 to the base portion 282. The attachment member 286 may comprise a plate 287 and an arm 288 that is oriented at an angle (e.g., approximately 90°) from the plate 287 (e.g., to bend the attachment member 286 behind the rear surface 234 of the covering material 230). The electrical conductors that extend between the base portion 282 of the dock 280 and the end portion 255 of the motor drive unit 250 may be located internal to or external to the attachment member 286. The plate 287 may comprise openings 289 through which the respective fasteners 224 may extend for coupling the window treatment assembly 210 to the first mounting bracket 220 (e.g., extending through the openings 256 in the first mounting bracket 220 and the openings 256 in the end portion 255 of the motor drive unit 250). For example, the attachment member 286 (e.g., the plate 287) may be affixed to and/or formed as a part of (e.g., integral with) the enclosure 252 and/or the end portion 255 of the motor drive unit 250. In some examples, the attachment member 286 may be affixed to and/or formed as a part of the first mounting bracket 220.

The electrical contacts 285 of the dock 280 may be configured to contact respective electrical contacts 275 (e.g., two vertically-oriented electrical contacts) on the rear surface 246 of the bottom bar 240 (e.g., at the first end 241 of the bottom bar 240) when the bottom bar 240 is docked (e.g., when the covering material 230 is in the raised position P_{RAISED}). Each of the electrical contacts 275 of the bottom bar 240 and the electrical contacts 285 of the dock 280 may be, for example, an elongated conductive element (e.g., an uninsulated wire). The electrical contacts 275 of the bottom bar 240 and the electrical contacts 285 of the dock 280 may be located next to each other (e.g., horizontally spaced apart from each other). For example, the electrical contacts 275 of the bottom bar 240 may be oriented vertically and the electrical contacts 285 of the dock 280 may be oriented horizontally to facilitate electrical connection between the respective electrical contacts 275, 285 when the bottom bar 240 is docked. The electrical contacts 275 of the bottom bar 240 may be electrically connected to the energy storage elements in the bottom bar 240, and the electrical contacts 285 of the dock 280 may be electrically connected to the energy storage elements of the motor drive unit 250, such that that the energy storage elements of the motor drive unit 250 may charge from the energy storage elements of the bottom bar 240 when the bottom bar 240 is docked. For example, the electrical contacts 275 of the bottom bar 240 may be biased (e.g., spring-loaded) away from the rear surface 246 and/or the electrical contacts 285 of the dock 280 may be biased (e.g., spring-loaded) away from the contact surface 284 to help establish and/or maintain the electrical contacts between the electrical contacts 275 of the bottom bar 240 and the electrical contacts 285 of the dock 280.

Alternatively or additionally, the electrical contacts 275 may be located on different surfaces of the bottom bar 240, such as on one of the end caps 244. In such examples, the dock 280 and the electrical contacts 285 of the dock 280 may be positioned such that the electrical contacts 285 of the dock 280 are aligned with the end cap 244 of the bottom bar 240.

Since the motor drive unit 250 is powered from (e.g., entirely powered from) the solar cells 270 and is configured to wirelessly communicate with external devices, the window treatment assembly 210 may be mounted to essentially any mounting brackets-even mounting brackets for manually-operated window treatment assemblies. Accordingly, the window treatment assembly 210 may provide a retro-fit solution for upgrading a manually-operated window treatment to a motorized window treatment without the need to replace the mounting brackets and/or run electrical wiring to the new motorized window treatment.

In some examples, the motor drive unit 250 may include electrical terminal (not shown) that are configured to allow for an external power source to jump start the motor drive unit 250 or recharge the motor drive unit 250 (e.g., if the motor drive unit 250 is uncharged and/or not performing well). In some examples, the electrical terminal may be a standard power supply connector (e.g., a USB connector). As such, the motor drive unit 250 (e.g., the energy storage element of the motor drive unit 250) could receive power from an external power source.

Although described in context of the motorized window treatment 200 comprises a bottom bar 240 that includes solar cells 270 and the bottom bar 240 is configured to charge the motor drive unit 250, the motorized window treatment 200 is not always so limited. For example, the motor drive unit 250 may be powered from an external source and/or changeable batteries. For instance, in some examples, the bottom bar 240 may include solar cells and the motor drive unit 250 may charge the energy storage element of the motor drive unit 250 when the bottom bar 240 is docked. The bottom bar 240 may include the solar cells 270, and one or more of the solar cells 270 may be configured to charge the energy storage element in the bottom bar 240 between docking events, or when docking is not possible. In some examples, the bottom bar 240 may not include solar cells 270. For example, the bottom bar 240 may not include solar cells 270 in examples where the bottom bar 240 is not able to or does not need to dock (e.g., when there is a wired connection between the bottom bar 240 and the motor drive unit 250. In some examples, the bottom bar 240 may not be configured to charge the motor drive unit 250. In some examples, the bottom bar 240 may include one or more sensors, such as an occupancy sensor, a vacancy sensor, a photosensor, etc., where the bottom bar 240 and/or the motor drive unit 250 may be configured to control the motorized window treatment 200 and/or external devices (e.g., such as lighting loads) based on feedback from the sensor(s). Finally, in some examples, the motor drive unit may be configured to move the covering material 230 to the raised position P_{RAISED} if the motor drive unit 250 detects that the window is open (e.g., based on feedback from one or more sensors).

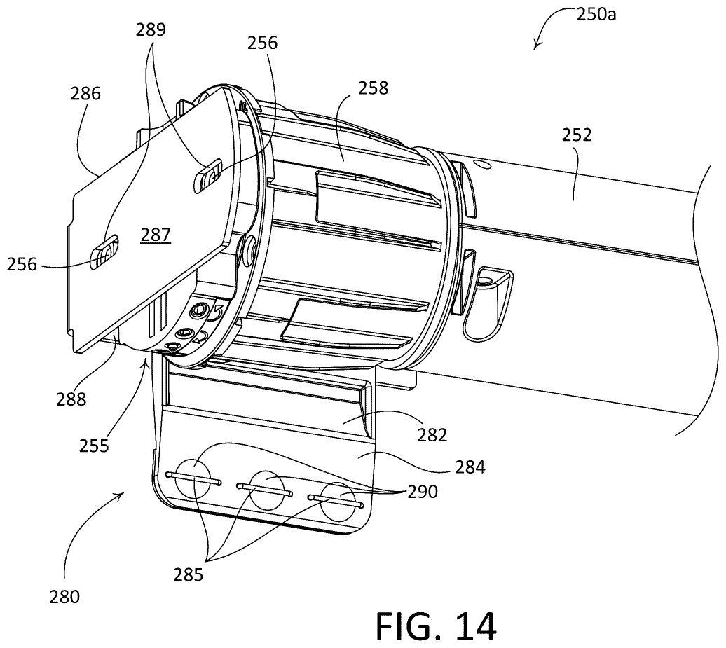

FIG. 14 is a partial enlarged perspective view of another example motor drive unit 250a for use in a motorized window treatment, such as the motorized window treatments 150 of the load control system 100 shown in FIG. 1 and/or the motorized window treatment 200 shown in FIG. 2. The motor drive unit 250a may be the same as the motor drive unit 250 except that the motor drive unit 250a may comprise one or more magnets 290. The magnets 290 may be located on the contact surface 284 of the base portion 282 of the dock 280 of the motor drive unit 250a. For example, as shown in FIG. 14, each of the magnets 290 may be located behind one of the respective electrical contacts 285 of the dock 280, and may be configured to be magnetically attracted to the respective electrical contacts 275 on the bottom bar 240. The magnets 290 may be configured to pull the electrical contacts 275 of the bottom bar 240 towards the electrical contacts 285 of the dock 280 to facilitate electrical connection between the electrical contacts 275 of the bottom bar 240 and the electrical contacts 285 of the dock 280 when the bottom bar 240 is docked. The bottom bar 240 may have a sufficient weight that may counteract the magnetic attraction between the magnets 290 and the respective electrical contacts 275 on the bottom bar 240 when the motor drive unit 250a lowers the bottom bar 240 below the raised position P_{RAISED} (e.g., to undock the bottom bar 240). In some examples, rather than being located behind the electrical contacts 285 of the dock 280, the magnets 290 may be located on other portions of the contact surface 284 of the base portion 282 and may be configured to be magnetically attracted to respective magnets (not shown) on the bottom bar 240. Further, while two magnets 290 are shown in FIG. 14, the motor drive unit 250a may comprise more or less magnets.

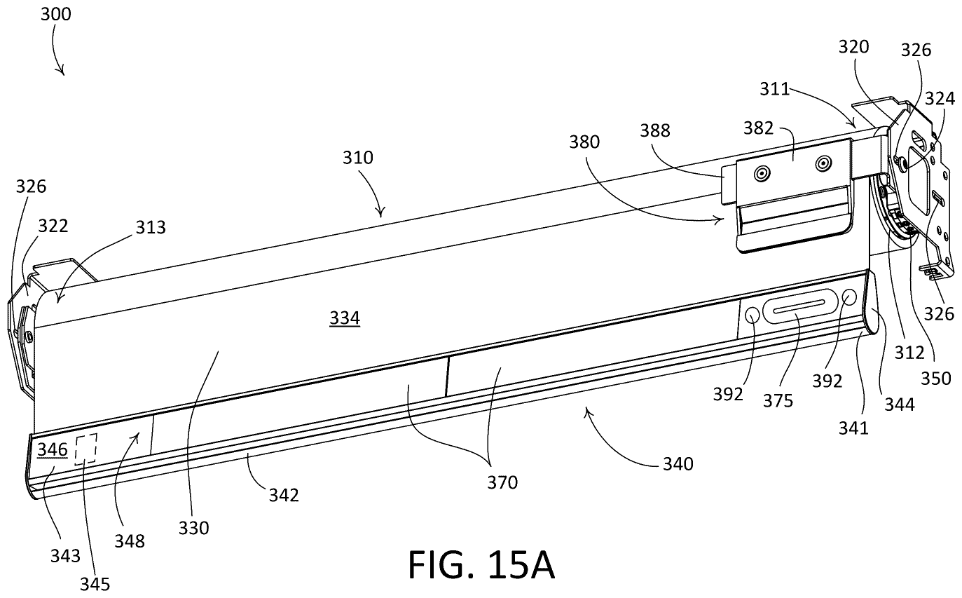

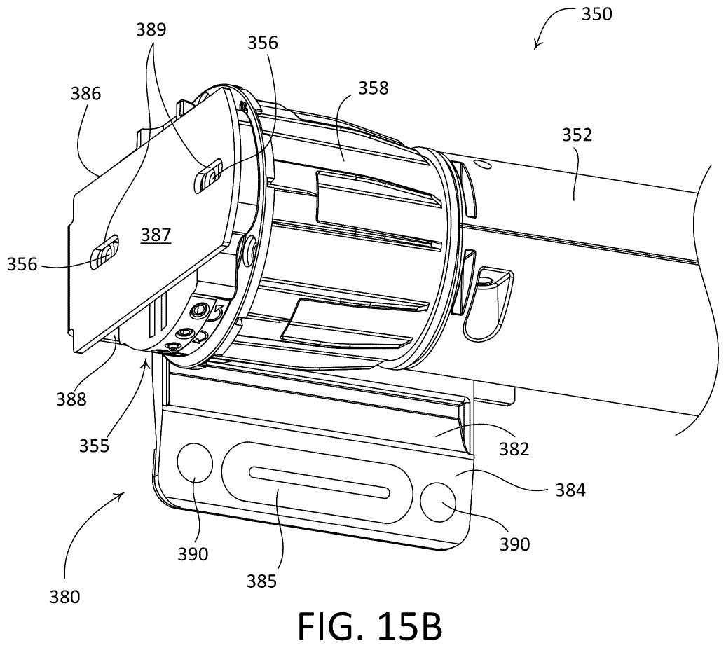

FIG. 15A is a rear perspective view of another example motorized window treatment 300, which may be deployed as one or more of the motorized window treatments 150 of the load control system 100. The motorized window treatment 300 may comprise a window treatment assembly 310 and one or more mounting brackets, such as first and second mounting brackets 320, 322. The first and second mounting brackets 320, 322 may be configured to be coupled to or otherwise mounted (e.g., wall-mounted and/or ceiling-mounted) to a structure (e.g., a window frame, a wall, or other structure of a building), such that the motorized window treatment 300 may be mounted proximate to an opening (e.g., a window). The window treatment assembly 310 may be coupled to (e.g., supported by) the first and second mounting bracket 320, 322. The window treatment assembly 310 may include a roller tube 312, a covering material 330, a bottom bar 340, a motor drive unit 350 at a first end 311 of the roller tube 312, and an idler (e.g., the idler 260) at a second end 313 of the roller tube 312. The motor drive unit 350 may be coupled to (e.g., fixedly coupled to) the first mounting bracket 320 and be rotatably coupled to the roller tube 312 at the first end 311 of the roller tube 312. The idler may be coupled to (e.g., fixedly coupled to) the second mounting bracket 322 and rotatably coupled to the roller tube 312 at the second end 313 of the roller tube 312.

The covering material 330 may be windingly attached to the roller tube 312. In some examples, a bottom end of the covering material 330 may be received within a housing 342 of the bottom bar 340 and secured to the bottom bar 340 inside the housing 342. The bottom bar 340 may comprise, for example, end caps 344 connected to the first and second ends 341, 343 of the bottom bar 340. The bottom bar 340 (e.g., the housing 342) may be configured, for example weighted, to cause the covering material 330 to hang vertically (e.g., to cover the window that is proximate to the motorized window treatment 300). The roller tube 312 of the window treatment assembly 310 may operate as a rotational element of the motorized window treatment 300. The roller tube 312 of the window treatment assembly 310 may be rotatably mounted to (e.g., rotatably supported by) the first and second mounting brackets 320, 322. Rotation of the roller tube 312 may cause the covering material 330 to wind around or unwind from the roller tube 312 to move the covering material 330 (e.g., the bottom bar 340) between a raised position P_{RAISED} (e.g., a fully-raised position and/or a fully-open position) and a lowered position P_{LOWERED} (e.g., a fully-lowered position and/or a fully-closed position). The covering material 320 may be fully wound around the roller tube 312 in the raised position P_{RAISED} and fully extended in the lowered position P_{LOWERED}.

FIG. 15B is a partial enlarged perspective view of an example of the motor drive unit 350. The motor drive unit 350 may include an enclosure 352 for housing an internal motor (not shown) that may be coupled to a drive coupler (e.g., such as the drive coupler 254). The motor drive unit 350 may be configured to rotate the drive coupler for rotatably driving the roller tube 312. The motor drive unit 350 may further comprise an end portion 355 that may be coupled to (e.g., supported by) the first mounting bracket 320. For example, the end portion 355 may comprise one or more openings 356 that are configured to receive respective fasteners 324 (e.g., screws). The fasteners 324 may also be received though respective openings 326 in the first and second mounting brackets 320, 322. In some examples, the end portion 355 of the motor drive unit 350 may comprise additional openings (not shown) configured to allow the window treatment assembly 310 to be mounted to other mounting brackets (e.g., other than the first and second mounting brackets 320, 322). The openings 356 and the additional openings may be sized and/or located to allow the window treatment assembly 310 to be mounted to multiple types of mounting brackets (e.g., the first and second mounting brackets 320, 322 as well as other mounting brackets). The motor drive unit 350 may comprise a bearing assembly 358, which may be located adjacent to the end portion 355 and may be rotatably coupled to the roller tube 312.

As shown in FIG. 15A, the bottom bar 340 may comprise one or more solar cells 370 (e.g., photovoltaic cells). The solar cells 370 may be attached to a rear surface 346 of the housing 342 of the bottom bar 340, such that the solar cells 370 face the window (e.g., that the covering material 330 is configured to cover) and are able to receive solar energy from outside the building (e.g., from the sun). The bottom bar 340 may comprise a printed circuit board (e.g., the printed circuit board 272) configured to be located in a channel (e.g., the channel 271) in the housing 342, such that an outer surface of the printed circuit board (e.g., the outer surface 273 of the printed circuit board 272) forms at least a portion of the rear surface 346 of the bottom bar 340. The solar cells 370 may be mounted to the outer surface of the printed circuit board, and may be located within a recess 348 in the housing 342. The rear surface 346 of the housing 342 of the bottom bar 340 may be oriented at an angle from the vertical axis (e.g., such as the angle θ_{SC} at which the rear surface 246 of the bottom bar 240 is oriented from a vertical axis V as shown in FIG. 6), such that the solar cells 370 may be angled up (e.g., towards the sky to maximize the amount of sunlight that may shine on the solar cells 370).

The solar cells 370 may be electrically connected to one or more energy storage elements 345 contained within the housing 342 of the bottom bar 340. For example, the energy storage elements 345 of the bottom bar 340 may comprise one or more of rechargeable batteries and/or supercapacitors. The solar cells 370 may be configured to convert the received solar energy into a photovoltaic output voltage, which may be used to charge the energy storage elements 345 located within the housing 342 of the bottom bar 340 (e.g., to generate a storage voltage across the energy storage element). The energy stored in the energy storage elements 345 of the bottom bar 340 may be discharged into the motor drive unit 350 when the bottom bar 340 is close to the motor drive unit 350, for example, when the bottom bar 340 is docked (e.g., when a covering material of the motorized window treatment is in the raised position P_{RAISED}). For example, the motor drive unit 350 may comprise one or more energy storage elements (not shown) configured to charge from the energy storage elements 345 of the bottom bar 340 when the bottom bar 340 is in the raised position P_{RAISED}. For example, the energy storage elements of the motor drive unit 350 may comprise one or more of rechargeable batteries and/or supercapacitors.

The motor drive unit 350 may comprise a dock 380 that is configured to facilitate discharging of the energy storage elements of the bottom bar 340 into the energy storage elements of the motor drive unit 350, for example, when the bottom bar 340 is docked. The motor drive unit 350 and the dock 380 may be collectively referred to as a base assembly of the motorized window treatment 300. In some examples, the base assembly of the motorized window treatment 300 may be supported by and/or integral with at least one of the first and second mounting brackets 320, 322. The dock 380 may comprise a base portion 382 that may be located adjacent to a rear surface 334 of the covering material 330 (e.g., adjacent to the window) at the first end 311 of the roller tube 312. The base portion 382 of the dock 380 may define a contact surface 384 that may be configured to abut against the rear surface 346 of the bottom bar 340 when the bottom bar 340 is docked. The contact surface 384 of the base portion 382 may be oriented at approximately the angle θ_{SC} from the vertical axis (e.g., to match the rear surface 346 of the bottom bar 340).

The base portion 382 of the dock 380 may be electrically coupled to the motor drive unit 350. For example, the base portion 382 of the dock 380 may be electrically coupled to the motor drive unit 350 via two or more electrical conductors (e.g., wires) extending between the base portion 382 of the dock 380 and the end portion 355 of the motor drive unit 350. The dock 380 may be configured to facilitate inductive coupling (e.g., magnetic coupling) between the energy storage elements of the bottom bar 340 and the energy storage elements of the motor drive unit 350. The bottom bar 340 may comprise a first induction coil 375 at the first end 341 of the bottom bar 340. The first induction coil 375 on the bottom bar 340 may be configured to be inductively coupled to a second induction coil 385 on the contact surface 384 of the base portion 382 of the dock 380. The dock 380 may further comprise an attachment member 386 that extends from the end portion 355 of the motor drive unit 350 to the base portion 382. The attachment member 386 may comprise a plate 387 and an arm 388 that is oriented at an angle (e.g., approximately 90°) from the plate 387 (e.g., to bend the attachment member 386 behind the rear surface 334 of the covering material 330). The electrical conductors that extend between the base portion 382 of the dock 380 and the end portion 355 of the motor drive unit 350 may be located internal to or external to the attachment member 386. The plate 387 may comprise openings 389 through which the respective fasteners 324 may extend for coupling the window treatment assembly 310 to the first mounting bracket 320 (e.g., extending through the openings 356 in the first mounting bracket 320 and the openings 356 in the end portion 355 of the motor drive unit 350). For example, the plate 387 of the attachment member 386 may be affixed to and/or formed as a part of (e.g., integral with) the enclosure 352 and/or the end portion 355 of the motor drive unit 350. In some examples, the attachment member 386 may be affixed to and/or formed as a part of the first mounting bracket 320.

The first induction coil 375 of the bottom bar 340 may be configured to be inductively coupled to the second induction coil 385 of the dock 380 when the bottom bar 340 is docked. The first induction coil 375 of the bottom bar 340 may be electrically connected to the energy storage elements in the bottom bar 340, and the second induction coil 385 of the dock 380 may be electrically connected to the energy storage elements of the motor drive unit 350, such that that the energy storage elements of the motor drive unit 350 may charge from the energy storage elements of the bottom bar 340 via the inductive coupling when the bottom bar 340 is docked.

Since the motor drive unit 350 is powered from (e.g., entirely powered from) the solar cells 370 and is configured to wirelessly communicate with external devices, the window treatment assembly 310 may be mounted to essentially any mounting brackets-even mounting brackets for manually-operated window treatment assemblies. Accordingly, the window treatment assembly 310 may provide a retro-fit solution for upgrading a manually-operated window treatment to a motorized window treatment without the need to replace the mounting brackets and/or run electrical wiring to the new motorized window treatment. In some examples, the motorized window treatment (e.g., the motor drive unit 350) may be configured to communicate with one or more external devices via a wired communication link.

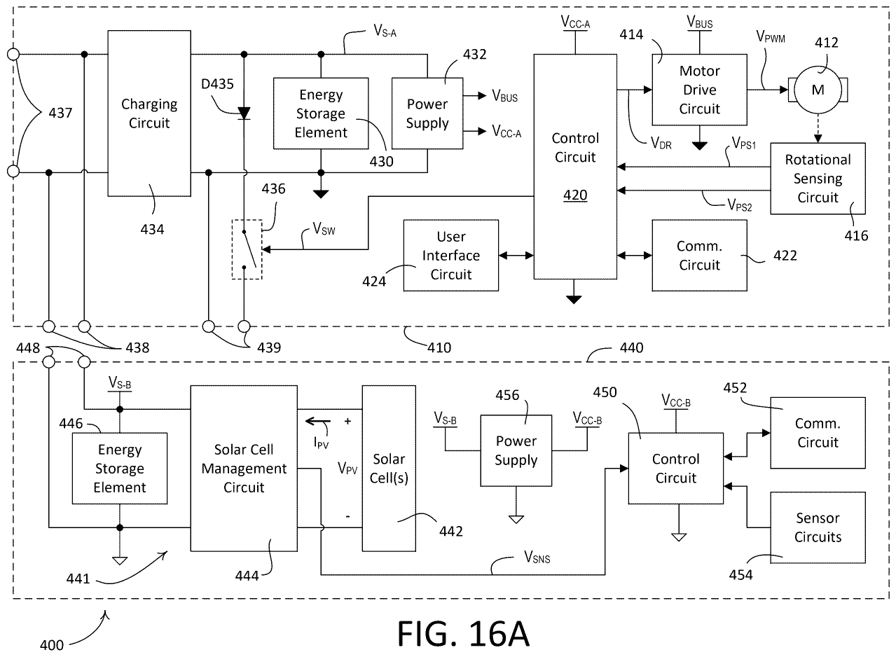

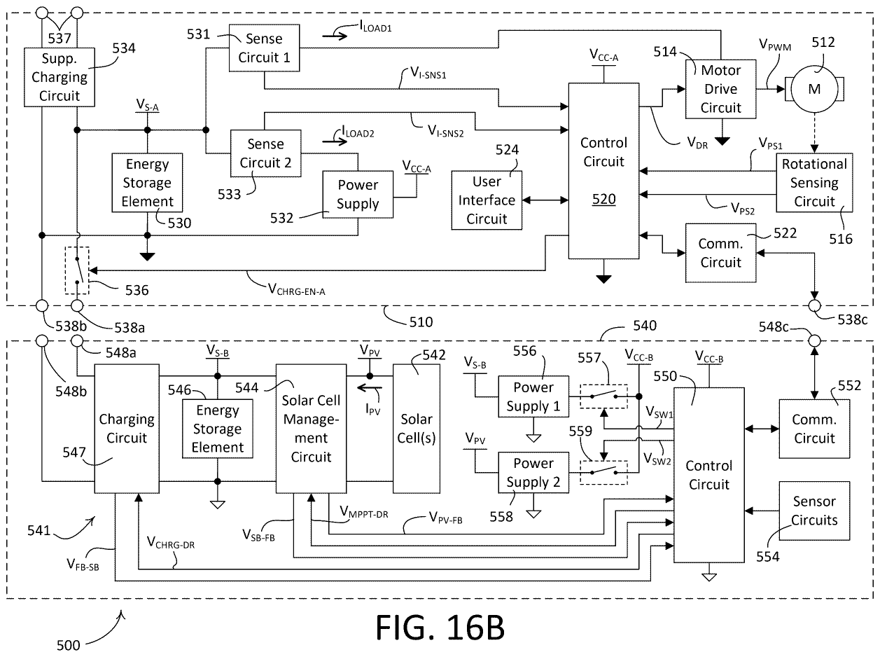

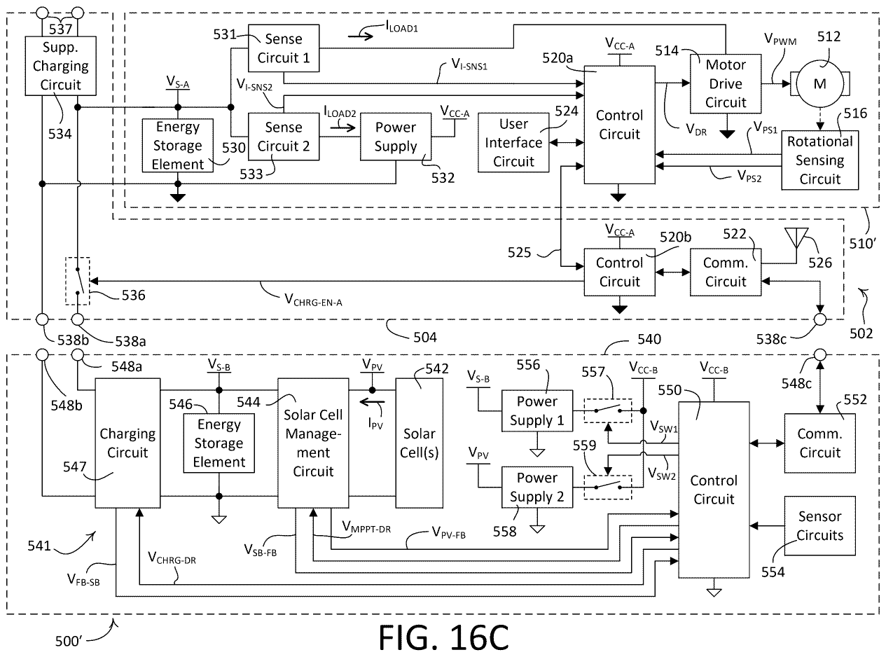

FIG. 16A is a simplified block diagram of a motorized window treatment system 400 for controlling a motorized window treatment (e.g., the motorized window treatments 150 of the load control system 100, the motorized window treatment 200, the motorized window treatment 300). The motorized window treatment may comprise a covering material (e.g., the covering material 152, 230, 3b30) that may be wound around a roller tube (e.g., the roller tubes 212, 312) and may extend to a bottom bar (e.g., the bottom bars 240, 340). The motorized window treatment system 400 may comprise a base assembly that includes a motor drive unit 410 (e.g., the motor drive units 156, the motor drive unit 250, and/or the motor drive unit 350) for rotating the roller tube for raising and lowering the covering material to adjust a present position P_{PRES} of the covering material (e.g., the bottom bar). The motorized window treatment system 400 may comprise a bottom bar module 440 that may be located in and/or on the bottom bar. The bottom bar module 440 may include a solar power system 441 for harvesting power (e.g., solar power) from sunlight that may shine through the window. The bottom bar module 440 (e.g., the solar power system 441) may comprise one or more solar cells 442 (e.g., photovoltaic cells) configured to receive the sunlight through the window. The base assembly of the motorized window treatment system 400 may further comprise a dock (e.g., the docks 280, 380) electrically coupled to the motor drive unit 410. The motor drive unit 410 may be configured to control the covering material to the raised position to dock the bottom bar, such that the motor drive unit 410 may be electrically connected to the bottom bar module 440 and may be powered via the solar power system 441 of the bottom bar module 440 (e.g., as will be described in greater detail below).

The motor drive unit 410 may comprise a motor 412 (e.g., a direct-current motor) that may be coupled to the roller tube for rotating the roller tube. The motor drive unit 410 may include a motor drive circuit 414 (e.g., an H-bridge drive circuit) that receives a bus voltage V_{BUS} and may generate a pulse-width modulated (PWM) voltage V_{PWM} for driving the motor 412. For example, the motor drive circuit 414 may comprise an H-bridge drive circuit and/or an H-bridge controller (e.g., an integrated circuit) for controlling the H-bridge drive circuit to generate the PWM voltage V_{PWM} across the motor 412.

The motor drive unit 410 may include a control circuit 420 (e.g., a motor control circuit) for controlling the operation of the motor 412. The control circuit 420 may include, for example, a microprocessor, a programmable logic device (PLD), a microcontroller, an application specific integrated circuit (ASIC), a field-programmable gate array (FPGA), or any suitable processing device or control circuit. The control circuit 420 may include instructions (e.g., software instructions) that configure the control circuit 420 to generate at least one drive signal VDR for controlling the motor drive circuit 414. The motor drive circuit 414 may be configured to control the rotational speed and the direction of rotation of the motor 412 in response to the drive signal VDR. The control circuit 420 may be configured to control the motor drive circuit 414 to rotate the motor 412 to adjust a present position P_{PRES} of the covering material (e.g., of the bottom bar). The motor drive unit 410 may be configured to control the covering material between a raised position P_{RAISED} (e.g., a fully-raised position and/or a fully-open position) and a lowered position P_{LOWERED} (e.g., a fully-lowered position and/or a fully-closed position). The control circuit 420 may be configured to set limits (e.g., an upper limit position P_{UP-LIMIT} and a lower limit position PLO-LIMIT) for limiting a range across which the present position P_{PRES} of the covering material may be adjusted (e.g., to be less than a full range between the raised position P_{RAISED} and lowered position P_{LOWERED}. In some examples, the control circuit 420 may be configured to keep track of a present time (e.g., an actual time) using a timeclock. For example, the timeclock may be implemented as an internal circuit of the control circuit 420 or as an external integrated circuit (IC). The present time indicated by the timeclock may represent, for example, a time of day, a week of the year, a month of the year, a day of the week, a day of the month, and/or a day of the year.

The motor drive unit 410 may comprise a memory (not shown), e.g., such as a non-volatile memory. The memory may be communicatively coupled to the control circuit 420 for the storage and/or retrieval of, for example, operational settings of the motor drive unit 410. In addition, the memory may be configured to store software for execution by the control circuit 420 to operate the motor drive unit 410 as described herein. The memory may be implemented as an internal circuit of the control circuit 420 or as an external integrated circuit (IC). The memory may comprise a computer-readable storage medium (e.g., non-transitory computer-readable storage medium) or machine-readable storage media that maintains computer-executable instructions for performing one or more of the procedures and/or routines as described herein. For example, the memory may comprise computer-executable instructions or machine-readable instructions that include one or more portions of the procedures and/or routines described herein. The control circuit 420 may access the instructions from memory for being executed to cause the control circuit 420 to operate as described herein, or to operate one or more other devices as described herein. The memory may comprise computer-executable instructions for executing configuration software. In addition, the memory may have stored thereon one or more settings and/or control parameters associated with the motor drive unit 410. The control circuit may store the present position of the covering material and/or limits for controlling the position of the covering material (e.g., the position P_{RAISED} and/or the position P_{LOWERED}) in the memory. The control circuit 420 may be configured to store a movement record of a movement of the covering material in a movement log each time that the control circuit 420 controls the motor 412 to adjust the present position P_{PRES} of the covering material. For example, the movement record of each movement of the covering material in the movement log may include a respective starting position, a respective stopping position, and a time of the movement (e.g., as determined from the timeclock).

The motor drive unit 410 may include a rotational position sensing circuit 416, such as, for example, a Hall effect sensor (HES) circuit, which may be configured to generate first and second rotational position sensing signals V_{PS1}, V_{PS2}. The first and second rotational position sensing signals V_{PS1}, V_{PS2} may indicate the rotational speed and/or the direction of rotation of the motor 412 to the control circuit 420. The rotational position sensing circuit 416 may include other suitable position sensors, such as, for example, magnetic, optical, and/or resistive sensors. The control circuit 420 may be configured to determine the rotational position of the motor 412 in response to the first and second rotational position sensing signals V_{PS1}, V_{PS2} generated by the rotational position sensing circuit 416. The control circuit 420 may be configured to determine the present position P_{PRES} of the covering material in response to the rotational position of the motor 412. The operation of a motor drive circuit and a rotational position sensing circuit of a motor drive unit is described in greater detail in U.S. Pat. No. 5,848,434, issued Dec. 15, 1998, entitled MOTORIZED WINDOW SHADE SYSTEM, and U.S. Pat. No. 7,839,109, issued Nov. 23, 2010, entitled METHOD OF CONTROLLING A MOTORIZED WINDOW TREATMENT, the entire disclosures of which are hereby incorporated by reference.

The motor drive unit 410 may include a communication circuit 422 that may allow the control circuit 420 to communicate (e.g., transmit and/or receive) messages (e.g., digital messages). For example, the communication circuit 422 may comprise one or more wired communication circuits and/or wireless communication circuits configured to transmit messages via signals, e.g., wired signals and/or wireless signals, such as radio-frequency (RF) signals. For example, the one or more wireless communication circuits of the communication circuit 422 may include for example, one or more a radio-frequency (RF) transceivers coupled to a respective antenna for transmitting and/or receiving RF signals. For example, the control circuit 420 may be configured to communicate messages via the RF signals via the one or more wireless communication circuits using a wireless communication protocol (e.g., a proprietary RF protocol, such as the CLEAR CONNECT protocol (e.g., CLEAR CONNECT TYPE A and/or CLEAR CONNECT TYPE X protocols), and/or a standard protocol, such as one of WIFI, cellular (e.g., 3G, 4G LTE, 5G NR, or other cellular protocol), BLUETOOTH, BLUETOOTH LOW ENERGY (BLE), ZIGBEE, Z-WAVE, THREAD, KNX-RF, ENOCEAN RADIO protocols, or a different standard protocol). In addition, the one or more wireless communication circuits of the communication circuit 422 may also include an RF transmitter for transmitting RF signals, an RF receiver for receiving RF signals, or an infrared (IR) transmitter and/or receiver for transmitting and/or receiving IR signals. The one or more wireless communication circuits of the communication circuit 422 may be capable of performing communication via the same communication channels or different communication channels. In some examples, the communication circuit 422 may be configured to communicate via a network, such as a wireless or wired local area network (LAN), e.g., for access to the Internet. In addition, the communication circuit 422 may be configured to communicate via a control network (e.g., a wired or wireless control communication link). The one or more wired communication circuits and/or wireless communication circuits of the communication circuit 422 may be implemented as an internal circuit of the control circuit 420 or as an external integrated circuit (IC). In some examples, the control circuit 420 may be configured to synchronize the timeclock with a timeclock of an external device (e.g., the system controller 110 and/or the remote services 164) in response to a message received (e.g., periodically received) via the communication circuit 422.

The control circuit 420 may be configured to control the motor 412 to control the movement of the covering material in response to a shade movement command received in messages received via the communication circuit 422 from a remote control device. For example, the shade movement command may include a commanded position P_{CMD} to which the control circuit 420 will control the covering material. In addition, the control circuit 420 may be configured to receive messages from external devices. For example, the control circuit 420 may be configured to receive messages including indications of occupancy conditions and/or vacancy conditions in the space in which the motorized window treatment is installed from occupancy sensors and/or vacancy sensors, and messages including indications of an ambient light level in the space in which the motorized window treatment is installed form daylight sensors. Further, the control circuit 420 may be configured to transmit messages including a status of the motorized window treatment system 400, such as the present position P_{PRES} of the covering material. During a configuration procedure (e.g., an association procedure), the motor drive unit 410 may be associated with a remote control device, such that the control circuit 420 may be responsive to the messages transmitted by the remote control device (e.g., via wireless signals).

The control circuit 420 may be configured to periodically wake up the communication circuit 422 from a sleep state (e.g., at a wake-up interval T_{WAKE-UP}) to determine if one of multiple messages of a transmission event is being transmitted (e.g., during a wake-up event). The transmission interval T_{TX} and the wake-up interval T_{WAKE-UP} may be sized such that control circuit 420 may not receive each of the multiple messages of the transmission event during a wake-up interval T_{WAKE-UP}, but such that the control circuit 420 may typically receive at least one of the messages when a predetermined number of the multiple messages of the transmission event have been transmitted. When a receive message includes a command, the control circuit 420 may wait until the predetermined number of the multiple messages of the transmission event have been transmitted before responding to the command. For example, the control circuit 420 may begin generating the at least one drive signal VDR to control the motor drive circuit 414 to adjust the present positions P_{PRES} of the bottom bar (e.g., a coordinated action time) that is based on the time at which the predetermined number of the multiple messages of the transmission event have been transmitted (e.g., immediately following when the predetermined number of the multiple messages of the transmission event have been transmitted).

The motor drive unit 410 may include a user interface circuit 424 having one or more actuators (e.g., buttons), for example, that allow a user to provide inputs to the control circuit 420 during setup and/or configuration of the motorized window treatment. The control circuit 420 may be configured to control the motor 412 to control the movement of the covering material in response to a shade movement command received via the communication circuit 422 and/or the user inputs received via the buttons of the user interface circuit 424. The user interface circuit 424 may also include one or more light-emitting diodes (LEDs) that may be illuminated by the control circuit 420, for example, to provide feedback to a user of the motorized window treatment.

The motor drive unit 410 may include a sensor circuit (not shown) coupled to the control circuit 420. For example, the sensor circuit may comprise a photosensor configured to generate a signal that indicates a light level, such as a daylight level L_{DL} outside the window that the motorized window treatment is covering and/or an ambient light level L_{AMB} inside the space in which the motorized window treatment is located. The control circuit 420 to control the motor 412 to control the movement of the covering material in response to the daylight level L_{DL} and/or the ambient light level L_{AMB} indicated by the sensor circuit. In addition, the sensor circuit may comprise an occupancy detection circuit configured to detect when the space in which the motorized window treatment is installed is occupied and/or vacant. For example, the occupancy detection circuit may comprise a passive infrared (PIR) detection circuit for detecting movement of occupants in the space. The control circuit 420 of the motor drive unit 410 may be configured to control the motor 412 to control the movement of the covering material in response to the occupancy condition and/or a vacancy condition detected by the occupancy detection circuit.

The electrical circuitry of the motor drive unit 410 may be powered from a first storage voltage V_{S-A} produced across an energy storage element 430 of the motor drive unit 410. For example, the energy storage element 430 may comprise one or more individual storage elements electrically coupled in parallel and/or in series. The individual storage elements of the energy storage element 430 may comprise, for example, one or more one or more of rechargeable batteries and/or supercapacitors. In some examples, the energy storage element 430 may be external to the motor drive unit 410 (e.g., external to an enclosure of the motor drive unit 410, such as the enclosure 252 of the motor drive unit 250).

The motor drive unit 410 may comprise a power supply 432 configured to receive the first storage voltage V_{S-A} and generate one or more supply voltages for powering the electrical circuitry of the motor drive unit 410. For example, the power supply 432 may be configured to generate a low-voltage supply voltage V_{CC-A} for powering the control circuit 420, the memory, the communication circuit 422, the user interface circuit 424, the rotational position sensing circuit 416, and/or other low-voltage circuitry of the motor drive unit 410. For example, the power supply 432 may comprise a buck converter circuit for generating the low-voltage supply voltage V_{CC-A}. In addition, the power supply 432 may be configured to generate the bus voltage V_{BUS} for powering the motor drive circuit 414. For example, the power supply 432 may comprise a boost converter circuit for generating the bus voltage V_{BUS}. In some examples, the motor drive circuit 414 may be configured to be powered directly from the first storage voltage V_{S-A} produced across the energy storage element 430. The energy storage element 430 of the motor drive unit 410 may be configured to charge through a charging circuit 434 from a second storage voltage V_{S-B} received via electrical connections 438.

The motor drive unit 410 may further comprise electrical connections 439 that may be connected to a power bus (e.g., the power bus 158 shown in FIG. 1) for coupling the motor drive unit 410 to the motor drive units of other motorized window treatments (e.g., nearby motorized window treatments). For example, the power bus may comprise two electrical conductors (e.g., wires) coupled between the motor drive units, which may be coupled in parallel with each other. The motor drive unit 410 may be configured to provide the storage voltage V_{S-A} produced across the energy storage element 430 at the electrical connections 439 (e.g., to provide the storage voltage V_{S-A} on the power bus). For example, the motor drive unit 410 may comprise a diode D435 coupled in series with a switching circuit 436 between the storage voltage V_{S-A} and one of the electrical connections 439 (e.g., with the other electrical connection 439 coupled to circuit common). The control circuit 420 may be configured to generate a switch control signal V_{SW} for rendering the switching circuit 436 conductive and non-conductive for controllably providing the storage voltage V_{S-A} the electrical connections 439. The control circuit 420 may be configured to generate the switch control signal V_{SW} to render the switching circuit 436 to charge energy storage elements of one or more of the other motor drive units coupled to the power bus.

The solar power system 441 of the bottom bar module 440 may comprise the one or more solar cells 442, a solar cell management circuit 444, and an energy storage element 446. For example, the electrical circuitry of the bottom bar module 440 (e.g., the solar power system 441) may be mounted to a printed circuit board (e.g., the printed circuit board 272) in the bottom bar. The solar power system 441 of the bottom bar module 440 configured to charge the energy storage element 430 of the motor drive unit 410 (e.g., as will be described in greater detail below). The energy storage element 446 of the bottom bar module 440 may, for instance, comprise one or more individual storage elements electrically coupled in parallel. The individual storage elements of the energy storage element 446 may comprise, for example, one or more one or more of rechargeable batteries and/or supercapacitors. For example, the solar cells 442 may be mounted to a rear surface of the bottom bar (e.g., such as the solar cells 270, 370 are mounted to the bottom bars 240, 340, 440). The solar cells 442 may be configured to convert received solar energy into a photovoltaic output current I_{PV} and may produce a photovoltaic output voltage V_{PV}. The solar cell management circuit 444 may be configured to charge the energy storage element 446 of the bottom bar for producing the second storage voltage V_{S-B} across the energy storage element 446. For example, the solar cell management circuit 444 may comprise a boost converter circuit for generating the second storage voltage V_{S-B} from the photovoltaic output voltage V_{PV}.

The solar cell management circuit 444 may be configured to control the charging of the energy storage element 446 using, for example, a maximum power point tracking (MPPT) control technique. The solar cell management circuit 444 may include, for example, a MPPT solar charge controller. The MPPT solar charge controller of the solar cell management circuit 444 may be configured to generate a drive signal (e.g., an internal drive signal) for driving a transistor of the boost converter circuit of the solar cell management circuit 444 to generate the second storage voltage V_{S-B} from the photovoltaic output voltage V_{PV}. For example, the drive signal generated by the MPPT solar charge controller may be characterized by a duty cycle DC_{SCM}. The MPPT solar charge controller of the solar cell management circuit 444 may be configured to adjust the duty cycle DC_{SCM} to track a maximum power point for charging the energy storage element 446.

The bottom bar module 440 may comprise electrical connections 448 configured to be coupled to (e.g., electrically and/or inductively coupled to) the electrical connections 438 of the motor drive unit 410. The motor drive unit 410 may be configured to control the covering material to the raised position P_{RAISED} in which the electrical connections 448 of the bottom bar module 440 may be electrically connected to the electrical connection 438 of the motor drive unit 410 (e.g., to dock the bottom bar module 440 with the motor drive unit 410). For example, the electrical connections 438 of the motor drive unit 410 may represent the electrical contacts 285 of the dock 280. In addition, the electrical connections 448 of the bottom bar module 440 may represent two of the electrical contacts 275 of the bottom bar 240. In some examples, the motor drive unit 410 and the bottom bar module 440 may not comprise the respective electrical connections 438, 448, but may alternatively comprise respective induction coils (e.g., the first induction coil 375 of the bottom bar 340 and/or the second induction coil 385 of the motor drive unit 350) to facilitate inductive coupling (e.g., magnetic coupling) between the bottom bar module 440 and the motor drive unit 410. When the covering material is in the raised position P_{RAISED} (e.g., when the bottom bar is docked), the electrical connections 448 of the bottom bar module 440 may be coupled to (e.g., electrically and/or inductively coupled to) the electrical connections 438 of the motor drive unit 410, such that the energy storage element 430 of the motor drive unit 410 is configured to charge from the energy storage element 446 of the bottom bar module 440 via the charging circuit 434. While the charging circuit 434 is shown in FIG. 16A as a part of the motor drive unit 410, the charging circuit 434 could alternatively or additionally be included in the bottom bar module 440.

The bottom bar module 440 may include a control circuit 450 (e.g., a bottom bar control circuit), which may include, for example, a microprocessor, a programmable logic device (PLD), a microcontroller, an application specific integrated circuit (ASIC), a field-programmable gate array (FPGA), or any suitable processing device or control circuit. The control circuit 450 of the bottom bar module 440 may be configured to monitor the operation of the solar cells 442 and/or the energy storage element 446. The control circuit 450 of the bottom bar module 440 may be configured to receive one or more sense signals V_{SCM-SNS} from the solar cell management circuit 444. The one or more sense signals V_{SCM-SNS} received from the solar cell management circuit 444 may indicate, for example, a magnitude of the photovoltaic output voltage V_{PV} generated by the solar cells 442 and/or a magnitude of the second storage voltage V_{S-B} generated across the energy storage element 446. For example, the one or more sense signals V_{SCM-SNS} generated by the solar cell management circuit 444 may comprise direct-current (DC) signals having magnitudes that indicate the magnitude of the photovoltaic output voltage V_{PV} and/or the magnitude of the second storage voltage V_{S-B} (e.g., the solar cell management circuit 444 may comprise one or more resistive divider circuits for generating the one or more sense signals V_{SCM-SNS}). In addition, the one or more sense signals V_{SCM-SNS} generated by the solar cell management circuit 444 may comprise messages (e.g., digital messages) including indications of the magnitude of the photovoltaic output voltage V_{PV} and/or the magnitude of the second storage voltage V_{S-B}.

In some examples, the bottom bar module 440 may comprise a memory (not shown), e.g., such as a non-volatile memory. The memory may be communicatively coupled to the control circuit 450 for the storage and/or retrieval of, for example, operational settings of the bottom bar module 440. In addition, the memory may be configured to store software for execution by the control circuit 450. The memory may be implemented as an internal circuit of the control circuit 450 or as an external integrated circuit (IC). The memory may comprise a computer-readable storage medium (e.g., non-transitory computer-readable storage medium) or machine-readable storage medium that maintains computer-executable instructions for performing one or more of the procedures and/or routines as described herein. For example, the memory may comprise computer-executable instructions or machine-readable instructions that include one or more portions of the procedures and/or routines described herein. The control circuit 450 may access the instructions from memory for being executed to cause the control circuit 420 to operate as described herein, or to operate one or more other devices as described herein. The memory may comprise computer-executable instructions for executing configuration software. In addition, the memory may have stored thereon one or more settings and/or control parameters associated with the bottom bar module 440. The control circuit may store measurements (e.g., the magnitude of the photovoltaic output voltage V_{PV} and/or the magnitude of the second storage voltage V_{S-B}) and/or operational characteristics (e.g., the duty cycle DC_{SCM} of the solar cell management circuit 444) in the memory.

The bottom bar module 440 may include a communication circuit 452 that may allow the control circuit 450 to communicate (e.g., transmit and/or receive) messages (e.g., digital messages) with the communication circuit 422 of the motor drive unit 410 via a communication link, such as a wired communication link and/or a wireless communication link, e.g., a radio-frequency (RF) communication link. For example, the communication circuit 452 may comprise one or more wired communication circuits and/or wireless communication circuits via signals, e.g., wired signals and/or wireless signals, such as RF signals. The one or more wired communication circuits and/or wireless communication circuits of the communication circuit 422 may be implemented as an internal circuit of the control circuit 420 or as an external integrated circuit (IC). For example, the one or more wireless communication circuits of the communication circuit 452 may include for example, one or more a radio-frequency (RF) transceivers coupled to a respective antenna for transmitting and/or receiving RF signals. The control circuit 450 of the bottom bar module 440 may be configured to communicate messages with the control circuit 420 of the motor drive unit 410, for example, via RF signals using a short-range wireless communication protocol (e.g., the BLUETOOTH LOW ENERGY (BLE) protocol, the Thread wireless communication protocol, etc.). In addition, the one or more wireless communication circuits of the communication circuit 422 may also include an RF transmitter for transmitting RF signals, an RF receiver for receiving RF signals, or an infrared (IR) transmitter and/or receiver for transmitting and/or receiving IR signals.

Further, the communication circuit 422 of the motor drive unit 410 and the communication circuit 452 of the bottom bar module 440 may be coupled together via a wired communication link, for example, when the bottom bar is docked. For example, the communication circuit 422 of the motor drive unit 410 may be coupled to the electrical connections 438 and the communication circuit 452 of the bottom bar module 440 may be coupled to the electrical connections 448, such that the communication circuits 422, 452 are configured to communicate with each other via the electrical connections 438, 448 when the bottom bar is docked. In addition, the motor drive unit 410 and/or the bottom bar module 440 may comprise additional electrical connections to allow the communication circuits 422, 452 to communicate with each other via the wired communication link.

In some examples, the communication circuit 422 and the communication circuit 452 may be configured for infrared (IR) communication. For example, the communication circuit 452 may comprise an IR emitter, and the communication circuit 422 may comprise an IR receiver. As such, the communication circuit 452 may allow the control circuit 450 to communicate messages (e.g., digital messages) with the communication circuit 422 of the motor drive unit 410 via an IR communication link. In some examples, the communication circuit 422 of the motor drive unit 410 may include an IR receiver that be located at an end portion of the motor drive unit 410, and the communication circuit 452 of the bottom bar module 440 may include an IR transmitter that be located at a corresponding (e.g., aligned) end portion of the bottom bar. Alternatively or additionally, the communication circuit 422 of the motor drive unit 410 may be an IR dongle that, for example, may be coupled to the control circuit 420 of the motor drive unit 410 via a Universal Serial Bus (USB) connection.

The control circuit 450 of the bottom bar module 440 may be configured to transmit messages including measurements recorded by the bottom bar module 440 and/or one or more operational characteristics of the bottom bar module 440. For example, the control circuit 450 of the bottom bar module 440 may be configured to transmit a message including an indication of a measurement of the magnitude of the photovoltaic output voltage V_{PV} generated by the solar cells 442 and/or an indication of a measurement of the magnitude of the second storage voltage V_{S-B} generated across the energy storage element 446 to the control circuit 420 of the motor drive unit 410. In addition, the control circuit 450 of the bottom bar module 440 may be configured to transmit a message an indication of an operational characteristic of the solar cell management circuit 444, such as the duty cycle DC_{SCM} of the solar cell management circuit 444.

The bottom bar module 440 may include a sensor circuit 454 coupled to the control circuit 450. For example, the sensor circuit 454 may comprise a photosensor configured to generate a signal that indicates a light level, such as a daylight level L_{DL} outside the window that the motorized window treatment is covering and/or an ambient light level L_{AMB} inside the space in which the motorized window treatment is located. The control circuit 450 of the bottom bar module 440 may be configured to transmit a message including the daylight level L_{DL} and/or the ambient light level L_{AMB} indicated by the sensor circuit 454 to the motor drive unit 410. In addition, the sensor circuit 454 may comprise one or more orientation detection sensors, such as an accelerometer and/or a gyroscope. For example, the control circuit 450 of the bottom bar module 440 may be configured to determine when the motor drive unit 410 is adjusting the present position P_{PRES} (e.g., the bottom bar is moving) in response to the accelerometer and/or the gyroscope of the sensor circuit 454. Further, the sensor circuit 454 may comprise an occupancy detection circuit configured to detect when the space in which the motorized window treatment is installed is occupied and/or vacant. For example, the occupancy detection circuit may comprise a passive infrared (PIR) detection circuit for detecting movement of occupants in the space. The control circuit 450 of the bottom bar module 440 may be configured to transmit a message including an indication of an occupancy condition and/or a vacancy condition to the motor drive unit 410.

The bottom bar module 440 may also comprise a power supply 456 configured to receive the second storage voltage V_{S-B} and generate a low-voltage supply voltage V_{CC-B} for powering the control circuit 450, the memory, the communication circuit 452, and/or the sensor circuit 454.

The control circuit 420 of the motor drive unit 410 and/or the control circuit 450 of the bottom bar module 440 may be configured to determine a magnitude of a solar power P_{SOLAR} being received (e.g., presently being received) by the solar cells 442. The control circuit 420 of the motor drive unit 410 and/or the control circuit 450 of the bottom bar module 440 may be configured to calculate the solar power P_{SOLAR} as a function of the magnitude of the photovoltaic output voltage V_{PV}, the magnitude of the second storage voltage V_{S-B}, and/or the duty cycle D_{CSCM} of the solar cell management circuit 444 (e.g., as received from the bottom bar module 440).

To charge the energy storage element 430 of the motor drive unit 410 from the energy storage element 446 of the bottom bar module 440, the control circuit 420 of the motor drive unit 410 may be configured to control the motor drive circuit 414 to move the covering material to the raised position P_{RAISED}, such that the bottom bar is docked and the electrical connections 448 of the bottom bar module 440 may be coupled to (e.g., electrically and/or inductively coupled to) the electrical connections 438 of the motor drive unit 410. When the control circuit 420 is moving the covering material to dock the bottom bar, the control circuit 420 may control the covering material through a docking movement (e.g., a docking sequence) as the bottom bar nears the dock. For example, the control circuit 420 may ramp down a rotational speed at which the motor is rotating as the bottom bar nears the dock. In some examples, the control circuit 420 may be configured to store in the memory a last-docking time T_{LAST-DOCK} which represents the last time that the control circuit 420 docked the bottom bar (e.g., as determined from the timeclock when the control circuit 420 docks the bottom bar).

The control circuit 420 of the motor drive unit 410 and/or the control circuit 450 of the bottom bar module 440 may be configured to determine that the bottom bar is docked by determining if the electrical connections 438 of the motor drive unit 410 are electrically connected to the electrical connections 448 of the bottom bar module 440. For example, the control circuit 420 of the motor drive unit 410 may be configured to determine that the bottom bar is docked by detecting that the second storage voltage V_{S-B} is present at the electrical connections 438. In addition, the control circuit 450 of the bottom bar module 440 may be configured to determine that the bottom bar is docked by detecting that the motor drive unit 410 is drawing current from the energy storage element 446 via the electrical connections 448. Further, the control circuit 450 of the motor drive unit 410 may be configured to determine that the bottom bar is docked in response to receiving a message from the bottom bar module 440, and the control circuit 450 of the bottom bar module 440 may be configured to determine that the bottom bar is docked in response to receiving a message from the motor drive unit 410. The control circuit 420 of the motor drive unit 410 may be configured to transmit a query message to the bottom bar module 440, and the control circuit 450 of the bottom bar module 440 may be configured to transmit a response to the query message to the motor drive unit 410. For example, the control circuit 420 of the motor drive unit 410 may be configured to transmit the query message to the bottom bar module 440 via a wired communication link (e.g., via the electrical connections 438, 448 and/or via separate electrical connections on the dock) and/or via a wireless communication link (e.g., where the query message may indicate that the bottom bar is docked).

In some examples, the motor drive unit 410 may include electrical terminals 437 that are configured to allow for an external power source to charge the energy storage element 430 of the motor drive unit 410. For example, the energy storage element 430 of the motor drive unit 410 may be charged (e.g., jump started) when the motorized window treatment system 400 is first installed and the motor drive unit 410 is first powered up. In addition, the energy storage element 430 of the motor drive unit 410 may be charged (e.g., recharged) when the energy storage element 430 is in a condition in which the energy storage element 430 is not able to properly charge from the energy storge element 446 of the bottom bar module 440 (e.g., if the solar cells 442 are not receiving an appropriate amount of solar energy. In some examples, the electrical terminals 437 may be a standard power supply connector, e.g., such as a universal serial bus (USB) connector. In some examples, the motor drive unit 410 (e.g., the energy storage element 430) may be configured to receive power from an external power source via the electrical terminals 437. For example, in the condition that the energy storage element 430 is not able to properly charge from the energy storge element 446 of the bottom bar module 440, the motor drive unit 410 (e.g., the energy storage element 430) may be configured to receive power (e.g., continuously receive power) from an external power source, such as an external power supply and/or an external battery pack.

FIG. 16B is a simplified block diagram of a motorized window treatment system 500 for controlling a motorized window treatment (e.g., the motorized window treatments 150 of the load control system 100, the motorized window treatment 200, the motorized window treatment 300). The motorized window treatment may comprise a covering material (e.g., the covering material 152, 230, 330) that may be wound around a roller tube (e.g., the roller tubes 212, 312) and may extend to a bottom bar (e.g., the bottom bars 240, 340). The motorized window treatment system 500 may comprise a base assembly that includes a motor drive unit 510 (e.g., the motor drive units 156, the motor drive unit 250, and/or the motor drive unit 350) for rotating the roller tube for raising and lowering the covering material to adjust a present position P_{PRES} of the covering material (e.g., the bottom bar). The motorized window treatment system 500 may comprise a bottom bar module 540 that may be located in and/or on the bottom bar. The bottom bar module 540 may include a solar power system 541 for harvesting power (e.g., solar power) from sunlight that may shine through the window. The bottom bar module 540 (e.g., the solar power system 541) may comprise one or more solar cells 542 (e.g., photovoltaic cells) configured to receive the sunlight through the window. The base assembly of the motorized window treatment system 500 may further comprise a dock (e.g., the docks 280, 380) electrically coupled to the motor drive unit 510. The motor drive unit 510 may be configured to control the covering material to the raised position to dock the bottom bar, such that the motor drive unit 510 may be electrically connected to the bottom bar module 540 and may be powered via the solar power system 541 of the bottom bar module 540 (e.g., as will be described in greater detail below).

The motor drive unit 510 may comprise a motor 512 (e.g., a direct-current motor) that may be coupled to the roller tube for rotating the roller tube. The motor drive unit 510 may include a motor drive circuit 514 (e.g., an H-bridge drive circuit) that may generate a pulse-width modulated (PWM) voltage V_{PWM} for driving the motor 512. For example, the motor drive circuit 514 may comprise an H-bridge drive circuit and/or an H-bridge controller (e.g., an integrated circuit) for controlling the H-bridge drive circuit to generate the PWM voltage V_{PWM} across the motor 512. The motor drive circuit 514 may receive (e.g., directly receive) a first storage voltage V_{S-A} produced across an energy storage element 530 of the motor drive unit 510. For example, the energy storage element 530 may comprise one or more individual storage elements electrically coupled in parallel. The individual storage elements of the energy storage element 530 may comprise, for example, one or more one or more of supercapacitors and/or rechargeable batteries, such as, lithium iron phosphate (LiFePO4 or LFP) batteries (e.g., six LFP batteries). For example, the energy storage element 530 may comprise a first set of three LFP batteries coupled in parallel and a second set of three LFP batteries coupled in parallel, where the first set of LFP batteries may be coupled in series with the second set of LFP batteries (e.g., in a 2S3P battery configuration). Each of the LFP batteries may have a rated maximum voltage of approximately 3.6 volts, such the energy storage element 530 (e.g., the 2S3P battery configuration) has a rated maximum voltage of approximately 7.2 volts. In some examples, the energy storage element 530 may be external to the motor drive unit 510 (e.g., external to an enclosure of the motor drive unit 510, such as the enclosure 252 of the motor drive unit 250). In some examples, motor drive unit 510 may comprise a boost converter circuit (not shown) coupled between the energy storage element 530 and the motor drive circuit 514, where the boost converter circuit may be configured to receive the first storage voltage V_{S-A} and a generate a bus voltage V_{BUS} for powering the motor drive circuit 514.

The motor drive unit 510 may include a control circuit 520 (e.g., a motor control circuit) for controlling the operation of the motor 512. The control circuit 520 may include, for example, a microprocessor, a programmable logic device (PLD), a microcontroller, an application specific integrated circuit (ASIC), a field-programmable gate array (FPGA), or any suitable processing device or control circuit. The control circuit 520 may include instructions (e.g., software instructions) that configure the control circuit 520 to generate at least one drive signal VDR for controlling the motor drive circuit 514. The motor drive circuit 514 may be configured to control the rotational speed and the direction of rotation of the motor 512 in response to the drive signal VDR. The control circuit 520 may be configured to control the motor drive circuit 514 to rotate the motor 512 to adjust a present position P_{PRES} of the covering material (e.g., of the bottom bar). The motor drive unit 510 may be configured to control the covering material between a raised position P_{RAISED} (e.g., a fully-raised position and/or a fully-open position) and a lowered position P_{LOWERED} (e.g., a fully-lowered position and/or a fully-closed position). The control circuit 520 may be configured to set limits (e.g., an upper limit position P_{UP-LIMIT} and a lower limit position PLO-LIMIT) for limiting a range across which the present position P_{PRES} of the covering material may be adjusted (e.g., to be less than a full range between the raised position P_{RAISED} and lowered position P_{LOWERED}. In some examples, the control circuit 520 may be configured to keep track of a present time (e.g., an actual time) using a timeclock. For example, the timeclock may be implemented as an internal circuit of the control circuit 520 or as an external integrated circuit (IC). The present time indicated by the timeclock may represent, for example, a time of day, a week of the year, a month of the year, a day of the week, a day of the month, and/or a day of the year.

The motor drive unit 510 may comprise a memory (not shown), e.g., such as a non-volatile memory. The memory may be communicatively coupled to the control circuit 520 for the storage and/or retrieval of, for example, operational settings of the motor drive unit 510. In addition, the memory may be configured to store software for execution by the control circuit 520 to operate the motor drive unit 510 as described herein. The memory may be implemented as an internal circuit of the control circuit 520 or as an external integrated circuit (IC). The memory may comprise a computer-readable storage media or machine-readable storage media that maintains computer-executable instructions for performing one or more of the procedures and/or routines as described herein. For example, the memory may comprise computer-executable instructions or machine-readable instructions that include one or more portions of the procedures and/or routines described herein. The control circuit 520 may access the instructions from memory for being executed to cause the control circuit 520 to operate as described herein, or to operate one or more other devices as described herein. The memory may comprise computer-executable instructions for executing configuration software. In addition, the memory may have stored thereon one or more settings and/or control parameters associated with the motor drive unit 510. The control circuit may store the present position of the covering material and/or limits for controlling the position of the covering material (e.g., the fully-raised position P_{RAISED} and/or the fully-lowered position P_{LOWERED}) in the memory. The control circuit 520 may be configured to store a movement record of a movement of the covering material in a movement log each time that the control circuit 520 controls the motor 512 to adjust the present position P_{PRES} of the covering material. For example, the movement record of each movement of the covering material in the movement log may include a respective starting position, a respective stopping position, and a time of the movement (e.g., as determined from the timeclock).

The motor drive unit 510 may include a rotational position sensing circuit 516, such as, for example, a Hall effect sensor (HES) circuit, which may be configured to generate first and second rotational position sensing signals V_{PS1}, V_{PS2}. The first and second rotational position sensing signals V_{PS1}, V_{PS2} may indicate the rotational speed and/or the direction of rotation of the motor 512 to the control circuit 520. The rotational position sensing circuit 516 may include other suitable position sensors, such as, for example, magnetic, optical, and/or resistive sensors. The control circuit 520 may be configured to determine the rotational position of the motor 512 in response to the first and second rotational position sensing signals V_{PS1}, V_{PS2} generated by the rotational position sensing circuit 516. The control circuit 520 may be configured to determine the present position P_{PRES} of the covering material in response to the rotational position of the motor 512. The operation of a motor drive circuit and a rotational position sensing circuit of a motor drive unit is described in greater detail in U.S. Pat. No. 5,848,634, issued Dec. 15, 1998, entitled MOTORIZED WINDOW SHADE SYSTEM, and U.S. Pat. No. 7,839,109, issued Nov. 23, 2010, entitled METHOD OF CONTROLLING A MOTORIZED WINDOW TREATMENT, the entire disclosures of which are hereby incorporated by reference.

The motor drive unit 510 may include a communication circuit 522 that may allow the control circuit 520 to communicate (e.g., transmit and/or receive) messages (e.g., digital messages). For example, the communication circuit 522 may comprise one or more wired communication circuits and/or wireless communication circuits configured to transmit messages via signals, e.g., wired signals and/or wireless signals, such as radio-frequency (RF) signals. For example, the one or more wireless communication circuits of the communication circuit 522 may include for example, one or more a radio-frequency (RF) transceivers coupled to a respective antenna for transmitting and/or receiving RF signals. For example, the control circuit 520 may be configured to communicate messages via the RF signals via the one or more wireless communication circuits using a wireless communication protocol (e.g., a proprietary RF protocol, such as the CLEAR CONNECT protocol (e.g., CLEAR CONNECT TYPE A and/or CLEAR CONNECT TYPE X protocols), and/or a standard protocol, such as one of WIFI, cellular (e.g., 3G, 4G LTE, 5G NR, or other cellular protocol), BLUETOOTH, BLUETOOTH LOW ENERGY (BLE), ZIGBEE, Z-WAVE, THREAD, KNX-RF, ENOCEAN RADIO protocols, or a different standard protocol). In addition, the one or more wireless communication circuits of the communication circuit 522 may also include an RF transmitter for transmitting RF signals, an RF receiver for receiving RF signals, or an infrared (IR) transmitter and/or receiver for transmitting and/or receiving IR signals. The one or more wireless communication circuits of the communication circuit 522 may be capable of performing communication via the same communication channels or different communication channels. In some examples, the communication circuit 522 may be configured to communicate via a network, such as a wireless or wired local area network (LAN), e.g., for access to the Internet. In addition, the communication circuit 522 may be configured to communicate via a control network (e.g., a wired or wireless control communication link). The one or more wired communication circuits and/or wireless communication circuits of the communication circuit 522 may be implemented as an internal circuit of the control circuit 520 or as an external integrated circuit (IC). In some examples, the control circuit 520 may be configured to synchronize the timeclock with a timeclock of an external device (e.g., the system controller 110 and/or the remote services 164) in response to a message received (e.g., periodically received) via the communication circuit 522.

The control circuit 520 may be configured to control the motor 512 to control the movement of the covering material in response to a shade movement command received in messages received via the communication circuit 522 from a remote control device. For example, the shade movement command may include a commanded position P_{CMD} to which the control circuit 520 will control the covering material. In addition, the control circuit 520 may be configured to receive messages from external devices. For example, the control circuit 520 may be configured to receive messages including indications of occupancy conditions and/or vacancy conditions in the space in which the motorized window treatment is installed from occupancy sensors and/or vacancy sensors, and messages including indications of an ambient light level in the space in which the motorized window treatment is installed form daylight sensors. Further, the control circuit 520 may be configured to transmit messages including a status of the motorized window treatment system 500, such as the present position P_{PRES} of the covering material. During a configuration procedure (e.g., an association procedure), the motor drive unit 510 may be associated with a remote control device, such that the control circuit 520 may be responsive to the messages transmitted by the remote control device (e.g., via wireless signals).

The control circuit 520 may be configured to periodically wake up the communication circuit 522 from a sleep state (e.g., at a wake-up interval T_{WAKE-UP}) to determine if one of multiple messages of a transmission event is being transmitted (e.g., during a wake-up event). The transmission interval T_{TX} and the wake-up interval T_{WAKE-UP} may be sized such that control circuit 520 may not receive each of the multiple messages of the transmission event during the wake-up interval T_{WAKE-UP}, but such that the control circuit 520 may typically receive at least one of the messages when a predetermined number of the multiple messages of the transmission event have been transmitted. When a receive message includes a command, the control circuit 520 may wait until the predetermined number of the multiple messages of the transmission event have been transmitted before responding to the command. For example, the control circuit 520 may begin generating the at least one drive signal VDR to control the motor drive circuit 514 to adjust the present positions P_{PRES} of the bottom bar (e.g., a coordinated action time) that is based on the time at which the predetermined number of the multiple messages of the transmission event have been transmitted (e.g., immediately following when the predetermined number of the multiple messages of the transmission event have been transmitted).

The motor drive unit 510 may include a user interface circuit 524 having one or more actuators (e.g., buttons), for example, that allow a user to provide inputs to the control circuit 520 during setup and/or configuration of the motorized window treatment. The control circuit 520 may be configured to control the motor 512 to control the movement of the covering material in response to a shade movement command received via the communication circuit 522 and/or the user inputs received via the buttons of the user interface circuit 524. The user interface circuit 524 may also include one or more light-emitting diodes (LEDs) that may be illuminated by the control circuit 520, for example, to provide feedback to a user of the motorized window treatment.

The motor drive unit 510 may include a sensor circuit (not shown) coupled to the control circuit 520. For example, the sensor circuit may comprise a photosensor configured to generate a signal that indicates a light level, such as a daylight level L_{DL} outside the window that the motorized window treatment is covering and/or an ambient light level L_{AMB} inside the space in which the motorized window treatment is located. The control circuit 520 to control the motor 512 to control the movement of the covering material in response to the daylight level L_{DL} and/or the ambient light level L_{AMB} indicated by the sensor circuit. In addition, the sensor circuit may comprise an occupancy detection circuit configured to detect when the space in which the motorized window treatment is installed is occupied and/or vacant. For example, the occupancy detection circuit may comprise a passive infrared (PIR) detection circuit for detecting movement of occupants in the space. The control circuit 520 of the motor drive unit 510 may be configured to control the motor 512 to control the movement of the covering material in response to the occupancy condition and/or a vacancy condition detected by the occupancy detection circuit.

The motor drive unit 510 may comprise a power supply 532 configured to receive the first storage voltage V_{S-A} from the energy storage element 530 and generate one or more supply voltages for powering the electrical circuitry of the motor drive unit 510. For example, the power supply 532 may be configured to generate a low-voltage supply voltage V_{CC-A} (e.g., at a second output) for powering one or more low-voltage electrical loads of the motor drive units, such as, the control circuit 520, the memory, the communication circuit 522, the user interface circuit 524, the rotational position sensing circuit 516, and/or other low-voltage circuitry of the motor drive unit 510. For example, the power supply 532 may comprise a buck converter circuit for generating the low-voltage supply voltage V_{CC-A}.

The motor drive unit 510 may comprise a first sense circuit 531 coupled between the energy storage element 530 and the motor drive circuit 514. The first sense circuit 531 may be configured to sense a magnitude of a first load current I_{LOAD1} conducted by the motor drive circuit 514 and generate a first sense signal V_{I-SNS1} that may be received by the control circuit 520. The first sense signal V_{I-SNS1} (e.g., the magnitude of the first sense signal V_{I-SNS1}) may indicate the magnitude of the first load current I_{LOAD1}. The control circuit 520 may be configured to determine a first load power P_{LOAD1} (e.g., a motor-control power) being consumed from the energy storage element 530 (e.g., by the motor drive circuit 514 and/or the motor 512) in response to the magnitude of the first load current I_{LOAD1} as indicated by the first sense signal V_{I-SNS1} (e.g., as will be explained in greater detail below).

The motor drive unit 510 may comprise a second sense circuit 533 coupled between the energy storage element 530 and the power supply 532. The second sense circuit 533 may be configured to sense a magnitude of a second load current I_{LOAD2} conducted by the power supply 532 to supply power to the electrical loads that are powered by the low-voltage supply voltage V_{CC-A} (e.g., the control circuit 520, the memory, the communication circuit 522, the user interface circuit 524, the sensor circuit, and other low-voltage circuitry of the motor drive unit 510) and generate a second sense signal V_{I-SNS2} that may be received by the control circuit 520. The second sense signal V_{I-SNS2} (e.g., the magnitude of the second sense signal V_{I-SNS2}) may indicate the magnitude of the second load current I_{LOAD2}. The control circuit 520 may be configured to determine a second load power P_{LOAD2} (e.g., a low-voltage-load power) being consumed from the energy storage element 530 (e.g., the power supply 732 and/or the electrical loads that are powered by the low-voltage supply voltage V_{CC-A}) in response to the magnitude of the second load current I_{LOAD2} as indicated by the second sense signal V_{I-SNS2} (e.g., as will be explained in greater detail below). The control circuit 520 may also be configured to determine (e.g., calculate) and store in memory a total charge Q_{LOAD-TOTAL} and/or a total energy E_{LOAD-TOTAL} consumed from the energy storage element 530 by the electrical loads of the motor drive unit 510 in response to the first load current I_{LOAD1} and the second load current I_{LOAD2} (e.g., as will be described in greater detail below).

The solar power system 541 of the bottom bar module 540 may comprise the one or more solar cells 542, a solar cell management circuit 544, an energy storage element 546, and a charging circuit 547. For example, the electrical circuitry of the bottom bar module 540 (e.g., the solar power system 541) may be mounted to a printed circuit board (e.g., the printed circuit board 272) in the bottom bar. The solar power system 541 of the bottom bar module 540 configured to charge the energy storage element 530 of the motor drive unit 510 (e.g., as will be described in greater detail below). The energy storage element 546 of the bottom bar module 540 may, for instance, comprise one or more individual storage elements electrically coupled in parallel and/or in series. The individual storage elements of the energy storage element 546 may comprise, for example, one or more one or more of supercapacitors and/or rechargeable batteries, such as, nickel-metal hydride (NiMH) batteries.

The solar cells 542 may be configured to convert received solar energy into a photovoltaic output current I_{PV} and may produce a photovoltaic output voltage V_{PV}. For example, the solar cells 542 may be configured to generate the photovoltaic output current I_{PV} based on the amount of sunlight being received, and the photovoltaic output voltage V_{PV} may be produced as a result of the photovoltaic output current I_{PV}. The solar cells 642 may be mounted to a rear surface of the bottom bar (e.g., such as the solar cells 270, 370 are mounted to the bottom bars 240, 340, 440). The solar cell management circuit 544 may be configured to charge the energy storage element 546 of the bottom bar module 540 for producing a second storage voltage V_{S-B} across the energy storage element 546. For example, the solar cell management circuit 544 may comprise a flyback converter for generating the second storage voltage V_{S-B} from the photovoltaic output voltage V_{PV}. The solar cell management circuit 544 may be configured to control the charging of the energy storage element 546 from the photovoltaic output voltage V_{PV}.

The motor drive unit 510 may comprise first and second electrical connections 538a, 538b through which the energy storage element 530 of the motor drive unit 510 may charge. The motor drive unit 510 may also comprise a switching circuit 536 coupled in series between the storage voltage V_{S-A} and of the first electrical connection 538a. The second electrical connection 538b may be coupled to circuit common of the motor drive unit 510. The control circuit 520 may be configured to generate a charge enable control signal V_{CHRG-EN-A} for rendering the switching circuit 536 conductive and non-conductive for enabling and disabling, respectively, charging of the energy storage element 530.

The bottom bar module 540 may comprise first and second electrical connections 548a, 548b configured to be coupled to (e.g., electrically and/or inductively coupled to) the first and second electrical connections 538a, 538b of the motor drive unit 510, respectively. The motor drive unit 510 may be configured to control the covering material to the raised position P_{RAISED} in which the first and second electrical connections 548a, 548b of the bottom bar module 540 may be electrically connected to the first and second electrical connections 538a, 538b of the motor drive unit 510, respectively (e.g., to dock the bottom bar module 540 with the motor drive unit 510). For example, the first and second electrical connections 538a, 538b of the motor drive unit 510 may represent the electrical contacts 285 of the dock 280. In addition, the first and second electrical connections 548a, 548b of the bottom bar module 540 may represent two of the electrical contacts 275 of the bottom bar 240. In some examples, the motor drive unit 510 and the bottom bar module 540 may not comprise the first and second electrical connections 538a, 538b and the first and second electrical connections 548a, 548b, respectively, but may alternatively comprise respective induction coils (e.g., the first induction coil 375 of the bottom bar 340 and/or the second induction coil 385 of the motor drive unit 350) to facilitate inductive coupling (e.g., magnetic coupling) between the bottom bar module 540 and the motor drive unit 510.

The charging circuit 547 of the bottom bar module 540 may be electrically coupled between the energy storage element 530 and the first and second electrical connections 548a, 548b, such that the charging circuit 547 may be configured to charge the energy storage element 530 of the motor drive unit 510 from the energy storage element 546 of the bottom bar module 540 when the bottom bar is docked. For example, the charging circuit 547 may comprise a boost converter for generating the first storage voltage V_{S-A} from the second storage voltage V_{S-B}. When the covering material is in the raised position P_{RAISED} (e.g., when the bottom bar is docked), the first and second electrical connections 548a, 548b of the bottom bar module 540 may be coupled to (e.g., electrically and/or inductively coupled to) the first and second electrical connections 538a, 538b of the motor drive unit 510, respectively. At this time, the control circuit 520 of the motor drive unit 510 may be configured to render the switching circuit 536 conductive to enable charging of the energy storage element 530 from the energy storage element 546 of the bottom bar module 540 via the charging circuit 547 when the bottom bar is docked. While the charging circuit 547 is shown in FIG. 16B as a part of the bottom bar module 540, the charging circuit 547 could alternatively or additionally be included in the motor drive unit 510.

The bottom bar module 540 may include a control circuit 550 (e.g., a bottom bar control circuit), which may include, for example, a microprocessor, a programmable logic device (PLD), a microcontroller, an application specific integrated circuit (ASIC), a field-programmable gate array (FPGA), or any suitable processing device or control circuit. The control circuit 550 of the bottom bar module 540 may be configured to monitor the operation of the solar cells 542 and/or the energy storage element 546.

In some examples, the bottom bar module 540 may comprise a memory (not shown), e.g., such as a non-volatile memory. The memory may be communicatively coupled to the control circuit 550 for the storage and/or retrieval of, for example, operational settings of the bottom bar module 540. In addition, the memory may be configured to store software for execution by the control circuit 550. The memory may be implemented as an internal circuit of the control circuit 550 or as an external integrated circuit (IC). The memory may comprise a computer-readable storage medium (e.g., non-transitory computer-readable storage medium) or machine-readable storage medium that maintains computer-executable instructions for performing one or more of the procedures and/or routines as described herein. For example, the memory may comprise computer-executable instructions or machine-readable instructions that include one or more portions of the procedures and/or routines described herein. The control circuit 550 may access the instructions from memory for being executed to cause the control circuit 520 to operate as described herein, or to operate one or more other devices as described herein. The memory may comprise computer-executable instructions for executing configuration software. In addition, the memory may have stored thereon one or more settings and/or control parameters associated with the bottom bar module 540.

The bottom bar module 540 may include a communication circuit 552 that may allow the control circuit 550 to communicate (e.g., transmit and/or receive) messages (e.g., digital messages) with the communication circuit 522 of the motor drive unit 510 via a communication link, such as a wired communication link and/or a wireless communication link, e.g., a radio-frequency (RF) communication link. For example, the communication circuit 552 may comprise one or more wired communication circuits and/or wireless communication circuits via signals, e.g., wired signals and/or wireless signals, such as RF signals. The one or more wired communication circuits and/or wireless communication circuits of the communication circuit 522 may be implemented as an internal circuit of the control circuit 520 or as an external integrated circuit (IC). For example, the one or more wireless communication circuits of the communication circuit 552 may include for example, one or more a radio-frequency (RF) transceivers coupled to a respective antenna for transmitting and/or receiving RF signals. The control circuit 550 of the bottom bar module 540 may be configured to communicate messages with the control circuit 520 of the motor drive unit 510, for example, via RF signals using a short-range wireless communication protocol (e.g., the BLUETOOTH LOW ENERGY (BLE) protocol, the Thread wireless communication protocol, etc.). In addition, the one or more wireless communication circuits of the communication circuit 522 may also include an RF transmitter for transmitting RF signals, an RF receiver for receiving RF signals, or an infrared (IR) transmitter and/or receiver for transmitting and/or receiving IR signals.

Further, the communication circuit 522 of the motor drive unit 510 and the communication circuit 552 of the bottom bar module 540 may be coupled together via a wired communication link, for example, when the bottom bar is docked. For example, the motor drive unit 510 may comprise a third electrical connection 538c and the bottom bar module 540 may comprise a third electrical connection 548c to allow the communication circuits 522, 552 to communicate with each other via the wired communication link when the bottom bar is docked. The control circuit 520 of the motor drive unit 510 and the control circuit 550 of the bottom bar module 540 may be configured to communicate (e.g., transmit and/or receive) messages (e.g., digital message) with each other via the respective third electrical connections 538c, 549c and the respective second electrical connection 538b, 549b (e.g., which may be electrically connected to circuit common of the motor drive unit 510). In addition, the communication circuit 522 of the motor drive unit 510 may be coupled to the first and second electrical connections 538a, 538b and the communication circuit 552 of the bottom bar module 540 may be coupled to the first and second electrical connections 548a, 548b, such that the communication circuits 522, 552 are configured to communicate with each other via the first and second electrical connections 538a, 538b of the motor drive unit 510 and the first and second electrical connections 548a, 548b of the bottom bar module 540 when the bottom bar is docked.

In some examples, the communication circuit 522 and the communication circuit 552 may be configured for infrared (IR) communication. For example, the communication circuit 552 may comprise an IR emitter, and the communication circuit 522 may comprise an IR receiver. As such, the communication circuit 552 may allow the control circuit 650 to communicate messages (e.g., digital messages) with the communication circuit 522 of the motor drive unit 510 via an IR communication link. In some examples, the communication circuit 522 of the motor drive unit 510 may include an IR receiver that be located at an end portion of the motor drive unit 510, and the communication circuit 552 of the bottom bar module 540 may include an IR transmitter that be located at a corresponding (e.g., aligned) end portion of the bottom bar. Alternatively or additionally, the communication circuit 522 of the motor drive unit 510 may be an IR dongle that, for example, may be coupled to the control circuit 520 of the motor drive unit 510 via a Universal Serial Bus (USB) connection.

The bottom bar module 540 may include a sensor circuit 554 coupled to the control circuit 550. For example, the sensor circuit 554 may comprise a photosensor configured to generate a signal that indicates a light level, such as a daylight level L_{DL} outside the window that the motorized window treatment is covering and/or an ambient light level L_{AMB} inside the space in which the motorized window treatment is located. The control circuit 550 of the bottom bar module 540 may be configured to transmit a message including the daylight level L_{DL} and/or the ambient light level L_{AMB} indicated by the sensor circuit 554 to the motor drive unit 510. In addition, the sensor circuit 554 may comprise one or more orientation detection sensors, such as an accelerometer and/or a gyroscope. For example, the control circuit 550 of the bottom bar module 540 may be configured to determine when the motor drive unit 510 is adjusting the present position P_{PRES} (e.g., the bottom bar is moving) in response to the accelerometer and/or the gyroscope of the sensor circuit 554. Further, the sensor circuit 554 may comprise an occupancy detection circuit configured to detect when the space in which the motorized window treatment is installed is occupied and/or vacant. For example, the occupancy detection circuit may comprise a passive infrared (PIR) detection circuit for detecting movement of occupants in the space. The control circuit 550 of the bottom bar module 540 may be configured to transmit a message including an indication of an occupancy condition and/or a vacancy condition to the motor drive unit 510.

The control circuit 550 of the bottom bar module 540 may be configured to control the solar power system 541 to charge the energy storage element 546 from the solar cells 542, and to charge the energy storage element 530 of the motor drive unit 510 from the energy storage element 546 of the bottom bar module 540 when the bottom bar is docked. The control circuit 550 of the bottom bar module 540 may be configured to control the solar cell management circuit 544 using, for example, a maximum power point tracking (MPPT) control technique. The control circuit 550 may be configured to generate one or more MPPT drive signals V_{MPPT-DR} for controlling the operation of the solar cell management circuit 544 using the MPPT control technique. For example, the one or more MPPT drive signals V_{MPPT-DR} may be used to drive respective transistors of the flyback converter circuit of the solar cell management circuit 544 to generate the second storage voltage V_{S-B} from the photovoltaic output voltage V_{PV}. The control circuit 550 may be configured to generate the one or more MPPT drive signals V_{MPPT-DR} to control the respective transistors of the solar cell management circuit 544 on a periodic basis at an operating frequency f_{MPPT} (e.g., at an operating period T_{MPPT}) according to a duty cycle DC_{MPPT}. The control circuit 550 may be configured to adjust the duty cycle DC_{MPPT} and/or the operating period T_{MPPT} of at least one of the one or more MPPT drive signals V_{MPPT-DR} for controlling the operation the solar cell management circuit 544 using the MPPT control technique, for example, to track a maximum power point for charging the energy storage element 546. The control circuit 520 may be configured to adjust an impedance Z_{MPPT} seen by the solar cells 542 (e.g., an impedance of solar cell management circuit 544) by adjusting the duty cycle DC_{MPPT} and/or the operating period T_{MPPT} of the at least one of the one or more MPPT drive signals V_{MPPT-DR}. The magnitude of the photovoltaic output voltage V_{PV} produced by the solar cells 542 may be based on the magnitude of the photovoltaic output current I_{PV} (e.g., which may be dependent upon the amount sunlight presently being received by the solar cells 542) and the impedance Z_{MPPT} due to the operation of the solar cell management circuit 544 at the duty cycle DC_{MPPT} and/or the operating period T_{MPPT} (e.g., V_{PV}=I_{PV}·Z_{MPPT}). The control circuit 550 may be configured to adjust the duty cycle DC_{MPPT} and/or the operating period T_{MPPT} of the at least one of the one or more MPPT drive signals V_{MPPT-DR} to adjust the solar cell management circuit 544 between a plurality of operating points (e.g., a plurality of predetermined discrete operating points as will be described in greater detail below).

The solar cell 542 may be configured to provide a solar power P_{SOLAR} that may be based on the operation of the solar cell management circuit 544 (e.g., the impedance Z_{MPPT} due to the duty cycle DC_{MPPT} and/or the operating period T_{MPPT}) and the magnitude of the photovoltaic output current I_{PV} (e.g., P_{SOLAR}=I_{PV}²/Z_{MPPT}). At a particular magnitude of the photovoltaic output current I_{PV}, the control circuit 550 may be configured to control the solar cell management circuit 544 to try to maximize the solar power P_{SOLAR} provided by the solar cells 542. The control circuit 550 may be configured to receive (e.g., from the solar management circuit 544) a photovoltaic output voltage feedback signal V_{PV-FB}, which may indicate the magnitude of the photovoltaic output voltage V_{PV}. For example, the control circuit 550 may be configured to determine (e.g., calculate) the solar power P_{SOLAR} using the magnitude of the photovoltaic output voltage V_{PV}, the duty cycle DC_{MPPT}, and the operating period T_{MPPT} (e.g., and/or the operating frequency f_{MPPT}). In addition, the control circuit 550 may also be configured to determine (e.g., calculate) a charge Q_{SOLAR} and/or a solar energy E_{SOLAR} received from the solar cells 542 (e.g., accumulated by the energy storage element 564) over an accumulation interval T_{ACC}, e.g., such as a day (e.g., as will be described in greater detail below). In some examples, the accumulation interval T_{ACC} may be other time periods (e.g., multiple days, a week, multiple weeks, a month, etc.).

The control circuit 550 may be configured to determine the duty cycle DC_{MPPT} and/or the operating period T_{MPPT} of at least one of the one or more MPPT drive signals V_{MPPT-DR} for controlling the operation the solar cell management circuit 544 by sweeping through all of the operating points of the solar cell management circuit 544 (e.g., by adjusting the duty cycle DC_{MPPT} and/or the operating period T_{MPPT}) to determine a present maximum solar power P_{SOLAR-MAX} that the solar cells 542 are capable of providing (e.g., due to the present magnitude of the photovoltaic output current I_{PV}). The control circuit 550 may be configured to sweep through all of the operating points of the solar cell management circuit 544 (e.g., by adjusting the duty cycle DC_{MPPT} and/or the operating period T_{MPPT}), measure the magnitude of the photovoltaic output voltage V_{PV} (e.g., as indicated by the photovoltaic output voltage feedback signal V_{PV-FB}), and calculate the solar power P_{SOLAR} at each of the operating points. The control circuit 550 may be configured to calculate the solar power P_{SOLAR} using the magnitudes of the photovoltaic output voltage V_{PV} measured during the sweep, the duty cycle DC_{MPPT}, and the operating period T_{MPPT} (e.g., and/or the operating frequency f_{MPPT}). The control circuit 550 may be configured to determine the operating point (e.g., the duty cycle DC_{MPPT} and/or the operating period T_{MPPT} of at least one of the one or more MPPT drive signals V_{MPPT-DR}) that provides the maximum solar power P_{SOLAR-MAX} from the solar cells 542 bye determining a maximum value of the magnitudes of the solar power P_{SOLAR} calculated during the sweep. The control circuit 550 may be configured to set the duty cycle DC_{MPPT} and/or the operating period T_{MPPT} of at least one of the one or more MPPT drive signals V_{MPPT-DR} to the operating point that provides the maximum solar power P_{SOLAR-MAX}.

The control circuit 550 may be configured to adjust the duty cycle DC_{MPPT} and/or the operating period T_{MPPT} to change the solar cell management circuit 544 from one of the operating points to the next and/or to monitor the magnitude of the photovoltaic output voltage V_{PV} to determine a change in the solar power P_{SOLAR} provided by the solar cells 542 as a result of the adjustment to the duty cycle DC_{MPPT} and/or the operating period T_{MPPT} (e.g., since P_{SOLAR}=V_{PV2}·Z_{MPPT}). When a change in the duty cycle DC_{MPPT} and/or the operating period T_{MPPT} (e.g., a change from one of the operating points to the next) of the solar cell management circuit 544 results in an increase in the solar power P_{SOLAR}, the control circuit 550 may continue to adjust the duty cycle DC_{MPPT} and/or the operating period T_{MPPT} in the same direction to attempt to increase the solar power P_{SOLAR}. When a change in the duty cycle DC_{MPPT} and/or the operating period T_{MPPT} (e.g., a change from one of the operating points to the next) of the solar cell management circuit 544 results in a decrease in the solar power P_{SOLAR}, the control circuit 550 may adjust the duty cycle DC_{MPPT} and/or the operating period T_{MPPT} in an opposite direction as previously adjusted to attempt to increase the solar power P_{SOLAR} (e.g., prevent further decrease in the solar power P_{SOLAR}). The control circuit 550 may also be configured to periodically sweep all of the operating points of the solar cell management circuit 544 (e.g., by adjusting the duty cycle DC_{MPPT} and/or the operating period T_{MPPT}) to determine operating point that provides the maximum solar power P_{SOLAR-MAX} from the solar cells 542. For example, the control circuit 550 may also be configured to periodically sweep all of the operating points of the solar cell management circuit 544 at a sweep interval T_{SWEEP} (e.g., approximately 30 minutes).

The control circuit 550 may be configured to enable and disable control of the solar cell management circuit 544 using the MPPT control technique to start and stop the charging of the energy storage element 546 of the bottom bar module 540, respectively. The control circuit 550 may be configured to start charging the energy storage element 546 (e.g., enable control of the solar cell management circuit 544 using the MPPT control technique) by generating (e.g., starting to generate) the one or more MPPT drive signals V_{MPPT-DR} for controlling the solar cell management circuit 544, and cease charging the energy storage element 546 (e.g., disable control of the solar cell management circuit 544 using the MPPT control technique) by not generating (e.g., ceasing to generate) the one or more MPPT drive signals V_{MPPT-DR}.

The control circuit 550 may be configured to enable and disable control of the solar cell management circuit 544 using the MPPT control technique, for example, in response to the magnitude of the second storage voltage V_{S-B} across the energy storage element 546. The control circuit 550 may be configured to receive (e.g., from the solar management circuit 544) a second storage voltage feedback signal V_{SB-FB}, which may indicate the magnitude of the second storage voltage V_{S-B}. The control circuit 550 may be configured to disable control of the solar cell management circuit 544 using the MPPT control technique when the magnitude of the second storage voltage V_{S-B} (e.g., as indicated by the second storage voltage feedback signal V_{SB-FB}) rises above (e.g., becomes greater than) a high storage voltage threshold V_{TH-HI}. The control circuit 550 may be configured to enable control of the solar cell management circuit 544 using the MPPT control technique when the magnitude of the second storage voltage V_{S-B} (e.g., as indicated by the second storage voltage feedback signal V_{SB-FB}) falls below (e.g., becomes less than) a low storage voltage threshold V_{TH-LO}.

The control circuit 550 may be configured to enable and disable control of the solar cell management circuit 544 using the MPPT control technique, for example, in response to an amount of sunlight presently being received by the solar cells 542 (e.g., in response to the magnitude of the photovoltaic output current I_{PV}). For example, the control circuit 550 may be configured to disable control of the solar cell management circuit 544 using the MPPT control technique when the present maximum solar power P_{SOLAR-MAX} that the solar cells 542 are capable of providing (e.g., due to the present magnitude of the photovoltaic output current I_{PV}) is less than an MPPT operating power threshold P_{TH-MPPT} (e.g., approximately 1 mW). For example, the MPPT operating power threshold P_{TH-MPPT} may represent the amount of power required by (e.g., consumed by) the control circuit 550 and/or the solar management circuit 544 when operating using the MPPT control technique. For example, the control circuit 550 may be configured to sweep through all of the operating points of the solar cell management circuit 544 (e.g., by adjusting the duty cycle DC_{MPPT} and/or the operating period T_{MPPT}), measure the magnitude of the photovoltaic output voltage V_{PV} (e.g., as indicated by the photovoltaic output voltage feedback signal V_{PV-FB}), and calculate the solar power P_{SOLAR} at each of the operating points. For example, the control circuit 550 may be configured to calculate the solar power P_{SOLAR} using the magnitudes of the photovoltaic output voltage V_{PV} measured during the sweep, the duty cycle DC_{MPPT}, and the operating period T_{MPPT} (e.g., and/or the operating frequency f_{MPPT}). The control circuit 550 may be configured to determine the maximum solar power P_{SOLAR-MAX} that the solar cells 542 are capable of providing from a maximum value of the magnitudes of the solar power P_{SOLAR} calculated during the sweep. The control circuit 550 may be configured to enable control of the solar cell management circuit 544 using the MPPT control technique when the maximum solar power P_{SOLAR-MAX} is greater than (e.g., greater than or equal to) the MPPT operating power threshold P_{TH-MPPT} and disable control of the solar cell management circuit 544 using the MPPT control technique when the maximum solar power P_{SOLAR-MAX} is less than the MPPT operating power threshold P_{TH-MPPT}.

The control circuit 550 may be configured to control the charging circuit 547 to charge the energy storage element 530 of the motor drive unit 510 from the energy storage element 546 of the bottom bar module 540, for example, during a charging event of the energy storage element 530 of the motor drive unit 510. The control circuit 550 may generate one or more charge drive signals V_{CHRG-DR} for controlling the operation of the charging circuit 547. For example, at least one of the one or more charge drive signals V_{CHRG-DR} may be used to render a respective transistor of the boost converter circuit of the charging circuit 547 conductive and non-conductive to generate the second storage voltage V_{S-B} from the photovoltaic output voltage V_{PV}. The control circuit 550 may be configured to generate the at least one of the charge drive signals V_{CHRG-DR} to control the respective transistor of the charging circuit 547 on a periodic basis at an operating frequency f_{CHRG} (e.g., at an operating period T_{CHRG}) according to a duty cycle DC_{CHRG}.

The control circuit 550 may be configured to enable and disable control of the charging circuit 547 to start and stop the charging of the energy storage element 530 of the motor drive unit 510, respectively. For example, the charging event may begin when the control circuit 550 starts charging the energy storage element 530 of the motor drive unit 510 and end when the control circuit 550 stops charging the energy storage element 530 of the motor drive unit 510. The control circuit 550 may be configured to start charging the energy storage element 530 of the motor drive unit 510 (e.g., enable control of the charging circuit 547) by generating (e.g., starting to generate) the one or more charge drive signals V_{CHRG-DR} for controlling the charging circuit 547, and cease charging the energy storage element 530 of the motor drive unit 510 (e.g., disable control of the charging circuit 547) by not generating (e.g., ceasing to generate) the one or more charge drive signals V_{CHRG-DR}. The control circuit 550 may be configured to calculate a charge Q_{CHRG} and/or an energy E_{CHRG} transferred to the energy storage element 530 of the motor drive unit 510 during the charging event of the energy storage element 530 of the motor drive unit 510 (e.g., as will be described in greater detail below). For example, the control circuit 550 may be configured to calculate and store the charge Q_{CHRG} and/or the energy E_{CHRG} transferred to the energy storage element 530 in memory periodically (e.g., at a timing interval T_{TIM2}) while the charging circuit 547 is charging the energy storage element 530 of the motor drive unit 510 (e.g., while the bottom bar is docked).

The control circuit 550 of the bottom bar module 540 may be configured to enable charging of the energy storage element 530 of the motor drive unit 510 when (e.g., only when) the bottom bar is docked and disable charging of the energy storage element 530 of the motor drive unit 510 when the bottom bar is not docked. When the bottom bar is docked with the motor drive unit 510 (e.g., when the bottom bar is in the raised position P_{RAISED}), the first, second, and third electrical connections 548a, 548b, 548c of the bottom bar module 540 may be electrically connected to respective first, second, and third electrical connections 538a, 538b, 538c of the motor drive unit 510, respectively. The control circuit 550 (e.g., the communication circuit 552) of the bottom bar module 540 may be configured to communicate with the control circuit 520 (e.g., the communication circuit 522) of the motor drive unit 510 to confirm that the bottom bar is docked. For example, after controlling the bottom bar to the raised position P_{RAISED}, the control circuit 520 of the motor drive unit 510 may be configured to transmit a message (e.g., a docking confirmation message) to the control circuit 550 of the bottom bar module 540 via the third electrical connections 538c, 548c. In some examples, after receiving the message, the control circuit 550 of the bottom bar module 540 may be configured to transmit a response message to the control circuit 520 of the motor drive unit 510 to confirm that the message was received and docking is confirmed. After docking has been confirmed (e.g., after the control circuit 550 of the bottom bar module 540 has received the docking confirmation message from the control circuit 520 of the motor drive unit 510), the control circuit 550 of the bottom bar module 540 may be configured to enable charging of the energy storage element 530 of the motor drive unit 510. For example, the control circuit 550 may be configured to start charging the energy storage element 530 of the motor drive unit 510 by generating (e.g., starting to generate) the one or more charge drive signals V_{CHRG-DR} for controlling the charging circuit 547.

The control circuit 550 of the bottom bar module 540 may be configured to disable control of the charging circuit 547, for example, when the energy storage element 530 of the motor drive unit 510 is full. For example, the control circuit 550 of the bottom bar module 540 may be configured to determine that the energy storage element 530 of the motor drive unit 510 is full in response to the magnitude of the first storage voltage V_{S-A} across the energy storage element 530 of the motor drive unit 510. The control circuit 550 of the bottom bar module 540 may be configured to receive (e.g., from the charging circuit 547) a first storage voltage feedback signal V_{SA-FB}, which may indicate the magnitude of the first storage voltage V_{S-A}. The control circuit 550 of the bottom bar module 540 may be configured to disable control of the charging circuit 547 when the magnitude of the first storage voltage V_{S-A} (e.g., as indicated by the first storage voltage feedback signal V_{SA-FB}) rises above (e.g., becomes greater than) to a full storage voltage threshold V_{TH-FULL}. In addition, the control circuit 550 of the bottom bar module 540 may be configured to determine that the energy storage element 530 of the motor drive unit 510 is full and subsequently disable charging of the energy storage element 530 in response to receiving a message indicating that the energy storage element 530 is full from the control circuit 520 of the motor drive unit 510 via the third electrical connections 538c, 548c.

Further, the control circuit 550 of the bottom bar module 540 may be configured to disable charging of the energy storage element 530 of the motor drive unit 510, for example, when the energy storage element 546 of the bottom bar module 540 is empty. For example, the control circuit 550 of the bottom bar module 540 may be configured to determine that the energy storage element 546 of the bottom bar module 540 is empty in response to the magnitude of the second storage voltage V_{S-B} across the energy storage element 546 (e.g., as indicated by the second storage voltage feedback signal V_{SB-FB}). The control circuit 550 of the bottom bar module 540 may be configured to disable charging of the energy storage element 530 of the motor drive unit 510 when, for example, the magnitude of the second storage voltage V_{S-B} falls below (e.g., becomes less than) an empty storage voltage threshold V_{TH-EMPTY}.

The control circuit 550 of the bottom bar module 540 may be configured to store in the memory one or more of the measurements recorded by the bottom bar module 540 and/or one or more operational characteristics of the bottom bar module 540. For example, the control circuit 550 of the bottom bar module 540 may be configured to store (e.g., periodically store) in the memory one or more measurements of the magnitude of the photovoltaic output voltage V_{PV} generated by the solar cells 542, the magnitude of the first storage voltage V_{S-A} generated across the energy storage element 530 of the motor drive unit 510, and/or the magnitude of the second storage voltage V_{S-B} generated across the energy storage element 546 to the control circuit 520 of the motor drive unit 510. In addition, the control circuit 550 of the bottom bar module 540 may be configured to store (e.g., periodically store) in the memory one or more indications of operational characteristics of the solar cell management circuit 544 (e.g., such as the duty cycle DC_{MPPT} and/or the operating period T_{MPPT} of the one or more MPPT drive signals V_{MPPT-DR} used to control the solar cell management circuit 544) and/or operational characteristics of the charging circuit 547 (e.g., such as the duty cycle DC_{CHRG} and/or the operating period T_{CHRG} of the one or more charge drive signals V_{CHRG-DR} used to control the charging circuit 547).

The control circuit 550 of the bottom bar module 540 may be configured to transmit messages including one or more performance values (e.g., measured and/or calculated values) recorded by the bottom bar module 540 and/or one or more operational characteristics (e.g., controlled settings and/or parameters) of the bottom bar module 540, e.g., when the bottom bar is docked. For example, the control circuit 550 of the bottom bar module 540 may be configured to transmit, to the control circuit 520 of the motor drive unit 510, messages including indications of measurements of the magnitude of the photovoltaic output voltage V_{PV} generated by the solar cells 542, the magnitude of the first storage voltage V_{S-A} generated across the energy storage element 530 of the motor drive unit 510, and/or the magnitude of the second storage voltage V_{S-B} generated across the energy storage element 546. In addition, the control circuit 550 of the bottom bar module 550 may be configured to transmit, to the control circuit 520 of the motor drive unit 510, messages including indications of calculated values, such as the charge Q_{SOLAR} and/or the solar energy E_{SOLAR} received from the solar cells 542 during one or more accumulation intervals T_{ACC}, and/or the charge Q_{CHRG} and/or the energy E_{CHRG} transferred to the energy storage element 530 of the motor drive unit 510 during one or more of the charging events. Further, the control circuit 550 of the bottom bar module 540 may be configured to transmit, to the control circuit 520 of the motor drive unit 510, messages including indications of operational characteristic of the solar cell management circuit 544 (e.g., such as the duty cycle DC_{MPPT} and/or the operating period T_{MPPT} of the one or more MPPT drive signals V_{MPPT-DR} used to control the solar cell management circuit 544) and/or operational characteristics of the charging circuit 547 (e.g., such as the duty cycle DC_{CHRG} and/or the operating period T_{CHRG} of the one or more charge drive signals V_{CHRG-DR} used to control the charging circuit 547).

The control circuit 520 of the motor drive unit 510 may be configured to monitor a present charge Q_{PRES-A} of the energy storage element 530 of the motor drive unit 510. For example, the control circuit 520 may be configured to adjust (e.g., update) the present charge Q_{PRES-A} of the energy storage element 530 of the motor drive unit 510 based on the charge Q_{CHRG} transferred to the energy storage element 530 of the motor drive unit 510 from the energy storage element 546 of the bottom bar module 540 during each charging event, and the total charge Q_{LOAD-TOTAL} consumed from the energy storage element 530 by the electrical loads of the motor drive unit 510 during each accumulation interval T_{ACC}. The control circuit 520 may be configured to add the charge Q_{CHRG} transferred to the energy storage element 530 of the motor drive unit 510 to the present charge Q_{PRES-A} (e.g., Q_{PRES-A}=Q_{PRES-A}+Q_{CHRG}), for example, periodically at the timing interval T_{TIM2} during each charging event. The control circuit 520 may be configured to subtract the total charge Q_{LOAD-TOTAL} consumed from the energy storage element 530 from the present charge Q_{PRES-A} (e.g., Q_{PRES-A}=Q_{PRES-A}−Q_{LOAD-TOTAL}), for example, at the end of each accumulation interval T_{ACC}.

The control circuit 520 of the motor drive unit 510 may be configured to determine a trend in the present charge Q_{PRES-A} of the energy storage element 530 of the motor drive unit 510. The control circuit 520 may be configured to estimate a lifetime of the motor drive unit 510 and/or predict a problem with the lifetime of the motor drive unit 510 (e.g., a short lifetime that may be undesirable to a user of the motorized window treatment) in response to the trend in the present charge Q_{PRES-A} of the energy storage element 530 of the motor drive unit 510. For example, the control circuit 520 may be configured to determine when the trend in the present charge Q_{PRES-A} of the energy storage element 530 of the motor drive unit 510 is decreasing with respect to time, and predict a problem with the lifetime of the motor drive unit 510 when the trend in the present charge Q_{PRES-A} of the energy storage element 530 of the motor drive unit 510 is decreasing with respect to time. Alternatively or additionally, the control circuit may be configured to compare an average solar energy E_{SOLAR-AVG} to an average energy E_{LOAD-AVG} consumed from the energy storage element by the electrical loads of the motor drive unit to predict a problem with the lifetime of the motor drive unit 510, for example, as described in more detailed herein. The lifetime of the motor drive unit 510 may indicate a time period or date by which the motor drive unit 510 will remain fully operational. For instance, the lifetime of the motor drive unit 510 may indicate the time period that the energy storage element 530 of the motor drive unit 510 is expected to maintain a charge (e.g., present charge Q_{PRES-A}), based on the total storage capacity of the energy storage element 530 and solar energy captured via the one or more solar cells 542 of the bottom bar, that is sufficient to provide the power consumed by the motor drive circuit 514 to move the bottom bar and the covering material (e.g., in accordance with normal movements of the covering material) and non-movement operations of the motor drive unit 510 (e.g., powering the one or more low-voltage circuitry of the motor drive unit 510).

The control circuit 550 may be configured to monitor a present charge Q_{PRES-B} of the energy storage element 546 of the bottom bar module 540. For example, the control circuit 550 may be configured to adjust (e.g., update) the present charge Q_{PRES-B} of the energy storage element 546 of the bottom bar module 540 based on the charge Q_{SOLAR} received from the solar cells 542 (e.g., accumulated by the energy storage element 564) during each accumulation interval T_{ACC} and the charge Q_{CHRG} transferred from the energy storage element 546 of the bottom bar module 540 to the energy storage element 530 of the motor drive unit 510 during each charging event. The control circuit 550 may be configured to add the charge Q_{SOLAR} received from the solar cells 542 to the present charge Q_{PRES-B} (e.g., Q_{PRES-B}=Q_{PRES-B}+Q_{SOLAR}), for example, at the end of each accumulation interval T_{ACC}. The control circuit 550 may be configured to subtract the charge Q_{CHRG} transferred to the energy storage element 530 of the motor drive unit 510 from the present charge Q_{PRES-B} (e.g., Q_{PRES-B}=Q_{PRES-B}−Q_{CHRG}), for example, periodically at the timing interval T_{TIM2} during each charging event.

As previously mentioned, the control circuit 550 may be configured to enable and disable control of the solar cell management circuit 544 using the MPPT control technique, for example, in response to the magnitude of the second storage voltage V_{S-B} across the energy storage element 546. In some examples, the control circuit 550 may be configured to enable and disable control of the solar cell management circuit 544 using the MPPT control technique, for example, in response to the present charge Q_{PRES-B} of the energy storage element 546 of the bottom bar module 540. The control circuit 550 may be configured to disable control of the solar cell management circuit 544 using the MPPT control technique when the present charge Q_{PRES-B} of the energy storage element 546 of the bottom bar module 540 rises above (e.g., becomes greater than) a high storage charge threshold Q_{TH-HI}. The control circuit 550 may be configured to enable control of the solar cell management circuit 544 using the MPPT control technique when the present charge Q_{PRES-B} of the energy storage element 546 of the bottom bar module 540 falls below (e.g., becomes less than) a low storage charge threshold Q_{TH-LO}.

As previously mentioned, the control circuit 550 of the bottom bar module 540 may be configured to disable charging of the energy storage element 530 of the motor drive unit 510 in response to the magnitude of the first storage voltage V_{S-A} across the energy storage element 530 of the motor drive unit 510 and/or the second storage voltage V_{S-B} across the energy storage element 546 of the bottom bar module 540. In some examples, the control circuit 550 may be configured to disable charging of the energy storage element 530 of the motor drive unit 510, for example, in response to the present charge Q_{PRES-A} of the energy storage element 530 of the motor drive unit 510 and/or the present charge Q_{PRES-B} of the energy storage element 546 of the bottom bar module 540. The control circuit 550 may be configured to disable charging of the energy storage element 530 of the motor drive unit 510 when the present charge Q_{PRES-A} of the energy storage element 530 of the motor drive unit 510 rises above (e.g., becomes greater than) to a full storage charge threshold Q_{TH-FULL}. The control circuit 550 may be configured to disable charging of the energy storage element 530 of the motor drive unit 510 when the present charge Q_{PRES-B} of the energy storage element 546 of the bottom bar module 540 falls below (e.g., becomes less than) an empty storage charge threshold Q_{TH-EMPTY}.

The bottom bar module 540 may comprise a first power supply 556 configured to receive the second storage voltage V_{S-B} from the energy storage element 546 and generate a low-voltage supply voltage V_{CC-B} (e.g., approximately 2.8 V) for powering one or more low-voltage electrical loads of the bottom bar module 540, such as, the control circuit 550, the memory, the communication circuit 552, the sensor circuit 554, and/or other low-voltage circuitry of the bottom bar module 540. For example, the first power supply 556 may comprise a low-dropout (LDO) linear regulator that may be characterized by a dropout voltage (e.g., approximately 140 mV). When the magnitude of the second storage voltage V_{S-B} is greater than a magnitude that is equal to the magnitude of the low-voltage supply voltage V_{CC-B} plus the dropout voltage V_{DO}, the first power supply 556 may be configured to generate the low-voltage supply voltage V_{CC-B}.

The bottom bar module 540 may also comprise a second power supply 558 that is configured to receive the photovoltaic output voltage V_{PV} from the solar cells 542 and also generate the low-voltage supply voltage V_{CC-B} for powering the one or more low-voltage electrical loads of the bottom bar module 540. For example, the second power supply 558 may comprise a buck-boost converter circuit. The second power supply 558 may be configured to generate the low-voltage supply voltage V_{CC-B} independent of whether the magnitude of the photovoltaic output voltage V_{PV} is greater than or less than the magnitude of the low-voltage supply voltage V_{CC-B}.

The bottom bar module 540 may further comprises a first switching circuit 557 coupled in series between the first power supply 556 (e.g., an output of the first power supply 556) and the one or more low-voltage electrical loads of the bottom bar module 540, and a second switching circuit 559 coupled in series between the second power supply 558 (e.g., an output of the second power supply 558) and the one or more low-voltage electrical loads of the bottom bar module 540. The control circuit 550 may be configured to generate a first switch control signal V_{SW1} for rendering the first switching circuit 557 conductive and/or non-conductive, and a second switch control signal V_{SW2} for rendering the second switching circuit 559 conductive and/or non-conductive. For example, the first switching circuit 557 may be a normally-open switching circuit, which may be in a non-conductive state by default and may be configured to be controlled to a conductive state in response to the first switch control signal V_{SW1} as generated by the control circuit 550. In addition, the second switching circuit 559 may be a normally-closed switching circuit, which may be in a conductive state by default and may be configured to be controlled to a non-conductive state in response to the second switch control signal V_{SW2} as generated by the control circuit 550. For example, the control circuit 550 may be configured to render the first and second switching circuits 557, 559 conductive on a mutually exclusive basis, such that only one of the first and second power supplies 556, 558 may be configured to generate the low-voltage supply voltage V_{CC-B} at a single time.

When the magnitude of the second storage voltage V_{S-B} is less than the magnitude of the low-voltage supply voltage V_{CC-B} plus the dropout voltage V_{DO} of the first power supply 556 (e.g., when the bottom bar module 540 is initially being powered up and/or if the energy storage element 546 of the bottom bar module 540 is depleted), the first power supply 556 may not be able to generate the low-voltage supply voltage V_{CC-B}. When the magnitude of the low-voltage supply voltage V_{CC-B} is less than a rated supply voltage of the control circuit 550, the control circuit 550 may be unpowered and non-functional. When the control circuit 550 is unpowered, the second switching circuit 558 may be conductive (e.g., since the switching circuit 558 may be in the conductive state absent the generation of the second switch control signal V_{SW2} by the control circuit 550) and the second power supply 558 may be configured to generate the low-voltage supply voltage V_{CC-B} from (e.g., directly from) the photovoltaic output voltage V_{PV}

When the magnitude of the low-voltage supply voltage V_{CC-B} as generated by the second power supply 558 becomes greater than (e.g., greater than or equal to) the rated supply voltage of the control circuit 550, the control circuit 550 may become powered up and functional. At this time, the control circuit 550 may generate the one or more MPPT drive signals V_{MPPT-DR} for controlling the solar cell management circuit 544 to generate the second storage voltage V_{S-B} from the photovoltaic output voltage V_{PV}. When the magnitude of the low-voltage supply voltage V_{CC-B} is greater than (e.g., greater than or equal to) a threshold voltage V_{CCB-TH} (e.g., which may be greater than the magnitude of the low-voltage supply voltage V_{CC-B} plus the dropout voltage V_{DO} of the first power supply 556), the control circuit 550 may be configured to render the second switching circuit 559 non-conductive and render the first switching circuit 557 conductive, such that the first power supply 556 may be configured to generate the low-voltage supply voltage V_{CC-B} from the second storage voltage V_{S-B}.

If the magnitude of the low-voltage supply voltage V_{CC-B} falls below (e.g., becomes less than) the low-voltage threshold voltage V_{CCB-TH}, the control circuit 550 may be configured to render the first switching circuit 557 non-conductive and render the second switching circuit 559 conductive, such that the second power supply 558 may generate the low-voltage supply voltage V_{CC-B} from the photovoltaic output voltage V_{PV}. The control circuit 550 may generate the one or more MPPT drive signals V_{MPPT-DR} for controlling the solar cell management circuit 544 to generate the second storage voltage V_{S-B} from the photovoltaic output voltage V_{PV} until the magnitude of the low-voltage supply voltage V_{CC-B} rises above (e.g., becomes greater than) the low-voltage threshold voltage V_{CCB-TH} at which time the control circuit 550 may render the second switching circuit 559 non-conductive and render the first switching circuit 557 conductive. For example, the control circuit 550 may be configured to use hysteresis when comparing the magnitude of the low-voltage supply voltage V_{CC-B} to the low-voltage threshold voltage V_{CCB-TH}.

To charge the energy storage element 530 of the motor drive unit 510 from the energy storage element 546 of the bottom bar module 540, the control circuit 520 of the motor drive unit 510 may be configured to control the motor drive circuit 514 to move the covering material to the raised position P_{RAISED}, such that the bottom bar is docked and the first and second electrical connections 548a, 548b of the bottom bar module 540 may be coupled to (e.g., electrically and/or inductively coupled to) the first and second electrical connections 538a, 538b of the motor drive unit 510, respectively. When the control circuit 520 is moving the covering material to dock the bottom bar, the control circuit 520 may control the covering material through a docking movement (e.g., a docking sequence) as the bottom bar nears the dock. For example, the control circuit 520 may ramp down a rotational speed at which the motor is rotating as the bottom bar nears the dock. In some examples, the control circuit 520 may be configured to store in the memory a last-docking time T_{LAST-DOCK} which represents the last time that the control circuit 520 docked the bottom bar (e.g., as determined from the timeclock when the control circuit 520 docks the bottom bar).

The control circuit 520 of the motor drive unit 510 and/or the control circuit 550 of the bottom bar module 540 may be configured to determine that the bottom bar is docked by determining if the first, second, and third electrical connections 538a, 538b, 538c of the motor drive unit 510 are electrically connected to the first, second, and third electrical connections 548a, 548b, 548c of the bottom bar module 540, respectively. For example, the control circuit 520 of the motor drive unit 510 may be configured to determine that the bottom bar is docked by detecting that the second storage voltage V_{S-B} is present at the first electrical connection 538a (e.g., as referenced to the second electrical connection 538b). In addition, the control circuit 550 of the bottom bar module 540 may be configured to determine that the bottom bar is docked by detecting that the motor drive unit 510 is drawing current from the energy storage element 546 via the electrical connections 548. Further, the control circuit 520 of the motor drive unit 510 may be configured to determine that the bottom bar is docked in response to receiving a message from the control circuit 550 of the bottom bar module 540 via the third electrical connections 538c, 548c, and the control circuit 550 of the bottom bar module 540 may be configured to determine that the bottom bar is docked in response to receiving a message from the control circuit 520 of the motor drive unit 510 via the third electrical connections 538c, 5489c. The control circuit 520 of the motor drive unit 510 may be configured to transmit a query message to the bottom bar module 540, and the control circuit 550 of the bottom bar module 540 may be configured to transmit a response to the query message to the motor drive unit 510. For example, the control circuit 520 of the motor drive unit 510 may be configured to transmit the query message to the bottom bar module 540 via a wired communication link (e.g., via two of the first, second, and third electrical connections 538a, 538b, 538c of the motor drive unit and/or the first, second, and third electrical connections 548a, 548b, 548c of the bottom bar module 540, respectively) and/or via a wireless communication link (e.g., where the query message may indicate that the bottom bar is docked).

In some examples, the motor drive unit 510 may include a supplemental charging circuit 534 coupled to electrical terminals 537 that are configured to be connected to an external power source (not shown). For example, the motor drive unit 510 (e.g., the energy storage element 530) may be configured to receive power from an external power source via the electrical terminals 537. The supplemental charging circuit 534 may be configured to charge (e.g., trickle charge) the energy storage element 530 of the motor drive unit 510 from the external power source. For example, the energy storage element 530 of the motor drive unit 510 may be charged (e.g., jump started) when the motorized window control systems 500 is first installed and the motor drive unit 510 is first powered up. In addition, the energy storage element 530 of the motor drive unit 510 may be charged (e.g., recharged) when the energy storage element 530 is in a condition in which the energy storage element 530 is not able to properly charge from the energy storge element 546 of the bottom bar module 540 (e.g., if the solar cells 542 are not receiving an appropriate amount of solar energy). In some examples, the electrical terminals 537 may be a standard power supply connector, e.g., such as a universal serial bus (USB) connector. For example, in the condition that the energy storage element 530 is not able to properly charge from the energy storge element 546 of the bottom bar module 540, the motor drive unit 510 (e.g., the energy storage element 530) may be configured to receive power (e.g., continuously receive power) from an external power source, such as an external power supply and/or an external battery pack.

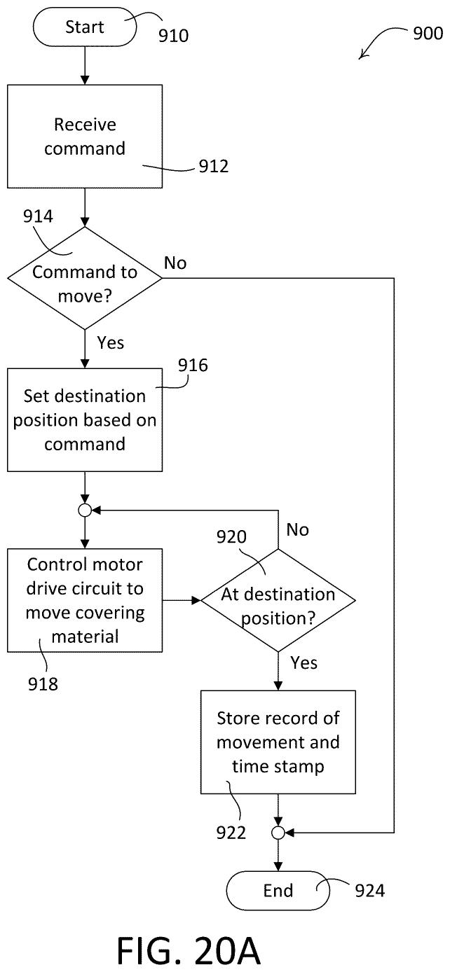

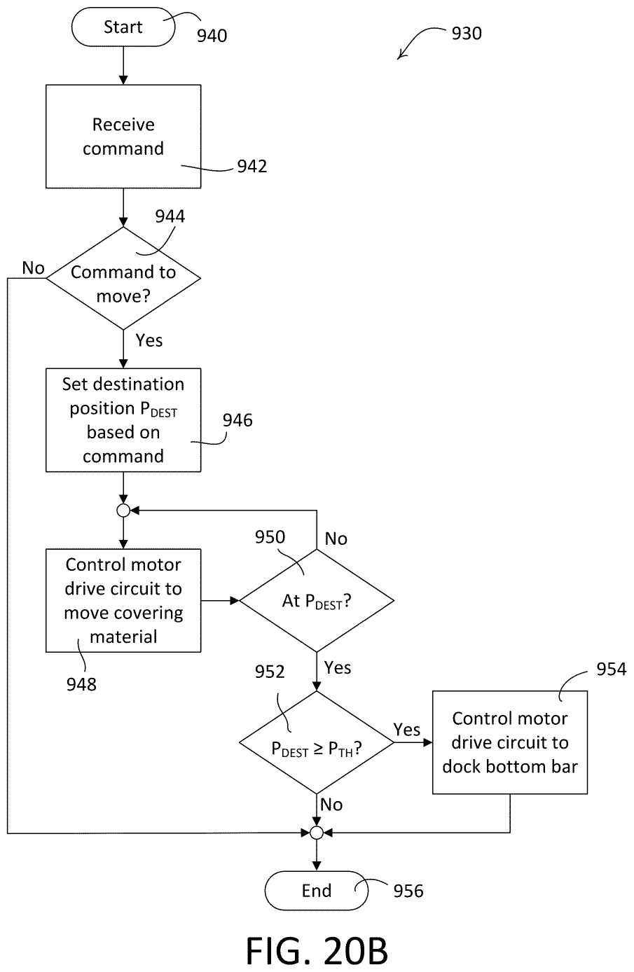

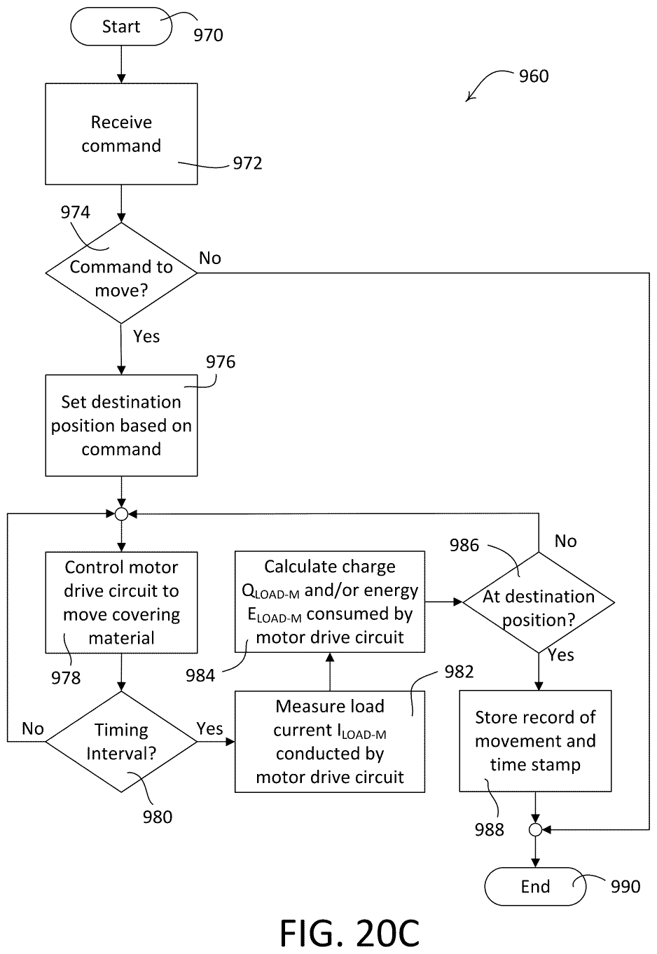

Although described primarily as being performed by a control circuit of a motor drive unit (e.g., the control circuit 420 of the motor drive unit 410 and/or the control circuit 520 of the motor drive unit 510) and/or a control circuit of a bottom bar module (e.g., the control circuit 450 of the bottom bar module 440 and/or the control circuit 550 of the bottom bar module 540), any of the procedures described herein (e.g., with reference to FIGS. 20A-50) could be performed by any control circuit of the a load control system (e.g., the load control system 100), such as a control circuit of the dock of the base assembly of the motorized window treatment system 400, a control circuit of the dock of the base assembly of the motorized window treatment system 500, a control circuit of a system controller (e.g., the system controller 110), a control circuit of a remote control device (e.g., the remote control device 170), and/or a control circuit of a remote computing device (e.g., a cloud server running cloud services, such as the remote services 164). Further, in some examples, any of the procedures described herein could be distributed across multiple control circuits, such as multiple control circuits of a single device or control circuits of multiple, different devices, for example, such that different control circuits perform a portion of the procedure.

FIG. 16C is a simplified block diagram of a motorized window treatment system 500′ for controlling a motorized window treatment (e.g., the motorized window treatments 150 of the load control system 100, the motorized window treatment 200, the motorized window treatment 300). The motorized window treatment 500′ may comprise a covering material (e.g., the covering material 152, 230, 330) that may be wound around a roller tube (e.g., the roller tubes 212, 312) and may extend to a bottom bar (e.g., the bottom bars 240, 340). The motorized window treatment system 500′ may be similar to the motorized window treatment system 500 shown in FIG. 16B. However, the motorized window treatment system 500′ may comprise a base assembly 502 that includes a motor drive unit 510′ (e.g., the motor drive units 156, the motor drive unit 250, and/or the motor drive unit 350) and a dock module 504. For example, the motor drive unit 510′ of the base assembly 502 may be configured to rotate the roller tube for raising and lowering the covering material to adjust a present position P_{PRES} of the covering material (e.g., the bottom bar).

The motorized window treatment system 500′ may also include the bottom bar module 540 (e.g., as also included in the motorized window treatment system 500 of FIG. 16B). The bottom bar module 540 may be located in and/or on the bottom bar, and may include the solar power system 541 for harvesting power (e.g., solar power) from sunlight that may shine through the window via the one or more solar cells 542.

The dock module 504 of the base assembly 502 of the motorized window treatment system 500′ may be located in and/or on a dock (e.g., the docks 280, 380). The dock module 504 may be electrically coupled to the motor drive unit 510′. The motor drive unit 510′ may be configured to control the covering material to the raised position to dock the bottom bar, such that the motor drive unit 510′ may be electrically connected to the bottom bar module 540 via the dock module 504 and may be powered via the solar power system 541 of the bottom bar module 540 (e.g., as will be described in greater detail below).

The base assembly 502 (e.g., the motor drive unit 510′ and/or the dock module 504) may include similar components and operate in a similar manner as the motor drive unit 510 shown in FIG. 16B. For example, the motor drive unit 510′ of the base assembly 502 may comprise the motor 512, the motor drive circuit 514, the rotational position sensing circuit 516, a control circuit 520a, the user interface circuit 524, the energy storage element 530, the first and second sense circuits 531, 533, and the power supply 532. In addition, the dock module 504 of the base assembly 502 may comprise a control circuit 520b, the communication circuit 522, the supplemental charging circuit 534, the switching circuit 536, the electrical terminals 537 that are configured to be electrically connected to the external power source, and the first, second, and third electrical connections 538a, 538b that are configured to be electrically connected to the bottom bar module 540 when the bottom bar is docked. While not shown in FIG. 16C, the motor drive unit 510′ and/or the dock module 504 may each comprise a memory (e.g., such as the memory of the motor drive unit 410 and/or the memory of the motor drive unit 510 as described above).

The control circuit 520a of the motor drive unit 510′ and the control circuit 520b of the dock module 504 may be electrically coupled together and/or configured to communicate with each other via a communication bus 525 (e.g., an inter-integrated circuit communication bus, such as an I²C bus). The control circuit 520a of the motor drive unit 510′ and the control circuit 520b of the dock module 504 may collectively execute the procedures and/or functionality of the control circuit 520 of the motor drive unit 510 of the motorized window treatment system 500 as described above. The control circuit 520b of the dock module 504 may be configured to communicate messages with the control circuit 550 of the bottom bar module 540 via the third electrical connection 538c and the second electrical connection 538b using the communication circuit 524 (e.g., as described above). In addition, the communication circuit 524 may include, for example, a wireless communication circuit (e.g., a RF transceiver) configured to transmit and receive wireless signals (e.g., RF signals) via an antenna 526 (e.g., which may be included as part of the dock module 504).

The dock module 504 (e.g., the control circuit 520b and/or the communication circuit 524) may be powered from, for example, the low-voltage supply voltage V_{CC-A} generated by the power supply 532 of the motor drive unit 510′. In some examples, the dock module 504 may comprise one or more additional power supplies for generating respective low-voltage supply voltages for powering the control circuit 520b and/or the communication circuit 524. In some examples, the energy storage element 530 may be included in the dock module 504 (e.g., rather than in the motor drive unit 510). In addition, the first sense circuit 531 and/or the second sense circuit 533 may be included in the dock module 504 504 (e.g., rather than in the motor drive unit 510).

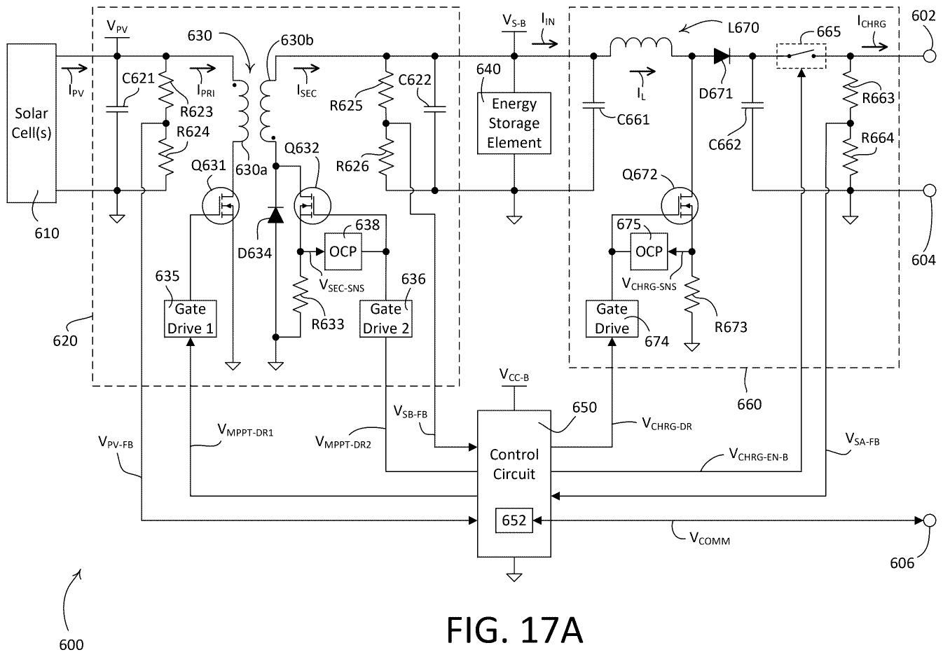

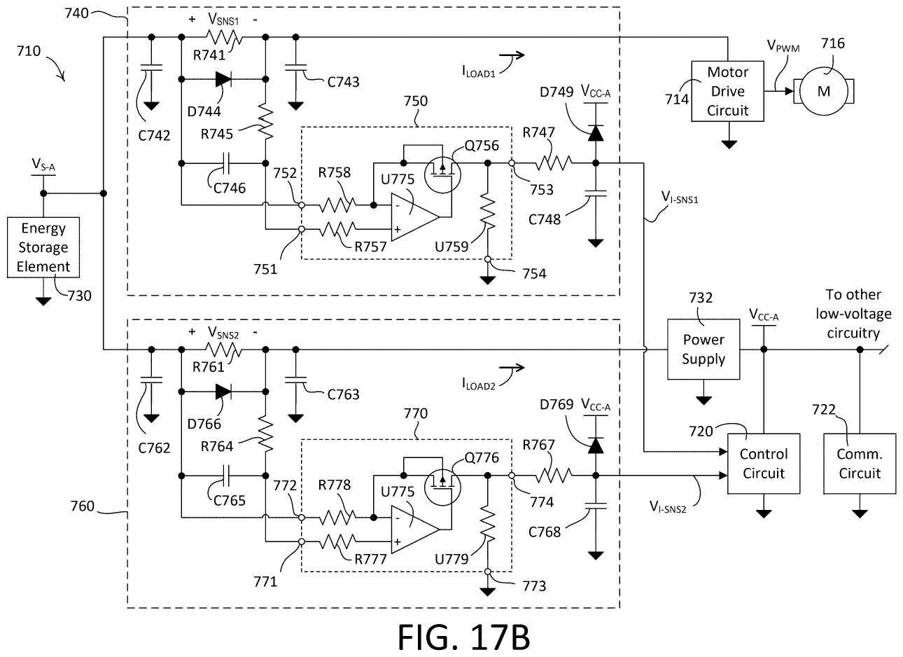

FIG. 17A is a schematic view of an example of a solar power system 600 (e.g., the solar power system 441, 541) of a motorized window treatment (e.g., the motorized window treatments 150, 200, 300 and/or the motorized window treatment systems 400, 500). The motorized window treatment may comprise a covering material (e.g., the covering materials 152, 230, 330) and a bottom bar (e.g., the bottom bars 240, 340) connected to a bottom end of the covering material. The motorized window treatment may comprise a motor drive unit (e.g., the motor drive units 156, 250, 350, 410, 510, 510′) for adjusting a present position P_{PRES} of the bottom bar (e.g., the covering material) between a raised position P_{RAISED} (e.g., a fully-raised position and/or a fully-open position) and a lowered position P_{LOWERED} (e.g., a fully-lowered position and/or a fully-closed position). The solar power system 600 may be included as part of a bottom bar module (e.g., the bottom bar modules 440, 540) of the bottom bar of the motorized window treatment. For example, the motorized window treatment system may comprise a dock (e.g., the docks 280, 380), and the motor drive unit may be configured to control the covering material to dock the bottom bar with the motor drive unit. In some examples, the solar power system 600 may be included in the motor drive unit of the motorized window treatment. For instance, in some alternative examples, a motor drive unit of a motorized window treatment may include the solar power system 600 (e.g., which may, or may not, include the solar cells). For instance, in some examples, the motor drive unit may include all components of the solar power system 600 (e.g., including the solar cells), while in other examples, the motor drive unit may include all components of the solar power system 600 except for the solar cells, and the solar cells may be included as part of the bottom bar (e.g., the solar power system 600 of the motor drive unit may have wired electrical connections to the bottom bar that includes the solar cells). In addition, the motor drive unit may include all components of the solar power system 600 except for the solar cells, and the solar cells may be external to the motor drive unit (e.g., mounted to the structure to which the motorized window treatment is mounted and/or the window that the motorized window treatment is covering.

The solar power system 600 may be configured to charge an energy storage element of the motor drive unit (e.g., the energy storage elements 430, 530) when the bottom bar is docked. For example, the energy storage element of the motor drive unit may be configured to store a first storage voltage V_{S-A} (e.g., the first storage voltages V_{S-A} stored in the energy storage elements 430, 530 of the motor drive units 410, 510, 510′. The solar power system 600 may be electrically coupled to the energy storage element of the motor drive unit via a positive voltage connection 602 and a circuit common connection 604 (e.g., a negative voltage connection), which may represent the electrical connections 448, 548 of the bottom bar modules 440, 540. For example, the positive and negative voltage connections 602, 604 may represent two of the electrical contacts 275 of the bottom bar 240. The energy storage element of the motor drive unit may be configured to charge via the positive voltage connection 602 and the circuit common connection 604.

The solar power system 600 may comprise, for example, one or more solar cells 610 (e.g., photovoltaic cells), a solar cell management circuit 620, an energy storage element 640, and a charging circuit 660. The energy storage element 640 of the solar power system 600 may be configured to store a second storage voltage V_{S-B} (e.g., the second storage voltages V_{S-B} stored in the energy storage elements 446, 546 of the bottom bar modules 440, 540). For example, the energy storage element 640 may comprise one or more individual storage elements electrically coupled in parallel and/or in series. The individual storage elements of the energy storage element 640 may comprise, for example, one or more one or more of supercapacitors and/or rechargeable batteries, such as, nickel-metal hydride (NiMH) batteries.

The solar power system 600 may be controlled by a control circuit 650 (e.g., the control circuits 450, 550, of the bottom bar modules 440, 540). For example, the control circuit 650 may include, for example, a microprocessor, a programmable logic device (PLD), a microcontroller, an application specific integrated circuit (ASIC), a field-programmable gate array (FPGA), or any suitable processing device or control circuit. The control circuit 650 may be configured to receive power from a low-voltage supply voltage V_{CC-B} that may be generated by a power supply that may receive power from the energy storage element 640 (e.g., the power supplies 456, 556, 558 of the bottom bar modules 440, 540).

The control circuit 650 may comprise, for example, a communication circuit 652 that may allow the control circuit 650 to communicate messages (e.g., digital messages) with the motor drive unit. The communication circuit 652 may be implemented as an internal circuit of the control circuit 650 (e.g., as shown in FIG. 17A) or as an external integrated circuit (IC). For example, the communication circuit 652 may be configured to communicate messages via a wired communication link when the bottom bar is docked. The control circuit 650 of the solar power system 600 (e.g., the bottom bar module) may be configured to be electrically coupled to the motor drive unit (e.g., to a control circuit and/or a communication circuit of the motor drive unit) via, for example, a communication connection 606 (e.g., which may represent the electrical connection 549 of the bottom bar module 540) when the bottom bar is docked. The control circuit 650 of the solar power system 600 (e.g., the bottom bar module) may be configured to communication (e.g., transmit and/or receive) messages (e.g., digital messages) with the control circuit of the motor drive unit via the communication connection 606 and the circuit common connection 604 (e.g., the messages may be referenced to the circuit common connection 604). For example, the communication connection 606 may represent one of the electrical contacts 275 of the bottom bar 240. In some examples, the communication circuit 652 may be configured to communicate messages via a wireless communication link (e.g., an RF communication link) using a short-range wireless communication protocol (e.g., the BLUETOOTH LOW ENERGY (BLE) protocol, the Thread wireless communication protocol, etc.).

The solar cells 610 may be configured to convert received solar energy into a photovoltaic output current I_{PV} and may produce a photovoltaic output voltage V_{PV}. The solar cell management circuit 620 may be configured to charge the energy storage element 640 for producing the second storage voltage V_{S-B} across the energy storage element 640. The solar cell management circuit 620 may comprise an input capacitor C621 across which the photovoltaic output voltage V_{PV} of the solar cells 542 may be coupled and an output capacitor C622 across which the second storage voltage V_{S-B} of the energy storage element 640 may be coupled.

The solar cell management circuit 620 may also comprise a first resistive divider circuit having a resistor R623 (e.g., having a resistance of approximately 14.3 kΩ in series with a resistor R624 (e.g., having a resistance of approximately 7.32 kΩ. The series combination of the resistors R623, R624 of the first resistive divider circuit may be coupled in parallel with the input capacitor C621 for receiving the photovoltaic output voltage V_{PV}, such that a photovoltaic output voltage feedback signal V_{PV-FB} may be generated at the junction of the resistors R623, R624 of the first resistive divider circuit. For example, the photovoltaic output voltage feedback signal V_{PV-FB} (e.g., the magnitude of the photovoltaic output voltage feedback signal V_{PV-FB}) may indicate the magnitude of the photovoltaic output voltage V_{PV}. The control circuit 650 may receive the photovoltaic output voltage feedback signal V_{PV-FB} and may be configured to determine the magnitude of the photovoltaic output voltage V_{PV} from the photovoltaic output voltage feedback signal V_{PV-FB}.

The solar cell management circuit 620 may also comprise a second resistive divider circuit having a resistor R625 (e.g., having a resistance of approximately 14.3 kΩ in series with a resistor R626 (e.g., having a resistance of approximately 7.32 kΩ. The series combination of the resistors R625, R626 of the second resistive divider circuit may be coupled in parallel with the output capacitor C622 for receiving the second storage voltage V_{S-B}, such that a second storage voltage feedback signal V_{SB-FB} may be generated at the junction of the resistors R625, R626 of the second resistive divider circuit. For example, the second storage voltage feedback signal V_{SB-FB} (e.g., the magnitude of the second storage voltage feedback signal V_{SB-FB}) may indicate the magnitude of the second storage voltage V_{S-B}. The control circuit 650 may receive the second storage voltage feedback signal V_{SB-FB} and may be configured to determine the magnitude of the second storage voltage V_{S-B} from the second storage voltage feedback signal V_{SB-FB}.

The control circuit 650 may be configured to control the solar cell management circuit 620 using, for example, a maximum power point tracking (MPPT) control technique. The solar cell management circuit 620 may be, for example, a flyback converter circuit for generating the second storage voltage V_{S-B} from the photovoltaic output voltage V_{PV}. The solar cell management circuit 620 may comprise a transformer 630 (e.g., a flyback transformer) that has a primary winding 630a and a secondary winding 630b. The transformer 630 may be characterized by a turns ratio N_{T} (e.g., N_{T}=N_{PRI}/N_{SEC}, where N_{PRI} is the number of turns in the primary winding 630a and N_{SEC} is the number of turns in the secondary winding 630b). The solar cell management circuit 620 may also comprise a first semiconductor switch, such as a first field-effect transistor (FET) Q631, coupled in series with the primary winding 630a of the transformer 630 and a second semiconductor switch, such as a second FET Q632, coupled in series with the secondary winding 630b of the transformer 630. The solar cell management circuit 620 may further comprise a sense resistor R633 coupled in series with the second FET Q632 (e.g., the drain-source channel of the second FET Q632) and a diode D634 coupled in parallel with the series combination of the sense resistor R633 and the second FET Q632 (e.g., the drain-source channel of the second FET Q632). The gate of the first FET Q631 and the gate of the second FET Q632 may be coupled to the control circuit 650 via respective first and second gate drive circuits 635, 636. The control circuit 650 may be configured to generate a first MPPT drive signal V_{MPPT-DR1} that may be received by the first gate drive circuit 635 for rendering the first FET Q631 conductive and non-conductive, and a second MPPT drive signal V_{MPPT-DR2} that may be received by the second gate drive circuit 636 for rendering the second FET Q632 conductive and non-conductive.

The control circuit 650 may be configured to generate the first MPPT drive signal V_{MPPT-DR1} and the second MPPT drive signal V_{MPPT-DR2} to control the first and second FETs Q631, Q632, respectively, on a periodic basis at an operating frequency f_{MPPT} (e.g., at an operating period T_{MPPT}). For example, the control circuit 650 may be configured to control the operating frequency f_{MPPT} of the first MPPT drive signal V_{MPPT-DR1} and the second MPPT drive signal V_{MPPT-DR2} between a minimum operating frequency f_{MPPT-MIN} (e.g., approximately 500 Hz) and a maximum operating frequency f_{MPPT-MAX} (e.g., approximately 35 kHz), such that the operating period T_{MPPT} may be adjusted between a minimum operating period T_{MPPT-MIN} (e.g., approximately 29 microseconds) and a maximum operating period T_{MPPT-MAX} (e.g., approximately 2000 microseconds). The control circuit 650 may be configured to generate the first MPPT drive signal V_{MPPT-DR1} according to a first duty cycle DC_{MPPT1} to render the first FET Q631 conductive for a first on time T_{MPPT-ON1} and non-conductive for a first off time T_{MPPT-OFF1}, e.g.,

$${DC}_{MPPT 1} = {T}_{MPPT - ON 1} / ( {T}_{MPPT - ON 1} + {T}_{MPPT - OFF 1} ) .$$

The control circuit 650 may be configured to generate the second MPPT drive signal V_{MPPT-DR2} according to a second duty cycle DC_{MPPT2} to render the second FET Q632 conductive for a second on time T_{MPPT-ON2} and non-conductive for a second off time T_{MPPT-OFF2}, e.g.,

$${DC}_{MPPT 2} = {T}_{MPPT - ON 2} / ( {T}_{MPPT - ON 2} + {T}_{MPPT - OFF 2} ) .$$

For example, the control circuit 650 may be configured to not render the second FET Q632 conductive at the same time that the first FET Q631 is rendered conductive (e.g., the control circuit 650 may render the first and second FETs Q631, Q632 conductive on a mutually exclusive basis).

The control circuit 650 may be configured to control the first on time T_{MPPT-ON1} of the first MPPT drive signal V_{MPPT-DR1} and the second on time T_{MPPT-ON2} of the second MPPT drive signal V_{MPPT-DR2}, for example, down to a minimum on time T_{ON-MIN} (e.g., approximately 2 microseconds). The control circuit 650 may be configured to adjust the first on time T_{MPPT-ON1} of the first MPPT drive signal V_{MPPT-DR1} and the second on time T_{MPPT-ON2} of the second MPPT drive signal V_{MPPT-DR2} by, for example, a minimum step size ΔT_{ON} (e.g., approximately 0.5 microseconds) or greater. For example, the control circuit 650 may be configured to adjust each of the first on time T_{MPPT-ON1} of the first MPPT drive signal V_{MPPT-DR1} and the second on time T_{MPPT-ON2} of the second MPPT drive signal V_{MPPT-DR2} to multiples of the minimum step size ΔT_{ON} (e.g., discrete values separated by the minimum step size ΔT_{ON}). The minimum step size ΔT_{ON} may be based on a clock speed of the control circuit 650 of the bottom bar module 640. Reducing the clock speed may allow for decreased power dissipation in the control circuit 650, but may also increase the minimum step size ΔT_{ON}.

The primary winding 630a of the transformer 630 may be configured to conduct a primary current I_{PRI} and the secondary winding 630b of the transformer 630 may be configured to conduct a secondary current I_{SEC}. While the control circuit 650 is rendering the first FET Q631 conductive for the first on time T_{MPPT-ON1}, the first FET Q631 may conduct the primary current I_{PRI} through the primary winding 630a of the transformer 630. During the first on time T_{MPPT-ON1}, a primary magnetizing inductance L_{M} of the primary winding 630a of the transformer 630 may charge, and a magnitude of the primary current I_{PRI} through the primary winding 630a may increase with respect to time (e.g., linearly increase with respect to time at a rate based on the magnitude of the photovoltaic output voltage V_{PV} of the solar cells 610). Since the control circuit 650 renders the second FET Q632 non-conductive while the first FET Q631 is conductive, a magnitude of the secondary current I_{SEC} through the secondary winding 630b may be approximately zero amps during the first on time T_{MPPT-ON1} (e.g., since the diode D634 and the body diode of the second FET Q631 are both reverse biased). The control circuit 650 may be configured to render the first FET Q631 non-conductive and render the second FET Q632 conductive at the end of the first on time T_{MPPT-ON1} of the first MPPT drive signal V_{MPPT-DR1} (e.g., at the beginning of the second on time T_{MPPT-ON2} of the second MPPT drive signal V_{MPPT-DR2}).

While the control circuit 650 is rendering the second FET Q631 conductive for the second on time T_{MPPT-ON2}, the second FET Q632 may conduct the secondary current I_{SEC} through the secondary winding 630b of the transformer 630. During the second on time T_{MPPT-ON2}, the primary magnetizing inductance L_{M} of the transformer 630 may discharge, and the magnitude of the secondary current I_{SEC} through the secondary winding 630b may decrease with respect to time. Since the control circuit 650 renders the first FET Q631 non-conductive while the second FET Q632 is conductive, the magnitude of the primary current I_{PRI} through the primary winding 630a may be approximately zero amps during the second on time T_{MPPT-ON2}.

The control circuit 650 may be configured to control the second FET Q632 using a synchronous rectification (e.g., active rectification) technique. When the second FET Q632 is conductive, the series combination of the second FET Q632 (e.g., the drain-source channel of the FET Q632) and the sense resistor R633 may provide a lower impedance path than the diode D634, such that the diode D634 is non-conductive. The control circuit 650 may be configured to set the second on time T_{MPPT-ON2} of the second MPPT drive signal V_{MPPT-DR2} to allow for discharging of the primary magnetizing inductance L_{M} of the transformer 630 through the secondary winding 630b of the transformer 630. For example, the control circuit 650 may be configured to set the second on time T_{MPPT-ON2} of the second MPPT drive signal V_{MPPT-DR2} based on the first on time T_{MPPT-ON1} of the first MPPT drive signal V_{MPPT-DR1}, the magnitude of the photovoltaic output voltage V_{PV} (e.g., as indicated by the photovoltaic output voltage feedback signal V_{PV-FB}), the magnitude of the second storage voltage V_{S-B} (e.g., as indicated by the second storage voltage feedback signal V_{SB-FB}), and the turns ratio N_{T} of the transformer 630, e.g.,

$${T}_{MPPT - ON 2} = ( {N}_{T} \cdot {V}_{PV} \cdot {T}_{MPPT - ON 1} ) / {V}_{S - B} .$$

When the control circuit 650 renders the FET Q632 non-conductive at the end of the second on time T_{MPPT-ON2}, the diode D634 may be configured to conduct the secondary current I_{SEC} through the secondary winding 630b of the transformer 630 (e.g., if the magnitude of the secondary current I_{SEC} is greater than approximately zero amps).

In some examples, the FET Q632 and the sense resistor R633 may be omitted, such that the diode D634 is configured to conduct the secondary current I_{SEC} (e.g., all of the secondary current I_{SEC}). However, when the FET Q632 and the sense resistor R633 are coupled in parallel with the diode D634 (e.g., as shown in FIG. 17A) and the second FET Q632 is rendered conductive for the second on time T_{MPPT-ON2}, the series combination of the second FET Q632 (e.g., the drain-source channel of the FET Q632) and the sense resistor R633 may provide for less voltage loss that the diode D634 and higher efficiency operation of the solar cell management circuit 620.

When the second FET Q632 is conductive during the second on time T_{MPPT-ON2}, the sense resistor R633 may be configured to generate a secondary current sense signal V_{SEC-SNS}, which may have a magnitude that indicates the magnitude of the secondary current I_{SEC}. The solar cell management circuit 620 may further comprise an overcurrent protection (OCP) circuit 638 configured to receive the secondary current sense signal V_{SEC-SNS}. The overcurrent protection circuit 638 may be coupled to the gate of the second FET Q632 for rendering the second FET Q632 non-conductive in the event of an overcurrent condition is the second FET Q632. While the secondary winding 630b is conducting the secondary current I_{SEC} to charge the energy storage element 640 of the solar power system 600, the magnitude of the secondary current sense signal V_{SEC-SNS} may be negative. The overcurrent protection circuit 638 may be responsive to the secondary current sense signal V_{SEC-SNS} when (e.g., only when) the magnitude of the secondary current sense signal V_{SEC-SNS} is positive. For example, the overcurrent protection circuit 638 may be configured to render the second FET Q632 non-conductive in response to the secondary current sense signal V_{SEC-SNS} when the magnitude of the secondary current sense signal V_{SEC-SNS} is positive to prevent the secondary winding 630b of the transformer 630 from conducting a large magnitude of current from the energy storage element 640 of the solar power system 600.

After the second on time T_{MPPT-ON2}, the control circuit 650 may be configured to render both of the first FET Q631 and the second FET Q632 non-conductive for a non-conduction period T_{NC} (e.g., such that the solar cell management circuit 620 may operate in a discontinuous current mode). The control circuit 650 may be configured to render the first FET Q631 non-conductive for the first off time T_{MPPT-OFF1}, which may be the sum of the second on time T_{MPPT-ON2} and the non-conduction period T_{NC} (e.g., T_{MPPT-OFF1}=T_{MPPT-ON2}+T_{NC}). The control circuit 650 may be configured to render the second FET Q632 non-conductive for the second off time T_{MPPT-OFF2}, which may be the sum of the first on time T_{MPPT-ON1} and the non-conduction period T_{NC} (e.g., T_{MPPT-OFF2}=T_{MPPT-ON1}+T_{NC}).

The control circuit 650 may be configured to control the first MPPT drive signal V_{MPPT-DR1} and the second MPPT drive signal V_{MPPT-DR2} using the MPPT control technique to track a maximum power point for charging the energy storage element 640 of the solar power system 600. The control circuit 650 may be configured to adjust an impedance Z_{MPPT} seen by the solar cells 610 (e.g., an impedance of solar cell management circuit 620) by adjusting the first on time T_{MPPT-ON1} and the first off time T_{MPPT-OFF1} of the first MPPT drive signal V_{MPPT-DR1}. The magnitude of the photovoltaic output voltage V_{PV} produced by the solar cells 610 may be based on the magnitude of the photovoltaic output current I_{PV} (e.g., which may be dependent upon the amount sunlight presently being received by the solar cells 610) and the impedance Z_{MPPT} due to the operation of the solar cell management circuit 620 based on the first MPPT drive signal V_{MPPT-DR1} (e.g., and/or the second MPPT drive signal V_{MPPT-DR2}) generated by the control circuit 650. The solar cells 610 may be configured to provide a solar power P_{SOLAR} that is based on the impedance Z_{MPPT} due the operation of the solar cell management circuit 620 and the magnitude of the photovoltaic output current I_{PV} (e.g., P_{SOLAR}=I_{PV2}·Z_{MPPT}). At a particular magnitude of the photovoltaic output current I_{PV}, the control circuit 650 may be configured to control the solar cell management circuit 620 to try to maximize the solar power P_{SOLAR} provided by the solar cells 610.

The control circuit 650 may be configured to adjust the first duty cycle DC_{MPPT1} of the first MPPT drive signal V_{MPPT-DR1} and the second duty cycle DC_{MPPT2} of the second MPPT drive signal V_{MPPT-DR2} to adjust the solar cell management circuit 620 between a plurality of operating points (e.g., a plurality of predetermined values the respective duty cycles). For example, the control circuit 650 may be configured to adjust the first duty cycle DC_{MPPT1} of the first MPPT drive signal V_{MPPT-DR1} to adjust the impedance Z_{MPPT} of the solar cell management circuit 620 as seen by the solar cells 610 between the plurality of operating points (e.g., a plurality of predetermined values of the impedance Z_{MPPT}). The control circuit 650 may be configured to adjust the first duty cycle DC_{MPPT1} of the first MPPT drive signal V_{MPPT-DR1} to a target duty cycle DC_{TRGT} by adjusting the first on time T_{MPPT-ON1} and the operating period T_{MPPT} of the first MPPT drive signal V_{MPPT-DR1} (e.g., and thus the first off time T_{MPPT-OFF1}).

The control circuit 650 may be configured to adjust the target duty cycle DC_{TRGT} (e.g., and thus first duty cycle DC_{MPPT1} of the first MPPT drive signal V_{MPPT-DR1}) by a duty cycle adjustment amount ΔDC_{MPPT} (e.g., approximately 0.33%). When the target duty cycle DC_{TRGT} is less than (e.g., less than or equal to) a threshold duty cycle DC_{TH} (e.g., approximately 7%), the control circuit 650 may be configured to maintain the first on time T_{MPPT-ON1} of the first MPPT drive signal V_{MPPT-DR1} equal (e.g., approximately equal) to the minimum on time T_{ON-MIN} and adjust the operating period T_{MPPT} (e.g., and/or the first off time T_{MPPT-OFF1}) to adjust the first duty cycle DC_{MPPT1} of the first MPPT drive signal V_{MPPT-DR1}. For example, the threshold duty cycle DC_{TH} may represent the operating point at which the first on time T_{MPPT-ON1} is approximately equal to the minimum on time T_{ON-MIN} and the operating period T_{MPPT} is approximately equal to the minimum operating period T_{MPPT-MIN}.

When the target duty cycle DC_{TRGT} is greater than the threshold duty cycle DC_{TH}, the control circuit 650 may be configured to adjust the first duty cycle DC_{MPPT1} of the first MPPT drive signal V_{MPPT-DR1} by adjusting the first on time T_{MPPT-ON1} and/or the operating period T_{MPPT} of the first MPPT drive signal V_{MPPT-DR1}. Since the control circuit 650 may be limited to adjusting (e.g., only adjusting) the first on time T_{MPPT-ON1} of the first MPPT drive signal V_{MPPT-DR1} by the minimum step size ΔT_{ON}, the control circuit 650 may not be able to adjust the first duty cycle DC_{MPPT1} of the first MPPT drive signal V_{MPPT-DR1} by the duty cycle adjustment amount ΔDC_{MPPT} by only adjusting the first on time T_{MPPT-ON1} of the first MPPT drive signal V_{MPPT-DR1}. The control circuit 650 may be configured to adjust the first on time T_{MPPT-ON1} of the first MPPT drive signal V_{MPPT-DR1} to one of the multiples of the minimum step size ΔT_{ON} and then adjust the operating period T_{MPPT} (e.g., and/or the first off time T_{MPPT-OFF1}) to provide fine tune adjustment of the first duty cycle DC_{MPPT1} of the first MPPT drive signal V_{MPPT-DR1} between duty cycles that may be achieved at multiples of the minimum step size ΔT_{ON} (e.g., to provide finer tune adjustment than can be achieved through control of the of the first on time T_{MPPT-ON1} alone). For example, the control circuit 650 may be configured to adjust the first on time T_{MPPT-ON1} of the first MPPT drive signal V_{MPPT-DR1} to one of the multiples of the minimum step size ΔT_{ON} that results in the next larger duty cycle value and then increase the operating period T_{MPPT} (e.g., and/or the first off time T_{MPPT-OFF1}) until the first duty cycle DC_{MPPT1} of the first MPPT drive signal V_{MPPT-DR1} is at the target duty cycle DC_{TRGT}.

The control circuit 650 may be configured to adjust the second on time T_{MPPT-ON2} and the operating period T_{MPPT} of the second MPPT drive signal V_{MPPT-DR2} (e.g., and thus the second off time T_{MPPT-OFF2}) based on the first on time T_{MPPT-ON1} and the operating period T_{MPPT} of the first MPPT drive signal V_{MPPT-DR1}. As previously mentioned, the operating periods T_{MPPT} of the first drive signal V_{MPPT-DR1} and the second MPPT drive signal V_{MPPT-DR2} may be the same. In addition, the control circuit 650 may be configured to set the second on time T_{MPPT-ON2} of the second MPPT drive signal V_{MPPT-DR2} using the synchronous rectification (e.g., active rectification) technique. For example, the control circuit 650 may be configured to set the second on time T_{MPPT-ON2} based on the first on time T_{MPPT-ON1} of the first MPPT drive signal V_{MPPT-DR1}, the magnitude of the photovoltaic output voltage V_{PV} (e.g., as indicated by the photovoltaic output voltage feedback signal V_{PV-FB}), the magnitude of the second storage voltage V_{S-B} (e.g., as indicated by the second storage voltage feedback signal V_{SB-FB}), and the turns ratio N_{T} of the transformer 630, e.g.,

$${T}_{MPPT - ON 2} = ( {N}_{T} \cdot {V}_{PV} \cdot {T}_{MPPT - ON 1} ) / {V}_{S - B} .$$

As a result, the non-conduction T_{NC} during which the control circuit 650 may render both of the first FET Q631 and the second FET Q632 non-conductive may be based on the first on time T_{MPPT-ON1} of the first MPPT drive signal V_{MPPT-DR1}, the second on time T_{MPPT-ON2} of the second MPPT drive signal V_{MPPT-DR2}, and the operating period T_{MPPT} (e.g., T_{NC}=T_{MPPT}−T_{MPPT-ON1}−T_{MPPT-ON2}).

As previously mentioned, the control circuit 650 may be configured to control the solar power management circuit 620 using the MPPT control technique to try to maximize the solar power P_{SOLAR} provided by the solar cells 610 (e.g., at a particular magnitude of the photovoltaic output current I_{PV}). The control circuit 650 may be configured to determine the solar power P_{SOLAR} based on an average magnitude I_{PV-AVE} of the photovoltaic output current I_{PV} and the magnitude of the photovoltaic output voltage V_{PV}, e.g., as indicated by the photovoltaic output voltage feedback signal V_{PV-FB} (e.g., P_{SOLAR}=V_{PV}·I_{PV}). For example, the control circuit 650 may be configured to calculate (e.g., update) the average magnitude I_{PV-AVE} of the photovoltaic output current I_{PV} based on the operating period T_{MPPT}, the first on time T_{MPPT-ON1} of the first MPPT drive signal V_{MPPT-DR1}, the magnitude of the photovoltaic output voltage V_{PV} (e.g., as indicated by the photovoltaic output voltage feedback signal V_{PV-FB}), and the primary magnetizing inductance L_{M} of the transformer 630, e.g.,

$${I}_{PV - AVE} = ( {V}_{PV} \cdot {T}_{MPPT - ON 1}^{2} ) / ( 2 \cdot {L}_{M} \cdot {T}_{MPPT} ) .$$

The control circuit 650 may be configured to calculate the solar power P_{SOLAR} based on the operating period T_{MPPT}, the first on time T_{MPPT-ON1} of the first MPPT drive signal V_{MPPT-DR1}, the magnitude of the photovoltaic output voltage V_{PV} (e.g., as indicated by the photovoltaic output voltage feedback signal V_{PV-FB}), and the primary magnetizing inductance L_{M} of the transformer 630, e.g.,

$${P}_{SOLAR} = {V}_{PV} \cdot {I}_{PV - AVE} = {( {V}_{PV} \cdot {T}_{MPPT - ON 1} )}^{2} / ( 2 \cdot {L}_{M} \cdot {T}_{MPPT} ) .$$

The control circuit 650 may be configured to store the magnitude of the photovoltaic output voltage V_{PV} (e.g., as indicated by the photovoltaic output voltage feedback signal V_{PV-FB}), the average magnitude I_{PV-AVE} of the photovoltaic output current I_{PV}, and/or the solar power P_{SOLAR} in memory (e.g., the memory of the bottom bar modules 440, 540).

The control circuit 650 may be configured to determine the first on time T_{MPPT-ON1} and/or the operating period T_{MPPT} of the first MPPT drive signal V_{MPPT-DR1} by sweeping through all of the operating points of the solar cell management circuit 620 (e.g., by adjusting the first on time T_{MPPT-ON1} and/or the operating period T_{MPPT}) to determine a present maximum solar power P_{SOLAR-MAX} that the solar cells 610 are capable of providing (e.g., due to the present magnitude of the photovoltaic output current I_{PV}). The control circuit 650 may be configured to sweep through all of the operating points of the solar cell management circuit 620 (e.g., by adjusting the first on time T_{MPPT-ON1} and/or the operating period T_{MPPT}), measure the magnitude of the photovoltaic output voltage V_{PV} (e.g., as indicated by the photovoltaic output voltage feedback signal V_{PV-FB}), and calculate the solar power P_{SOLAR} at each of the operating points. The control circuit 650 may be configured to calculate the solar power P_{SOLAR} using the magnitudes of the photovoltaic output voltage V_{PV} measured during the sweep, the first on time T_{MPPT-ON1}, and the operating period T_{MPPT}. The control circuit 650 may be configured to determine the operating point (e.g., the first on time T_{MPPT-ON1} and/or the operating period T_{MPPT} of the first MPPT drive signal V_{MPPT-DR1}) that provides the maximum solar power P_{SOLAR-MAX} from the solar cells 610 bye determining a maximum value of the magnitudes of the solar power P_{SOLAR} calculated during the sweep. The control circuit 650 may be configured to set the first on time T_{MPPT-ON1} and/or the operating period T_{MPPT} of the first MPPT drive signal V_{MPPT-DR1} to the operating point that provides the maximum solar power P_{SOLAR-MAX}.

The control circuit 650 may be configured to adjust the first MPPT drive signal V_{MPPT-DR1} and/or the second MPPT drive signal V_{MPPT-DR2} to change the solar cell management circuit 620 from one of the operating points to the next and monitor magnitude of the photovoltaic output voltage V_{PV} to determine a change in the solar power P_{SOLAR} provided by the solar cells 610 (e.g., since P_{SOLAR}=V_{PV2}/Z_{MPPT}). When a change from one of the operating points of the solar cell management circuit 620 to the next operating point results in an increase in the magnitude of the solar power P_{SOLAR}, the control circuit 650 may continue to adjust the operating point of the solar cell management circuit 620 in the same direction to attempt to increase the solar power P_{SOLAR} more. When a change from one of the operating points of the solar cell management circuit 620 to the next operating point results in a decrease in the magnitude of the solar power P_{SOLAR}, the control circuit 650 may adjust the operating point of the solar cell management circuit 620 in an opposite direction as previously adjusted to attempt to increase the solar power P_{SOLAR} (e.g., prevent further decrease in the solar power P_{SOLAR}). The control circuit 650 may also be configured to periodically sweep all of the operating points of the solar cell management circuit 620 (e.g., by adjusting the first on time T_{MPPT-ON1} and/or the operating period T_{MPPT} of the first MPPT drive signal V_{MPPT-DR1}) to determine operating point that provides the maximum solar power P_{SOLAR-MAX} from the solar cells 610. For example, the control circuit 650 may also be configured to periodically sweep all of the operating points of the solar cell management circuit 620 at a sweep interval T_{SWEEP} (e.g., approximately 30 minutes).

The control circuit 650 may be configured to periodically adjust the first MPPT drive signal V_{MPPT-DR1} and/or the second MPPT drive signal V_{MPPT-DR2} to change the solar cell management circuit 620 from one of the operating points to the next at a timing interval T_{TIM1} (e.g., approximately five seconds). Each time that the control circuit 650 periodically adjusts the first MPPT drive signal V_{MPPT-DR1} and/or the second MPPT drive signal V_{MPPT-DR2} (e.g., at the timing interval T_{TIM1}), the control circuit 650 may be configured to store one or more of control parameters and/or operating characteristics of the solar management circuit 620 in memory (e.g., the memory of the bottom bar modules 440, 540). For example, the control circuit 650 may be configured to store in memory one or more operating parameters of the solar management circuit 620, such as, the operating frequency f_{MPPT}, the operating period T_{MPPT}, the first on time T_{MPPT-ON1}, the first off time T_{MPPT-OFF1}, the first duty cycle DC_{MPPT1} of the first MPPT drive signal V_{MPPT-DR1}, the second on time T_{MPPT-ON2}, the second off time T_{MPPT-OFF2}, and/or the second duty cycle DC_{MPPT2} of the second MPPT drive signal V_{MPPT-DR2}. In addition, the control circuit 650 may be configured to store in memory one or more measured (e.g., sensed) operating characteristics (e.g., such as the magnitude of the photovoltaic output voltage V_{PV} and/or the magnitude of the second storage voltage V_{S-B}) and/or one or more calculated operating characteristics (e.g., such as the average magnitude I_{PV-AVE} of the photovoltaic output current I_{PV} and/or the solar power P_{SOLAR}). In some examples, the control circuit 650 may be configured to store timing information when storing the one or more of control parameters and/or operating characteristics of the solar power management circuit 620 in memory.

The control circuit 650 may be configured to determine (e.g., calculate) and store one or more performance values and/or operational characteristics of the solar cells 610 and/or the solar power management circuit 620 of the solar power system 600. As previously mentioned, the control circuit 650 may be configured to determine (e.g., calculate) and store in memory the average magnitude I_{PV-AVE} of the photovoltaic output current I_{PV} of the solar cells 610 and/or the solar power P_{SOLAR} received by the solar cells 610. The control circuit 650 may be configured to periodically calculate and store in memory the average magnitude I_{PV-AVE} of the photovoltaic output current I_{PV} of the solar cells 610 and/or the solar power P_{SOLAR} received by the solar cells 610 (e.g., at the timing interval T_{TIM1}).

In addition, the control circuit 650 may also be configured to determine (e.g., calculate) a charge Q_{SOLAR} and/or a solar energy E_{SOLAR} received from the solar cells 610 (e.g., accumulated by the energy storage element 640) over an accumulation interval T_{ACC} (e.g., such as a day). In some examples, the accumulation interval T_{ACC} may be other time periods (e.g., multiple days, a week, multiple weeks, a month, etc.). For example, each time that the control circuit 650 periodically adjusts the first MPPT drive signal V_{MPPT-DR1} and/or the second MPPT drive signal V_{MPPT-DR2} (e.g., at the timing interval T_{TIM1}), the control circuit 650 may be configured to determine (e.g., calculate) the average magnitude I_{PV-AVE} of the photovoltaic output current I_{PV} and/or the solar power P_{SOLAR} (e.g., as described above). For example, the control circuit 650 may be configured to calculate the charge Q_{SOLAR} received from the solar cells 610 based on the average magnitude I_{PV-AVE} of the photovoltaic output current I_{PV} and the timing interval T_{TIM1}, e.g.,

$${Q}_{SOLAR} = {Q}_{SOLAR} + ( {I}_{PV - AVE} \cdot {T}_{TIM 1} ) .$$

In addition, the control circuit 650 may be configured to calculate the solar energy E_{SOLAR} received from the solar cells 610 based on the magnitude of the photovoltaic output voltage V_{PV} (e.g., as indicated by the photovoltaic output voltage feedback signal V_{PV-FB}), the average magnitude I_{PV-AVE} of the photovoltaic output current I_{PV}, and the timing interval T_{TIM1}, e.g.,

$${E}_{SOLAR} = {E}_{SOLAR} + ( {V}_{PV} \cdot {I}_{PV - AVE} \cdot {T}_{TIM 1} ) .$$

In some examples, the control circuit 650 may be configured to calculate the solar energy E_{SOLAR} received from the solar cells 610 based on the solar power P_{SOLAR} and the timing interval T_{TIM1}, e.g.,

$${E}_{SOLAR} = {E}_{SOLAR} + ( {P}_{SOLAR} \cdot {T}_{TIM 1} ) .$$

At the end of the accumulation interval T_{ACC} (e.g., at the end of each day), the control circuit 650 may be configured to store the accumulated charge Q_{SOLAR} and/or the accumulated solar energy E_{SOLAR} in memory along with timing information (e.g., the present date). In addition, the control circuit 650 may be configured to reset the charge Q_{SOLAR} to zero coulombs and/or the solar energy E_{SOLAR} to zero joules at the end of the accumulation interval T_{ACC}, such that the control circuit 650 may be configured to determine the charge Q_{SOLAR} and/or the solar energy E_{SOLAR} received from the solar cells 610 during the next accumulation interval T_{ACC}.

The control circuit 650 may be configured to enable and disable control of the solar cell management circuit 620 using the MPPT control technique to start and stop charging the energy storage element 640 of the solar power system 600, respectively. The control circuit 650 may be configured to start charging the energy storage element 640 (e.g., enable control of the solar cell management circuit 620 using the MPPT control technique) by generating (e.g., starting to generate) the first MPPT drive signal V_{MPPT-DR1} and/or the second MPPT drive signal V_{MPPT-DR2} for controlling the solar cell management circuit 620, and cease charging the energy storage element 640 (e.g., disable control of the solar cell management circuit 620 using the MPPT control technique) by not generating (e.g., ceasing to generate) the first MPPT drive signal V_{MPPT-DR1} and/or the second MPPT drive signal V_{MPPT-DR2}.

The control circuit 650 may be configured to enable and disable control of the solar cell management circuit 620 using the MPPT control technique, for example, in response to the magnitude of the second storage voltage V_{S-B} across the energy storage element 640 (e.g., as indicated by the second storage voltage feedback signal V_{SB-FB}). The control circuit 650 may be configured to disable control of the solar cell management circuit 620 using the MPPT control technique when the magnitude of the second storage voltage V_{S-B} rises above (e.g., becomes greater than) a high storage voltage threshold V_{TH-HI} (e.g., approximately 75% of a rated maximum voltage V_{R-MAX}, such as approximately 5.4 volts). The control circuit 650 may be configured to enable control of the solar cell management circuit 620 using the MPPT control technique when the magnitude of the second storage voltage V_{S-B} falls below (e.g., becomes less than) a low storage voltage threshold V_{TH-LO}.

The control circuit 650 may be configured to enable and disable control of the solar cell management circuit 620 using the MPPT control technique, for example, based on an amount of sunlight presently being received by the solar cells 610 (e.g., in response to the magnitude of the photovoltaic output current I_{PV}). For example, the control circuit 550 may be configured to disable control of the solar cell management circuit 620 using the MPPT control technique when the present maximum solar power P_{SOLAR-MAX} that the solar cells 610 are capable of providing (e.g., due to the present magnitude of the photovoltaic output current I_{PV}) is less than an MPPT operating power threshold P_{TH-MPPT} (e.g., approximately 1 mW). For example, the MPPT operating power threshold P_{TH-MPPT} may represent the amount of power required by (e.g., consumed by) the control circuit 650 and/or the solar power management circuit 620 when operating using the MPPT control technique. For example, the control circuit 650 may be configured to sweep (e.g., periodically sweep) through all of the operating points of the solar cell management circuit 620 (e.g., by adjusting the duty cycle DC_{MPPT} and/or the operating period T_{MPPT}), measure the magnitude of the photovoltaic output voltage V_{PV} (e.g., as indicated by the photovoltaic output voltage feedback signal V_{PV-FB}) and calculate the solar power P_{SOLAR} at each operating point. The control circuit 650 may be configured to determine the maximum solar power P_{SOLAR-MAX} that the solar cells 610 are capable of providing from a maximum value of the magnitudes of the solar power P_{SOLAR} calculated during the sweep. For example, the control circuit 650 may be configured to periodically sweep through all of the operating points to determine the maximum solar power P_{SOLAR-MAX} at the sweep interval T_{SWEEP} (e.g., approximately 30 minutes). The control circuit 650 may be configured to enable control of the solar cell management circuit 620 using the MPPT control technique when the maximum solar power P_{SOLAR-MAX} is greater than (e.g., greater than or equal to) the MPPT operating power threshold P_{TH-MPPT} and disable control of the solar cell management circuit 620 using the MPPT control technique when the maximum solar power P_{SOLAR-MAX} is less than the MPPT operating power threshold P_{TH-MPPT}.

When control of the solar cell management circuit 620 using the MPPT control technique is disabled (e.g., due to either the magnitude of the second storage voltage V_{S-B} being greater than the high storage voltage threshold V_{TH-HI} and/or the maximum solar power P_{SOLAR-MAX} being less than the MPPT operating power threshold P_{TH-MPPT}), the control circuit 650 may be configured to continue to determine (e.g., calculate) and store in memory the one or more operating characteristics of the solar cells 610 and/or the solar power management circuit 620 of the solar power system 600 (e.g., the average magnitude I_{PV-AVE} of the photovoltaic output current I_{PV}, the solar power P_{SOLAR}, the charge Q_{SOLAR}, and/or the solar energy E_{SOLAR}). For example, when control of the solar cell management circuit 620 using the MPPT control technique is disabled, the control circuit 650 may be configured to periodically sweep through all of the operating points to determine the maximum solar power P_{SOLAR-MAX} (e.g., at the sweep interval T_{SWEEP}). The control circuit 650 may be configured to calculate the one or more operating characteristics of the solar cells 610 and/or the solar power management circuit 620 of the solar power system 600 based on the magnitude of a maximum magnitude of the photovoltaic output voltage V_{PV-MAX} (e.g., as indicated by the photovoltaic output voltage feedback signal V_{PV-FB}) at the maximum solar power P_{SOLAR-MAX}, and in some examples, further based on an operating period T_{MPPT-MAX} and a first on time T_{MPPT-ON1-MAX} of the first MPPT drive signal V_{MPPT-DR1} at the maximum solar power P_{SOLAR-MAX}. The control circuit 650 may be configured to calculate the one or more operating characteristics of the solar cells 610 and/or the solar power management circuit 620 of the solar power system 600.

When control of the solar cell management circuit 620 using the MPPT control technique is disabled, the control circuit 650 may be configured to calculate (e.g., update) the average magnitude I_{PV-AVE} of the photovoltaic output current I_{PV} based on the operating period T_{MPPT-MNAX} and the first on time T_{MPPT-ON1-MAX} of the first MPPT drive signal V_{MPPT-DR1} at the maximum solar power P_{SOLAR-MAX}, the maximum magnitude of the photovoltaic output voltage V_{PV-MAX} at the maximum solar power P_{SOLAR-MAX}, and the primary magnetizing inductance L_{M} of the transformer 630, e.g.,

$${I}_{PV - AVE} = {( {V}_{PV - MAX} \cdot {T}_{MPPT - ON 1 - MAX} )}^{2} / ( 2 \cdot {L}_{M} \cdot {T}_{MPPT - MAX} ) .$$

In addition, when control of the solar cell management circuit 620 using the MPPT control technique is disabled, the control circuit 650 may be configured to calculate the solar power P_{SOLAR} based on the operating period T_{MPPT-MAX} and the first on time T_{MPPT-ON1-MAX} of the first MPPT drive signal V_{MPPT-DR1} at the maximum solar power P_{SOLAR-MAX}, the magnitude of the photovoltaic output voltage V_{PV-MAX} at the maximum solar power P_{SOLAR-MAX}, and the primary magnetizing inductance L_{M} of the transformer 630, e.g.,

$${P}_{SOLAR} = {V}_{PV - MAX} \cdot {I}_{PV - AVE} = {( {V}_{PV - MAX} \cdot {T}_{MPPT - ON 1 - MAX} )}^{2} / ( 2 \cdot {L}_{M} \cdot {T}_{MPPT - MAX} ) .$$

The control circuit 650 may be configured to periodically calculate and store the magnitude of the photovoltaic output voltage V_{PV} (e.g., the maximum magnitude of the photovoltaic output voltage V_{PV-MAX} at the maximum solar power P_{SOLAR-MAX}), the average magnitude I_{PV-AVE} of the photovoltaic output current I_{PV}, and/or the solar power P_{SOLAR} in memory (e.g., the memory of the bottom bar modules 440, 540) at the sweep interval T_{SWEEP}.

When control of the solar cell management circuit 620 using the MPPT control technique is disabled, the control circuit 650 may be configured to calculate the charge Q_{SOLAR} received from the solar cells 610 based on the average magnitude I_{PV-AVE} of the photovoltaic output current I_{PV} and the sweep interval T_{SWEEP}, e.g.,

$${Q}_{SOLAR} = {Q}_{SOLAR} + ( {I}_{PV - AVE} \cdot {T}_{SWEEP} ) .$$

In addition, the control circuit 650 may be configured to calculate the solar energy E_{SOLAR} received from the solar cells 610 based on the maximum magnitude of the photovoltaic output voltage V_{PV-MAX} at the maximum solar power P_{SOLAR-MAX}, the average magnitude I_{PV-AVE} of the photovoltaic output current I_{PV}, and the sweep interval T_{SWEEP}, e.g.,

$${E}_{SOLAR} = {E}_{SOLAR} + ( {V}_{PV - MAX} \cdot {I}_{PV - AVE} \cdot {T}_{SWEEP} ) .$$

In some examples, the control circuit 650 may be configured to calculate the solar energy E_{SOLAR} received from the solar cells 610 based on the solar power P_{SOLAR} and the sweep interval T_{SWEEP}, e.g.,

$${E}_{SOLAR} = {E}_{SOLAR} + ( {P}_{SOLAR} \cdot {T}_{SWEEP} ) .$$

The control circuit 650 may be configured to periodically calculate (e.g., update) the charge Q_{SOLAR} and/or the solar energy E_{SOLAR} at the sweep interval T_{SWEEP}.

The control circuit 650 may be configured to control the charging circuit 660 to charge the energy storage element of the motor drive unit when the bottom bar is docked with the motor drive unit, for example, during a charging event of the energy storage element of the motor drive unit. The charging circuit 660 may receive the second storage voltage V_{S-B} stored in the energy storage element 640 and may be configured to charge the energy storage element of the motor drive unit for producing the first storage voltage V_{S-B} across the energy storage element of the motor drive unit when the bottom bar is docked. The charging circuit 660 may be configured to conduct an input current I_{IN} from the energy storage element 640. The energy storage element of the motor drive unit may be configured to conduct a charging current I_{CHRG} (e.g., an output current) from the charging circuit 660 (e.g., through the positive voltage connection 602 when the bottom bar is docked). The charging circuit 660 may comprise an input capacitor C661 across which the second storage voltage V_{S-B} may be coupled and an output capacitor C662 across which the first storage voltage V_{S-A} of the energy storage element of the motor drive unit may be coupled (e.g., when the bottom bar is docked).

The charging circuit 660 may comprise a switching circuit 665 coupled in series with the positive voltage connection 602. For example, the switching circuit 665 may comprise one or more FETs, such as a FET in a full-wave rectifier bridge or two FETs coupled in anti-series connection. The control circuit 650 may be configured to generate a charge enable control signal V_{CHRG-EN-B} that may be received by the switching circuit 665 for rendering the switching circuit conductive and non-conductive. When the bottom bar is not docked with the motor drive unit, the control circuit 650 may be configured to control the charge enable control signal V_{CHRG-EN-B} to render the switching circuit 665 non-conductive. When the bottom bar is docked with the motor drive unit, the control circuit 650 may be configured to control the charge enable control signal V_{CHRG-EN-B} to render the switching circuit 665 conductive.

The charging circuit 660 may also comprise a resistive divider circuit having a resistor R663 (e.g., having a resistance of approximately 47.5 kΩ in series with a resistor R664 (e.g., having a resistance of approximately 7.32 kΩ. The series combination of the resistors R663, R664 of the resistive divider circuit may be coupled in parallel with the output capacitor C662 for receiving the first storage voltage V_{S-A}, such that a first source voltage feedback signal V_{SA-FB} is generated at the junction of the resistors R663, R664 of the resistive divider circuit when the bottom bar is docked with the motor drive unit. For example, the first source voltage feedback signal V_{SA-FB} (e.g., the magnitude of the first source voltage feedback signal V_{SA-FB}) may indicate the magnitude of the first source voltage V_{S-A}. The control circuit 650 may receive the first source voltage feedback signal V_{SA-FB} and may be configured to determine the magnitude of the first source voltage V_{S-A} from the first source voltage feedback signal V_{SA-FB}.

The charging circuit 660 may comprise, for example, a boost converter circuit for generating the first storage voltage V_{S-A} from the second storage voltage V_{S-B}. The charging circuit 660 may comprise an inductor L670 (e.g., having an inductance L_{CHRG} of approximately 17 μH) and a diode D671. When the switching circuit 665 is conductive, the inductor L670 and the diode D671 may be coupled in series between the energy storage element 640 of the solar power system 600 and the energy storage element of the motor drive unit. The charging circuit 660 may further comprise a FET Q672 and a sense resistor R673 coupled in series with the FET Q672 (e.g., with the drain-source channel of the FET Q672). The series combination of the FET Q672 (e.g., the drain-source channel of the FET Q672) and the sense resistor R673 may be coupled between the junction of the inductor L670 and the diode D671 and circuit common. The gate of the FET Q672 may be coupled to the control circuit 650 via a gate drive circuit 674. The control circuit 650 may be configured to generate a charge drive signal V_{CHRG-DR} that may be received by the gate drive circuit 674 for rendering the FET Q672 conductive and non-conductive.

The control circuit 650 may be configured to generate the charge drive signal V_{CHRG-DR} to control the FET Q672 on a periodic basis at an operating frequency f_{CHRG} (e.g., at an operating period T_{CHRG}). For example, the control circuit 650 may be configured to maintain the operating frequency f_{CHRG} constant (e.g., at approximately 35 kHz) and maintain the operating period T_{CHRG} constant (e.g., at approximately 29 microseconds) during operation of the charging circuit 660. The control circuit 650 may be configured to generate the charge drive signal V_{CHRG-DR} according to a duty cycle DC_{CHRG} to render the FET Q672 conductive for an on time T_{CHRG-ON} and non-conductive for an off time T_{CHRG-OFF} (e.g., DC_{CHRG}=T_{CHRG-ON}/[T_{CHRG-ON}+T_{CHRG-OFF}]). The control circuit 650 may be configured to control the on time T_{CHRG-ON} of the charge drive signal V_{CHRG-DR} down to, for example, the minimum on time T_{ON-MIN} (e.g., approximately 2 microseconds). The control circuit 650 may be configured to adjust the on time T_{CHRG-ON} of the charge drive signal V_{CHRG-DR} by, for example, the minimum step size ΔT_{ON} (e.g., approximately 0.5 microseconds). For example, the control circuit 650 may be configured to adjust the on time T_{CHRG-ON} of the charge drive signal V_{CHRG-DR} to multiples of the minimum step size ΔT_{ON} (e.g., discrete values separated by the minimum step size ΔT_{ON}).

The control circuit 650 may be configured to render the FET Q672 conductive and non-conductive, such that the inductor L670 conducts an inductor current IL. While the control circuit 650 is rendering the FET Q672 conductive for the on time T_{CHRG-ON}, the FET Q672 may conduct the inductor current IL through the inductor L670 causing the inductor L760 to charge and a magnitude of the inductor current IL to increase with respect to time (e.g., linearly increase with respect to time at a rate based on the magnitude of the second storage voltage V_{S-B} of the energy storage element 640). When the FET Q672 is conductive, the sense resistor R673 may be configured to generate a charge current sense signal V_{CHRG-SNS}, which may have a magnitude that indicates the magnitude of the inductor current IL during the on time T_{CHRG-ON}. The charging circuit 660 may further comprise an overcurrent protection (OCP) circuit 675 configured to receive the charge current sense signal V_{CHRG-SNS}. The overcurrent protection circuit 675 may be coupled to the gate of the FET Q672 for rendering the FET Q672 non-conductive in the event of an overcurrent condition is the FET Q672.

The control circuit 650 may be configured to render the FET Q672 non-conductive at the end of the on time T_{CHRG-ON}. While the control circuit 650 is rendering the FET Q672 non-conductive for the off time T_{CHRG-OFF}, the inductor L670 may discharge through the diode D671 into the energy storage element of the motor drive unit. A voltage having a magnitude equal to the magnitude of the second storage voltage V_{S-B} plus a magnitude of an inductor voltage across the inductor L670 may be coupled across the series combination of the diode D671 and the energy storage element of the motor drive unit (e.g., such that the magnitude of the first storage voltage V_{S-A} across the energy storage element of the motor drive unit is greater than a magnitude of the second storage voltage V_{S-B} across the energy storage element 640).

The control circuit 650 may be configured to adjust the on time T_{CHRG-ON} of the charge drive signal V_{CHRG-DR} to maintain an average magnitude I_{IN-AVE} of the input current I_{IN} (e.g., conducted by the charging circuit 660 from the energy storage element 640) at a constant magnitude I_{IN-CNST} (e.g., approximately 250 milliamps). For example, the control circuit 650 may be configured to set the on time T_{CHRG-ON} of the charge drive signal V_{CHRG-DR} based on the operating period T_{CHRG}, the magnitude of the first storage voltage V_{S-A} (e.g., as indicated by the first storage voltage feedback signal V_{SA-FB}), the magnitude of the second storage voltage V_{S-B} (e.g., as indicated by the second storage voltage feedback signal V_{SB-FB}), the inductance LIND of the inductor L670, and the average magnitude I_{IN-AVE} of the input current I_{IN}, e.g.,

$${T}_{CHRG - ON} = Square Root [ ( {L}_{IND} \cdot {T}_{CHRG} \cdot {I}_{IN - AVE} \cdot [ {V}_{S - A} - {V}_{S - B} ] ) / ( 2 \cdot {V}_{S - A} \cdot {V}_{S - B} ) ] .$$

The control circuit 650 may be configured to set the off time T_{CHRG-OFF} based on the determined on time T_{CHRG-ON} and the operating period T_{CHRG} (e.g., T_{CHRG-OFF}=T_{CHRG}−T_{CHRG-ON}).

The control circuit 650 may be configured to enable and disable charging of the energy storage element of the motor drive unit via the charging circuit 660. For example, the charging event may begin when the control circuit 650 enables charging the energy storage element of the motor drive unit and end when the control circuit 650 disables charging the energy storage element of the motor drive unit. The control circuit 650 may be configured to enable charging of the energy storage element of the motor drive unit when (e.g., only when) the bottom bar is docked and disable charging of the energy storage element of the motor drive unit when the bottom bar is not docked. When the bottom bar is docked with the motor drive unit (e.g., when the bottom bar is in a raised position P_{RAISED}), the positive voltage connection 602, the circuit common connection 604, and the communication connection 606 may be electrically connected to respective electrical connections on the dock of the motorized window treatment. The control circuit 650 (e.g., the communication circuit 652) may be configured to communicate with the motor drive unit (e.g., with the control circuit and/or the communication circuit of the motor drive unit) to confirm that the bottom bar is docked. For example, after controlling the bottom bar to the raised position P_{RAISED}, the motor drive unit may be configured to transmit a message (e.g., a docking confirmation message) to the control circuit 650 via the communication connection 606. In some examples, after receiving the message, the control circuit 650 may transmit a response message to the motor drive unit to confirm that the message was received and docking is confirmed.

After docking has been confirmed (e.g., after the control circuit 650 has received the docking confirmation message from the motor drive unit), the control circuit may be configured to enable charging of the energy storage element of the motor drive unit. For example, the control circuit 650 may be configured to enable charging of the energy storage element of the motor drive unit by controlling the charge enable control signal V_{CHRG-EN-B} to render the switching circuit 665 conductive, and disable charging of the energy storage element of the motor drive unit by controlling the charge enable control signal V_{CHRG-EN-B} to render the switching circuit 665 non-conductive. When charging of the energy storage device of the motor drive unit is enabled and the switching circuit 665 is conductive, the control circuit 650 may be configured to control the charging circuit 660 to start and stop charging of the energy storage element of the motor drive unit. The control circuit 650 may be configured to start charging the energy storage element of the motor drive unit by generating (e.g., starting to generate) the charge drive signal V_{CHRG-DR} for controlling the charging circuit 660, and cease charging the energy storage element of the motor drive unit by not generating (e.g., ceasing to generate) the charge drive signal V_{CHRG-DR}.

The control circuit 650 may be configured to disable charging of the energy storage element of the motor drive unit, for example, when the energy storage element of the motor drive unit is full. For example, the control circuit 650 may be configured to determine that the energy storage element of the motor drive unit is full in response to the magnitude of the first storage voltage V_{S-A} across the energy storage element of the motor drive unit (e.g., as indicated by the first storage voltage feedback signal V_{SA-FB}). The control circuit 650 may be configured to disable charging of the energy storage element of the motor drive unit when, for example, the magnitude of the first storage voltage V_{S-A} rises above (e.g., becomes greater than) a full storage voltage threshold V_{TH-FULL} (e.g., approximately 6.5 volts). In addition, the control circuit 650 may be configured to determine that the energy storage element is full and subsequently disable charging of the energy storage element in response to receiving a message indicating that the energy storage element is full from the motor drive unit via the communication connection 606.

Further, the control circuit 650 may be configured to disable charging of the energy storage element of the motor drive unit, for example, when the energy storage element 640 of the solar power system 600 is empty. For example, the control circuit 650 may be configured to determine that the energy storage element is empty in response to the magnitude of the second storage voltage V_{S-B} across the energy storage element 640 (e.g., as indicated by the second storage voltage feedback signal V_{SB-FB}). The control circuit 650 may be configured to disable charging of the energy storage element of the motor drive unit when, for example, the magnitude of the second storage voltage V_{S-B} falls below (e.g., becomes less than) an empty storage voltage threshold V_{TH-EMPTY}. Accordingly, the control circuit 650 may be configured to charge the energy storage element of the motor drive unit during each charging event, where a charging event may be defined by the time period between when charging is enabled (e.g., when the bottom bar is docked) and then disabled (e.g., based on the energy storage element of the motor drive unit being full or the energy storage element 640 of the bottom bar being empty).

When the control circuit 650 determines to disable charging of the energy storage element of the motor drive unit (e.g., when either the energy storage element of the motor drive unit is full or the energy storage element 640 of the solar power system 600 is full), the control circuit 650 may be configured cease charging the energy storage element 546 by not generating (e.g., ceasing to generate) the charge drive signal V_{CHRG-DR} and then controlling the charge enable control signal V_{CHRG-EN-B} to render the switching circuit 665 non-conductive. In some examples, the control circuit 650 may also be configured to transmit a message indicating that charging of the energy storage element is complete to the motor drive unit via the communication connection 606.

The control circuit 650 may be configured to determine (e.g., calculate) and store in the memory (e.g., the memory of the bottom bar modules 440, 540) one or more performance values (e.g., calculated values) of the charging circuit 660 of the solar power system 600. For example, the control circuit 650 may be configured to calculate and store the one more performance values of the charging circuit 660 in memory periodically (e.g., at a timing interval T_{TIM2}) while the charging circuit 660 is charging the energy storage element of the motor drive unit (e.g., while the bottom bar is docked). For example, the control circuit 650 may be configured to determine (e.g., calculate) an average magnitude I_{CHRG-AVE} of the charging current I_{CHRG} based on the operating period T_{CHRG}, the on time T_{ON} of the charge drive signal V_{CHRG-DR}, the magnitude of the first storage voltage V_{S-A} (e.g., as indicated by the first storage voltage feedback signal V_{SA-FB}), the magnitude of the second storage voltage V_{S-B} (e.g., as indicated by the second storage voltage feedback signal V_{SB-FB}), and the inductance LIND of the inductor L670, e.g.,

$${I}_{CHRG - AVE} = {( {V}_{SB} \cdot {T}_{CHRG} )}^{2} / ( 2 \cdot {L}_{IND} \cdot {T}_{CHRG} \cdot [ {V}_{SA} - {V}_{SB} ] ) .$$

The control circuit 650 may also be configured to calculate a charging power P_{CHRG} delivered to the energy storage element of the motor drive unit based on the operating period T_{CHRG}, the on time T_{ON} of the charge drive signal V_{CHRG-DR}, the magnitude of the first storage voltage V_{S-A} (e.g., as indicated by the first storage voltage feedback signal V_{SA-FB}), the magnitude of the second storage voltage V_{S-B} (e.g., as indicated by the second storage voltage feedback signal V_{SB-FB}), and the inductance LIND of the inductor L670, e.g.,

$${P}_{CHRG} = {V}_{SA} \cdot {I}_{CHRG - AVE} = ( {V}_{SA} \cdot {[ {V}_{SB} \cdot {T}_{CHRG} ]}^{2} ) / ( 2 \cdot {L}_{IND} \cdot {T}_{CHRG} \cdot [ {V}_{SA} - {V}_{SB} ] ) .$$

The control circuit 650 may be configured to store the magnitude of the first storage voltage V_{S-A} (e.g., as indicated by the first storage voltage feedback signal V_{SA-FB}), the magnitude of the second storage voltage V_{S-B} (e.g., as indicated by the second storage voltage feedback signal V_{SB-FB}), the average magnitude I_{CHRG-AVE} of the charging current I_{CHRG} of the charging circuit 660, and/or the charging power P_{CHRG} in memory.

In addition, the control circuit 650 may also be configured to determine (e.g., calculate) a charge Q_{CHRG} and/or an energy E_{CHRG} transferred to the energy storage element of the motor drive unit (e.g., when the bottom bar is docked). For example, the control circuit 650 may be configured to calculate the charge Q_{CHRG} and/or the energy E_{CHRG} transferred to the energy storage element of the motor drive unit during a single charging event when the bottom bar is docked. For example, the control circuit 650 may be configured to calculate and store in memory the charge Q_{CHRG} and/or the energy E_{CHRG} transferred to the energy storage element of the motor drive unit periodically (e.g., at the timing interval T_{TIM2}) during the charging event. For example, the control circuit 650 may be configured to calculate the charge Q_{CHRG} transferred to the energy storage element of the motor drive unit based on the average magnitude I_{CHRG-AVE} of the charging current I_{CHRG} and the timing interval T_{TIM2}, e.g.,

$${Q}_{CHRG} = {Q}_{CHRG} + ( {I}_{CHRG - AVE} \cdot {T}_{TIM 2} ) .$$

In addition, the control circuit 650 may be configured to calculate the energy E_{CHRG} transferred to the energy storage element of the motor drive unit based on the magnitude of the first storage voltage V_{S-A} (e.g., as indicated by the second storage voltage feedback signal V_{SA-FB}), the average magnitude I_{CHRG-AVE} of the charging current I_{CHRG}, and the timing interval T_{TIM2}, e.g.,

$${E}_{CHRG} = {E}_{CHRG} + ( {V}_{S - A} \cdot {I}_{CHRG - AVE} \cdot {T}_{TIM 2} ) .$$

In some examples, the control circuit 650 may be configured to calculate the energy E_{CHRG} transferred to the energy storage element of the motor drive unit based on the charging power P_{CHRG} and the timing interval T_{TIM2}, e.g.,

$${E}_{CHRG} = {E}_{CHRG} + ( {P}_{CHRG} \cdot {T}_{TIM 2} ) .$$

At the end of the charging event (e.g., after charging of the energy storage element of the motor drive unit is disabled), the control circuit 650 may be configured to store the charge Q_{CHRG} and/or the energy E_{CHRG} transferred to the energy storage element of the motor drive unit in memory along with timing information (e.g., the present date). In addition, the control circuit 650 may be configured to reset the charge Q_{CHRG} to zero coulombs and/or the solar energy E_{CHRG} to zero joules at the end of the charging event, such that the control circuit 650 may be configured to determine the charge Q_{CHRG} and/or the solar energy E_{CHRG} transferred to the energy storage element of the motor drive unit during the charging event.

The control circuit 650 may be configured to monitor a present charge Q_{PRES-B} of the energy storage element 640 of the solar power system 600. For example, the control circuit 650 may be configured to adjust (e.g., update) the present charge Q_{PRES-B} of the energy storage element 640 of based on the charge Q_{SOLAR} received from the solar cells 610 (e.g., accumulated by the energy storage element 640) during each accumulation interval T_{ACC} and the charge Q_{CHRG} transferred from the energy storage element 640 to the energy storage element of the motor drive unit during each charging event. The control circuit 650 may be configured to add the charge Q_{SOLAR} received from the solar cells 610 to the present charge Q_{PRES-B} (e.g., Q_{PRES-B}=Q_{PRES-B}+Q_{SOLAR}), for example, at the end of each accumulation interval T_{ACC}. The control circuit 650 may be configured to subtract the charge Q_{CHRG} transferred to the energy storage element of the motor drive unit from the present charge Q_{PRES-B} (e.g., Q_{PRES-B}=Q_{PRES-B}−Q_{CHRG}), for example, periodically at the timing interval T_{TIM2} during each charging event.

As previously mentioned, the control circuit 650 may be configured to enable and disable control of the solar cell management circuit 620 using the MPPT control technique, for example, in response to the magnitude of the second storage voltage V_{S-B} across the energy storage element 640. In some examples, the control circuit 650 may be configured to enable and disable control of the solar cell management circuit 644 using the MPPT control technique, for example, in response to the present charge Q_{PRES-B} of the energy storage element 640. The control circuit 650 may be configured to disable control of the solar cell management circuit 620 using the MPPT control technique when the present charge Q_{PRES-B} of the energy storage element 640 rises above (e.g., becomes greater than) a high storage charge threshold Q_{TH-HI}. The control circuit 650 may be configured to enable control of the solar cell management circuit 620 using the MPPT control technique when the present charge Q_{PRES-B} of the energy storage element 640 falls below (e.g., becomes less than) a low storage charge threshold Q_{TH-LO}.

As previously mentioned, the control circuit 650 of the solar power system 600 may be configured to disable charging of the energy storage element of the motor drive unit in response to the magnitude of the second storage voltage V_{S-B} across the energy storage element 640. In some examples, the control circuit 650 may be configured to disable charging of the energy storage element of the motor drive unit, for example, in response to the present charge Q_{PRES-B} of the energy storage element 640. The control circuit 650 may be configured to disable charging of the energy storage element of the motor drive unit when the present charge Q_{PRES-B} of the energy storage element 640 falls below (e.g., becomes less than) an empty storage charge threshold Q_{TH-EMPTY}.

The control circuit 650 of the solar power system 600 may also be configured to determine a present light level L_{SUN-PRES} of the sunlight shining onto the solar cells 610. In some examples, the present light level L_{SUN-PRES} may be similar to the daylight level L_{DL} outside the window that the motorized window treatment is covering. The control circuit 650 may also be configured to determine the present light level L_{SUN-PRES} in units of, for example, lux and/or foot-candles (fcd). For example, the control circuit 650 may also be configured to determine the present light level L_{SUN-PRES} in response to a magnitude of a short-circuit current I_{SC} of the solar cells 610. The control circuit 650 may be configured to control the first MPPT drive signal V_{MPPT-DR1} to render the first FET Q631 of the solar power management circuit 620 conductive for a discharge period T_{DC}. While the first FET Q631 is conductive during the discharge period T_{DC}, the first FET Q631 may conduct the primary current I_{PRI} through the primary winding 630a of the transformer 630 and the magnitude of the photovoltaic output voltage V_{PV} generated across the input capacitor C621 drops to approximately zero volts.

The control circuit 650 may then control the first MPPT drive signal V_{MPPT-DR1} to render the first FET Q631 non-conductive, such that the solar cells 610 may conduct the photovoltaic output current I_{PV} into the input capacitor C621 (e.g., which may appear as a short circuit to the solar cells 610 since the magnitude of the photovoltaic output voltage V_{PV} is approximately zero volts). The control circuit 650 may be configured to measure a charging time period T_{CHARGE} from when the first FET Q631 is rendered non-conductive until the magnitude of the photovoltaic output voltage V_{PV} (e.g., as determined from the photovoltaic output voltage feedback signal V_{PV-FB}) exceeds (e.g., is greater than) a measurement threshold V_{TH-M} (e.g., approximately 0.05 V). For example, the control circuit 650 may be configured to use a hardware comparator circuit to determine when the magnitude of the photovoltaic output voltage V_{PV} is greater than the measurement threshold V_{TH-M}. In some examples, the control circuit 650 may be configured to determine when the magnitude of the photovoltaic output voltage V_{PV} is greater than the measurement threshold V_{TH-M} by sampling the magnitude of the photovoltaic output voltage V_{PV} and comparing the magnitude of the photovoltaic output voltage V_{PV} to the measurement threshold V_{TH-M} in software. The control circuit 650 may be configured to calculate the short-circuit current I_{SC} of the solar cells 610 based on the charging time period T_{CHARGE}, the measurement threshold V_{TH-M}, and a capacitance CIN of the input capacitor C621, e.g.,

$${I}_{SC} = {C}_{IN} \cdot ( {V}_{TH - M} / {T}_{CHARGE} ) .$$

The control circuit 650 may be configured to use a look-up table stored in memory to determine the present light level L_{SUN-PRES} (e.g., in units of, for example, lux and/or foot-candles) based on the short-circuit current I_{SC} of the solar cells 610. In some examples, the control circuit 650 may be configured to measure the charging time period T_{CHARGE} multiple times using different values for the measurement threshold V_{TH-M} and to determine the average value of the short-circuit current I_{SC} as calculated at the different values for the measurement threshold V_{TH-M}. As described in more detail below, the control circuit 650 of the solar power system 600 may be configured to record and/or collect solar data regarding the operation of the solar power system 600. The solar data may comprise one or more performance values (e.g., measured and/or calculated values) recorded by the motor drive unit and/or the bottom bar module, and/or one or more operational characteristics (e.g., controlled settings and/or parameters) of the motor drive unit and/or the bottom bar module. For example, the control circuit 650 of the solar power system 600 may be configured to store in memory the performance values and/or the operational characteristics of the solar data periodically (e.g., at a timing interval T_{TIM}).

In some examples, the control circuit 650 of the solar power system 600 may be configured to determine the short-circuit current I_{SC} of the solar cells 610 by sampling the magnitude of the photovoltaic output voltage V_{PV}. For example, after controlling the first MPPT drive signal V_{MPPT-DR1} to render the first FET Q631 of the solar power management circuit 620 conductive for the discharge period T_{DC}, the control circuit 650 be configured to control the first MPPT drive signal V_{MPPT-DR1} to render the first FET Q631 non-conductive, such that the solar cells 610 may conduct the photovoltaic output current I_{PV} into the input capacitor C621 (e.g., which may appear as a short circuit to the solar cells 610 since the magnitude of the photovoltaic output voltage V_{PV} is approximately zero volts). The control circuit 650 may be configured to measure (e.g., sample) the magnitude of the photovoltaic output voltage V_{PV} after a predetermined time period T_{PRE} from when the first FET Q631 of the solar power management circuit 620 is rendered non-conductive. The control circuit 650 may be configured to calculate the short-circuit current I_{SC} of the solar cells 610 based on a sampled magnitude of the photovoltaic output voltage V_{PV}, the predetermined time period T_{PRE}, and the capacitance CIN of the input capacitor C621, e.g.,

$${I}_{SC} = {C}_{IN} \cdot ( {V}_{PV - S} / {T}_{PRE} ) .$$

The control circuit 650 may be configured to use a look-up table stored in memory to determine the present light level L_{SUN-PRES} (e.g., in units of, for example, lux and/or foot-candles) based on the short-circuit current I_{SC} of the solar cells 610. In some examples, the control circuit 650 may be configured to measure the charging time period T_{CHARGE} multiple times using different values for the predetermined time period T_{PRE} and to determine the average value of the short-circuit current I_{SC} as calculated at the different values for the predetermined time period T_{PRE}.

As described in more detail below, the control circuit 650 of the solar power system 600 may be configured to record and/or collect solar data regarding the operation of the solar power system 600. The solar data may comprise one or more performance values (e.g., measured and/or calculated values) recorded by the motor drive unit and/or the bottom bar module, and/or one or more operational characteristics (e.g., controlled settings and/or parameters) of the motor drive unit and/or the bottom bar module. For example, the control circuit 650 of the solar power system 600 may be configured to store in memory the performance values and/or the operational characteristics of the solar data periodically (e.g., at a timing interval T_{TIM}).

The control circuit 650 of the solar power system 600 may be configured to transmit one or more of the performance values and/or operational characteristics of the solar data to the control circuit of the motor drive unit, and vice versa (e.g., as will be described in greater detail below). For instance, the control circuit 650 of the solar power system 600 may be configured to transmit the solar data when the bottom bar is docked with the motor drive unit. For example, the control circuit 650 may be configured to transmit, to the motor drive unit, messages including indications of measurements of the magnitude of the photovoltaic output voltage V_{PV} generated by the solar cells 610, the magnitude of the first storage voltage V_{S-A} generated across the energy storage element of the motor drive unit, and/or the magnitude of the second storage voltage V_{S-B} generated across the energy storage element 640. In addition, the control circuit 650 may be configured to transmit, to the motor drive unit, messages including indications of calculated values, such as the charge Q_{SOLAR} and/or the solar energy E_{SOLAR} received from the solar cells 610 during one or more accumulation intervals T_{ACC}, and/or the charge Q_{CHRG} and/or the energy E_{CHRG} transferred to the energy storage element of the motor drive unit during one or more of the charging events. Further, the control circuit 650 may be configured to transmit, to the motor drive unit, messages including indications of operational characteristic of the solar cell management circuit 620 and/or the charging circuit 660.

FIG. 17B is a schematic view of a portion of an example motor drive unit 710 (e.g., the motor drive units 156, 250, 350, 410, 510) of a motorized window treatment (e.g., the motorized window treatments 150, 200, 300, 400, 500). The motorized window treatment may comprise a covering material (e.g., the covering materials 152, 230, 330) and a bottom bar (e.g., the bottom bars 240, 340) connected to a bottom end of the covering material. The motor drive unit may be configured to adjust a present position P_{PRES} of the bottom bar (e.g., the covering material) between a raised position P_{RAISED} (e.g., a fully-raised position and/or a fully-open position) and a lowered position P_{LOWERED} (e.g., a fully-lowered position and/or a fully-closed position). The bottom bar may comprise a bottom bar module (e.g., the bottom bar modules 440, 540) that include a solar power system (e.g., the solar power systems 441, 541, 600) for harvesting power (e.g., solar power) from sunlight shining through a window and charging an energy storage element 730 of the motor drive unit 710. The bottom bar module (e.g., the solar power system) may comprise one or more solar cells (e.g., the solar cells 270, 370, 442, 542, 610) connected to a rear surface of the bottom bar for receiving the sunlight through the window. For example, the motorized window treatment system may comprise a dock (e.g., the docks 280, 380), and the motor drive unit may be configured to control the covering material to dock the bottom bar with the motor drive unit 710.

The motor drive unit 710 may comprise a motor 712 (e.g., a direct-current motor) that may be coupled to the roller tube for rotating the roller tube. The motor drive unit 710 may include a motor drive circuit 714 (e.g., an H-bridge drive circuit) that may generate a pulse-width modulated (PWM) voltage V_{PWM} for driving the motor 712. For example, the motor drive circuit 714 may comprise an H-bridge drive circuit and/or an H-bridge controller (e.g., an integrated circuit) for controlling the H-bridge drive circuit to generate the PWM voltage V_{PWM} across the motor 712. The motor drive circuit 714 may receive a first storage voltage V_{S-A} produced across the energy storage element 730 of the motor drive unit 710 (e.g., the energy storage elements 430, 530 of the motor drive units 410, 510, 510′). For example, the energy storage element 730 may comprise one or more individual storage elements electrically coupled in parallel. The individual storage elements of the energy storage element 730 may comprise, for example, one or more one or more of supercapacitors and/or rechargeable batteries, such as, lithium iron phosphate (LiFePO4 or LFP) batteries (e.g., six LFP batteries). For example, the energy storage element 730 may comprise a first set of three LFP batteries coupled in parallel and a second set of three LFP batteries coupled in parallel, where the first set of LFP batteries may be coupled in series with the second set of LFP batteries (e.g., in a 2S3P battery configuration). Each of the LFP batteries may have a rated maximum voltage of approximately 3.6 volts, such the energy storage element 730 (e.g., the 2S3P battery configuration) has a rated maximum voltage of approximately 7.2 volts. In some examples, the energy storage element 730 may be external to the motor drive unit 710 (e.g., external to an enclosure of the motor drive unit 710, such as the enclosure 252 of the motor drive unit 250).

The motor drive unit 710 may include a control circuit 720 (e.g., the control circuits 420, 520, 520a of the motor drive units 410, 510, 510′ and/or the control circuit 520b of the dock module 504) for controlling the operation of the motor 712. The control circuit 720 may include, for example, a microprocessor, a programmable logic device (PLD), a microcontroller, an application specific integrated circuit (ASIC), a field-programmable gate array (FPGA), or any suitable processing device or control circuit. The control circuit 720 may include instructions (e.g., software instructions) that configure the control circuit 720 to generate at least one drive signal for controlling the motor drive circuit 714 (e.g., such as the one or more drive signals VDR generated by the control circuits 420, 520, 520a). The motor drive circuit 714 may be configured to control the rotational speed and the direction of rotation of the motor 712 in response to the drive signal VDR. The control circuit 720 may be configured to control the motor drive circuit 714 to rotate the motor 712 to adjust a present position P_{PRES} of the covering material (e.g., of the bottom bar). The motor drive unit 710 may be configured to control the covering material between a raised position P_{RAISED} (e.g., a fully-raised position and/or a fully-open position) and a lowered position P_{LOWERED} (e.g., a fully-lowered position and/or a fully-closed position). The control circuit 720 may be configured to set limits (e.g., an upper limit position P_{UP-LIMIT} and a lower limit position PLO-LIMIT) for limiting a range across which the present position P_{PRES} of the covering material may be adjusted (e.g., to be less than a full range between the raised position P_{RAISED} and lowered position P_{LOWERED}. In some examples, the control circuit 720 may be configured to keep track of a present time (e.g., an actual time) using a timeclock. For example, the timeclock may be implemented as an internal circuit of the control circuit 720 or as an external integrated circuit (IC). The present time indicated by the timeclock may represent, for example, a time of day, a week of the year, a month of the year, a day of the week, a day of the month, and/or a day of the year.

The motor drive unit 710 may include a communication circuit 722 that may allow the control circuit 720 to communicate (e.g., transmit and/or receive) messages (e.g., digital messages). For example, the communication circuit 722 may comprise one or more wired communication circuits and/or wireless communication circuits configured to transmit messages via signals, e.g., wired signals and/or wireless signals, such as radio-frequency (RF) signals. For example, the one or more wireless communication circuits of the communication circuit 722 may include for example, one or more a radio-frequency (RF) transceivers coupled to a respective antenna for transmitting and/or receiving RF signals. For example, the control circuit 720 may be configured to communicate messages via the RF signals via the one or more wireless communication circuits using a wireless communication protocol (e.g., a proprietary RF protocol, such as the CLEAR CONNECT protocol (e.g., CLEAR CONNECT TYPE A and/or CLEAR CONNECT TYPE X protocols), and/or a standard protocol, such as one of WIFI, cellular (e.g., 3G, 4G LTE, 5G NR, or other cellular protocol), BLUETOOTH, BLUETOOTH LOW ENERGY (BLE), ZIGBEE, Z-WAVE, THREAD, KNX-RF, ENOCEAN RADIO protocols, or a different standard protocol). In addition, the one or more wireless communication circuits of the communication circuit 722 may also include an RF transmitter for transmitting RF signals, an RF receiver for receiving RF signals, or an infrared (IR) transmitter and/or receiver for transmitting and/or receiving IR signals. The one or more wireless communication circuits of the communication circuit 722 may be capable of performing communication via the same communication channels or different communication channels. In some examples, the communication circuit 722 may be configured to communicate via a network, such as a wireless or wired local area network (LAN), e.g., for access to the Internet. In addition, the communication circuit 722 may be configured to communicate via a control network (e.g., a wired or wireless control communication link). The one or more wired communication circuits and/or wireless communication circuits of the communication circuit 722 may be implemented as an internal circuit of the control circuit 520 or as an external integrated circuit (IC). In some examples, the control circuit 720 may be configured to synchronize the timeclock with a timeclock of an external device (e.g., the system controller 110 and/or the remote services 164) in response to a message received (e.g., periodically received) via the communication circuit 722.

While not shown in FIG. 17B, the motor drive unit 710 may comprise other functional circuits (e.g., low-voltage circuitry). For example, the motor drive unit 710 may comprise a memory (e.g., the memory of the motor drive units 410, 510) communicatively coupled to the control circuit 720 for the storage and/or retrieval of, for example, operational settings of the motor drive unit 710, and/or software for execution by the control circuit 720 to operate the motor drive unit 710 as described herein. The memory may be implemented as an internal circuit of the control circuit 720 or as an external integrated circuit (IC). In addition, the motor drive unit 710 may comprise a rotational position sensing circuit (e.g., the rotational position sensing circuits 416, 516) that may generate one or more rotational position sensing signals (e.g., the rotational position sensing signals V_{PS1}, V_{PS2}) that allow the control circuit 720 to determine the rotational speed and/or the direction of rotation of the motor 712 to the control circuit 720. Further the motor drive unit 710 may comprise a user interface circuit (e.g., the user interface circuits 424, 524) to allow the control circuit 720 to receive user inputs and/or to provide feedback to a user of the motorized window treatment.

The motor drive unit 710 may comprise a power supply 732 configured to receive the first storage voltage V_{S-A} from the energy storage element 730 and generate one or more supply voltages for powering the electrical circuitry of the motor drive unit 710. For example, the power supply 732 may be configured to generate a low-voltage supply voltage V_{CC-A} (e.g., having a magnitude of approximately 3.3 V) for powering the one or more low-voltage electrical loads of the motor drive unit 710, such as, the control circuit 720, the memory, the communication circuit 722, the user interface circuit, and/or other low-voltage circuitry of the motor drive unit 710. For example, the power supply 732 may comprise a buck converter circuit for generating the low-voltage supply voltage V_{CC-A}.

The motor drive unit 710 may further comprise a first sense circuit 740 (e.g., the first sense circuit 531) coupled between the energy storage element 730 and the motor drive circuit 714. The first sense circuit 740 may be configured to sense a magnitude of a first load current I_{LOAD1} conducted from the energy storage element 730 by the motor drive circuit 714 and generate a first current sense signal V_{I-SNS1} that may be received by the control circuit 720 and may indicate the magnitude of the first load current I_{LOAD1}. The first sense circuit 740 may comprise a sense resistor R741 coupled in series between energy storage element 730 and the motor drive circuit 714 for conducting the first load current I_{LOAD1}. For example, the sense resistor R741 may have a resistance R_{SNS1} of approximately 100 mΩ. The sense resistor R741 may be configured to generate a first sense voltage V_{SNS1}, which may have a magnitude that indicates (e.g., is proportional to) the magnitude of the first load current I_{LOAD1}. The first sense circuit 740 may comprise a capacitor C742 (e.g., having a capacitance of approximately 1 μF) coupled between one side of the sense resistor R741 (e.g., the side coupled to the energy storage element 730) and circuit common. The first sense circuit 740 may comprise a capacitor C743 (e.g., having a capacitance of approximately 1 μF) coupled between the other side of the sense resistor R741 (e.g., the side coupled to the motor drive circuit 714) and circuit common. The first sense circuit 740 may further comprise a diode D744 coupled in parallel with the sense resistor R741 for limiting the magnitude of the first sense voltage V_{SNS1} to a rated forward voltage of the diode D744 (e.g., approximately 1.0 V).

The first sense circuit 740 may comprise a current-sense amplifier circuit 750 (e.g., an integrated circuit, such as part number MAX9938 manufactured by Analog Device, Inc.®). The current-sense amplifier circuit 750 may comprise first and second input terminals 751, 752, an output terminal 753, and a ground terminal 754 (e.g., which may be coupled to circuit common). The first sense voltage V_{SNS1} generated across the sense resistor R741 may be coupled to the first and second input terminals 751, 752 of the current-sense amplifier circuit 750 via an input filter circuit that includes a resistor R744 (e.g., have a resistance of approximately 240Ω) and a capacitor C745 (e.g., having a capacitance of approximately 10 μF). The current-sense amplifier circuit 750 may comprise an operational amplifier U755 and a FET Q756 (e.g., p-channel FET). The current-sense amplifier circuit 750 may also comprise a first input resistor R757 coupled between a non-inverting input of the operational amplifier U755 and the first input terminal 751, and a second input resistor R758 coupled between an inverting input of the operational amplifier U755 and the second input terminal 752. For example, both of the input resistors R757, R758 may have a resistance R_{IN1} of approximately 400Ω. An output of the operational amplifier U755 may be coupled to a gate of the FET Q756. The FET Q756 (e.g., the drain-source channel of the FET Q756) may be coupled between the inverting input of the operational amplifier U755 and the output terminal 753 of the current-sense amplifier circuit 750. The current-sense amplifier circuit 750 may further comprise a resistor R759 coupled between the output terminal 753 and the ground terminal 754 (e.g., circuit common). For example, the output resistor 759 may have an output resistance R_{OUT1} of approximately 10 kΩ. The current-sense amplifier circuit 750 may be characterized by a gain β_{AMP1} that is based on the resistance R_{SNS1} of the sense resistor R741, the input resistance R_{IN1} of the input resistors R757, R758, and the output resistance R_{OUT1} of the output resistor R759 (e.g., β_{AMP1}=R_{SNS1}·R_{OUT1}·R_{IN1}).

The first sense circuit 740 may further comprise an output filter circuit including a resistor R747 (e.g., having a resistance of approximately 1 MΩ) and a capacitor C748 (e.g., having a capacitance of approximately 2200 pF). The output filter may be coupled to the output terminal 753 of the current-sense amplifier circuit 750, such that the resistor R747 is coupled between the output terminal 753 and the capacitor C748, and the capacitor C748 may be coupled between the resistor R747 and circuit common. The first current sense signal V_{I-SNS1} may be generated at the junction of the resistor R747 and the capacitor C748 (e.g., across the capacitor C748). The first current sense signal V_{I-SNS1} may have a magnitude that indicates (e.g., is proportional to) the magnitude of the first load current I_{LOAD1} (e.g., V_{I-SNS1}=β_{AMP1}·I_{OUT1}=[R_{SNS1}·R_{OUT1}·R_{IN1}]·I_{OUT1}). The first sense circuit 740 may further comprise a diode D749 having an anode coupled to the junction of the resistor R747 and the capacitor C748 and a cathode coupled to the low-voltage supply voltage V_{CC-A}. The diode D749 may operate to prevent the magnitude of the first current sense signal V_{I-SNS1} from becoming greater than the low-voltage supply voltage V_{CC-A} plus a rated forward voltage of the diode D749 (e.g., approximately 0.4-0.6 V).

The motor drive unit 710 may further comprise a second sense circuit 760 (e.g., the second sense circuit 533) between the energy storage element 730 and the power supply 732. The second sense circuit 760 may be configured to sense a magnitude of a second load current I_{LOAD2} conducted from the energy storage element 730 by the power supply 732 and generate a second current sense signal V_{I-SNS2} that may be received by the control circuit 720 and may indicate the magnitude of the second load current I_{LOAD2}. The second sense circuit 760 may comprise a sense resistor R761 coupled in series between the energy storage element 730 and the power supply 732 for conducting the second load current I_{LOAD2}. For example, the sense resistor R761 may have a resistance R_{SNS2} of approximately 8Ω. The sense resistor R761 may be configured to generate a second sense voltage V_{SNS2}, which may have a magnitude that indicates (e.g., is proportional to) the magnitude of the second load current I_{LOAD2}. The second sense circuit 760 may comprise a capacitor C762 (e.g., having a capacitance of approximately 1 μF) coupled between one side of the sense resistor R761 (e.g., the side coupled to the energy storage element 730) and circuit common. The second sense circuit 760 may comprise a capacitor C763 (e.g., having a capacitance of approximately 1 μF) coupled between the other side of the sense resistor R761 (e.g., the side coupled the power supply 732) and circuit common. The second sense circuit 760 may further comprise a diode D764 coupled in parallel with the sense resistor R761 for limiting the magnitude of the second sense voltage V_{SNS2} to a rated forward voltage of the diode D764 (e.g., approximately 1.0 V).

The second sense circuit 760 may comprise a current-sense amplifier circuit 770 (e.g., an integrated circuit, such as part number MAX9938 manufactured by Analog Device, Inc.®). The current-sense amplifier circuit 770 may comprise first and second input terminals 771, 772, an output terminal 773, and a ground terminal 774 (e.g., which may be coupled to circuit common). The second sense voltage V_{SNS2} generated across the sense resistor R761 may be coupled to the first and second input terminals 771, 772 of the current-sense amplifier circuit 770 via an input filter circuit that includes a resistor R764 (e.g., have a resistance of approximately 240Ω) and a capacitor C765 (e.g., having a capacitance of approximately 1 μF). The current-sense amplifier circuit 770 may comprise an operational amplifier U775 and a FET Q776 (e.g., p-channel FET). The current-sense amplifier circuit 770 may also comprise a first input resistor R777 coupled between a non-inverting input of the operational amplifier U775 and the first input terminal 771, and a second input resistor R778 coupled between an inverting input of the operational amplifier U775 and the second input terminal 772. For example, both of the input resistors R777, R778 may have a resistance R_{IN2} of approximately 400Ω. An output of the operational amplifier U775 may be coupled to a gate of the FET Q776. The FET Q776 (e.g., the drain-source channel of the FET Q776) may be coupled between the inverting input of the operational amplifier U775 and the output terminal 773 of the current-sense amplifier circuit 770. The current-sense amplifier circuit 770 may further comprise a resistor R779 coupled between the output terminal 773 and the ground terminal 774 (e.g., circuit common). For example, the output resistor 779 may have an output resistance R_{OUT2} of approximately 10 kΩ. The current-sense amplifier circuit 770 may be characterized by a gain β_{AMP2} that is based on the resistance R_{SNS2} of the sense resistor R761, the input resistance R_{IN2} of the input resistors R777, R778, and the output resistance R_{OUT2} of the output resistor R779 (e.g., β_{AMP2}=R_{SNS2}·R_{OUT2}·R_{IN2}).

The second sense circuit 760 may further comprise an output filter circuit including a resistor R767 (e.g., having a resistance of approximately 1 M (2) and a capacitor C768 (e.g., having a capacitance of approximately 4.7 μF). The output filter may be coupled to the output terminal 773 of the current-sense amplifier circuit 770, such that the resistor R767 is coupled between the output terminal 773 and the capacitor C768, and the capacitor C768 may be coupled between the resistor R767 and circuit common. The second current sense signal V_{I-SNS2} may be generated at the junction of the resistor R767 and the capacitor C768 (e.g., across the capacitor C768). The second current sense signal V_{I-SNS2} may have a magnitude that indicates (e.g., is proportional to) the magnitude of the second load current I_{LOAD2} (e.g., V_{I-SNS2}=β_{AMP2}·I_{OUT2}=[R_{SNS2}·R_{OUT2}·R_{IN2}]·I_{OUT2}). The second sense circuit 760 may further comprise a diode D769 having an anode coupled to the junction of the resistor R767 and the capacitor C768 and a cathode coupled to the low-voltage supply voltage V_{CC-A}. The diode D769 may operate to prevent the magnitude of the second current sense signal V_{I-SNS2} from becoming greater than the low-voltage supply voltage V_{CC-A} plus a rated forward voltage of the diode D769 (e.g., approximately 0.4-0.6 V).

The control circuit 720 may be configured to determine a total amount of power P_{LOAD-TOTAL} being consumed from the energy storage element 730 (e.g., by one or more of the electrical loads of the motor drive unit 710) in response to the first current sense signal V_{I-SNS1} and/or the second current sense signal V_{I-SNS2}. The control circuit 720 may be configured to determine (e.g., calculate), for example, a first load power P_{LOAD1} being consumed from the energy storage element 730 by the motor drive circuit 714 and/or the motor 712. The control circuit 720 may be configured to calculate the first load power P_{LOAD1} being consumed from the energy storage element 730 by the motor drive circuit 714 and/or the motor 712, for example, periodically (e.g., at a load measurement interval T_{LOAD1}). For example, the control circuit 720 may be configured to calculate the first load power P_{LOAD1} being consumed from the energy storage element 730 by the motor drive circuit 714 and/or the motor 712 based on the magnitude of the first supply voltage V_{S-A} and the magnitude of the first load current I_{LOAD1} (e.g., P_{LOAD1}=V_{S-A}·I_{LOAD1}). The control circuit 720 may be configured to store the magnitude of the first load current I_{LOAD1} and/or the first load power P_{LOAD1} in the memory, for example, periodically (e.g., at the load measurement interval T_{LOAD1} at the same time that the control circuit 720 calculates the first load power P_{LOAD1}).

In addition, the control circuit 720 may be configured to determine (e.g., calculate), for example, a second load power P_{LOAD2} being consumed from the energy storage element 730 by the power supply 732 and/or the low-voltage electrical loads that are powered by the low-voltage supply voltage V_{CC-A} (e.g., the control circuit 720, the communication circuit 722, and other low-voltage circuitry of the motor drive unit 710). The control circuit 720 may be configured to calculate the second load power P_{LOAD2} being consumed from the energy storage element 730 by the power supply 732 and/or the low-voltage electrical loads, for example, periodically (e.g., at the load measurement interval T_{LOAD1}). For example, the control circuit 720 may be configured to calculate the second load power P_{LOAD2} being consumed from the energy storage element 730 by the low-voltage electrical loads based on the magnitude of the first supply voltage V_{S-A} and the magnitude of the second load current I_{LOAD2} (e.g., P_{LOAD2}=V_{S-A}·I_{LOAD2}). The control circuit 720 may be configured to store the magnitude of the second load current I_{LOADs} and/or the second load power P_{LOADs} in the memory, for example, periodically (e.g., at the load measurement interval T_{LOAD1} at the same time that the control circuit 720 calculates the second load power P_{LOAD2}).

The control circuit 720 may be configured to determine the total power P_{LOAD-TOTAL} being consumed from the energy storage element 730 by the electrical loads of the motor drive unit 710, for example, by summing the first load power P_{LOAD1} and the second load power P_{LOAD2} (e.g., P_{LOAD-TOTAL}=P_{LOAD1}+P_{LOAD2}). The control circuit 720 may be configured to store the total power P_{LOAD-TOTAL} in the memory, for example, periodically (e.g., at the load measurement interval T_{LOAD1} at the same time that the control circuit 720 calculates the first load power P_{LOAD1} and/or the second load power P_{LOAD2}).

In addition, the control circuit 720 may also be configured to determine (e.g., calculate) and store in memory a total charge Q_{LOAD-TOTAL} and/or a total energy E_{LOAD-TOTAL} consumed from the energy storage element 730 by the electrical loads of the motor drive unit 710. The control circuit 720 may be configured to calculate the total charge Q_{LOAD-TOTAL} and/or the total energy E_{LOAD-TOTAL} consumed from the energy storage element 730 by the electrical loads of the motor drive unit 710, for example, over an accumulation interval T_{ACC} (e.g., such as a day). e.g., such as a day). As noted herein, in some examples, the accumulation interval T_{ACC} may be other time periods (e.g., multiple days, a week, multiple weeks, a month, etc.). At the end of the accumulation interval T_{ACC} (e.g., at the end of each day), the control circuit 720 may be configured to store the total charge Q_{LOAD-TOTAL} and/or the total energy E_{LOAD-TOTAL} consumed from the energy storage element 730 in the memory along with timing information (e.g., the present date). In addition, the control circuit 720 may be configured to reset the total charge Q_{LOAD-TOTAL} to zero coulombs and/or the total energy E_{LOAD-TOTAL} to zero joules at the end of the accumulation interval T_{ACC}, such that the control circuit 720 may be configured to determine the total charge Q_{LOAD-TOTAL} and/or the total energy E_{LOAD-TOTAL} consumed from the energy storage element 730 during the next accumulation interval T_{ACC}.

The control circuit 720 may be configured to calculate a first charge Q_{LOAD1} and/or a first energy E_{LOAD1} (e.g., a motor-control energy) consumed from the energy storage element 730 by the motor drive circuit 714 and/or the motor 712. The control circuit 720 may be configured to calculate the first charge Q_{LOAD1} and/or the first energy E_{LOAD1} consumed from the energy storage element 730 by the motor drive circuit 714 and/or the motor 712, for example, over the accumulation interval T_{ACC}. For example, the control circuit 720 may be configured to calculate the first charge Q_{LOAD1} and/or the energy E_{LOAD1} consumed from the energy storage element 730 by the motor drive circuit 714 and/or the motor 712 when (e.g., only when) the control circuit 720 is controlling the motor drive circuit 714 to rotate the motor 712. The control circuit 720 may be configured to calculate the first charge Q_{LOAD1} and/or the first energy E_{LOAD1} consumed from the energy storage element 730 by the motor drive circuit 714 and/or the motor 712, for example, periodically (e.g., at a load measurement interval T_{LOAD1}) when the control circuit 720 is controlling the motor drive circuit 714 to rotate the motor 712. For example, the control circuit 720 may be configured to calculate the first charge Q_{LOAD1} consumed from the energy storage element 730 by the motor drive circuit 714 and/or the motor 712 based on the first load current I_{LOAD1} (e.g., as indicated by the first current sense signal V_{I-SNS1}) and the load measurement interval T_{LOAD1}, e.g.,

$${Q}_{LOAD 1} = {Q}_{LOAD 1} + ( {I}_{LOAD 1} \cdot {T}_{LOAD 1} ) .$$

In addition, the control circuit 720 may be configured to calculate the first energy E_{LOAD1} consumed from the energy storage element 730 by the motor drive circuit 714 and/or the motor 712 based on the magnitude of the first supply voltage V_{S-A}, the magnitude of the first load current I_{LOAD1}, and the load measurement interval T_{LOAD1}, e.g.,

$${E}_{LOAD 1} = {E}_{LOAD 1} + ( {V}_{S - A} \cdot {I}_{LOAD 1} \cdot {T}_{LOAD 1} ) .$$

For example, the first charge Q_{LOAD1} and/or the first energy E_{LOAD1} consumed from the energy storage element 730 by the motor drive circuit 714 and/or the motor 712 may represent the charge and/or energy required to operate the motor 712 to move the covering material over the course of a day.

The control circuit 720 may be configured to calculate a second charge Q_{LOAD2} and/or a second energy E_{LOAD2} (e.g., a low-voltage-load energy) consumed from the energy storage element 730 by the power supply 732 and/or the low-voltage electrical loads that are powered by the low-voltage supply voltage V_{CC-A} (e.g., the control circuit 720, the communication circuit 722, and other low-voltage circuitry of the motor drive unit 710). The control circuit 720 may be configured to calculate the second charge Q_{LOAD2} and/or the second energy E_{LOAD2} consumed from the energy storage element 730 by the power supply 732 and/or the low-voltage electrical loads, for example, over the accumulation interval T_{ACC}. The control circuit 720 may be configured to calculate the second charge Q_{LOAD2} and/or the second energy E_{LOAD2} consumed from the energy storage element 730 by the power supply 732 and/or the low-voltage electrical loads, for example, periodically (e.g., at a load measurement interval T_{LOAD2}) during the length (e.g., the entire length) of the accumulation interval T_{ACC}. For example, the control circuit 720 may be configured to calculate the second charge Q_{LOAD2} consumed from the energy storage element 730 by the power supply 732 and/or the low-voltage electrical loads based on the second load current I_{LOAD2} (e.g., as indicated by the second current sense signal V_{I-SNS2}) and the load measurement interval T_{LOAD2}, e.g.,

$${Q}_{LOAD 2} = {Q}_{LOAD 2} + ( {I}_{LOAD 2} \cdot {T}_{LOAD 2} ) .$$

In addition, the control circuit 720 may be configured to calculate the second energy E_{LOAD2} consumed from the energy storage element 730 by the power supply 732 and/or the low-voltage electrical loads based on the magnitude of the first supply voltage V_{S-A}, the magnitude of the second load current I_{LOAD2}, and the load measurement interval T_{LOAD2}, e.g.,

$${E}_{Load 2} = {E}_{LOAD 2} + ( {V}_{S - A} \cdot {I}_{LOAD 2} \cdot {T}_{LOAD 2} ) .$$

Since the operation of the control circuit 720 and/or the communication circuit 722 to transmit wireless signals provides the greatest load on the energy storage element 730 by the low-volage electrical loads of the motor drive unit 710, the second charge Q_{LOAD2} and/or the second energy E_{LOAD2} consumed from the energy storage element 730 by the low-voltage electrical loads of the motor drive unit 710 may represent the charge and/or energy required to operate transmit and receive wireless signals (e.g., provide RF communication) over the course of a day.

In typical scenarios, the second charge Q_{LOAD2} and/or the second energy E_{LOAD2} consumed from the energy storage element 730 by the low-voltage electrical loads of the motor drive unit 710 may be substantially constant across the course of a day. In some examples, the control circuit 720 may be configured to calculate a partial second charge Q_{LOAD2-P} and/or a partial second energy E_{LOAD2-P} consumed from the energy storage element 730 by the power supply 732 and/or the low-voltage electrical loads during (e.g., only during) a portion of the accumulation interval T_{ACC}, such during a measurement window T_{WIN} (e.g., approximately 1 hour), and apply the partial second charge Q_{LOAD2-P} and/or the partial second energy E_{LOAD2-P} over the rest of the day. The control circuit 720 may be configured to calculate the partial second charge Q_{LOAD2-P} and/or the partial second energy E_{LOAD2-P} consumed from the energy storage element 730 by the power supply 732 and/or the low-voltage electrical loads, for example, periodically (e.g., at the load measurement interval T_{LOAD2}) during the measurement window T_{WIN}.

For example, the control circuit 720 may be configured to calculate the partial second charge Q_{LOAD2-P} consumed from the energy storage element 730 by the motor drive circuit 714 and/or the motor 712 during the measurement window T_{WIN} based on the second load current I_{LOAD2} (e.g., as indicated by the second current sense signal V_{I-SNS2}) and the load measurement interval T_{LOAD2}, e.g.,

$${Q}_{LOAD 2 - P} = {Q}_{LOAD 2 - P} + ( {I}_{LOAD 2} {T}_{LOAD 2} ) .$$

The control circuit 720 may be configured to calculate the second charge Q_{LOAD2} consumed from the energy storage element 730 by the power supply 732 and/or the low-voltage electrical loads over the accumulation interval T_{ACC}, for example, based on the partial second charge Q_{LOAD2-P}, the accumulation interval T_{ACC}, and the measurement window T_{WIN}, e.g.,

$${Q}_{LOAD 2} = ( {T}_{ACC} / {T}_{WIN} ) \cdot {Q}_{LOAD 2 - P .}$$

In addition, the control circuit 720 may be configured to calculate the partial second energy E_{LOAD2-P} consumed from the energy storage element 730 by the power supply 732 and/or the low-voltage electrical loads during the measurement window T_{WIN} based on the magnitude of the first supply voltage V_{S-A}, the magnitude of the second load current I_{LOAD2}, and the load measurement interval T_{LOAD2}, e.g.,

$${E}_{Load 2} = {E}_{LOAD 2} + ( {V}_{S - A} \cdot {I}_{LOAD 2} \cdot {T}_{LOAD 2} ) .$$

The control circuit 720 may be configured to calculate the second energy E_{LOAD2} consumed from the energy storage element 730 by the power supply 732 and/or the low-voltage electrical loads over the accumulation interval T_{ACC}, for example, based on the partial second energy E_{LOAD2-P}, the accumulation interval T_{ACC}, and the measurement window T_{WIN}, e.g.,

$${E}_{LOAD 2} = ( {T}_{ACC} / {T}_{WIN} ) \cdot {E}_{LOAD 2 - P .}$$

As previously mentioned, the second charge Q_{LOAD2} and/or the second energy E_{LOAD2} consumed from the energy storage element 730 by the low-voltage electrical loads of the motor drive unit 710 may represent the charge and/or energy required to operate transmit and receive wireless signals (e.g., provide RF communication) over the course of a day.

The control circuit 720 may be configured to determine (e.g., calculate) the total charge Q_{LOAD-TOTAL} and/or the total energy E_{LOAD-TOTAL} consumed from the energy storage element 730 by the electrical loads of the motor drive unit 710 during the accumulation interval T_{ACC}, for example, based the first charge Q_{LOAD1}, the second charge Q_{LOAD2}, the second energy E_{LOAD2}, and/or the second energy E_{LOAD2}. For example, the control circuit 720 may be configured to calculate the total charge Q_{LOAD-TOTAL} consumed from the energy storage element 730 during the accumulation interval T_{ACC} by summing the first charge Q_{LOAD1} and the second charge Q_{LOAD2} (e.g., Q_{LOAD-TOTAL}=Q_{LOAD1}+Q_{LOAD2}). In addition, the control circuit 720 may be configured to calculate the total energy E_{LOAD-TOTAL} consumed from the energy storage element 730 during the accumulation interval T_{ACC} by summing the first energy E_{LOAD1} and the second energy E_{LOAD2} (e.g., E_{LOAD-TOTAL}=E_{LOAD1}+E_{LOAD2}). At the end of the accumulation interval T_{ACC} (e.g., at the end of each day), the control circuit 720 may be configured to store the total charge Q_{LOAD-TOTAL} and/or the total energy E_{TOTAL} consumed from the energy storage element 730 during the accumulation interval T_{ACC} in the memory along with timing information (e.g., the present date). In addition, the control circuit 720 may be configured to reset the total charge Q_{LOAD-TOTAL} to zero coulombs and/or the total energy E_{LOAD-TOTAL} to zero joules at the end of the accumulation interval T_{ACC}, such that the control circuit 720 may be configured to determine the total charge Q_{LOAD-TOTAL} and/or the total energy E_{LOAD-TOTAL} consumed by the electrical loads of the motor drive unit 710 during the next accumulation interval T_{ACC}.

In some examples, the motor drive unit 710 may be a part of a base assembly of the motorized window treatment (e.g., the base assembly 502 of the motorized window treatment system 500′). The base assembly of the motorized window treatment may also include a dock module (e.g., the dock module 504), which may be a part of the dock of the motorized window treatment and may, in some examples, include one or more of the components of the motor drive unit 710 as shown in FIG. 17B. For example, the energy storage element 730 may be included in the dock module (e.g., rather than in the motor drive unit 710). In addition, the first sense circuit 740 and/or the second sense circuit 760 may be included in the dock module (e.g., rather than in the motor drive unit 710). Further, one or more of the functions and/or procedures executed by the control circuit 720 of the motor drive unit 710 as described above may be executed by a control circuit of the dock module.

As described herein, a motorized window treatment (e.g., the motorized window treatments of the embodiments shown in FIGS. 1-15B) may comprise a covering material (e.g., the covering materials 152, 230, 330) configured to cover an opening, such as a window, and a bottom bar (e.g., the bottom bars 155, 240, 340) connected to a bottom end of the covering material. The motorized window treatment may further comprise a base assembly (e.g., the base assembly 502) that includes a motor drive unit (e.g., the motor drive units 156, 250, 350, 410, 510, 510′, 710). In some examples, the base assembly may also comprise a dock module (e.g., the dock module 504). For example, the motor drive unit of the base assembly may be configured to adjust a present position P_{PRES} of the bottom bar (e.g., the covering material) between a raised position P_{RAISED} (e.g., a fully-raised position and/or a fully-open position as shown in FIG. 3) and a lowered position P_{LOWERED} (e.g., a fully-lowered position and/or a fully-closed position as shown in FIG. 2). The base assembly (e.g., the motor drive unit and/or the dock module) may comprise a control circuit (e.g., the control circuits 420, 520, 520a, 520b) configured to control a motor (e.g., the motors 412, 512) for adjusting the position of the bottom bar (e.g., the covering material) and an energy storage element (e.g., the energy storage elements 430, 530) for powering the motor and the control circuit.

The bottom bar may comprise a bottom bar module (e.g., the bottom bar modules 440, 540) that includes a solar power system (e.g., the solar power systems 441, 541, 600) for harvesting power (e.g., solar power) from sunlight that may shin through the window and charging the energy storage element of the base assembly (e.g., the motor drive unit and/or the dock module). The bottom bar module may comprise a control circuit (e.g., the control circuits 450, 550, 650) configured to control the operation of the bottom bar module (e.g., the solar power system). The bottom bar module (e.g., the solar power system) may comprise one or more solar cells (e.g., the solar cells 270, 370, 442, 542, 610) connected to a rear surface of the bottom bar for receiving the sunlight through the window. The bottom bar module (e.g., the solar power system) may comprise an energy storage element (e.g., the energy storage elements 446, 546, 640) and a solar power management circuit (e.g., the solar power management circuits 444, 544, 620) for charging the energy storage element of the bottom bar module from the solar cells. In some examples, the bottom bar module (e.g., the solar power system) may comprise a charging circuit (e.g., the charging circuits 547, 660) for charging the energy storage element of the base assembly (e.g., the motor drive unit and/or the dock module) from the energy storage element of the bottom bar module.

The dock module of the base assembly of the motorized window treatment may be located in and/or on a dock (e.g., the docks 280, 380). The dock module may be electrically coupled to the motor drive unit. The base assembly (e.g., the motor drive unit and/or the dock module) may be configured to control the covering material to the raised position to dock the bottom bar, such that the motor drive unit is electrically connected to the bottom bar module. When the bottom bar is docked with the base assembly (e.g., the motor drive unit and/or the dock module), the solar power system (e.g., the charging circuit) may be able to charge the energy storage element of the base assembly from the energy storage element of the bottom bar module.

The control circuit of the base assembly (e.g., the motor drive unit and/or the dock module) and/or the control circuit of the bottom bar module may be configured to record and/or collect solar data regarding the operation of the solar power system of the motorized window treatment. The solar data may comprise one or more performance values (e.g., measured and/or calculated values) recorded by the base assembly and/or the bottom bar module, and/or one or more operational characteristics (e.g., controlled settings and/or parameters) of the motor drive unit and/or the bottom bar module. For example, the control circuit of the base assembly and/or the control circuit of the bottom bar module may be configured to store in memory the performance values and/or the operational characteristics of the solar data periodically (e.g., at a timing interval T_{TIM}). The control circuit of the bottom bar module may be configured to transmit one or more of the performance values and/or operational characteristics of the solar data to the control circuit of the base assembly, and vice versa (e.g., as will be described in greater detail below).

For example, the performance values included in the solar data may comprise include measured values, such as, measurements of one or more of the following. The performance values may include a magnitude of a photovoltaic output voltage V_{PV} of the solar cells (e.g., the photovoltaic output voltage V_{PV} generated by the solar cells 442, 542, 610). The performance values may include a magnitude of a first storage voltage V_{S-A} stored in the energy storage element of the base assembly (e.g., the magnitude of the first storage voltage V_{S-A} stored in the energy storage elements 430, 530). The performance values may include a magnitude of a second storage voltage V_{S-B} stored in the energy storage elements of the bottom bar module (e.g., the magnitude of the second storage voltage V_{S-B} stored in the energy storage elements 446, 546, 640). The performance values may include a present light level L_{SUN-PRES} of the sunlight shining onto the solar cells (e.g., the solar cells 442, 542, 610) and/or an ambient light level (e.g., the ambient light level L_{AMB} measured by the sensor circuits 454, 554). The performance values may include other measured values (e.g., measurements) of the base assembly and/or the bottom bar module.

In addition, the operational characteristics included in the solar data may comprise control parameters, such as one or more of one or more drive signals for controlling the operation of respective circuits of the base assembly and/or bottom bar module. For example, the operational characteristics included in the solar data may comprise one or more of the following. The operational characteristics included in the solar data may include an operating frequency of a drive signal (e.g., the operating frequency f_{MPPT} of the respective MPPT drive signals V_{MPPT-DR}, V_{MPPT-DR1}, V_{MPPT-DR2}, and/or the charge drive signals V_{CHRG-DR}). The operational characteristics included in the solar data may include an operating period of a drive signal (e.g., the operating period T_{MPPT} of the respective MPPT drive signals V_{MPPT-DR}, V_{MPPT-DR1}, V_{MPPT-DR2}, and/or the charge drive signals V_{CHRG-DR}). The operational characteristics included in the solar data may include an on time of a drive signal (e.g., the on time T_{MPPT-ON}, T_{MPPT-ON1}, T_{MPPT-ON2}, of the respective MPPT drive signals V_{MPPT-DR}, V_{MPPT-DR1}, V_{MPPT-DR2}, and/or the on time T_{CHRG-ON} of the charge drive signals V_{CHRG-DR}). The operational characteristics included in the solar data may include an off time of a drive signal (e.g., the off time T_{MPPT-OFF}, T_{MPPT-OFF1}, T_{MPPT-OFF2}, of the respective MPPT drive signals V_{MPPT-DR}, V_{MPPT-DR1}, V_{MPPT-DR2}, and/or the off time T_{CHRG-OFF} of the charge drive signals V_{CHRG-DR}). The operational characteristics included in the solar data may include a duty cycle of a drive signal (e.g., the duty cycle DC_{SCM} of the internal drive signal of the solar cell management circuit 444, the duty cycles DC_{MPPT}, DC_{MPPT1}, DC_{MPPT2} of the of the respective MPPT drive signals V_{MPPT-DR}, V_{MPPT-DR1}, V_{MPPT-DR2}, and/or the duty cycle DC_{CHRG} of the charge drive signals V_{CHRG-DR}). The operational characteristics included in the solar data may include other operational characteristics of the control circuits of the base assembly and/or the bottom bar module.

The solar data may also comprise tracking information associated with each of the measurements and/or operational characteristics. For example, the tracking information may include timing information (e.g., a time stamp indicating a time and/or date at which the respective measurement and/or operational characteristic was recorded) and/or position information (e.g., the present position P_{PRES} of the covering material at the time at which the respective performance value and/or operational characteristic was recorded). Each time that the control circuit of the base assembly and/or the control circuit of the bottom bar module records the one or more performance values and/or operational characteristics, the control circuit of the base assembly and/or the control circuit of the bottom bar module may generate an entry in the solar data with the timing information and a unique index number for that entry. For example, the index number may be an integer value that starts at one and is incremented by one for each entry in the solar data. Since the control circuit of the base assembly and the control circuit of the bottom bar may be configured to record the performance value and/or operational characteristics of the solar data periodically at the timing interval T_{TIM}, the timing information of solar data may be spaced apart by the timing interval T_{TIM}.

The control circuit of the base assembly and/or the control circuit of the bottom bar module be also be configured to determine (e.g., calculate or process) one or more of the performance values of the solar data. For example, the control circuit of the base assembly and/or the control circuit of the bottom bar module may be configured to calculate performance values of the solar power system (e.g., the solar management circuit and/or the charging circuit of the bottom bar module) using one or more of the performance values and the operating characteristics of the solar data.

The control circuit of the base assembly and/or the control circuit of the bottom bar may be configured to determine (e.g., calculate) one or more performance values that indicate the performance of the solar cells of the bottom bar module. For example, the control circuit of the bottom bar may be configured to calculate the one or more performance values that indicate the performance of the solar cells based on performance values measured directly at the solar cells, performance values calculated at the control circuit of the bottom bar, and/or operational characteristics of a drive signal used to control the solar management circuit and/or the charging circuit of the bottom bar module. In addition, the control circuit of the bottom bar module may be configured to calculate the one or more performance values that indicate the performance of the solar cells based on performance values and/or operational characteristics received from the control circuit of the base assembly. Further, the control circuit of the base assembly may be configured to calculate the one or more performance values that indicate the performance of the solar cells based on performance values measured directly measured directly therein and/or performance values and/or operational characteristics received from the control circuit of the bottom bar module.

The control circuit of the base assembly and/or control circuit of the bottom bar may be configured to determine (e.g., calculate), for example, an average magnitude I_{PV-AVE} of a photovoltaic output current I_{PV} and/or a solar power P_{SOLAR} provided by the solar cells based on performance values measured directly at the solar cells, performance values calculated at the control circuit of the bottom bar, and/or operational characteristics of the MPPT drive signal(s) used to control the solar management circuit of the bottom bar module. For example, the control circuit of the base assembly and/or the control circuit of the bottom bar may be configured to calculate the average magnitude I_{PV-AVE} of the photovoltaic output current I_{PV} and/or the solar power P_{SOLAR} periodically at the timing interval T_{TIM} (e.g., at the same time that the present magnitude of the photovoltaic output voltage V_{PV} is measured and one or more present operational characteristics of the MMPT drive signal are collected).

The control circuit of the base assembly and/or control circuit of the bottom bar may be configured to calculate the average magnitude I_{PV-AVE} of the photovoltaic output current I_{PV} based on, for example, the present magnitude of the photovoltaic output voltage V_{PV} and one or more present operational characteristics of a drive signal that controls the operation of the solar power management circuit (e.g., the MPPT drive signals V_{MPPT-DR}, V_{MPPT-DR1}). For example, the control circuit 650 of the solar power system 600 shown in FIG. 17A may calculate the average magnitude I_{PV-AVE} of the photovoltaic output current I_{PV} based on the operating period T_{MPPT}, the first on time T_{MPPT-ON1} of the first MPPT drive signal V_{MPPT-DR1}, the magnitude of the photovoltaic output voltage V_{PV} (e.g., as indicated by the photovoltaic output voltage feedback signal V_{PV-FB}), and the primary magnetizing inductance L_{M} of the transformer 630, e.g.,

$${I}_{PV - AVE} = ( {V}_{PV} \cdot {T}_{MPPT - ON 1}^{2} ) / ( 2 \cdot {L}_{M} \cdot {T}_{MPPT} ) .$$

The control circuit of the base assembly and/or the control circuit of the bottom bar may be configured to store the average magnitude I_{PV-AVE} of the photovoltaic output current I_{PV} in the solar data with timing information that indicates the time at which the performance values and the operational settings used in the calculation were recorded.

The control circuit of the base assembly and/or the control circuit of the bottom bar may be configured to calculate the solar power P_{SOLAR} provided by the solar cells based on, for example, the present magnitude of the photovoltaic output voltage V_{PV} and one or more present operational characteristics of the drive signal that controls the operation of the solar power management circuit (e.g., the MPPT drive signals V_{MPPT-DR}, V_{MPPT-DR1}). For example, the control circuit 650 of the solar power system 600 shown in FIG. 17A may be configured to calculate the solar power P_{SOLAR} based on the operating period T_{MPPT}, the first on time T_{MPPT-ON1} of the first MPPT drive signal V_{MPPT-DR1}, the magnitude of the photovoltaic output voltage V_{PV} (e.g., as indicated by the photovoltaic output voltage feedback signal V_{PV-FB}), and the primary magnetizing inductance L_{M} of the transformer 630, e.g.,

$${P}_{SOLAR} = {V}_{PV} \cdot {I}_{PV - AVE} = {( {V}_{PV} \cdot {T}_{MPPT - ON 1} )}^{2} / ( 2 \cdot {L}_{M} \cdot {T}_{MPPT} ) .$$

The control circuit of the base assembly and/or the control circuit of the bottom bar may be configured to store the solar power P_{SOLAR} in the solar data with timing information that indicates the time at which the performance values and the operational settings used in the calculation were recorded.

In addition, the control circuit of the base assembly and/or the control circuit of the bottom bar may also be configured to determine (e.g., calculate) a charge Q_{SOLAR} and/or a solar energy E_{SOLAR} received from the solar cells (e.g., accumulated by the energy storage element of the bottom bar module) over an accumulation interval T_{ACC} (e.g., such as a day). The control circuit of the base assembly and/or the control circuit of the bottom bar may be configured to calculate the charge Q_{SOLAR} and/or the solar energy E_{SOLAR}, for example, periodically at the timing interval T_{TIM} (e.g., at the same time that the average magnitude I_{PV-AVE} of the photovoltaic output current I_{PV} and/or the solar power P_{SOLAR} are calculated).

The control circuit of the base assembly and/or control circuit of the bottom bar may be configured to calculate the charge Q_{SOLAR} based on, for example, the present average magnitude I_{PV-AVE} of the photovoltaic output current I_{PV} and one or more present operational characteristics of the drive signal that controls the operation of the solar power management circuit (e.g., the MPPT drive signals V_{MPPT-DR}, V_{MPPT-DR1}). For example, the control circuit 650 of the solar power system 600 shown in FIG. 17A may be configured to calculate the charge Q_{SOLAR} received from the solar cells 610 based on the average magnitude I_{PV-AVE} of the photovoltaic output current I_{PV} and the timing interval T_{TIM}, e.g.,

$${Q}_{SOLAR} = {Q}_{SOLAR} + ( {I}_{PV - AVE} \cdot {T}_{TIM} ) .$$

At the end of the accumulation interval T_{ACC} (e.g., at the end of each day), the control circuit of the base assembly and/or the control circuit of the bottom bar may be configured to store the accumulated charge Q_{SOLAR} in the solar data along with timing information that indicates the present date. In addition, the control circuit of the base assembly and/or the control circuit of the bottom bar may be configured to reset the charge Q_{SOLAR} to zero coulombs at the end of the accumulation interval T_{ACC} (e.g., to initialize calculation of the charge Q_{SOLAR} during the next accumulation interval T_{ACC}).

The control circuit of the base assembly and/or the control circuit of the bottom bar may be configured to calculate the solar energy E_{SOLAR} received from the solar cells based on, for example, one or more present operational characteristics of the drive signal that controls the operation of the solar power management circuit (e.g., the MPPT drive signals V_{MPPT-DR}, V_{MPPT-DR1}) and the present average magnitude I_{PV-AVE} of the photovoltaic output current I_{PV} and/or the present solar power P_{SOLAR}. For example, the control circuit 650 of the solar power system 600 shown in FIG. 17A may be configured to calculate the solar energy E_{SOLAR} received from the solar cells 610 based on the magnitude of the photovoltaic output voltage V_{PV} (e.g., as indicated by the photovoltaic output voltage feedback signal V_{PV-FB}), the average magnitude I_{PV-AVE} of the photovoltaic output current I_{PV}, and the timing interval T_{TIM}, e.g.,

$${E}_{SOLAR} = {E}_{SOLAR} + ( {V}_{PV} \cdot {I}_{PV - AVE} \cdot {T}_{TIM} ) .$$

In addition, the control circuit 650 of the solar power system shown in FIG. 17A may be configured to calculate the solar energy E_{SOLAR} received from the solar cells 610 based on the solar power P_{SOLAR} and the timing interval T_{TIM}, e.g.,

$${E}_{SOLAR} = {E}_{SOLAR} + ( {P}_{SOLAR} \cdot {T}_{TIM} ) .$$

At the end of the accumulation interval T_{ACC} (e.g., at the end of each day), the control circuit of the base assembly and/or the control circuit of the bottom bar may be configured to store the accumulated solar energy E_{SOLAR} in the solar data along with timing information that indicates the present date. In addition, the control circuit of the base assembly and/or the control circuit of the bottom bar may be configured to reset the solar energy E_{SOLAR} to zero coulombs at the end of the accumulation interval T_{ACC} (e.g., to initialize calculation of the solar energy E_{SOLAR} during the next accumulation interval T_{ACC}).

The control circuit of the base assembly and/or the control circuit of the bottom bar module may be configured to determine the solar power P_{SOLAR} (e.g., as received by the solar cells) with respect to a position P_{CM} of the covering material (e.g., determine a relationship between the solar power P_{SOLAR} and the position P_{CM} of the covering material). The control circuit of the base assembly and/or the control circuit of the bottom bar module may be configured to calculate the solar power P_{SOLAR} using the solar data. The control circuit of the base assembly and/or the control circuit of the bottom bar module may be configured to determine the solar power P_{SOLAR} at each of a plurality of intermediate positions between the raised position P_{RAISED} and the lowered position P_{LOWERED}. The control circuit of the base assembly and/or the control circuit of the bottom bar module may be configured to store data defining the relationship between the solar power P_{SOLAR} and the position P_{CM} of the covering material in the solar data.

The control circuit of the base assembly and/or the control circuit of the bottom bar module to measure and/or collect solar data regarding the operation of the motorized window treatment system during a configuration procedure of the motorized window treatment system. During the configuration procedure, the control circuit of the base assembly and/or the control circuit of the bottom bar module may be configured to measure and/or collect the solar data. In addition, the control circuit of the base assembly and/or the control circuit of the bottom bar module may be configured to determine the solar power P_{SOLAR} with respect to the position P_{CM} of the covering material (e.g., the relationship between the solar power P_{SOLAR} and the position P_{CM} of the covering material) during the configuration procedure. For example, the configuration procedure may be completed when the motorized window treatment system is first installed (e.g., prior to normal operation). In some examples, the control circuit of the base assembly may be configured to execute the configuration procedure in response to an actuation of one or more of the buttons of the user interface and/or a message received via the communication circuit of the base assembly, and the control circuit of the bottom bar module may be configured to execute the configuration procedure in response to a message received via the communication circuit of the bottom bar module. In addition, the control circuit of the base assembly and/or the control circuit of the bottom bar module may be configured to execute the configuration procedure during normal operation (e.g., continuously and/or periodically over time). Further, the control circuit of the base assembly and/or the control circuit of the bottom bar module may be configured to execute the configuration procedure in response to determining a change in the solar power P_{SOLAR} received by the solar cells (e.g., as compared to an expected solar power).

The control circuit of the base assembly and/or the control circuit of the bottom bar module may be configured to measure and/or collect solar data regarding the operation of the motorized window treatment system when the bottom bar is docked. For example, the control circuit of the base assembly and/or the control circuit of the bottom bar module may be configured to measure and/or collect solar data that indicates the charging of the energy storage element of the base assembly from the energy storage element of the bottom bar module when the bottom bar is docked.

The control circuit of the base assembly and/or control circuit of the bottom bar may be configured to determine (e.g., calculate), for example, an average magnitude I_{CHRG-AVE} of a charging current I_{CHRG} and/or a charging power P_{CHRG} delivered by the charging circuit of the bottom bar module to the energy storage element of the base assembly based on performance values measured directly at the solar cells, performance values calculated at the control circuit of the bottom bar, and/or operational characteristics of a charge drive signal used to control the charging circuit of the bottom bar module. For example, the control circuit of the base assembly and/or the control circuit of the bottom bar may be configured to calculate the average magnitude I_{CHRG-AVE} of the charging current I_{CHRG} and/or the charging power P_{CHRG} periodically at the timing interval T_{TIM} (e.g., at the same time that the present magnitude of the first storage voltage V_{S-A} and/or the second storage voltage V_{S-B} are measured and one or more present operational characteristics of the charge drive signal are collected).

The control circuit of the base assembly and/or control circuit of the bottom bar may be configured to calculate the average magnitude I_{CHRG-AVE} of the charging current I_{CHRG} based on, for example, the present magnitude of the first storage voltage V_{S-A} and/or the second storage voltage V_{S-B} and one or more present operational characteristics of a drive signal that controls the operation of the charging circuit (e.g., the charge drive signals V_{CHRG-DR}). For example, the control circuit 650 of the solar power system 600 shown in FIG. 17A may be configured to calculate the average magnitude I_{CHRG-AVE} of the charging current I_{CHRG} based on the operating period T_{CHRG}, the on time T_{ON} of the charge drive signal V_{CHRG-DR}, the magnitude of the first storage voltage V_{S-A} (e.g., as indicated by the first storage voltage feedback signal V_{SA-FB}), the magnitude of the second storage voltage V_{S-B} (e.g., as indicated by the second storage voltage feedback signal V_{SB-FB}), and the inductance LIND of the inductor L670, e.g.,

$${I}_{CHRG - AVE} = {( {V}_{SB} \cdot {T}_{MPPT - ON 1} )}^{2} / ( 2 \cdot {L}_{IND} \cdot {T}_{MPPT} \cdot [ {V}_{SB} - {V}_{SA} ] ) .$$

The control circuit of the base assembly and/or the control circuit of the bottom bar may be configured to store the average magnitude I_{CHRG-AVE} of the charging current I_{CHRG} in the solar data with timing information that indicates the time at which the performance values and the operational settings used in the calculation were recorded.

The control circuit of the base assembly and/or the control circuit of the bottom bar may be configured to calculate the charging power P_{CHRG} delivered to the energy storage element of the base assembly based on, for example, the present magnitude of the first storage voltage V_{S-A} and/or the second storage voltage V_{S-B} and one or more present operational characteristics of the drive signal that controls the operation of the charging circuit (e.g., the charge drive signals V_{CHRG-DR}). For example, the control circuit 650 of the solar power system 600 shown in FIG. 17A may be configured to calculate the charging power P_{CHRG} delivered to the energy storage element of the base assembly based on the operating period T_{CHRG}, the on time T_{ON} of the charge drive signal V_{CHRG-DR}, the magnitude of the first storage voltage V_{S-A} (e.g., as indicated by the first storage voltage feedback signal V_{SA-FB}), the magnitude of the second storage voltage V_{S-B} (e.g., as indicated by the second storage voltage feedback signal V_{SB-FB}), and the inductance LIND of the inductor L670, e.g.,

$${P}_{CHRG} = {V}_{SA} \cdot {I}_{CHRG - AVE} = ( {V}_{SA} \cdot {[ {V}_{SB} \cdot {T}_{MPPT - ON 1} ]}^{2} ) / ( 2 \cdot {L}_{IND} \cdot {T}_{MPPT} \cdot [ {V}_{SB} - {V}_{SA} ] ) .$$

The control circuit of the base assembly and/or the control circuit of the bottom bar may be configured to store the charging power P_{CHRG} in the solar data with timing information that indicates the time at which the performance values and the operational settings used in the calculation were recorded.

In addition, the control circuit of the base assembly and/or the control circuit of the bottom bar may also be configured to determine (e.g., calculate) a charge Q_{CHRG} and/or a solar energy E_{CHRG} transferred to (e.g., accumulated by) the energy storage element of the base assembly (e.g., when the bottom bar is docked). For example, the control circuit of the base assembly and/or the control circuit of the bottom bar may be configured to calculate the charge Q_{CHRG} and/or the energy E_{CHRG} transferred to the energy storage element of the base assembly during a single charging event when the bottom bar is docked. For example, the control circuit of the base assembly and/or the control circuit of the bottom bar may be configured to calculate and store in memory the charge Q_{CHRG} and/or the energy E_{CHRG} transferred to the energy storage element of the base assembly periodically (e.g., at the timing interval T_{TIM}) during the charging event.

The control circuit of the base assembly and/or control circuit of the bottom bar may be configured to calculate the charge Q_{CHRG} based on, for example, the present average magnitude I_{CHRG-AVE} of the charging current I_{CHRG} and one or more present operational characteristics of the drive signal that controls the operation of the charging circuit (e.g., the charge drive signals V_{CHRG-DR}). For example, the control circuit 650 of the solar power system 600 shown in FIG. 17A may be configured to charge Q_{CHRG} transferred to the energy storage element of the base assembly based on the average magnitude I_{CHRG-AVE} of the charging current I_{CHRG} and the timing interval T_{TIM}, e.g.,

$${Q}_{CHRG} = {Q}_{CHRG} + ( {I}_{CHRG - AVE} \cdot {T}_{TIM} ) .$$

At the end of the charging event (e.g., after charging of the energy storage element of the base assembly is disabled), the control circuit of the base assembly and/or the control circuit of the bottom bar may be configured to store the accumulated charge Q_{CHRG} in the solar data along with timing information that indicates the present date. In addition, the control circuit of the base assembly and/or the control circuit of the bottom bar may be configured to reset the charge Q_{CHRG} to zero coulombs at the end of the charging event (e.g., to initialize calculation of the charge Q_{CHRG} during the next charging event).

The control circuit of the base assembly and/or the control circuit of the bottom bar may be configured to calculate the energy E_{CHRG} transferred to the energy storage element of the base assembly based on, for example, one or more present operational characteristics of the drive signal that controls the operation of the solar power management circuit (e.g., the MPPT drive signals V_{MPPT-DR}, V_{MPPT-DR1}) and the present average magnitude I_{CHRG-AVE} of the charging current I_{CHRG} and/or the present charging power P_{CHRG}. For example, the control circuit 650 of the solar power system 600 shown in FIG. 17A may be configured to calculate the energy E_{CHRG} transferred to the energy storage element of the base assembly based on the magnitude of the first storage voltage V_{S-A} (e.g., as indicated by the second storage voltage feedback signal V_{SA-FB}), the average magnitude I_{CHRG-AVE} of the charging current I_{CHRG}, and the timing interval T_{TIM}, e.g.,

$${E}_{CHRG} = {E}_{CHRG} + ( {V}_{S - A} \cdot {I}_{CHRG - AVE} \cdot {T}_{TIM} ) .$$

In addition, the control circuit 650 of the solar power system shown in FIG. 17A may be configured to calculate the energy E_{CHRG} transferred to the energy storage element of the base assembly based on the charging power P_{CHRG} and the timing interval T_{TIM}, e.g.,

$${E}_{CHRG} = {E}_{CHRG} + ( {P}_{CHRG} \cdot {T}_{TIM} ) .$$

At the end of the charging event (e.g., after charging of the energy storage element of the base assembly is disabled), the control circuit of the base assembly and/or the control circuit of the bottom bar may be configured to store the accumulated energy E_{CHRG} in the solar data along with timing information that indicates the present date. In addition, the control circuit of the base assembly and/or the control circuit of the bottom bar may be configured to reset the energy E_{CHRG} to zero coulombs at the end of the charging event (e.g., to initialize calculation of the energy E_{CHRG} during the next charging event).

When the communication circuit of the bottom bar module is configured to communicate with the communication circuit of the base assembly via a wireless communication link (e.g., via RF signals using a short-range wireless communication protocol), the control circuit of the bottom bar module may be configured to periodically transmit the solar data (e.g., one or more measurements and/or operational characteristics) to the control circuit of the base assembly at a transmission rate T_{TX}. In some examples, the wireless communication link between the control circuit of the base assembly and the control circuit of the bottom bar module may be a one-way communication link (e.g., from the control circuit of the bottom bar module to the control circuit of the base assembly) to facilitate reporting of the solar data to the control circuit of the base assembly. In some examples, the communication circuit of the bottom bar module may be configured to communicate with the communication circuit of the base assembly via a wired communication link (e.g., as described herein). The control circuit of the base assembly may be configured to store the solar data received from the control circuit of the bottom bar module in the memory of the base assembly. For each of the measurements and/or operational characteristics of the solar data, the control circuit of the base assembly may be configured to add to the solar data a respective position P_{DATA} of the covering material at the time at which the solar data was received. In some examples, the control circuit may be configured to adjust the transmission rate T_{TX} of the communication circuit of the bottom bar module based on the magnitude of the second storage voltage V_{S-B} across the energy storage element. For example, the control circuit of the bottom bar module may be configured to decrease the transmission rate T_{TX} when the magnitude of the second storage voltage V_{S-B} is high, such that the control circuit of the bottom bar module transmits the solar data at a higher rate when the magnitude of the second storage voltage V_{S-B} is high than when the magnitude of the second storage voltage V_{S-B} is low.

When the communication circuit of the bottom bar module is configured to communicate with the communication circuit of the base assembly via a wired communication link (e.g., via the electrical connections of the base assembly and the bottom bar module), the control circuit of the bottom bar module may be configured to collect and store the solar data in the memory of the bottom bar module, and then transmit the solar data to the communication circuit of the base assembly via the wired communication link when the bottom bar is docked. Since the control circuit of the bottom bar module may not have access to the present position P_{PRES} of the covering material (e.g., which is maintained by the control circuit of the base assembly), the control circuit of the bottom bar module may be configured to store in the solar data timing information (e.g., a time stamp indicating a time at which the respective measurement and/or operational characteristic was recorded). After receiving the solar data from the control circuit of the bottom bar module, the control circuit of the base assembly may be determine a respective position P_{DATA} of the covering material for each of the measurements and/or operational characteristics of the solar data by comparing the respective time stamp with the record of movements of the covering material that are stored in the memory of the base assembly. In some examples, the control circuit of the bottom bar module may be configured to estimate the present position P_{PRES} of the covering material in response to the accelerometer and/or the gyroscope of a sensor circuit of the bottom bar module (e.g., the sensor circuits 454, 554) and add to the solar data a respective position P_{DATA} of the covering material at the time at which the measurement and/or operational characteristic was recorded.

The control circuit of the bottom bar module may be configured to record the measurements and/or operational characteristics of the solar data (e.g., generate an entry in the solar data) at a timing interval T_{TIM}. For example, the transmission rate T_{TX} of the communication circuit communication circuit of the bottom bar module may be equal to the timing interval T_{TIM}, such the control circuit of the bottom bar module is configured to record the measurements and/or operational characteristics of the solar data and/or transmit the measurements and/or operational characteristics of the solar data at the same time (e.g., at the timing interval T_{TIM}). The control circuit of the bottom bar module may be configured to set the timing interval T_{TIM} based on whether the covering material is moving or not. For example, the control circuit of the bottom bar module may be configured to increase the timing interval T_{TIM} when the covering material is not moving and decrease the timing interval T_{TIM} when the covering material is moving. The control circuit of the bottom bar module may be configured to set the timing interval T_{TIM} to an inactive interval value T_{INACTIVE} when the covering material is not moving and to an active interval value T_{ACTIVE} when the covering material is moving, where the inactive interval value T_{INACTIVE} is longer than the active interval value T_{ACTIVE}. For example, the control circuit of the bottom bar module may be configured to determine that the covering material is moving in response to the accelerometer and/or the gyroscope of the sensor circuit of the bottom bar module. In addition, the control circuit of the bottom bar module may be configured to determine that the covering material is moving in response to a message received from the control circuit of the base assembly (e.g., which may include an indication that the control circuit is presently moving the covering material).

As described herein, the bottom bar module may collect and store solar data (e.g., bottom bar solar data) in memory of the bottom bar module and may transmit the solar data to the base assembly. The solar data stored in memory of the bottom bar module (e.g., the bottom bar solar data) may include data that is collected by the bottom bar module. In some examples, solar data stored in memory of the bottom bar module (e.g., the bottom bar solar data) may be used to calculate the solar power P_{SOLAR} received by the solar cells.

The control circuit of the base assembly may be configured to receive the solar data from the bottom bar module (e.g., the bottom bar solar data) and reformat the solar data and/or generate additional solar data to create new solar data (e.g., base assembly solar data). For example, when the base assembly receives the solar data from the bottom bar module (e.g., the bottom bar solar data), the control circuit of the base assembly may generate a solar data structure, such as a table, using the solar data received from the bottom bar module (e.g., as will be described in greater detail below). The base assembly solar data may be generated based on the bottom bar solar data. The solar data at the base assembly (e.g., the base assembly solar data) may include a solar power P_{SOLAR} received by the solar cells of the bottom bar module, a position P_{S} of the bottom bar when the solar cells collected the respective solar power P_{SOLAR}, and a time T_{S} at which the solar cells collected the respective solar power P_{SOLAR}. For instance, as described herein, the control circuit of the base assembly may calculate the solar power P_{SOLAR} as a function of the bottom bar solar data, for example, one entry of the solar data (e.g., the magnitude of the photovoltaic output voltage V_{PV}, the magnitude of the second storage voltage V_{S-B}, and/or the duty cycle D_{CSCM} of the solar cell management circuit 444, 544 of one entry of the solar data). The control circuit of the base assembly may determine a position P_{S} of the bottom bar when the solar cells collected the respective solar power P_{SOLAR} based on the movement log that includes movement records of each respective movement of the covering material (e.g., as stored in the memory of the base assembly). In some examples, the control circuit of the base assembly may determine the position P_{S} of the bottom bar when the solar cells collected the respective solar power P_{SOLAR} based on position data from the bottom bar solar data (e.g., the position of the bottom bar when the entry of the solar data was stored by the solar cell management circuit 444, 544). The control circuit of the base assembly may determine the time T_{S} at which the solar cells collected the respective solar power P_{SOLAR} based on timing information from the bottom bar solar data (e.g., the timing information corresponding to when the entry of solar data was stored by the solar cell management circuit 444, 544).

As described in more detail herein, the control circuit of the base assembly may be configured to store and communicate solar data (e.g., the solar data structure) with one or more components of a load control system (e.g., the load control system 100). For example, the control circuit of the base assembly may transmit the solar data (e.g., the solar data structure) to a computing device of the load control system, such as a system controller (e.g., the system controller 110 of the load control system 100). In some examples, the control circuit of the base assembly may transmit the solar data to a network device (e.g., the mobile device 180) and/or a remote computing device (e.g., the remote services 164), which both may be configured to execute the operations of the system controller as described herein. For example, the system controller, the network devices, and/or the remote computing devices may be configured to receive the solar data from the base assembly and generate the solar data structure, and/or the system controller, the network devices, and/or the remote computing devices may be configured to receive the solar data structure from the base assembly and add to and/or reconfigure the solar data structure.

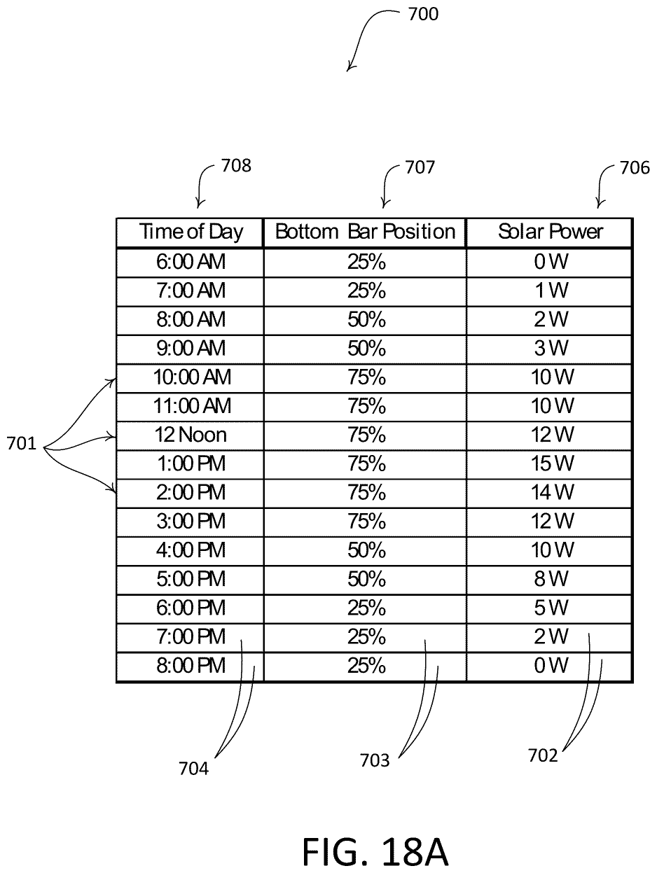

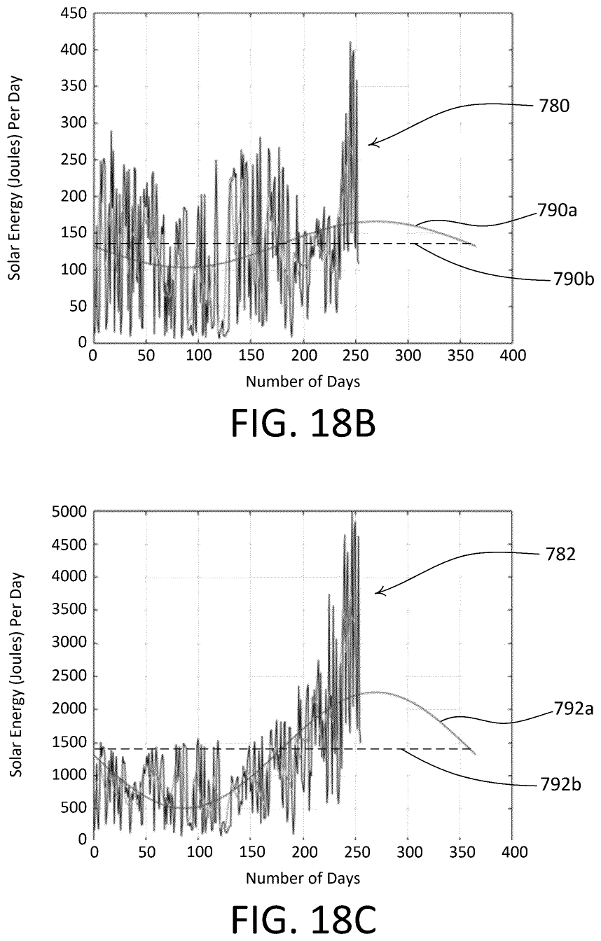

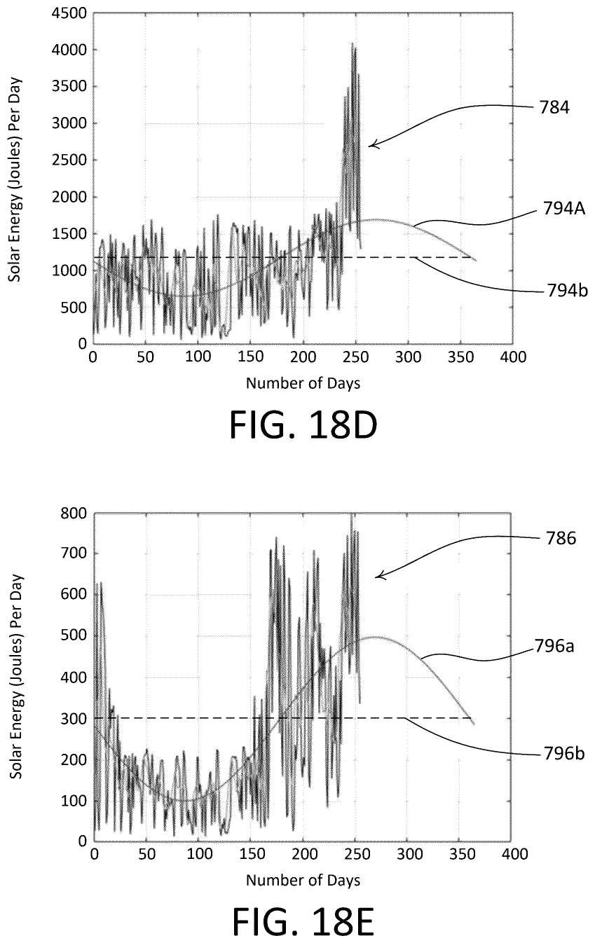

FIG. 18A illustrates an example solar data structure 700, such as a table of solar data that may be used by and/or generated by a base assembly (e.g., a motor drive unit and/or a dock module) of a motorized window treatment. For example, the solar data structure 700 may be generated by the control circuit of the base assembly based on solar data that the base assembly receives from the bottom bar module (e.g., the bottom bar solar data). The solar data structure 700 may be an example and/or a part of base assembly solar data. However, in other examples, some or all of the solar data structure 700 may be generated by the system controller, the network device, and/or the remote computing devices and, for example, the system controller, the network device, and/or the remote computing devices may send the solar data structure 700 to the base assembly. Further, as described in more detail herein, the base assembly may use the solar data structure 700 to determine where to locate the bottom bar module during subsequent movements of the bottom bar module.

The solar data structure 700 may include a plurality of records 701 (e.g., rows). Each record 701 of the solar data structure 700 may a plurality of fields. For example, the fields of each record 701 of the solar data structure 700 may comprise a solar power field 702, a position field 703, and a time field 704. The fields of each record 701 of the solar data structure 700 may be arranged into a plurality of columns, such as a solar power column 706 (e.g., which may include the solar power field 702 of each record 701), a position column 707 (e.g., which may include the position field 703 of each record 701), and a time column 708 (e.g., which may include the time field 704 of each record 701). For example, the solar power field 702 of each record 701 may be populated with a solar power P_{SOLAR} field 702, (e.g., in the solar power column 702), the position field 703 of each record 701 may be populated with a position P_{S} corresponding to the respective solar power P_{SOLAR} in the solar power field 702 (e.g., in the position column 707), and the time field 704 of each record 701 may be populated with a time T_{S} corresponding to the respective solar power P_{SOLAR} in the solar power field 702 (e.g., in the time column 708). In some examples, the solar power field may include solar data, for example, bottom bar solar data and/or base assembly solar data.

The solar power field 702 of each record 701 may indicate the solar power P_{SOLAR} received by the solar cells of the bottom bar module (e.g., in Watts). The control circuit may determine solar power P_{SOLAR} for populating the solar power field 702 of each record 701 (e.g., in the solar power column 706) of the solar data structure 700 by calculating the solar power P_{SOLAR} using one entry of the bottom bar solar data, for example, as a function of the magnitude of the photovoltaic output voltage V_{PV}, the magnitude of the second storage voltage V_{S-B}, and/or the duty cycle DC_{SCM} of the solar cell management circuit 644 of one entry of the solar data (e.g., as described above).

The time field 704 of each record 701 of the solar data structure 700 may indicate the position P_{S} of the bottom bar at which the solar cells of the bottom bar module collected the respective solar power P_{SOLAR} (e.g., in the solar power field 702 of the same record 701). The control circuit may determine the time T_{S} for the time field 704 of each record 701 (e.g., in the time column 708) of the solar data structure 700 based on the present time indicated by the timeclock. For example, when the communication circuit of the bottom bar module is configured to communicate with the communication circuit of the base assembly via a wireless communication link (e.g., as described above), the control circuit of the base assembly may be configured to set the time T_{S} for the time field 704 of the present record 701 presently being created in the solar data structure 700 to be equal to the present time (e.g., as determined from the timeclock) whenever the control circuit of the bottom bar module periodically transmits the bottom bar solar data to the control circuit of the base assembly (e.g., at a transmission rate T_{TX}).

When the communication circuit of the bottom bar module is configured to communicate with the communication circuit of the base assembly via a wired communication link (e.g., as described above), the control circuit of the base assembly may determine the time T_{S} for the time field 704 of each record 701 (e.g., in the time column 708) of the solar data structure 700 based on the timing information of the corresponding entry in the bottom bar solar data. For example, the control circuit of the bottom bar module may operate a counter, and may associate a count (e.g., a time stamp) of the counter as the timing information for each entry in the bottom bar solar data. In such examples, the control circuit of the base assembly may determine the time T_{S} (e.g., an actual time in seconds) corresponding to the solar power P_{SOLAR} (e.g., in the solar power field 702 of the same record 701) for the solar data structure 700 by converting the timing information (e.g., the count and/or time stamp) of the entry of the bottom bar solar data to a time offset (e.g., an actual time offset in seconds) and adding the time offset to the last-docking time T_{LAST-DOCK} which represents the last time that the control circuit docked the bottom bar (e.g., as determined from the timeclock and stored in the memory when the control circuit last docked the bottom bar. Additionally or alternatively, the time T_{S} corresponding to the solar data P_{SOLAR} (e.g., in the solar power field 702 of the same record 701) for the solar data structure 700 may be determined by a system controller (e.g., the system controller 110 as in FIG. 1). For example, the control circuit of the base assembly may send the timing information (e.g., count and/or the time stamp) from the entry of the bottom bar solar data and the last-docking time T_{LAST-DOCK} to the system controller, and the system controller may determine the time T_{S} corresponding to the solar data P_{SOLAR} associated with the record 701 having the solar data P_{SOLAR} in the solar power field 702 based on the timing information from the bottom bar solar data and the last-docking time T_{LAST-DOCK}, and transmit the time T_{S} corresponding to the solar data P_{SOLAR} to the control circuit of the base assembly.

While the example solar data structure 700 shows the time fields 704 of each of the records 701 as a time-of-day field (e.g., an actual time based on a 12-hour clock), the time fields 704 of each of the records 701 may be formatted to indicate any combination of a time of day, a day of the year (e.g., a date), a day of a week, a month of a year, or a year associated with the time at which the solar cells collected the respective solar power P_{SOLAR}. Further, the time fields 704 of the records 701 may comprise times T_{S} at any interval (e.g., in 15 minute increments, 30 minute increments, hour increments, etc.). In some examples, the control circuit of the base assembly may be configured to create the records 701 in the solar data structure 700, such that the time fields 704 may comprise (e.g., only comprise) times T_{S} from when sunlight is (e.g., likely to) be shining on the bottom bar, for example, when sun is likely to be shining on a façade where the motorized window treatment is installed. For example, the control circuit of the base assembly may be configured to not create records 701 for times T_{S} that are during nighttime hours (e.g., between sunset and sunrise).

The position field 703 of each record 701 of the solar data structure 700 may indicate the position P_{S} of the bottom bar at which the solar cells 642 of the bottom bar module received the respective solar power P_{SOLAR} (e.g., in the solar power field 702 of the same record 701). The control circuit may determine the position P_{S} for populating the position field 703 of each record 701 (e.g., in the position column 707) of the solar data structure 700 based on the time T_{S} of the record 701 (e.g., having the solar power P_{SOLAR} (e.g., in the solar power field 702) and the movement log that includes movement records of each respective movement of the covering material (e.g., as stored in the memory of the base assembly). The position P_{S} of the bottom bar may be expressed as a percentage. For example, the position P_{S} of the bottom bar may be 0% when the covering material is in the fully-lowered position P_{LOWERED}, and the position Pₛ of the bottom bar may be 100% when the covering material is in the fully-raised position P_{RAISED}. In addition, the position P_{S} of the bottom bar may be at a percentage between 0% and 100% when the covering material is in a position between the fully-lowered position and the fully-raised position. In other examples, the position field 703 of each record 701 of the solar data structure 700 may indicate the position P_{S} of the bottom bar using a numerical value that ranges from a first value to a second value, where each numerical value indicates a position of the covering material between the fully-lowered position and the fully-raised position.

In some examples, the solar data structure 700 may include fields that are an average of multiple fields over time. For instance, the solar power P_{SOLAR} in the solar power field 702 of each record 701 may be a rolling average (e.g., a seven-day rolling average) of solar power P_{SOLAR} at a particular position P_{S} of the bottom bar at a particular time of day (e.g., as determined from the time T_{S}). For example, the control circuit and/or the system controller may be configured to average multiple values of the solar power P_{SOLAR} over a period of time (e.g., multiple days) to generate a single value for the solar power P_{SOLAR} at a particular position P_{S} at a particular time of the day (e.g., 9 am). For example, period of time may be seven days (e.g., one week), such that the average is a seven-day rolling average. In such examples, the solar data structure 700 that is stored at the base assembly may include records 701 with solar power fields 702 that indicate the solar power P_{SOLAR} over the period of time (e.g., by storing a rolling average of multiple solar powers associated with a particular position P_{S} of the bottom bar at a particular time of day) as compared to storing individual records for multiple days of the weeks and/or tables for multiple days of the week.

The control circuit of the base assembly may dock the bottom bar, and receive the solar data from the bottom bar module (e.g., bottom bar solar data) when the bottom bar is docked (e.g., when the first, second, and third electrical connections 438a-438c, 538a-538c of the motor drive units 410, 510 and/or the dock module 504 are electrically connected to the first, second, and third electrical connections 448a-448c, 548a-548c of the bottom bar modules 440, 540, respectively). The control circuit of the base assembly may determine the last-docking time T_{LAST-DOCK} of a last docking event of the bottom bar. For example, solar data received prior to the last-docking time T_{LAST-DOCK} of the last docking event may have already been received by the base assembly (e.g., and added to the solar data structure 700). For example, the control circuit of the base assembly may step through the solar data received from the bottom bar (e.g., after the time T_{LAST-DOCK} of the last docking event) and generate a new corresponding record in the solar data structure 700. The control circuit of the base assembly may determine the position and the time associated with the solar power P_{SOLAR} received from the bottom bar module, for example by identifying a position P_{S} of the covering material at the time T_{S} associated with the solar power P_{SOLAR} based on movement records from the bottom bar solar data. The control circuit of the base assembly may store the new record in the solar data structure 700, and may then determine if there is at least one additional entry in the bottom bar solar data that can be added to the solar data structure 700. As such, the control circuit of the base assembly may generate or update the solar data structure 700 when the bottom bar is docket so that all of the new records from the bottom bar solar data (e.g., the records since the last docketing event) are added to the solar data structure 700.

As described in more detail herein, the control circuit of the base assembly may transmit the solar data structure 700 to the system controller, for example, periodically (e.g., once a week). The system controller may process the solar data (e.g., the solar data structure 700) to enable configuration and/or control of the motorized window treatment (e.g., the base assembly of the motorized window treatment), for example, and generate control and/or configuration data based on the solar data (e.g., the solar data structure 700). Further, the system controller may receive solar data structures 700 from a plurality of motorized window treatment control systems. The system controller may aggregate the solar data structures 700 and/or may send a solar data structure 700 to one or more motorized window treatments for future use. Further, in some examples, the system controller may add a second time record (e.g., column) to each record of the solar data structure 700, such that the second time record (e.g., column) includes a time associated with the time the solar data structure 700 is sent to the system controller from the base assembly. Additionally or alternatively, the system controller may store multiple solar data structures 700 such that each solar data structure 700 includes the time associated with the time the solar data structure 700 is sent to the system controller from the base assembly. The second time record (e.g., column) may include a date (e.g., the date that the data is received) and/or a week (e.g., number representing the week of the year) associated with each record in the solar data structure 700. The system controller may retrieve the date associated with the second time record (e.g., column) via the Internet.

In addition, the control circuit of the base assembly and/or the system controller may transmit the solar data (e.g., the solar data structure 700) with the network devices and/or the remote computing devices. The system controller may communicate with the base assembly, such that the base assembly may receive the solar data (e.g., the solar data structure) from the system controller, the network devices, and/or the remote computing device, and/or transmit the solar data (e.g., the solar data structure 700) to the system controller and/or the remote computing device. Additionally or alternatively, the system controller may be configured to be coupled to a network, such as a wireless or wired local area network (LAN), e.g., for access to the Internet. The system controller may communicate via the network, such that the system controller may access the remote services running on the remote computing device for enabling configuration and/or control of the motorized window treatment (e.g., the base assembly). For example, the system controller may communicate via the network to generate and/or update the solar data (e.g., the solar data structure 700) based on the remote services running on the remote computing device. As such, the remote computing device may configure the solar data stored at the motorized window treatment.

The system controller, the network devices, and/or the remote computing devices may aggregate the solar data from a plurality of motorized window treatments to generate a group solar data structure as each of the plurality of motorized window treatments may be installed on the same façade of a building and therefore receive similar solar data. Since the solar data received from each of the group of motorized window treatments is very similar in value, the system controller, the network devices, and/or the remote computing devices may assign one of the motorized window treatments as a data transmission manager, such that the data transmission manager is responsible for transmitting the solar data to the system controller (e.g., exclusively). The system controller, the network devices, and/or the remote computing devices may send a message to the motorized window treatments that are not the data transmission manager that indicates that these motorized window treatments should decrease their data update interval for sending solar data to the system controller. Additionally or alternatively, the system controller, the network devices, and/or the remote computing devices may send a message to the motorized window treatment that is the data transmission manager that indicates that the data transmission manager should increase its data update interval for sending solar data. As such, motorized window treatments other than the data transmission manager may decrease their data update interval for sending solar data to the system controller such that power is saved.

The control circuit of the base assembly may be configured to control a position of the bottom bar based on solar data stored within the solar data structure 700. For example, the control circuit of the base assembly may retrieve the solar data from the solar data structure 700 and process the solar data to determine a charging position P_{CHRG} of the bottom bar. For example, the control circuit of the base assembly may set a destination position P_{DEST} for the bottom bar to the charging position P_{CHRG} associated with a record from the solar data structure 700, and may control the motor to move the bottom bar to the destination position P_{DEST}. For example, the destination position P_{DEST} may be the position in the solar data structure 700 (e.g., the position column 707) that is associated with the maximum solar power P_{MAX} of solar power P_{SOLAR} (e.g., at the present time). Accordingly, the control circuit of the base assembly may position the bottom bar at the position most likely to cause to the solar cells to receive the most sunlight based on the solar data structure 700.

The control circuit of the base assembly may sort the solar data structure 700 based on a time associated with each record. For example, the control circuit of the base assembly may select a time range and may select a record within the solar data structure 700 (e.g., a position) that is associated with a maximum magnitude P_{MAX} of solar power P_{SOLAR} that is received by the solar cells on the bottom bar module that is within the selected time range. The control circuit may determine a charging position P_{CHRG} of the bottom bar based on the determined highest solar power P_{MAX} in the time range and may control the motor drive circuit to control the motor to move the bottom bar to the destination position P_{DEST}, such that the bottom bar is in the ideal charging position for the solar cells.

The control circuit and/or the system controller may be configured to reduce the number of transmissions of the solar data from the base assembly to the system controller based on a trend in the storage level of the energy storage element of the base assembly and/or the energy storage element of the bottom bar module, for example, such that bandwidth on a wireless communication connection between the base assembly and the system controller may be minimized when possible. The control circuit of the base assembly and/or the system controller may determine a data update interval for transmitting updated solar data (e.g., an updated solar data structure) from the base assembly based on the energy storage level of the energy storage element of the base assembly. The control circuit of the base assembly and/or the system controller may store the data update interval in memory, such that the base assembly may be configured transmit the solar data (e.g., the solar data structure 700) to the system controller at the data update interval. Accordingly, the control circuit of the base assembly and/or the system controller may adjust the data update interval to reduce the number of transmissions of the solar data from the base assembly to the system controller, such that bandwidth on a wireless communication connection between the base assembly and the system controller is minimized.

One or more of the base assemblies (e.g., motor drive units and/or dock modules) of a plurality of a plurality of motorized window treatments of a load control system (e.g., the load control system 100) may be assigned to be a data transmission manager for a group of motorized window treatments of the load control systems. For example, the base assembly of the motorized window treatment system may be assigned to be the data transmission manager for the group of motorized window treatments. The data transmission manager may transmit solar data that is representative of the solar data for the group of motorized window treatments, for example, in situations where the solar data of the group of motorized window treatments is substantially similar to one another. The use of a data transmission manager may reduce the number of transmissions of the solar data from the base assemblies of the group of motorized window treatments to the system controller, such that bandwidth on a wireless communication connection between the base assemblies of the group of motorized window treatments and the system controller is minimized.

The control circuit of the base assembly and/or the system controller may be configured to assign a motorized window treatment system as the data transmission manager. For example, the control circuit and/or the system controller may receive respective solar data for each motorized window treatment system of the group of motorized window treatments system. The control circuit and/or the system controller may determine whether the solar data for each of the group of motorized window treatment systems of the group is within a threshold range of each other. If so, the control circuit and/or the system controller may choose one of the base assemblies of the group of motorized window treatment systems to be the data transmission manager and may set that motorized window treatment system to be the data transmission manager. In some examples, the group of motorized window treatment systems may be a group of group of motorized window treatment systems that are positioned along a façade of a building (e.g., all or a subset of the group of motorized window treatment systems that are positioned along the façade of the building). The motorized window treatment assembly that is assigned to be the data transmission manager for the group may transmit solar data that is representative of the solar data for the group. As such, the other motorized window treatments of the group may save communication power, and the number of transmissions of the solar data from the group of motorized window treatment systems to the system controller may be reduced, such that bandwidth between the group of motorized window treatment systems and the system controller is minimized.

The control circuit of the base assembly may be configured to record and/or collect consumption data regarding energy consumption of one or more of the electrical loads of the base assembly. For example, the electrical loads of the base assembly may comprise the motor drive circuit and/or the motor. In addition, the electrical loads of the base assembly may comprise one or more circuits (e.g., low-voltage circuits) of the base assembly that provide for wireless communication. The consumption data may comprise one or more performance values (e.g., measured and/or calculated values) recorded by the base assembly and/or the bottom bar module. For example, the control circuit of the base assembly and/or the control circuit of the bottom bar module may be configured to store in memory the performance values of the consumption data periodically (e.g., at a at a load measurement interval T_{LOAD1}). For example, the performance values included in the consumption data may comprise include measured values, such as measurements of one or more of the following.

The performance values included in the consumption data may include a load current I_{LOAD} conducted by one or more of the electrical loads of the base assembly. For example, the performance value may include any combination of the first load current I_{LOAD1} conducted by the motor drive circuit 514 of the motor drive unit 510, 510′, the second load currents I_{LOAD2} conducted by the power supply 532 to supply power to the low-voltage circuitry of the motor drive unit 510, 510′, the first load current I_{LOAD1} conducted by the motor drive circuit 714 of the motor drive unit 710, and/or the second load current I_{LOAD2} conducted by the power supply 732 to supply power to the low-voltage circuitry of the motor drive unit 710. Further, the performance values included in the consumption data may include a magnitude of a first storage voltage V_{S-A} stored in the energy storage element of the base assembly (e.g., the magnitude of the first storage voltage V_{S-A} stored in the energy storage elements 430, 530). Finally, the performance values included in the consumption data may include other measured values (e.g., measurements) of the base assembly and/or the bottom bar module.

The control circuit of the base assembly and/or the control circuit of the bottom bar module be also be configured to determine (e.g., calculate or process) one or more of the performance values of the consumption data. For example, the control circuit of the base assembly and/or the control circuit of the bottom bar module may be configured to calculate performance values of the electrical loads of the base assembly (e.g., the solar management circuit and/or the charging circuit of the bottom bar module) using one or more of the performance values of the consumption data. The control circuit of the base assembly may be configured to store the calculated performance values in the consumption data (e.g., in memory).

The control circuit of the base assembly may be configured to determine (e.g., calculate) and store in the consumption data (e.g., in memory) a total amount of power P_{LOAD-TOTAL} presently being consumed by one or more of the electrical loads of the base assembly. For example, the control circuit of the base assembly may be configured to determine a first load power P_{LOAD1} being consumed by one or more circuits of the base assembly due to movements of the bottom bar via the motor and the motor drive circuit. In addition, the control circuit of the base assembly may be configured to determine a second load power P_{LOAD2} being consumed by one or more circuits of the base assembly due to wireless communication (e.g., due to communications that are transmitted and/or received via by the control circuit via the communication circuit of the base assembly. The control circuit of the base assembly may be configured to use the total power P_{TOTAL} presently being consumed by one or more of the electrical loads to determine a trend in the storage level of the energy storage element of the base assembly and/or the energy storage element of the bottom bar module and/or a life expectancy (e.g., end of life) of one or more components of the motorized window treatment system.

The control circuit of the base assembly may be configured to determine (e.g., calculate) the first load power P_{LOAD1} being consumed by one or more circuits of the base assembly due to movements of the bottom bar in response to a first load current I_{LOAD1} conducted by the motor drive circuit and/or the motor. For example, the control circuit of the base assembly may be configured to determine a magnitude of the first load current I_{LOAD1} in response to a first current sense signal V_{I-SNS1} generated by a first current sense circuit (e.g., the first current sense circuits 531, 740). The control circuit of the base assembly may be configured to calculate the first load power P_{LOAD1} being consumed from the energy storage element by the motor drive circuit and/or the motor, for example, periodically (e.g., at a load measurement interval T_{LOAD1}) while the control circuit is controlling the motor drive circuit to rotate the motor and move the covering material. For example, the control circuit 750 of the motor drive unit 710 shown in FIG. 17B may be configured to calculate the first load power P_{LOAD1} being consumed from the energy storage element 730 by the motor drive circuit 714 and/or the motor 712 based on the magnitude of the first supply voltage V_{S-A} and the magnitude of the first load current I_{LOAD1} (e.g., P_{LOAD1}=V_{S-A}·I_{LOAD1}). The control circuit 750 may be configured to store the magnitude of the first load current I_{LOAD1} and/or the first load power P_{LOAD1} in the consumption data in memory, for example, periodically (e.g., at the load measurement interval T_{LOAD1} at the same time that the first load power P_{LOAD1} is calculated).

The control circuit of the base assembly may be configured to determine the second load power P_{LOAD2} being consumed by one or more circuits (e.g., low-voltage circuits) of the base assembly due to wireless communication in response to a second load current I_{LOAD2} conducted by the control circuit, the communication circuit, and/or other low-voltage circuitry of the base assembly. For example, the control circuit of the base assembly may be configured to determine a magnitude of the second load current I_{LOAD2} in response to a second current sense signal V_{I-SNS2} generated by a second current sense circuit (e.g., the second current sense circuits 533, 760). The control circuit of the base assembly may be configured to calculate the second load power P_{LOAD2} being consumed from the energy storage element by the control circuit, the communication circuit, and/or other low-voltage circuitry of the base assembly, for example, periodically (e.g., at the load measurement interval T_{LOAD1}). For example, the control circuit 720 of the motor drive unit 710 shown in FIG. 17B may be configured to calculate the second load power P_{LOAD2} being consumed from the energy storage element 730 by the control circuit 720, the communication circuit 722, and/or other low-voltage electrical loads of the motor drive unit 710 based on the magnitude of the first supply voltage V_{S-A} and the magnitude of the second load current I_{LOAD2} (e.g., P_{LOAD2}=V_{S-A}·I_{LOAD2}).

The control circuit of the base assembly may be configured to determine the total power P_{LOAD-TOTAL} being consumed from the energy storage element of the base assembly by the electrical loads of the base assembly, for example, by summing the first load power P_{LOAD1} and the second load power P_{LOAD2} (e.g., P_{LOAD-TOTAL}=P_{LOAD1}+P_{LOAD2}). The control circuit of the base assembly may be configured to store the total power P_{LOAD-TOTAL} in the memory, for example, periodically (e.g., at the load measurement interval T_{LOAD1} at the same time that the control circuit calculates the first load power P_{LOAD1} and/or the second load power P_{LOAD2}).

In addition, the control circuit of the motor drive circuit may also be configured to determine (e.g., calculate) and store in the consumption data a total charge Q_{LOAD-TOTAL} and/or a total energy E_{LOAD-TOTAL} consumed from the energy storage element by the electrical loads of the base assembly. The control circuit of the base assembly may be configured to calculate the total charge Q_{LOAD-TOTAL} and/or the total energy E_{LOAD-TOTAL} consumed from the energy storage element by the electrical loads of the base assembly, for example, over an accumulation interval T_{ACC} (e.g., such as a day). Further, as noted herein, in some examples, the accumulation interval T_{ACC} may be other time periods (e.g., multiple days, a week, multiple weeks, a month, etc.). At the end of the accumulation interval T_{ACC} (e.g., at the end of each day), the control circuit of the base assembly may be configured to store the total charge Q_{SOLAR} and/or the total energy E_{SOLAR} consumed from the energy storage element in the consumption data in memory along with timing information (e.g., the present date). In addition, the control circuit of the base assembly may be configured to reset the total charge Q_{SOLAR} to zero coulombs and/or the total energy E_{SOLAR} to zero joules at the end of the accumulation interval T_{ACC}, such that the control circuit of the base assembly may be configured to determine the total charge Q_{SOLAR} and/or the total energy E_{SOLAR} consumed from the energy storage element of the base assembly during the next accumulation interval T_{ACC}.

The control circuit of the base assembly may be configured to calculate a first charge Q_{LOAD1} and/or a first energy E_{LOAD-TOTAL} (e.g., a motor-control energy) consumed from the energy storage element by the motor drive circuit and/or the motor. The control circuit of the base assembly may be configured to calculate the first charge Q_{LOAD1} and/or the first energy E_{LOAD1} consumed from the energy storage element by the motor drive circuit and/or the motor, for example, over the accumulation interval T_{ACC}. For example, the control circuit of the base assembly may be configured to calculate the first charge Q_{LOAD1} and/or the energy E_{LOAD1} consumed from the energy storage element by the motor drive circuit and/or the motor when (e.g., only when) the control circuit is controlling the motor drive circuit to rotate the motor. The control circuit of the base assembly may be configured to calculate the first charge Q_{LOAD1} and/or the first energy E_{LOAD1} consumed from the energy storage element by the motor drive circuit and/or the motor, for example, periodically (e.g., at a load measurement interval T_{LOAD1}) when the control circuit is controlling the motor drive circuit to rotate the motor. For example, the control circuit 720 of the motor drive unit 710 shown in FIG. 17B may be configured to calculate the first charge Q_{LOAD1} consumed from the energy storage element 730 by the motor drive circuit 714 and/or the motor 712 based on the first load current I_{LOAD1} (e.g., as indicated by the first current sense signal V_{I-SNS1}) and the load measurement interval T_{LOAD1}, e.g.,

$${Q}_{LOAD 1} = {Q}_{LOAD 1} + ( {I}_{LOAD 1} \cdot {T}_{LOAD 1} ) .$$

In addition, the control circuit 720 of the motor drive unit 710 shown in FIG. 17B may be configured to calculate the first energy E_{LOAD1} consumed from the energy storage element 730 by the motor drive circuit 714 and/or the motor 712 based on the magnitude of the first supply voltage V_{S-A}, the magnitude of the first load current I_{LOAD1}, and the load measurement interval T_{LOAD1}, e.g.,

$${E}_{LOAD 1} = {E}_{LOAD 1} + ( {V}_{S - A} \cdot {I}_{LOAD 1} \cdot {T}_{LOAD 1} ) .$$

For example, the first charge Q_{LOAD1} and/or the first energy E_{LOAD1} consumed from the energy storage element by the motor drive circuit and/or the motor may represent the charge and/or energy required to operate the motor to move the covering material over the course of a day.

The control circuit of the base assembly may be configured to calculate a second charge Q_{LOAD2} and/or a second energy E_{LOAD2} (e.g., a low-voltage-load energy) consumed from the energy storage element by the power supply and/or the low-voltage electrical loads that are powered by the low-voltage supply voltage V_{CC-A}. The control circuit of the base assembly may be configured to calculate the second charge Q_{LOAD2} and/or the second energy E_{LOAD2} consumed from the energy storage element by the power supply and/or the low-voltage electrical loads, for example, over the accumulation interval T_{ACC}. The control circuit of the base assembly may be configured to calculate the second charge Q_{LOAD2} and/or the second energy E_{LOAD2} consumed from the energy storage element by the power supply and/or the low-voltage electrical loads, for example, periodically (e.g., at a load measurement interval T_{LOAD2}) during the length (e.g., the entire length) of the accumulation interval T_{ACC}. For example, the control circuit 720 of the motor drive unit 710 shown in FIG. 17B may be configured to calculate the second charge Q_{LOAD2} consumed from the energy storage element 730 by the power supply 732 and/or the low-voltage electrical loads of the motor drive unit 710 (e.g., the control circuit 720, the communication circuit 722, and other low-voltage circuitry of the motor drive unit 710) based on the second load current I_{LOAD2} (e.g., as indicated by the second current sense signal V_{I-SNS2}) and the load measurement interval T_{LOAD2}, e.g.,

$${Q}_{LOAD 2} = {Q}_{LOAD 2} + ( {I}_{LOAD 2} \cdot {T}_{LOAD 2} ) .$$

In addition, the control circuit 720 of the motor drive unit 710 shown in FIG. 17B may be configured to calculate the second energy E_{LOAD2} consumed from the energy storage element 730 by the power supply 732 and/or the low-voltage electrical loads of the motor drive unit 710 based on the magnitude of the first supply voltage V_{S-A}, the magnitude of the second load current I_{LOAD2}, and the load measurement interval T_{LOAD2}, e.g.,

$${E}_{LOAD 2} = {E}_{LOAD 2} + ( {V}_{S - A} \cdot {I}_{LOAD 2} \cdot {T}_{LOAD 2} ) .$$

Since the operation of the control circuit and/or the communication circuit of the base assembly to transmit wireless signals provides the greatest load on the energy storage element by the low-volage electrical loads of the base assembly, the second charge Q_{LOAD2} and/or the second energy E_{LOAD2} consumed from the energy storage element by the low-voltage electrical loads of the base assembly may represent the charge and/or energy required to operate transmit and receive wireless signals (e.g., provide RF communication) over the course of a day.

In typical scenarios, the second charge Q_{LOAD2} and/or the second energy E_{LOAD2} consumed from the energy storage element by the low-voltage electrical loads of the base assembly may be substantially constant across the course of a day. In some examples, the control circuit of the base assembly may be configured to calculate a partial second charge Q_{LOAD2-P} and/or a partial second energy E_{LOAD2-P} consumed from the energy storage element by the power supply and/or the low-voltage electrical loads during (e.g., only during) a portion of the accumulation interval T_{ACC}, such during a measurement window T_{WIN} (e.g., approximately 1 hour), and apply the partial second charge Q_{LOAD2-P} and/or the partial second energy E_{LOAD2-P} over the rest of the day. The control circuit of the base assembly may be configured to calculate the partial second charge Q_{LOAD2-P} and/or the partial second energy E_{LOAD2-P} consumed from the energy storage element by the power supply and/or the low-voltage electrical loads, for example, periodically (e.g., at the load measurement interval T_{LOAD2}) during the measurement window T_{WIN}.

For example, the control circuit 720 of the motor drive unit 710 shown in FIG. 17B may be configured to calculate the partial second charge Q_{LOAD2-P} consumed from the energy storage element 730 by the motor drive circuit 714 and/or the motor 712 during the measurement window T_{WIN} based on the second load current I_{LOAD2} (e.g., as indicated by the second current sense signal V_{I-SNS2}) and the load measurement interval T_{LOAD2}, e.g.,

$${Q}_{LOAD 2 - P} = {Q}_{LOAD 2 - P} + ( {I}_{LOAD 2} \cdot {T}_{LOAD 2} ) .$$

The control circuit 720 of the motor drive unit 710 shown in FIG. 17B may be configured to calculate the second charge Q_{LOAD2} consumed from the energy storage element 730 by the power supply 732 and/or the low-voltage electrical loads over the accumulation interval T_{ACC}, for example, based on the partial second charge Q_{LOAD2-P}, the accumulation interval T_{ACC}, and the measurement window T_{WIN}, e.g.,

$${Q}_{LOAD 2} = ( {T}_{ACC} / {T}_{WIN} ) \cdot {Q}_{LOAD 2 - P} .$$

In addition, the control circuit 720 of the motor drive unit 710 shown in FIG. 17B may be configured to calculate the partial second energy E_{LOAD2-P} consumed from the energy storage element 730 by the power supply 732 and/or the low-voltage electrical loads during the measurement window T_{WIN} based on the magnitude of the first supply voltage V_{S-A}, the magnitude of the second load current I_{LOAD2}, and the load measurement interval T_{LOAD2}, e.g.,

$${E}_{LOAD 2} = {E}_{LOAD 2} + ( {V}_{S - A} \cdot {I}_{LOAD 2} \cdot {T}_{LOAD 2} ) .$$

The control circuit 720 of the motor drive unit 710 shown in FIG. 17B may be configured to calculate the second energy E_{LOAD2} consumed from the energy storage element 730 by the power supply 732 and/or the low-voltage electrical loads over the accumulation interval T_{ACC}, for example, based on the partial second energy E_{LOAD2-P}, the accumulation interval T_{ACC}, and the measurement window T_{WIN}, e.g.,

$${E}_{LOAD 2} = ( {T}_{ACC} / {T}_{WIN} ) \cdot {E}_{LOAD 2 - P} .$$

As previously mentioned, the second charge Q_{LOAD2} and/or the second energy E_{LOAD2} consumed from the energy storage element by the low-voltage electrical loads of the base assembly may represent the charge and/or energy required to operate transmit and receive wireless signals (e.g., provide RF communication) over the course of a day.

The control circuit of the base assembly may be configured to determine (e.g., calculate) the total charge Q_{LOAD-TOTAL} and/or the total energy E_{LOAD-TOTAL} consumed from the energy storage element by the electrical loads of the base assembly during the accumulation interval T_{ACC}, for example, based the first charge Q_{LOAD1}, the second charge Q_{LOAD2}, the second energy E_{LOAD2}, and/or the second energy E_{LOAD2}. For example, the control circuit of the base assembly may be configured to calculate the total charge Q_{LOAD-TOTAL} consumed from the energy storage element during the accumulation interval T_{ACC} by summing the first charge Q_{LOAD1} and the second charge Q_{LOAD2} (e.g., Q_{LOAD-TOTAL}=Q_{LOAD1}+Q_{LOAD2}). In addition, the control circuit of the base assembly may be configured to calculate the total energy E_{LOAD-TOTAL} consumed from the energy storage element during the accumulation interval T_{ACC} by summing the first energy E_{LOAD1} and the second energy E_{LOAD2} (e.g., E_{LOAD-TOTAL}=E_{LOAD1}+E_{LOAD2}). At the end of the accumulation interval T_{ACC} (e.g., at the end of each day), the control circuit of the base assembly may be configured to store the total charge Q_{LOAD-TOTAL} and/or the total energy E_{LOAD-TOTAL} consumed from the energy storage element during the accumulation interval T_{ACC} in the consumption data in memory along with timing information (e.g., the present date). In addition, the control circuit of the base assembly may be configured to reset the total charge Q_{LOAD-TOTAL} to zero coulombs and/or the total energy E_{LOAD-TOTAL} to zero joules at the end of the accumulation interval T_{ACC}, such that the control circuit may be configured to determine the total charge Q_{LOAD-TOTAL} and/or the total charge Q_{LOAD-TOTAL} consumed by the electrical loads of the base assembly during the next accumulation interval T_{ACC}.

In addition, the control circuit of the base assembly may be configured to determine (e.g., calculate) an average (e.g., a running average) of the total charge Q_{LOAD-TOTAL} and/or the total energy E_{LOAD-TOTAL} consumed from the energy storage element by the electrical loads of the base assembly during the accumulation interval T_{ACC} over multiple instances of the accumulation interval T_{ACC}. For example, at the end of the accumulation interval T_{ACC}, the control circuit of the base assembly may be configured to calculate (e.g., update) an average charge Q_{LOAD-AVG} (e.g., consumed from the energy storage element by the electrical loads of the base assembly) based on total charge Q_{LOAD-TOTAL} for the present accumulation interval T_{ACC} and a previous value of the average charge Q_{LOAD-AVG}. In addition, at the end of the accumulation interval T_{ACC}, the control circuit of the base assembly may be configured to calculate (e.g., update) an average consumed energy E_{LOAD-AVG} (e.g., consumed from the energy storage element by the electrical loads of the base assembly) based on total energy E_{LOAD-TOTAL} for the present accumulation interval T_{ACC} and a previous value of the average energy E_{LOAD-AVG}.

In some examples, the control circuit of the base assembly may be configured to estimate the total energy E_{LOAD-TOTAL} consumed from the energy storage element by the electrical loads of the base assembly during the accumulation interval T_{ACC}. The control circuit of the base assembly may be configured determine (e.g., estimate), for example, a total movement energy E_{LOAD-M} consumed from the energy storage element due to movements of bottom bar (e.g., the covering material) during the accumulation interval T_{ACC}. For example, the control circuit of the base assembly may be configured to estimate the total movement energy E_{LOAD-M} (e.g., an average amount of energy) due to movements of bottom bar based on stored records of movements of the bottom bar (e.g., a full raise and/or a full lower of the bottom bar).

The memory of the base assembly may be configured to store, for example, a movement log including movement records of each movement of the bottom bar. The control circuit of the base assembly may be configured to determine a number of movements N_{MOVE} of the bottom bar during the accumulation interval from the movement log stored in memory. In addition, the memory of the base assembly may be configured to store a predetermined energy E_{MOVE} that may indicate an average energy consumed from the energy storage element by the motor drive circuit and/or the motor during a single movement of the bottom bar. For example, the control circuit of the base assembly may be configured to estimate (e.g., calculate) the total movement energy E_{LOAD-M} consumed from the energy storage element due to movements of bottom bar during the accumulation interval T_{ACC} by multiplying the number of movements N_{MOVE} of the bottom bar during the accumulation interval by the predetermined energy E_{MOVE} (e.g., E_{LOAD-M}=N_{MOVE}·E_{MOVE}).

In addition, the control circuit of the base assembly may be configured to estimate the total movement energy E_{LOAD-M} (e.g., an average amount of energy) due to movements of bottom bar during the accumulation interval T_{ACC} based on an amount of movement of the bottom bar indicated by the stored records of movements of the bottom bar in the movement log. For example, the memory of the base assembly may be configured to store a raise profile that indicates a relationship between a power P_{LOAD-M} that may be consumed from the energy storage element by the motor drive circuit and/or the motor with respect to the present position P_{PRES} of the bottom bar during a raise movement (e.g., a full raise of the bottom bar from the lowered position P_{LOWERED} to the raised position P_{RAISED}), and/or a lower profile that indicates a relationship between the power P_{LOAD-M} that may be consumed from the energy storage element by the motor drive circuit and/or the motor with respect to the present position P_{PRES} of the bottom bar during a lower movement (e.g., a full lower of the bottom bar from the raised position P_{RAISED} to the lowered position P_{LOWERED}).

For each movement during the accumulation interval, the control circuit of the base assembly may be configured to determine a starting position P_{START}, an ending position PEND, and a time T_{MOVE} required for the movement. The control circuit of the base assembly may be configured to determine whether the movement was raising or lowering the bottom bar based on the starting position P_{START} and the ending position PEND. The control circuit of the base assembly may be configured to determine a starting power P_{START} and an ending power PEND based on the starting position P_{START} and the ending position PEND, respectively, by using the raise profile when the raising the bottom bar or the lower profile when lowering the bottom bar. The control circuit of the bottom bar module by be configured to determine an energy E_{LOAD-M} that was consumed from the energy storage element by the motor drive circuit and/or the motor during each of the movements within the accumulation interval T_{ACC} based on the starting power P_{START}, the ending power PEND, and the time T_{MOVE} required for the movement, e.g.,

$${E}_{LOAD - M} = {T}_{MOVE} \cdot ( {P}_{START} + {P}_{END} ) / 2.$$

The control circuit of the base assembly may be configured to estimate (e.g., calculate) the total movement energy E_{LOAD-M} consumed from the energy storage element due to movements of bottom bar during the accumulation interval T_{ACC} by summing the calculated energy E_{LOAD-M} that was consumed from the energy storage element during each of the movements of the bottom bar within the accumulation interval T_{ACC}.

In addition, the control circuit of the base assembly may be configured to determine (e.g., estimate and/or calculate), for example, a total communication energy E_{LOAD-RF} consumed from the energy storage element due to wireless communication (e.g., by the control circuit and/or the communication circuit of the base assembly due to operation of the communication circuit) during the accumulation interval T_{ACC}. For instance, as described in more detail below, the control circuit of the base assembly may be configured to determine a number N_{LOW} of wake-up events where no message is received and/or a number N_{HIGH} of wake-up events where a message is received. The control circuit of the base assembly may be configured to count the number N_{LOW} of wake-up events where no message is received and/or the number N_{HIGH} of wake-up events where a message is received during each of the accumulation intervals T_{ACC}. For example, each time that the control circuit of the base assembly wakes up (e.g., at the wake-up interval T_{WAKE-UP}), the control circuit may increment the number N_{LOW} when no message is received during the wake-up event and increment the number N_{HIGH} when a message is received during the wake-up event. At the end of each of the accumulation intervals T_{ACC}, the control circuit of the base assembly may reset the number N_{LOW} and the number N_{HIGH} (e.g., set the number N_{LOW} and the number N_{HIGH} both equal to zero). For example, the control circuit of the base assembly may be configured to store the number N_{LOW} and the number N_{HIGH} in the memory (e.g., in the consumption data).

The control circuit of the base assembly may be configured to determine (e.g., estimate and/or calculate) the total communication energy E_{LOAD-RF} consumed from the energy storage element due to wireless communication based on the determined number N_{LOW} of wake-up events where no message is received and/or the determined number N_{HIGH} of wake-up events where a message is received during the accumulation interval T_{ACC}. The memory of the base assembly may be configured to store a low communication energy E_{WAKE-LOW} that indicates an average energy consumed from the energy storage element during a wake-up event when no message is received and a high communication energy E_{WAKE-HIGH} that indicates an average energy consumed from the energy storage element during a wake-up event when a message is received. The control circuit of the base assembly may be configured to determine a total low communication energy E_{LOAD-LOW} associated with the wake up periods where no message is received, for example, by multiplying the number N_{LOW} of a wake-up events where no message is received by the low communication energy E_{WAKE-LOW} (e.g., E_{LOAD-LOW}=N_{LOW}·E_{WAKE-LOW}). In addition, the control circuit of the base assembly may be configured to determine a total high communication energy E_{LOAD-HIGH} associated with the wake-up events where a message is received, for example, by multiplying the number N_{HIGH} of a wake-up events where a message is received by the high communication energy E_{WAKE-HIGH} (e.g., E_{LOAD-HIGH}=N_{HIGH}·E_{WAKE-HIGH}).

The control circuit of the base assembly may determine the total communication energy E_{LOAD-RF} based on the total high communication energy E_{LOAD-HIGH} and the total low communication energy E_{LOAD-LOW}, for example by adding the total high communication energy E_{LOAD-HIGH} and the total low communication energy E_{LOAD-LOW}, such that the total communication energy E_{LOAD-RF} may indicate the total power consumed by the control circuit and/or the communication circuit of the base assembly due to wireless communication. The control circuit of the base assembly may be configured to determine (e.g., estimate and/or calculate) the total energy E_{LOAD-TOTAL} based on the total communication energy E_{LOAD-RF} and the total movement energy E_{LOAD-M}, for example, by summing the total communication energy E_{LOAD-RF} and the total movement energy E_{LOAD-M} (e.g., E_{LOAD-TOTAL}=E_{LOAD-RF}+E_{LOAD-M}).

In some examples, the control circuit of the base assembly may be configured to determine the total energy E_{LOAD-TOTAL} consumed from the energy storage element by the electrical loads of the base assembly during the accumulation interval T_{ACC} use the total energy E_{LOAD-TOTAL} to determine a trend of energy consumption and/or a life expectancy (e.g., end of life) of the motorized window treatment (e.g., as will be described in greater detail below).

The control circuit of the base assembly may be configured to process the solar data to determine a trend in the charge Q_{SOLAR} and/or the solar energy E_{SOLAR} received from the solar cells over time (e.g., over a number of days). FIGS. 18B-18E illustrate example plots of solar energy E_{SOLAR} with respect to time (e.g., days) for a number of different motorized window treatments installed in a building (e.g., the same building). For example, FIG. 18B illustrates an example plot 780 of solar energy E_{SOLAR1} with respect to time for a first motorized window treatment that may be installed on a lower-level floor of a north-facing façade of the building; FIG. 18C illustrates an example plot 782 of solar energy E_{SOLAR2} with respect to time for a second motorized window treatment that may be installed on a higher-level floor of the north-facing façade of the building; FIG. 18D illustrates an example plot 784 of solar energy E_{SOLAR3} with respect to time for a third motorized window treatment that may be installed on a mid-level floor of the north-facing façade of the building; and FIG. 18E illustrates an example plot 786 of solar energy E_{SOLAR4} with respect to time for a fourth motorized window treatment that may be installed on the mid-level floor of a south-facing façade of the building. A respective base assembly of each of the first, second, third, and fourth motorized window treatments may be configured to record and store the respective solar energy E_{SOLAR1}, E_{SOLAR2}, E_{SOLAR3}, E_{SOLAR4}.

As shown in FIGS. 18B and 18C, magnitudes of the solar energy E_{SOLAR2} of the second motorized window treatment on the higher-level floor may be greater than magnitudes of the solar energy E_{SOLAR1} of the first motorized window treatment on the lower-level floor due to greater exposure to sunlight near at the higher-level floor than the lower-level floor. As shown in FIGS. 18D and 18E, magnitudes of the solar energy E_{SOLAR3} of the third motorized window treatment on the north-facing façade may be greater than magnitudes of the solar energy E_{SOLAR4} of the fourth motorized window treatment on the south-facing façade due to the geographical location of the building and thus the location of the sun with respect to the facades of the building. The solar energy E_{SOLAR1}, E_{SOLAR2}, E_{SOLAR3}, E_{SOLAR4} of each of the motorized window treatments may change from day to day due to changes in the weather. The solar energy E_{SOLAR1}, E_{SOLAR2}, E_{SOLAR3}, E_{SOLAR4} of each of the motorized window treatments may change (e.g., trend) higher and lower across the course of year due to changes in the position of the sun throughout the year.

The control circuit of the base assembly may be configured to process the solar data to determine the trend in the solar energy E_{SOLAR} received from the solar cells over time through the course of a year. For example, the control circuit of the base assembly may be configured to retrieve from the solar data in memory the solar energy E_{SOLAR} received from the solar cells during a data analysis time period T_{DATA} that may include a number of accumulation intervals T_{ACC} (e.g., a number of consecutive days). For example, the data analysis time period T_{DATA} may include a number of the accumulation intervals T_{ACC} (e.g., all of the accumulation intervals T_{ACC}) during which the control circuit of the base assembly has collected the solar energy E_{SOLAR}. In some examples, the control circuit of the base assembly may be configured to process the solar data when (e.g., only when) the control circuit has enough solar data to appropriately process the solar data.

In some examples, the control circuit of the base assembly may be configured to fit the solar energy E_{SOLAR} to a curve with respect to time to determine the trend in the solar energy E_{SOLAR} received from the solar cells over time through the course of a year. For example, the control circuit of the base assembly may be configured to fit the solar energy E_{SOLAR} to a curve by performing a least-squares fit procedure (e.g., to a sinusoidal waveform) on data representing the solar energy E_{SOLAR} with respect to time. The curve that represents the trend in the solar energy E_{SOLAR} received by the solar cells with respect to time may be, for example, a sinusoidal waveform. For example, the sinusoidal shape of each of curve may indicate higher exposure to sunlight in a portion of the year (e.g., the summer in the northern hemisphere) and lower exposure to sunlight in another portion of the year (e.g., the winter in the northern hemisphere). For example, FIG. 18B illustrates a first curve 790a that may indicate a first trend in the solar energy E_{SOLAR1} with respect to time for the first motorized window treatment on the lower-level floor of the north-facing façade of the building. FIG. 18B also illustrates an average solar energy E_{SOLAR} 790b for the first motorized window treatment. FIG. 18C illustrates a second curve 792a that may indicate a second trend in the solar energy E_{SOLAR2} with respect to time for the second motorized window treatment on the higher-level floor of the north-facing façade of the building. FIG. 18C also illustrates an average solar energy E_{SOLAR} 792b for the second motorized window treatment. FIG. 18D illustrates a third curve 794a that may indicate a third trend in the solar energy E_{SOLAR3} with respect to time for the third motorized window treatment on the mid-level floor of the north-facing façade of the building. FIG. 18D also illustrates an average solar energy E_{SOLAR} 794b for the third motorized window treatment. FIG. 18E illustrates a fourth curve 796a that may indicate a fourth trend in the solar energy E_{SOLAR4} with respect to time for the fourth motorized window treatment on the mid-level floor of the south-facing façade of the building. FIG. 18E also illustrates an average solar energy E_{SOLAR} 796b for the fourth motorized window treatment.

The control circuit of the base assembly may be configured to determine (e.g., calculate) the average solar energy E_{SOLAR} for the respective motorized window treatment. The control circuit of the base assembly may be configured to determine the average solar energy E_{SOLAR-AVG} for the respective motorized window treatment by determining an average of the curve that represents the trend in the solar energy E_{SOLAR} received by the solar cells of the respective motorized window treatment with respect to time. For example, the average of the curve that represents the trend in the solar energy E_{SOLAR} may be an offset of the sinusoidal waveform of the curve. The control circuit of the base assembly may be configured to determine (e.g., calculate) the average solar energy E_{SOLAR-AVG} as the average of the curve that represents the trend in the solar energy E_{SOLAR} based on a high peak magnitude E_{SOLAR-HI} and a low peak magnitude E_{SOLAR-LO}, e.g.,

$${E}_{SOLAR - AVG} = ( {E}_{SOLAR - HI} + {E}_{SOLAR - LO} ) / 2.$$

The control circuit may be configured to process the solar data and/or the consumption data to estimate a lifetime of the motorized window treatment and/or predict a problem with the lifetime of the motorized window treatment (e.g., a short lifetime that may be undesirable to a user of the motorized window treatment). For example, the control circuit may be configured to compare the average solar energy E_{SOLAR-AVG} to the average energy E_{LOAD-AVG} consumed from the energy storage element by the electrical loads of the base assembly to estimate a lifetime of the motorized window treatment and/or predict a problem with the lifetime of the motorized window treatment. For example, the control circuit may fit the solar energy E_{SOLAR} to a curve with respect to time, for example, by performing a least-squares fit procedure (e.g., to a sinusoidal waveform) on data representing the solar energy E_{SOLAR} with respect to time. The curve that represents the trend in the solar energy E_{SOLAR} received by the solar cells with respect to time may be, for example, a sinusoidal waveform (e.g., as shown in FIGS. 18A-18E). For example, the sinusoidal shape of each of curve may indicate higher exposure to sunlight in a portion of the year (e.g., the summer in the northern hemisphere) and lower exposure to sunlight in another portion of the year (e.g., the winter in the northern hemisphere). As such, the control circuit may be configured to process the solar data to determine the trend in the solar energy E_{SOLAR} received from the solar cells over time (e.g., through the course of a year). The control circuit may compare an average solar energy E_{SOLAR-AVG} to an average consumed energy E_{LOAD-AVG} to determine whether a problem with the lifetime of the motorized window treatment is likely to occur and/or determine an estimated end of life indication of the motorized window treatment. The control circuit may generate an indication of the problem (e.g., an alert). For example, when the control circuit determines that it is likely that a problem with the lifetime of the motorized window treatment will occur, the control circuit may generate an alert or communication (e.g., send a message to a mobile device and/or a system controller) that indicates the problem (e.g., that indicates that the motorized window treatment should be serviced).

Alternatively or additionally, the control circuit may be configured to estimate the lifetime of the motorized window treatment and/or predict a problem with the lifetime of the motorized window treatment (e.g., a short lifetime that may be undesirable to a user of the motorized window treatment) in response to the trend in a charge Q_{SOLAR} of the energy storage element of the base assembly. For example, the control circuit may be configured to determine when the trend in the charge Q_{SOLAR} of the energy storage element of the base assembly is decreasing with respect to time, and predict a problem with the lifetime of the motorized window treatment when the trend in the charge Q_{SOLAR} of the energy storage element of the base assembly is decreasing with respect to time. For example, the control circuit may fit the charge Q_{SOLAR} to a curve with respect to time, for example, by performing a least-squares fit procedure (e.g., to a sinusoidal waveform) on data representing the charge Q_{SOLAR} with respect to time. The curve that represents the trend in the charge Q_{SOLAR} received by the solar cells with respect to time may be, for example, a sinusoidal waveform. For example, the sinusoidal shape of each of curve may indicate higher exposure to sunlight in a portion of the year (e.g., the summer in the northern hemisphere) and lower exposure to sunlight in another portion of the year (e.g., the winter in the northern hemisphere). As such, the control circuit may be configured to process the solar data to determine the trend in the charge Q_{SOLAR} of the solar cells over time (e.g., through the course of a year). The control circuit may compare an average charge Q_{SOLAR-AVG} to an average consumed charge Q_{LOAD-AVG} to determine whether a problem with the lifetime of the motorized window treatment is likely to occur and/or determine an estimated end of life indication of the motorized window treatment. The control circuit may generate an indication of the problem (e.g., an alert). For example, when the control circuit determines that it is likely that a problem with the lifetime of the motorized window treatment will occur, the control circuit may generate an alert or communication (e.g., send a message to a mobile device and/or a system controller) that indicates the problem (e.g., that indicates that the motorized window treatment should be serviced).

The control circuit of the base assembly may be configured to use the solar data to configure the base assembly (e.g., configure the behavior of the base assembly during normal operation). For example, the control circuit of the base assembly may be configured to analyze the solar data to determine a charging position P_{CHRG} (e.g., a maximum-solar-power position) at which the solar cells of the bottom bar module may appropriately charge. For example, the charging position P_{CHRG} may be a position at which the solar cells of the bottom bar module may receive a maximum magnitude of solar power P_{SOLAR} between the lowered position P_{LOWER} and the raised position P_{RAISED}. The control circuit of the base assembly may be configured to control the covering material to the charging position P_{CHRG} at one or more predetermined times (e.g., when the space is vacant and/or over the weekends). In addition, the control circuit of the base assembly may be configured to analyze the solar data to set an upper limit position P_{UP-LIMIT} of the motorized window treatment. For example, the control circuit of the base assembly may be configured to determine a position between the lowered position P_{LOWER} and the raised position P_{RAISED} above which the solar cells of the bottom bar module may not receive an appropriate amount of sunlight and set that position as the upper limit position P_{UP-LIMIT}.

Further, the control circuit of the base assembly may be configured to analyze the solar data to identify one or more dead-bands (e.g., dead regions) between the lowered position P_{LOWER} and the raised position P_{RAISED} (e.g., positions of the covering material between which the solar cells of the bottom bar module may not receive an appropriate amount of sunlight, e.g., below a defined threshold). For example, each dead-band may be characterized by an upper dead-band limit position P_{DB-UL} and a lower dead-band limit position P_{DB-LL}. During normal operation, the control circuit of the base assembly may be configured to not maintain the present position P_{PRES} of the covering material within any of the dead regions between the lowered position P_{LOWER} and the raised position P_{RAISED}. For example, when a commanded position P_{CMD} of a received message falls between the upper dead-band limit position P_{DB-UL} and the lower dead-band limit position P_{DB-LL} of a dead-band, the control circuit of the base assembly may be configured to adjust the present position P_{PRES} of the covering material to the closet position outside of the respective dead region (e.g., to either and/or the upper dead-band limit position P_{DB-UL} and the lower dead-band limit position P_{DB-LL} of the respective dead-band). In addition, the control circuit of the base assembly may be configured to adjust the present position P_{PRES} of the covering material to a position that is at least an offset amount Δ_{OFFSET} away from the respective dead-bands (e.g., either P_{DB-UL}+Δ_{OFFSET} or P_{DB-LL}−Δ_{OFFSET}).

In some examples, the control circuit of the base assembly may be configured to detect trends in storage level of the energy storage element (e.g., based on the magnitude of the first storage voltage V_{S-A}). For example, the control circuit of the base assembly may process the storage level (e.g., the first storage voltage V_{S-A}) of the energy storage element to determine a trend of any change in the storage level over time. For example, the control circuit of the base assembly may determine whether the storage level of the energy storage element is greater than or less than the storage level over a previous time period. Further, the control circuit of the base assembly may be configured to determine whether a rolling average of the storage level of a predetermined number of previous storage level measurements is increasing or decreasing to, for example, determine whether the energy storage element is starting to degrade (e.g., fail). In some examples, the control circuit of the base assembly may perform an action in response to a determination that the energy storage element is starting to degrade. For instance, the control circuit of the base assembly may send an alert to a mobile device and/or a system controller (e.g., indicating that the motorized window treatment should be serviced). Alternatively or additionally, the control circuit of the base assembly may move the covering material to the raised position P_{RAISED} and start to shut down some of the internal components of the motorized window treatment (e.g., the communication circuit). In response, a technician may change out the energy storage element, charge the energy storage element (e.g., via the electrical terminals 437, 537 of the motor drive units 410, 510 and/or the dock module 504 using a USB connector), and/or connect the energy storage element to an external power source, such as an external power supply and/or an external battery pack (e.g., via the electrical terminals 437, 537 using the USB connector).

When the base assembly is configured to communicate wirelessly with the bottom bar module, the control circuit of the base assembly may be configured to adjust the present position P_{PRES} of the covering material in response to the magnitude of the solar power P_{SOLAR} being received (e.g., presently being received) by the solar cells of the bottom bar. The control circuit of the base assembly may be configured to adjust the present position P_{PRES} of the covering material to improve the magnitude of the solar power P_{SOLAR} being received by the solar cells. For example, the control circuit of the base assembly may be configured to adjust present position P_{PRES} of the covering material to move the bottom bar out of a location of low sunlight to a location of higher sunlight. The control circuit of the base assembly may be configured to compare the magnitude of the solar power P_{SOLAR} being received by the solar cells to a low-power threshold P_{TH-LP} and may be configured to move the covering material until the magnitude of the solar power P_{SOLAR} being received by the solar cells of the bottom bar module has increased above an acceptable-power threshold P_{TH-ACC}.

The control circuit of the base assembly and/or the control circuit of the bottom bar module may be configured to determine (e.g., automatically determine) when the base assembly should dock the bottom bar (e.g., move the covering material to the raised position P_{RAISED}) to charge the energy storage element from the energy storage element of the bottom bar module. For example, the control circuit of the base assembly may be configured to determine that the bottom bar should be docked when the magnitude of the first storage voltage V_{S-A} produced across the energy storage element of the base assembly falls too low (e.g., is less than a low-charge threshold V_{TH-LC}). The control circuit of the base assembly may be move (e.g., automatically move) the covering material to the raised position P_{RAISED} when the magnitude of the first storage voltage V_{S-A} drops below the low-charge threshold V_{TH-LC}. Although described in context of storage voltages, the control circuit of the base assembly may be configured to determine whether or not the bottom bar should be docked (e.g., whether to charge the energy storage element of the base assembly) based on the state of charge of the energy storage elements of the motorized window treatment, for instance, when the state of charge of the energy storage element falls below a threshold. For example, the control circuit of the base assembly may be configured to calculate the state of charge of the energy storage element based on the first storage voltage V_{S-A}. In some examples, the control circuit of the base assembly may use the magnitude of the first storage voltage V_{S-A} as an indication of the state of charge of the energy storage element.

In addition, the control circuit of the bottom bar module may be configured to determine that the bottom bar should be docked when the magnitude of the second storage voltage V_{S-B} produced across the energy storage element is greater than a high-charge threshold V_{TH-HC}. For example, the control circuit of the bottom bar module may be configured to transmit a message indicating that the bottom bar should be docked to the base assembly via the communication circuit of the bottom bar module when the magnitude of the second storage voltage V_{S-B} rises above the high-charge threshold V_{TH-HC}. The control circuit of the base assembly may be configured to move the covering material to the raised position P_{RAISED} in response to receiving the message from the bottom bar module via the communication circuit of the base assembly. In addition, the control circuit of the bottom bar module may be configured to transmit a message including an indication of the magnitude of the second storage voltage V_{S-B} to the base assembly, and the base assembly may be configured to move the covering material to the raised position P_{RAISED} when the magnitude of the second storage voltage V_{S-B} rises above the high-charge threshold V_{TH-HC}.

The control circuit of the base assembly may be configured to determine when to dock the bottom bar in response to occupancy conditions or vacancy conditions in the space in which the motorized window treatment is located. The control circuit of the base assembly may receive messages including indications of occupancy conditions and/or vacancy conditions in the space from the bottom bar module (e.g., as determined by the sensor circuit of the bottom bar module) and/or from external occupancy sensors. For example, the control circuit of the base assembly may be configured to dock the bottom bar when the control circuit of the base assembly has determined that the bottom bar should be docked (e.g., when the magnitude of the second storage voltage V_{S-B} has risen below the high-charge threshold V_{TH-HC}) and when (e.g., only when) the space is vacant. In addition, the control circuit of the base assembly may be configured to dock the bottom bar when the control circuit of the base assembly has determined that the bottom bar should be docked (e.g., when the magnitude of the first storage voltage V_{S-A} has dropped below the low-charge threshold V_{TH-LC}) and when (e.g., only when) the space is vacant. In some examples, the control circuit of the base assembly may be configured to dock the bottom bar when the space is occupied, but the magnitude of the first storage voltage V_{S-A} has dropped below a critical-charge threshold V_{TH-CRIT} (e.g., which may be smaller than the low-charge threshold V_{TH-LC}). Further, in some examples, the control circuit of the base assembly may use the status of one or more lighting loads as a proxy or indicator that the space is occupied or vacant. For instance, the control circuit of the base assembly may determine that the space is occupied when the lighting loads are on, and determine that the space is vacant when the lighting loads are off. Alternatively or additionally, the control circuit of the base assembly may determine that the space is occupied or vacant based on external feedback, such as indications as to whether a meeting is scheduled for the space. For instance, the control circuit of the base assembly may receive data from one or more calendar programs (e.g., such as Microsoft® Outlook®), and may determine that the space is vacant based on there not being a meeting scheduled for the space at a particular day and time.

The control circuit of the base assembly may be configured to determine when to dock the bottom bar in response to the present day of the week and/or the time of the day. For example, the control circuit of the base assembly may be configured to not dock the bottom bar during a nighttime period (e.g., during a privacy mode, which may be between sunset and sunrise), for example, to maintain the covering material at a lowered position P_{LOWER} to provide privacy for occupants of the space. In addition, the control circuit of the base assembly may be configured to dock the bottom bar at a predetermined docking time. For example, the base assembly may use the timeclock to keep track of the day of the week and/or the time of the day. In addition, the control circuit of the base assembly may be configured to determine the present day of the week and/or the time of the day from messages received via the communication circuit of the base assembly (e.g., from the Internet). Further, the control circuit of the bottom bar may be configured to estimate the time of the day in response to the sensor circuit of the bottom bar module. For example, the control circuit of the bottom bar module may be configured to determine that the present time of the day is during the nighttime period when the ambient light level L_{AMB} indicated by the sensor circuit of the bottom bar module is less than a nighttime threshold L_{TH-NIGHT}, and may transmit a message indicating that the present time of the day is during the nighttime period to the base assembly.

Further, in some examples, the control circuit of the base assembly may schedule one or more docking events (e.g., period and/or reoccurring docking events) based on occupancy and/or vacancy information for the space. The control circuit of the base assembly may be configured to determine the occupancy and vacancy of the space over time, for instance, based on the occupancy or vacant messages received from one or more occupancy or vacancy sensors. As noted herein, the control circuit of the base assembly may receive messages including indications of occupancy conditions and/or vacancy conditions in the space from the bottom bar module (e.g., as determined by the sensor circuit of the bottom bar module) and/or from external occupancy sensors. For instance, the control circuit of the base assembly may determine, over time, that the space is vacant at certain days and/or times (e.g., Sundays from 8-10 am), and may schedule a docking event for those days/times. Further, in some examples, the control circuit of the base assembly may use the status of one or more lighting loads as a proxy or indicator that the space is occupied or vacant. For instance, the control circuit may determine that the space is occupied when the lighting loads are on, and determine that the space is vacant when the lighting loads are off. In some examples, the control circuit of the base assembly may determine that the space is vacant on certain days and/or times (e.g., Sundays from 8-10 am) based on the lighting loads within the space consistently being off during those days and/or times, and may schedule a docking event for those days/times. Alternatively or additionally, the control circuit of the base assembly may determine that the space is occupied or vacant based on external feedback, such as indications as to whether a meeting is scheduled for the space. For instance, the control circuit of the base assembly may receive data from one or more calendar programs (e.g., such as Microsoft® Outlook®), and may determine that the space is vacant based on there not being a meeting scheduled for the space at a particular day and time.

In addition, the control circuit of the base assembly may be configured to determine when to dock the bottom bar in response to one or more other factors. For example, after determining the control circuit of the base assembly should dock the bottom bar (e.g., based on the magnitude of the first storage voltage V_{S-A}, the magnitude of the second storage voltage V_{S-B}, the occupancy or vacancy status of the space, and/or the present day of the week and/or the time of the day), the control circuit of the base assembly may also consider one or more factors to determine if the control circuit of the base assembly should dock the bottom bar. For example, the control circuit of the base assembly may determine whether or not to dock the bottom bar based on the position of the sun, for example, if the sun is not shining on a façade on which the motorized window treatment is installed, for instance, to take advance of instances where the solar cells are less likely to be missing out on collecting a relatively large amount of solar energy. In addition, the control circuit of the base assembly may determine whether or not to dock the bottom bar based on weather information (e.g., temperature, cloud coverage, precipitation, barometric pressure, etc.). For example, the control circuit of the base assembly may determine to dock the bottom bar if it is cloudy, for instance, to take advance of instances where the solar cells are less likely to be missing out on collecting a relatively large amount of solar energy. The control circuit may determine whether or not to dock the bottom bar based on feedback from the photosensor of the sensor circuits of the base assembly. For example, the control circuit of the base assembly may determine to dock the bottom bar if there is less daylight as indicated by the sensor circuit of the bottom bar module and/or a photosensor of the base assembly, for instance, to take advance of instances where the solar cells are less likely to be missing out on collecting a relatively large amount of solar energy.

As briefly noted above, the motorized window treatment may communicate with a system controller and/or via a network. For example, the motorized window treatment may be configured to receive data, such as solar data, from the system controller and/or via the network, and/or send data, such as solar data, to the system controller and/or via the network. For example, the motorized window treatment may determine solar data and send the solar data to the system controller such that the system controller may determine control and/or configuration information based on the solar data. Control and/or configuration information may be used (e.g., by the motorized window treatment) to maximize collection of solar power. Additionally or alternatively, the control and/or configuration information may be used (e.g., by the motorized window treatment) to optimize power consumption such that the life of the motorized window treatment is extended.

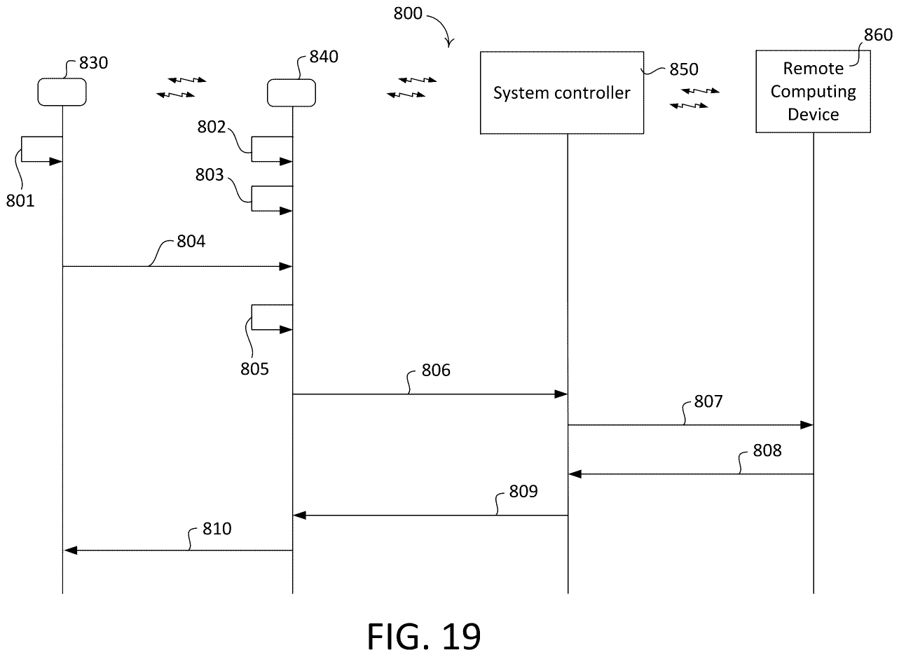

FIG. 19 is a sequence diagram 800 illustrating communications within a system that includes a motorized window treatment, a system controller, and a network device. As shown in FIG. 19, the sequence diagram 800 illustrates example communications (e.g., messages) transmitted between control devices of the system (e.g., a load control system, such as the load control system 100 shown in FIG. 1). The control devices of the system may comprise a motorized window treatment with a bottom bar having a bottom bar module 830 (e.g., the bottom bar module 440 or 540) and a base assembly 840 (e.g., the base assembly 502), a system controller 850 (e.g., the system controller 110), and a remote computing device 860 (e.g., a cloud server running cloud services, such as the cloud services 164). For example, the base assembly 840 may comprise a motor drive unit (e.g., the motor drive unit 410, 510, 510′, 710) and/or a dock module (e.g., the dock module 504), Although a single motorized window treatment (e.g., the bottom bar module 830 and the base assembly 840) are shown, it should be appreciated that the system may include a plurality of motorized window treatments. One or more devices of the system may execute the operations shown in the sequence diagram 800 periodically and/or in response to one or more events, such as in response to docking events between the bottom bar module 830 and the base assembly 840.

At 801, the bottom bar module 830 may collect and store (e.g., periodically collect and store) solar data (e.g., in memory) of the bottom bar module 830 (e.g., at a timing interval T_{TIM}). At 802, the base assembly 840 may adjust a position of the bottom bar through various movements. For example, the base assembly 840 may adjust the position of the bottom bar one or more times at 802. As such, at 801, the bottom bar module 830 may collect and store the solar data associated with a plurality of different positions of the bottom bar module 830. The solar data stored in memory of the bottom bar module 830 (e.g., bottom bar solar data) may include data that is captured by the bottom bar module 440 and that is used to calculate the solar power P_{SOLAR} received by the solar cells (e.g., solar cells 442). For example, the solar data at the bottom bar module 830 (e.g., bottom bar solar data) may comprise any combination of the photovoltaic output voltage V_{PV}, the magnitude of the second storage voltage V_{S-B}, the duty cycle DC_{SCM} of a solar cell management circuit (e.g., the solar cell management circuit 444), a position of the bottom bar when the photovoltaic output voltage V_{PV} is stored by the solar cell management circuit, and/or a time when the photovoltaic output voltage V_{PV} is stored by the solar cell management circuit.

At 803, the base assembly 840 may dock (e.g., determine to dock) the bottom bar, such that an electrical contact of a dock of the motorized window treatment is electrically connected to an electrical contact of the bottom bar module 830, as described herein. For example, the base assembly 840 may determine to dock the bottom bar based on one or more inputs (e.g., as described above with reference to FIG. 17). For example, the base assembly 840 may determine to dock the bottom bar when the magnitude of the first storage voltage V_{S-A} produced across the energy storage element of the base assembly 840 falls too low (e.g., is less than a low-charge threshold V_{TH-LC}) and/or when the magnitude of the second storage voltage V_{S-B} produced across the energy storage element of the bottom bar module 830 is greater than a high-charge threshold V_{TH-HC}. In some examples, the base assembly 840 may determine to dock the bottom bar in response to an occupancy or vacancy condition in a space where the motorized window treatment is located, for example based on indications of occupancy conditions and/or vacancy conditions in the space (e.g., from the bottom bar module 830 and/or from one or more occupancy or vacancy sensors). Additionally or alternatively, the base assembly 840 may determine to dock the bottom bar based on a position of the sun, for example such that if the sun is not shining on a façade on which the motorized window treatment is installed, the solar cells of the bottom bar module 830 are less likely to be missing out on collecting a relatively large amount of solar energy. In addition, the base assembly 840 may determine a time of (e.g., each) docking at the bottom bar and may store (e.g., each) time of docking in a memory.

At 804, the bottom bar module 830 may be configured to transmit the solar data (e.g., the bottom bar solar data) to the base assembly 840 via a wired or wireless communication link. When the bottom bar module 830 is configured to communicate wirelessly with the base assembly 840, the bottom bar module 830 may be configured to transmit the solar data to the base assembly 840 each time that the solar data is collected at 801 and/or periodically after a number of collections of the solar data at 801. When the bottom bar module 830 is configured to communicate with the base assembly 840 via a wired connection when the bottom bar is docked, the bottom bar module 830 may be configured to transmit the solar data to the base assembly 840 after the base assembly 840 docks the bottom bar at 803. When the base assembly 840 receives the solar data from the bottom bar module 830, the base assembly 840 may store the solar data in memory of the base assembly 840.

At 805, the base assembly 840 may process the solar data from the bottom bar module 830 (e.g., the bottom bar solar data). For example, the base assembly 840 may process the solar data received from the bottom bar module 440 to generate a solar data structure (e.g., the solar data structure 700). As described herein, the solar data (e.g., the solar data structure) at the base assembly 840 (e.g., base assembly solar data) may include multiple records, where each record may include a solar power P_{SOLAR} received by the solar cells 442 of the bottom bar module 440, a position P_{S} of the bottom bar when the solar cells 442 collected the respective solar power P_{SOLAR}, and a time T_{S} at which the solar cells 442 collected the respective solar power P_{SOLAR}. In some examples, the base assembly 840 may step through a plurality of unique entries within the solar data received from the bottom bar (e.g., new entries that are subsequent to the time of the last docking event) and generate a corresponding record in the solar data structure (e.g., the solar data structure 700). The base assembly 840 may calculate a solar power P_{SOLAR} from the solar data from the bottom bar module 830 (e.g., the bottom bar solar data). The base assembly 840 may determine the position P_{S} and the time T_{S} associated with the solar power P_{SOLAR} calculated from the bottom bar solar data and may store the record in the solar data structure.

At 806, the base assembly 840 may transmit the solar data (e.g., the solar data structure 700 and/or the bottom bar solar data) to the system controller 850. For example, the base assembly 840 may generate the solar data structure at 805 and transmit the solar data structure to the system controller at 806. In some examples, the system controller 850 may generate the solar data structure (e.g., all of or a part of the solar data structure). For example, the base assembly 840 may transmit the solar data (e.g., the bottom bar solar data) to the system controller 850, such that the system controller 850 may generate the solar data structure from the bottom bar solar data. In addition, the system controller 850 and the base assembly 840 may each generate a portion of the solar data structure.

At 807, the system controller 850 may send the solar data (e.g., the solar data structure and/or the bottom bar solar data) to the remote computing device 860 such that the remote computing device 860 may process the solar data. For example, the base assembly 840 and/or the system controller 850 may generate the solar data structure and the system controller 850 may transmit the solar data structure to the remote computing device 860 at 807. In some examples, the remote computing device 860 may generate the solar data structure (e.g., all of or a part of the solar data structure). For example, the system controller 850 may transmit the solar data (e.g., the bottom bar solar data) to the remote computing device 860, such that the remote computing device 860 may generate the solar data structure from the bottom bar solar data. In addition, the remote computing device 860, the system controller 850, and the base assembly 840 may each generate a portion of the solar data structure 700.

Further, as described in more detail herein, the system controller 850 and/or the remote computing device 860 may process the solar data from base assemblies (e.g., such as the base assembly 840) of a plurality of motorized window treatments (e.g., those motorized window treatments that are installed along the same façade of a building). The system controller 850 and/or the remote computing device 860 may alter the solar data structure 700 based on solar data received from the base assemblies of the plurality of motorized window treatments. For example, the system controller 850 and/or the remote computing device 860 may aggregate the solar data from a plurality of motorized window treatments, for example, to generate a group solar data structure (e.g., a façade solar data structure) that can be is used by the base assemblies of the plurality of motorized window treatments. For example, in some instances, each of the plurality of motorized window treatments may be installed on the same façade of a building and therefore receive similar solar data.

Further, in some examples, the system controller 850 and/or the remote computing device 860 may enable configuration and/or control of the motorized window treatment (e.g., the base assembly 840) based on the received and/or processed solar data. For example, the system controller 850 and/or the remote computing device 860 may process the solar data structure and generate control and/or configuration information. The control and/or configuration information may be used by the base assembly 840 to maximize collection of solar power by the bottom bar module 830, for example, by controlling the position of the bottom bar based on the solar data structure 700. Additionally or alternatively, the control and/or configuration information may be used by the base assembly 840 to optimize power consumption of the base assembly 840, such that the life of the motorized window treatment is extended.

At 808, the remote computing device 860 may send the solar data structure 700 and/or control and/or configuration information to the system controller 850. At 809, the system controller 850 may send the solar data structure 700 and/or the control and/or configuration information to the base assembly 840. The base assembly 840 may store the solar data structure 700 and/or the control and/or configuration information in memory. The base assembly 840 may control the position of the bottom bar based on the solar data structure 700. Finally, at 810, the base assembly 840 may send configuration information to the bottom bar module 830 based on the control and/or configuration information. For example, configuration information may include a new value for a timing interval (e.g., the timing interval T_{TIM}) and/or a communication interval (e.g., the transmission rate T_{TX}) such that the bottom bar module 830 may be configured to begin to store the solar data (e.g., the bottom bar solar data) at timing interval and/or transmit the solar data at the communication interval.

FIG. 20A is a flowchart of an example procedure 900 for adjusting a present position P_{PRES} of a covering material of a motorized window treatment (e.g., the motorized window treatments described herein). The procedure 900 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). For example, the control circuit may execute the procedure 900 periodically starting at 910. In addition, the control circuit may execute the procedure 900 in response to receiving a message via a communication circuit at 910.

At 912, the control circuit may receive a command. For example, the control circuit may receive a message including a command via a communication circuit (e.g., the communication circuit 622). The command may be, for example, a command to move the covering material (e.g., a shade movement command to adjust the present position P_{PRES} of the covering material). For example, the command may include a commanded position P_{CMD} to which the control circuit should control the present position P_{PRES} of the covering material. In addition, the command may include a command to raise or lower the present position P_{PRES} of the covering material, and the control circuit may be configured to adjust the present position P_{PRES} of the covering material by a predetermined amount ΔP in response to receiving the command. In some examples, the control circuit may be configured to start raising or lowering the covering material in response to receiving a message including a raise command or a lower command, respectively, and may stop raising or lowering the present position P_{PRES} of the covering material in response to receiving a message including a stop command. Further, the command in the message received at 912 may not be a command to move the covering material, but may be a command to enter a mode (e.g., a configuration mode), a command to transmit status information of the motor drive unit, and/or other commands that are not movement commands. Additionally or alternatively, the command may be received in response to an actuation of one or more of the buttons of the motor drive unit (e.g., the button of the user interface circuit 624). For example, the control circuit may be configured to raise or lower the present position P_{PRES} of the covering material by a predetermined amount ΔP in response to detecting an actuation of a first button or a second button, respectively, of the motor drive unit. In addition, the control circuit may be configured to start raising or lowering the covering material in response to detecting a first actuation of the first button or the second button, respectively, and may stop raising or lowering the present position P_{PRES} of the covering material in response to detecting a second subsequent actuation of the first button or the second button, respectively.

At 914, the control circuit may be configured to determine if the command received at 912 is a command to move the covering material (e.g., a shade movement command). When the command is not a command to move the covering material at 914, the procedure 900 may end at 924. When the command is a command to move the covering material at 914, the control circuit may at 916 set a destination position P_{DEST} for the covering material based on the command in the message received at 912. For example, when the message includes a commanded position P_{CMD}, the control circuit may set the destination position P_{DEST} equal to the commanded position P_{CMD} at 916. In addition, when the message includes a raise command or a lower command, the control circuit may set the destination position P_{DEST} to be a predetermined amount ΔP from the present position P_{PRES} before movement of the covering material starts at 916 (e.g., P_{DEST}=P_{PRES}+ΔP when the command is a raise command or P_{DEST}=P_{PRES}−ΔP when the command is a lower command).

At 918, the control circuit may control the motor drive circuit to rotate the motor to move the covering material. For example, the control circuit may be configured to generate at least one drive signal (e.g., the at least one drive signal VDR) for controlling the motor drive circuit to control the rotational speed and the direction of rotation of the motor. At 920, the control circuit may be configured to determine if the covering material is at the destination position P_{DEST}. When the control circuit determines that the covering material is not at the destination position P_{DEST} at 920, the control circuit may continue to control the motor drive circuit to move the covering material towards the destination position P_{DEST} at 918. When the control circuit determines that the covering material is the destination position P_{DEST} at 920, the control circuit may stop controlling the motor drive circuit to move the covering material and store a movement record of the movement of the covering material in a movement log (e.g., stored in memory) at 922, before the procedure 900 ends at 924. For example, the movement record of each movement of the covering material in the movement log may include a respective starting position, a respective stopping position, and a time of the movement (e.g., a time stamp indicating a time at which the movement occurred as determined from the timeclock).

FIG. 20B is a flowchart of an example procedure 930 for adjusting a present position P_{PRES} of a covering material of a motorized window treatment (e.g., the motorized window treatments described herein). The procedure 930 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). For example, the control circuit may execute the procedure 930 periodically starting at 940. In addition, the control circuit may execute the procedure 930 in response to receiving a message via a communication circuit at 940.

At 942, the control circuit may receive a command. For example, the control circuit may receive a message including a command via a communication circuit (e.g., the communication circuits 422, 522, 722). The command may be, for example, a command to move the covering material (e.g., a shade movement command to adjust the present position P_{PRES} of the covering material). For example, the command may include a commanded position P_{CMD} to which the control circuit should control the present position P_{PRES} of the covering material. In addition, the command may include a command to raise or lower the present position P_{PRES} of the covering material, and the control circuit may be configured to adjust the present position P_{PRES} of the covering material by a predetermined amount ΔP in response to receiving the command. In some examples, the control circuit may be configured to start raising or lowering the covering material in response to receiving a message including a raise command or a lower command, respectively, and may stop raising or lowering the present position P_{PRES} of the covering material in response to receiving a message including a stop command.

In some examples, the command in the message received at 942 may not be a command to move the covering material, but may be a command to enter a mode (e.g., a configuration mode), a command to transmit status information of the motor drive unit, and/or other commands that are not movement commands. Additionally or alternatively, the command may be received in response to an actuation of one or more of the buttons of the motor drive unit (e.g., the button of the user interface circuits 424, 524). For example, the control circuit may be configured to raise or lower the present position P_{PRES} of the covering material by a predetermined amount ΔP in response to detecting an actuation of a first button or a second button, respectively, of the motor drive unit. In addition, the control circuit may be configured to start raising or lowering the covering material in response to detecting a first actuation of the first button or the second button, respectively, and may stop raising or lowering the present position P_{PRES} of the covering material in response to detecting a second subsequent actuation of the first button or the second button, respectively.

At 944, the control circuit may be configured to determine if the command received at 942 is a command to move the covering material (e.g., a shade movement command). When the command is not a command to move the covering material at 944, the procedure 930 may end at 956. When the command is a command to move the covering material at 944, the control circuit may set a destination position P_{DEST} for the covering material at 946 based on the command in the message received at 942. For example, when the message includes a commanded position P_{CMD}, the control circuit may set the destination position P_{DEST} equal to the commanded position P_{CMD} at 946. In addition, when the message includes a raise command or a lower command, the control circuit may set the destination position P_{DEST} to be a predetermined amount ΔP from the present position P_{PRES} before movement of the covering material starts at 946 (e.g., P_{DEST}=P_{PRES}+ΔP when the command is a raise command or P_{DEST}=P_{PRES}−ΔP when the command is a lower command).

At 948, the control circuit may control the motor drive circuit to rotate the motor to move the covering material. For example, the control circuit may be configured to generate at least one drive signal (e.g., the at least one drive signal VDR) for controlling the motor drive circuit to control the rotational speed and the direction of rotation of the motor. At 950, the control circuit may be configured to determine if the covering material is at the destination position P_{DEST}. When the control circuit determines that the covering material is not at the destination position P_{DEST} at 950, the control circuit may continue to control the motor drive circuit to move the covering material towards the destination position P_{DEST} at 948.

When the control circuit determines that the covering material is the destination position P_{DEST} at 950, the control circuit may determine whether destination position P_{DEST} is greater than or equal to a position threshold P_{TH}. The position threshold P_{TH} may be between the lowered position P_{LOWERED} and the raised position P_{RAISED} (e.g., a position that is close to the raised position P_{RAISED}). For example, the position threshold P_{TH} may be a threshold distance away from the raised position P_{RAISED}. If the destination position P_{DEST} is less than the position threshold P_{TH}, the control circuit may exit the procedure 930 at 956. However, if the control circuit determines that destination position P_{DEST} is greater than or equal to the position threshold P_{TH}, the control circuit may control the motor drive circuit to dock the bottom bar (e.g., move the covering material to the raised position P_{RAISED}). For example, the control circuit may control the motor drive unit to dock the bottom bar to charge the energy storage element of the motor drive unit from the energy storage element of the bottom bar module if the destination position P_{DEST} of the covering material is greater than or equal to the position threshold P_{TH} (e.g., the destination position P_{DEST} of the covering material is close to the raised position P_{RAISED}). As such, the control circuit may be configured to dock the bottom bar when the covering material is moved to a position (e.g., the destination position P_{DEST}) that is close to the raised position P_{RAISED}. After controlling the motor drive circuit to dock the bottom bar, the control circuit may exit the procedure 930 at 956.

FIG. 20C is a flowchart of an example procedure 960 for adjusting a present position P_{PRES} of a covering material of a motorized window treatment (e.g., any of the motorized window treatments described herein). The procedure 960 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). For example, the control circuit may execute the procedure 960 periodically starting at 970. In addition, the control circuit may execute the procedure 960 in response to receiving a message via a communication circuit at 970.

At 972, the control circuit may receive a command. For example, the control circuit may receive a message including a command via a communication circuit (e.g., the communication circuits 422, 522, 722). The command may be, for example, a command to move the covering material (e.g., a shade movement command to adjust the present position P_{PRES} of the covering material). For example, the command may include a commanded position P_{CMD} to which the control circuit should control the present position P_{PRES} of the covering material. In addition, the command may include a command to raise or lower the present position P_{PRES} of the covering material, and the control circuit may be configured to adjust the present position P_{PRES} of the covering material by a predetermined amount ΔP in response to receiving the command. In some examples, the control circuit may be configured to start raising or lowering the covering material in response to receiving a message including a raise command or a lower command, respectively, and may stop raising or lowering the present position P_{PRES} of the covering material in response to receiving a message including a stop command.

In some examples, the command in the message received at 972 may not be a command to move the covering material, but may be a command to enter a mode (e.g., a configuration mode), a command to transmit status information of the motor drive unit, and/or other commands that are not movement commands. Additionally or alternatively, the command may be received in response to an actuation of one or more of the buttons of the motor drive unit (e.g., the button of the user interface circuits 424, 524). For example, the control circuit may be configured to raise or lower the present position P_{PRES} of the covering material by a predetermined amount ΔP in response to detecting an actuation of a first button or a second button, respectively, of the motor drive unit. In addition, the control circuit may be configured to start raising or lowering the covering material in response to detecting a first actuation of the first button or the second button, respectively, and may stop raising or lowering the present position P_{PRES} of the covering material in response to detecting a second subsequent actuation of the first button or the second button, respectively.

At 974, the control circuit may be configured to determine if the command received at 972 is a command to move the covering material (e.g., a shade movement command). When the command is not a command to move the covering material at 974, the procedure 970 may end at 990. When the command is a command to move the covering material at 974, the control circuit may set a destination position P_{DEST} for the covering material at 976 based on the command in the message received at 972. For example, when the message includes a commanded position P_{CMD}, the control circuit may set the destination position P_{DEST} equal to the commanded position P_{CMD} at 976. In addition, when the message includes a raise command or a lower command, the control circuit may set the destination position P_{DEST} to be a predetermined amount ΔP from the present position P_{PRES} before movement of the covering material starts at 976 (e.g., P_{DEST}=P_{PRES}+ΔP when the command is a raise command or P_{DEST}=P_{PRES}−ΔP when the command is a lower command).

At 978, the control circuit may control the motor drive circuit to rotate the motor to move the covering material. For example, the control circuit may be configured to generate at least one drive signal (e.g., the at least one drive signal VDR) for controlling the motor drive circuit to control the rotational speed and the direction of rotation of the motor. At 980, the control circuit may be configured to determine whether the timing interval (e.g., the load measurement interval T_{LOAD}) is complete. If the control circuit determines that the timing interval is not complete, the control circuit may continue to control the motor drive circuit to rotate the motor to move the covering material at 978.

If the control circuit determines that the timing interval is complete at 980, the control circuit may be configured to measure a load current I_{LOAD-M} (e.g., the first load current I_{LOAD1}) conducted by the motor drive circuit at 982. For example, the control circuit may receive a sense signal V_{I-SNS} (e.g., a first sense signal V_{I-SNS} from a first sense circuit) that indicates indicate the magnitude of the load current I_{LOAD-M}. The control circuit may be configured to determine the load current I_{LOAD-M} based on sense signal V_{I-SNS} (e.g., as described herein).

At 984, the control circuit may calculate a charge Q_{LOAD-M} and/or an energy E_{LOAD-M} (e.g., a motor-control energy) consumed from the energy storage element by the motor drive circuit and/or the motor, for example, over the timing interval (e.g., the load measurement interval T_{LOAD}). For example, the control circuit may be configured to calculate the charge Q_{LOAD-M} consumed from the energy storage element by the motor drive circuit and/or the motor based on the load current I_{LOAD-M} (e.g., as indicated by the current sense signal V_{I-SNS}) and the timing interval (e.g., the load measurement interval T_{LOAD1}), for example, as described herein. In addition, the control circuit may be configured to calculate the energy E_{LOAD-M} consumed from the energy storage element by the motor drive circuit and/or the motor based on the magnitude of the supply voltage V_{S-A}, the magnitude of the load current I_{LOAD-M}, and the timing interval (e.g., the load measurement interval T_{LOAD1}), for example, as described herein. As such, the control circuit may be configured to calculate the charge Q_{LOAD-M} and/or the energy E_{LOAD-M} consumed from the energy storage element by the motor drive circuit and/or the motor when (e.g., only when) the control circuit is controlling the motor drive circuit to rotate the motor. The control circuit may be configured to calculate the charge Q_{LOAD-M} and/or the energy E_{LOAD-M} consumed from the energy storage element by the motor drive circuit and/or the motor, for example, periodically (e.g., at the load measurement interval T_{LOAD}) when the control circuit is controlling the motor drive circuit to rotate the motor.

At 986, the control circuit may be configured to determine if the covering material is at the destination position P_{DEST}. When the control circuit determines that the covering material is not at the destination position P_{DEST} at 986, the control circuit may continue to control the motor drive circuit to move the covering material towards the destination position P_{DEST} at 978.

When the control circuit determines that the covering material is the destination position P_{DEST} at 986, the control circuit may stop controlling the motor drive circuit to move the covering material and store a movement record of the movement of the covering material in a movement log (e.g., stored in memory) at 988, before the procedure 970 ends at 990. For example, the movement record of each movement of the covering material in the movement log may include a respective starting position, a respective stopping position, and a time of the movement (e.g., a time stamp indicating a time at which the movement occurred as determined from the timeclock). Further, in some examples, the control circuit may be configured to store any combination of the load current I_{LOAD-M}, the charge Q_{LOAD-M} and/or the energy E_{LOAD-M} in memory of the motor drive unit.

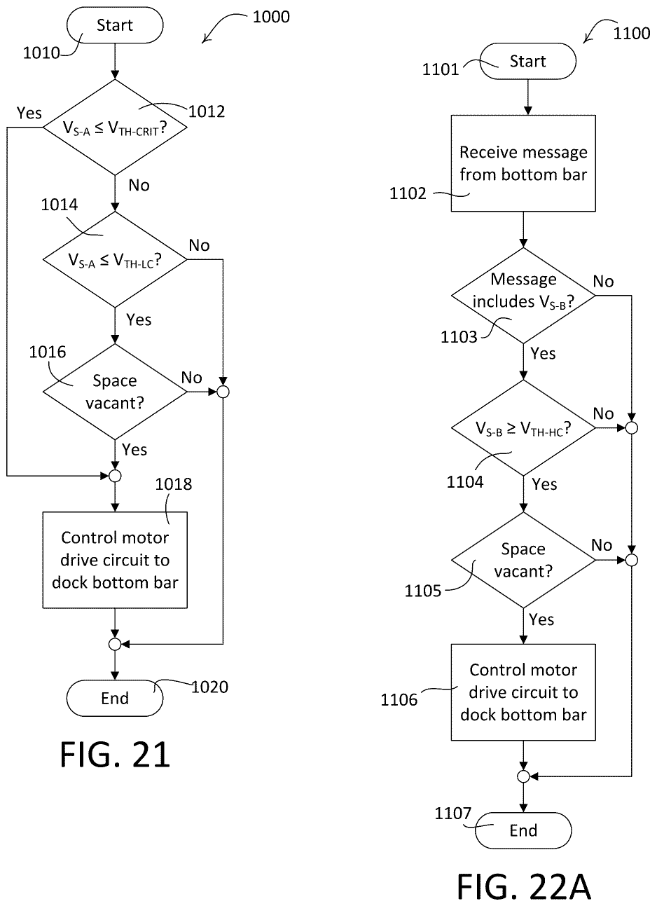

FIG. 21 is a flowchart of an example procedure 1000 for determining when to dock a bottom bar (e.g., the bottom bars 155, 240, 440, 540, 830) of a motorized window treatment (e.g., any of the motorized window treatments described herein). For example, the bottom bar may be connected to a bottom end of a covering material of the motorized window treatment. The procedure 1000 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motor drive unit may comprise a dock (e.g., any of the docks described herein) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1000, the control circuit may determine whether or not to dock the bottom bar in response to a magnitude of a supply voltage generated across the one or more storage element of the motor drive unit (e.g., the first storage voltage V_{S-A} produced across the energy storage element 630 of the solar power system 600). The control circuit may be configured to determine to dock the bottom bar when the magnitude of the first storage voltage V_{S-A} is less than (e.g., is less than or equal to) a low-charge threshold V_{TH-LC} and when (e.g., only when) the space is vacant. In addition, the control circuit may be configured to determine to dock the bottom bar when the magnitude of the first storage voltage V_{S-A} has dropped below a critical-charge threshold V_{TH-CRIT} (e.g., independent of whether the space is occupied or vacant). The critical-charge threshold V_{TH-CRIT} may be smaller than the low-charge threshold V_{TH-LC}. For example, the control circuit may execute the procedure 1000 periodically at 1010 to monitor the magnitude of the first storage voltage V_{S-A}. Further, it should be appreciated that in some examples, the control circuit may determine not to dock the bottom bar when the magnitude of the supply voltage generated across the one or more storage element of the motor drive unit is above an upper threshold (e.g., irrespective of whether other procedures may suggest that the bottom bar should be docked).

At 1012, the control circuit may determine if the magnitude of the first storage voltage V_{S-A} is less than (e.g., less than or equal to) the critical-charge threshold V_{TH-CRIT}. If so, the control circuit may control a motor drive circuit of the motor drive unit (e.g., the motor drive circuit 612) to dock the bottom bar (e.g., to adjust the present position P_{PRES} of the covering material to the raised position P_{RAISED}) at 1018, before the procedure 1000 ends at 1020. If the magnitude of the first storage voltage V_{S-A} is greater than the critical-charge threshold V_{TH-CRIT} at 1012, the control circuit may determine if the magnitude of the first storage voltage V_{S-A} is less than (e.g., less than or equal to) the low-charge threshold V_{TH-LC} at 1014. If the magnitude of the first storage voltage V_{S-A} is greater than the low-charge threshold V_{TH-LC} at 1014, the procedure 1000 may end at 1020 (e.g., without docking the bottom bar).

If the magnitude of the first storage voltage V_{S-A} is less than (e.g., less than or equal to) the low-charge threshold V_{TH-LC} at 1014, the control circuit may determine if the space is vacant at 1016. For example, the control circuit may be configured to determine whether the space is occupied or vacant in response to receiving a message indicating an occupancy condition or a vacancy condition in the space. If the magnitude of the first storage voltage V_{S-A} is less than (e.g., less than or equal to) the low-charge threshold V_{TH-LC} at 1014 and the space is vacant at 1016, the control circuit may control the motor drive circuit of the motor drive unit to dock the bottom bar (e.g., to adjust the present position P_{PRES} of the covering material to the raised position P_{RAISED}) at 1018, before the procedure 1000 ends at 1020. If the magnitude of the first storage voltage V_{S-A} is less than (e.g., less than or equal to) the low-charge threshold V_{TH-LC} at 1014 and the space is not vacant at 1016, the procedure 1000 may end at 1020 (e.g., without docking the bottom bar). As such, and as an example, the control circuit may be configured to dock more often when the space is vacant, such as on the weekends for an office building.

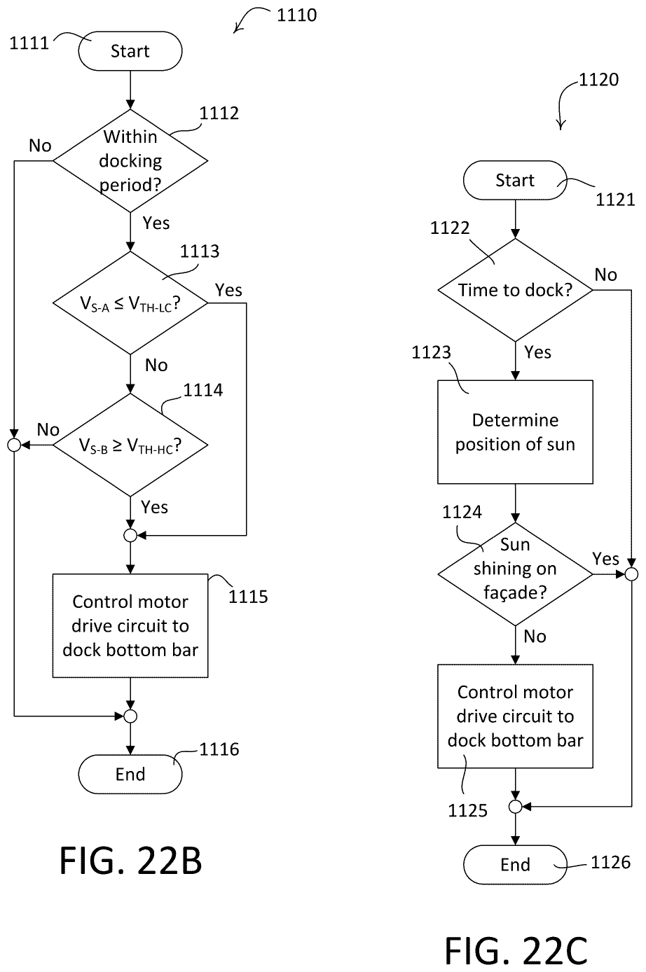

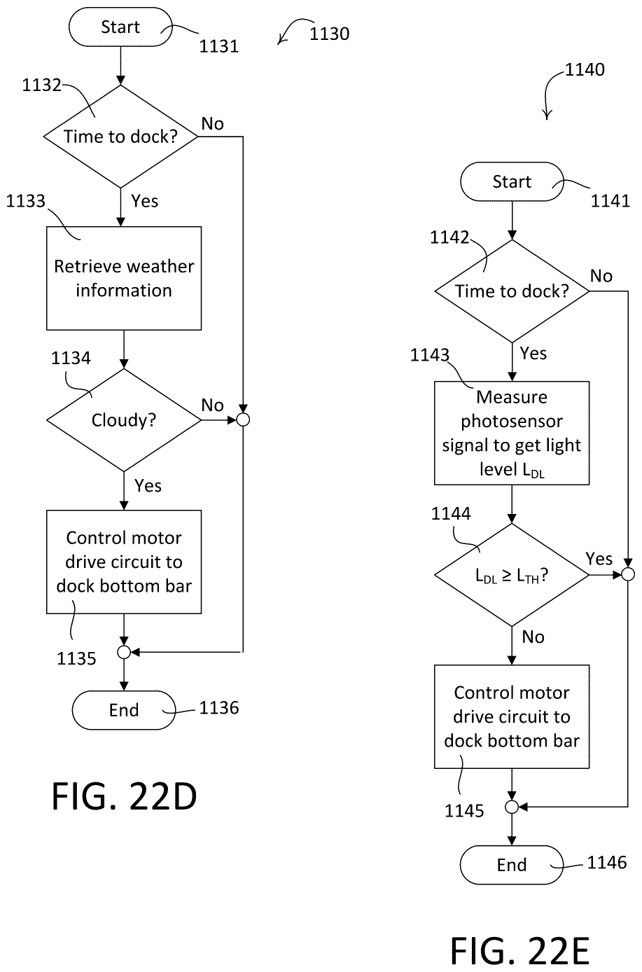

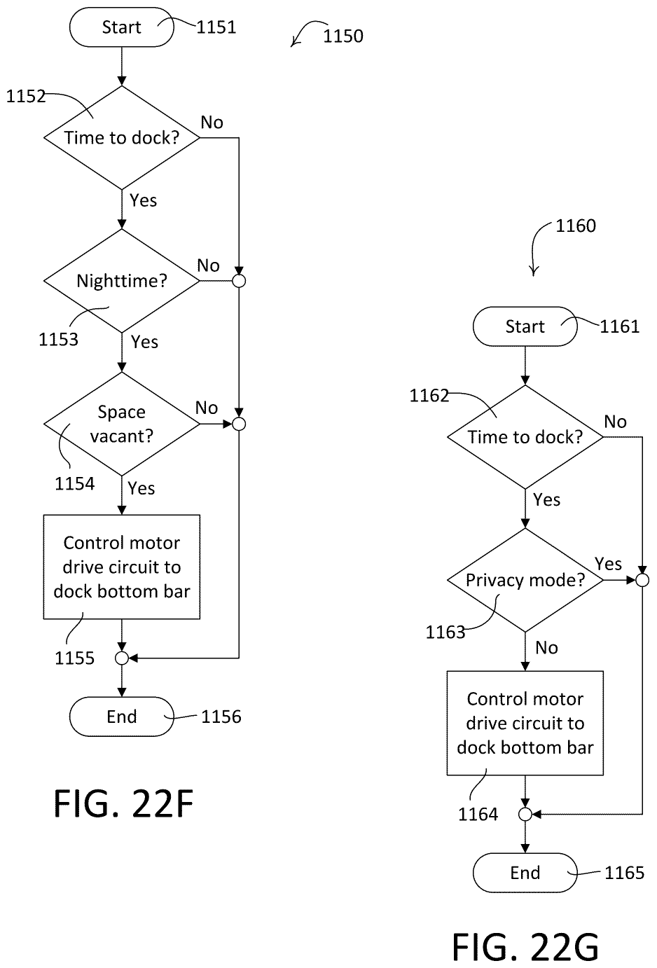

FIG. 22A is a flowchart of an example procedure 1100 for determining when to dock a bottom bar (e.g., the bottom bars 155, 240, 440, 540, 830) of a motorized window treatment (e.g., any of the motorized window treatments described herein). For example, the bottom bar may be connected to a bottom end of a covering material of the motorized window treatment. The procedure 1100 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motor drive unit may comprise a dock (e.g., any of the docks described herein) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1100, the control circuit may determine whether or not to dock the bottom bar in response to a magnitude of a supply voltage generated across the one or more storage elements of the bottom bar (e.g., the second storage voltage V_{S-B} produced across the energy storage element 446 of the bottom bar module 440). The control circuit may be configured to determine to dock the bottom bar when the magnitude of the second storage voltage V_{S-B} is greater than (e.g., is greater than or equal to) a high-charge threshold V_{TH-HC} and when (e.g., only when) the space is vacant. The bottom bar module may be configured to transmit a message including an indication of the magnitude of the second storage voltage V_{S-B} to the motor drive unit. For example, the control circuit may execute the procedure 1100 periodically at 1101 to monitor the magnitude of the second storage voltage V_{S-B}. In addition, the control circuit may execute the procedure 1100 in response to receiving a message from the bottom bar module at 1101.

At 1102, the control circuit may receive a message from the bottom bar module. For example, the message may include an indication of the magnitude of the second storage voltage V_{S-B}. If the message includes the magnitude of the second storage voltage V_{S-B} at 1103, the control circuit may determine if the magnitude of the second storage voltage V_{S-B} is greater than (e.g., greater than or equal to) the high-charge threshold V_{TH-HC} at 1104. If the message does not include the magnitude of the second storage voltage V_{S-B} at 1103 or if the magnitude of the second storage voltage V_{S-B} is greater than (e.g., greater than or equal to) the high-charge threshold V_{TH-HC} at 1104, the procedure 1100 may end at 1107.

If the magnitude of the second storage voltage V_{S-B} is greater than (e.g., greater than or equal to) the high-charge threshold V_{TH-HC} at 1104, the control circuit may determine if the space is vacant at 1105. For example, the control circuit may be configured to determine whether the space is occupied or vacant in response to receiving a message indicating an occupancy condition or a vacancy condition in the space. If the magnitude of the second storage voltage V_{S-B} is greater than (e.g., greater than or equal to) the high-charge threshold V_{TH-HC} at 1104 and the space is vacant at 1105, the control circuit may control a motor drive circuit of the motor drive unit (e.g., the motor drive circuit 612) to dock the bottom bar (e.g., to adjust the present position P_{PRES} of the covering material to the raised position P_{RAISED}) at 1106, before the procedure 1100 ends at 1107. If the magnitude of the second storage voltage V_{S-B} is greater than (e.g., greater than or equal to) the high-charge threshold V_{TH-LC} at 1104 and the space is not vacant at 1105, the procedure 1100 may end at 1107 (e.g., without docking the bottom bar).

Rather than transmitting a message that indicates the magnitude of the second storage voltage V_{S-B}, the bottom bar module may be configured to determine if the magnitude of the second storage voltage V_{S-B} is greater than (e.g., greater than or equal to) the high-charge threshold V_{TH-HC} and transmit a message indicating that the motor drive unit should dock the bottom bar when the magnitude of the second storage voltage V_{S-B} is greater than (e.g., greater than or equal to) the high-charge threshold V_{TH-HC}. In such an example, the control circuit may determine if the message includes an indication to dock the bottom bar at 1103 of the procedure 1100 and the determination of whether the magnitude of the second storage voltage V_{S-B} is greater than (e.g., greater than or equal to) the high-charge threshold V_{TH-HC} at 1104 may be omitted.

FIG. 22B is a flowchart of an example procedure 1110 for determining when to dock a bottom bar (e.g., the bottom bars 155, 240, 440, 540, 830) of a motorized window treatment (e.g., any of the motorized window treatments described herein). For example, the bottom bar may be connected to a bottom end of a covering material of the motorized window treatment. The procedure 1110 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motor drive unit may comprise a dock (e.g., the docks 280, 280b, 380, 480, 580a, 580b, 580c) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1110, the control circuit may determine whether or not to dock the bottom bar in response to a docking window (e.g., a docking time period), a magnitude of a supply voltage generated across the one or more energy storage elements of the motor drive unit (e.g., the first storage voltage V_{S-A} produced across the energy storage element 630 of the motor drive unit 610), a magnitude of a supply voltage generated across the one or more storage elements of the bottom bar (e.g., the second storage voltage V_{S-B} produced across the energy storage element 446 of the bottom bar module 440). The docking window may be a scheduled time that, for example, may be configured by the user. The docking window may occur periodically (e.g., at a docking interval), such as every day (e.g., every night at 3:00 am). The control circuit may be configured to determine to dock the bottom bar during the docking window when the magnitude of the first storage voltage V_{S-A} is less than (e.g., is less than or equal to) the low-charge threshold V_{TH-LC} or when the magnitude of the second storage voltage V_{S-B} is greater than (e.g., is greater than or equal to) the high-charge threshold V_{TH-HC}. The bottom bar module may be configured to transmit a message including an indication of the magnitude of the second storage voltage V_{S-B} to the motor drive unit. For example, the control circuit may periodically receive a message that indicates the magnitude of the second storage voltage V_{S-B}. The control circuit may start the procedure 1110 at 1111. The control circuit may execute the procedure 1110 periodically. In some examples, the control circuit may execute the procedure 1110 at a particular time of day (e.g., at the beginning of the docking time period and/or in response to receiving a message (e.g., a message indicating the beginning of the docking time period).

At 1112, the control circuit may determine whether the motorized window treatment is within the docking window (e.g., based on a timeclock of the control circuit and/or receiving a message indicating the beginning of the docking window). If the control circuit determines that the present time is not within the docking window, the control circuit may exit the procedure 1110. However, if the control circuit determines that the present time is within the docking window, the control circuit may determines whether the first storage voltage V_{S-A} of the energy storage elements in the motor drive unit is less than (e.g., is less than or equal to) the low-charge threshold V_{TH-LC} at 1113. If the control circuit determines that the first storage voltage V_{S-A} is less than the low-charge threshold V_{TH-LC} at 1113, the control circuit may control a motor drive circuit of the motor drive unit (e.g., the motor drive circuit 612) to dock the bottom bar (e.g., to adjust the present position P_{PRES} of the covering material to the raised position P_{RAISED}) at 1115, before the procedure 1110 ends at 1116. As such, if the control circuit determines that the first storage voltage V_{S-A} is less than the low-charge threshold V_{TH-LC} during the docking window, the control circuit may dock the bottom bar (e.g., to charge the storage element of the motor drive unit when the first storage voltage level V_{S-A} is low during the scheduled docking window).

If the control circuit determines that the first storage voltage V_{S-A} is greater than the low-charge threshold V_{TH-LC} at 1113, the control circuit may determine whether the magnitude of the second storage voltage V_{S-B} of the energy storage elements in the bottom bar is greater than (e.g., is greater than or equal to) the high-charge threshold V_{TH-HC} at 1114. If the control circuit determines that the magnitude of the second storage voltage V_{S-B} is greater than the high-charge threshold V_{TH-HC} at 1114, the control circuit may control the motor drive circuit of the motor drive unit to dock the bottom bar at 1115, before the procedure 1110 ends at 1116. As such, if the control circuit determines that the magnitude of the second storage voltage V_{S-B} is greater than the high-charge threshold V_{TH-HC} during the docking window, the control circuit may dock the bottom bar (e.g., to charge the storage element of the motor drive unit and discharge the storage elements of the bottom bar during the scheduled docking window). However, if the control circuit determines that the magnitude of the second storage voltage V_{S-B} is less than the high-charge threshold V_{TH-HC} at 1114, the control circuit may exit the procedure 1110 at 1116 (e.g., without docking the bottom bar), for example, because there is little benefit to moving the docking the bottom bar if the first storage voltage V_{S-A} is greater than the low-charge threshold V_{TH-LC} and the second storage voltage V_{S-B} is less than the high-charge threshold V_{TH-HC}.

FIG. 22C is a flowchart of an example procedure 1120 for determining when to dock a bottom bar (e.g., the bottom bars 155, 240, 440, 540, 830) of a motorized window treatment (e.g., any of the motorized window treatments described herein). For example, the bottom bar may be connected to a bottom end of a covering material of the motorized window treatment. The procedure 1120 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motor drive unit may comprise a dock (e.g., the docks 280, 280b, 380, 480, 580a, 580b, 580c) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1120, the control circuit may determine whether or not to dock the bottom bar based on the position of the sun. For example, the control circuit may determine to dock the bottom bar if the sun is not shining on a façade on which the motorized window treatment is installed, for instance, to take advance of instances where the solar cells are less likely to be missing out on collecting a relatively large amount of solar energy. The control circuit (e.g., and/or a system controller that is in communication with the control circuit) may be configured to calculate a predicted position of the sun at a plurality of discrete times in a day. The position of the sun in the sky may be defined by a solar altitude angle at and a solar azimuth angle a_{S}. The control circuit may determine the solar altitude angle at and the solar azimuth angle aₛ as functions of the date (e.g., a Julian date) and time (e.g., the standard time tₛ), as well as the position (e.g., longitude λ and latitude φ) of the building in which the window and/or motorized window treatment is located.

For example, the system controller and/or the control circuit may be configured to calculate the solar altitude angle aₜ and the solar azimuth angle aₛ using the following equations. The difference in a solar time tₛₒₗₐᵣ (e.g., a time as given by a sundial) and a standard time tₛ (e.g., a time as given by a clock) due to the obliquity of the Earth's axis of rotation may be defined by an equation of time ET. The equation of time ET can be determined as a function of the present Julian date J using, for example, the equation:

$$ET = 0.1644 \cdot sin ( A ) - 0.1273 \cdot cos ( B ) , \qquad ( Equation 1 )$$

where A=[4π·(J−81.6)]/365.25 and B=[2π·(J−2.5)]/365.25. The Julian date J may be a decimal number representing the present day in the year. For example, the Julian date J may equal one for January 1, two for January 2, three for January 3, and so on. The solar time tₛₒₗₐᵣ may be calculated as a function of the standard time tₛ, the equation of time ET, a standard meridian SM of the time zone of the location of the building, and the longitude λ, for example, using the equation:

$${t}_{solar} = {t}_{s} + ET + [ 12 \cdot ( SM - λ ) ] / π . \qquad ( Equation 2 )$$

The standard meridian SM may be determined from the time zone of the location of the building. Each time zone may have a unique standard meridian, which may define a particular line of latitude within the time zone. There may be approximately 15° between the standard meridians of adjacent time zones. The solar altitude angle as and the solar azimuth angle a_{z} may be determined from a solar declination δ. The solar declination δ may define an angle of incidence of the rays of the sun on the equatorial plane of the Earth. The solar declination δ may be determined using, for example, the equation:

$$δ = 0.4093 \cdot sin [ 2 π \cdot ( J - 81 ) / 368 ] . \qquad ( Equation 3 )$$

The solar altitude angle aₜ at the standard time is may be calculated as a function of the solar time tₛₒₗₐᵣ, the solar declination δ, and the local latitude Φ using, for example, the equation:

$${a}_{t} = arc sin [ sin ( Φ ) \cdot sin ( δ ) - cos ( Φ ) \cdot cos ( δ ) \cdot cos ( π \cdot {t}_{solar} / 12 ) ] . \qquad ( Equation 4 )$$

The solar azimuth angle as at the standard time is may be calculated as a function of the solar time tₛₒₗₐᵣ, the solar declination δ, and the local latitude Φ using, for example, the equation:

$$\begin{matrix}{a}_{s} = arc tan [ - cos ( δ ) \cdot sin ( π \cdot {t}_{solar} / 12 ) / C ] , \\ where C = - [ cos ( ϕ ) \cdot sin ( δ ) + sin ( ϕ ) \cdot cos ( δ ) \cdot cos ( π \cdot {t}_{solar} / 12 ) ] .\end{matrix} \qquad ( Equation 5 )$$

An example of a motorized window treatment that is configured to determine the position of the sun is described in U.S. Patent Pub. No. 2021/0180399, which is hereby incorporated by reference in its entirety.

The procedure 1120 may start at 1121. At 1122, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1120 may end at 1126. In some examples, the determination of whether or not to dock at 1122 may be omitted.

If the control circuit determines that it is time to dock, the control circuit may determine the position of the sun at 1123. For example, the control circuit may calculate the position of the sun based on a predicted position of the sun. Alternatively, the control circuit may receive an indication of the predicted position of the sun from a system controller. At 1124, the control circuit may determine whether the sun may be shining on a façade of the building of which the motorized window treatment is installed. Since there may be cloud cover or another obstruction between the façade and the sun, the predicted position of the sun may indicate whether there is potentially sun shining on the façade of the building of which the motorized window treatment is installed. For example, the control circuit may be configured to determine whether the sun may be shining on the façade of which the motorized window treatment is installed at 1123 by comparing the calculated solar altitude angle at and/or the calculated solar azimuth angle as to one or more thresholds to determine if the calculated solar altitude angle at and/or the calculated solar azimuth angle as are within ranges that indicate that the sun may be shining on the façade. If the control circuit determines that the sun may be shining on the façade, the procedure 1120 may end at 1126.

If the control circuit determines that the sun is not shining on the façade at 1124, the control circuit may control the motor drive circuit to dock the bottom bar at 1125, before the procedure 1120 exits at 1126. For instance, the control circuit may control a motor drive circuit of the motor drive unit (e.g., the motor drive circuit 612) to dock the bottom bar (e.g., to adjust the present position P_{PRES} of the covering material to the raised position P_{RAISED}) at 1125, before the procedure 1120 ends at 1126. As such, if the control circuit determines that the sun is not shining on the façade, the control circuit may dock the bottom bar because the solar cells of the bottom bar are unlikely to be receiving solar energy (e.g., or significant solar energy) from the sun at that moment in time. Therefore, docking the bottom bar when the sun is not shining on the façade will allow the bottom bar to dock when there is a lower likelihood or probability that the solar cells would be missing out on collecting a relatively large amount of solar energy.

FIG. 22D is a flowchart of an example procedure 1130 for determining when to dock a bottom bar (e.g., the bottom bars 155, 240, 440, 540, 830) of a motorized window treatment (e.g., any of the motorized window treatments described herein). For example, the bottom bar may be connected to a bottom end of a covering material of the motorized window treatment. The procedure 1130 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motor drive unit may comprise a dock (e.g., the docks 280, 280b, 380, 480, 580a, 580b, 580c) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1130, the control circuit may determine whether or not to dock the bottom bar based on weather information (e.g., temperature, cloud coverage, precipitation, barometric pressure, etc.). For example, the control circuit may determine to dock the bottom bar if it is cloudy, for instance, to take advance of instances where the solar cells are less likely to be missing out on collecting a relatively large amount of solar energy. The control circuit (e.g., and/or a system controller that is in communication with the control circuit) may be configured to determine the weather in the location of the motorized window treatment from an external source, such as a weather service (e.g., via the Internet), a weather application, and/or a weather application programming interface (API).

The procedure 1130 may start at 1131. At 1132, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1130 may end at 1136. In some examples, the determination of whether or not to dock at 1132 may be omitted.

If the control circuit determines that it is time to dock, the control circuit may retrieve weather information at 1133. For example, the control circuit may retrieve the weather information (e.g., directly or indirectly, via a system controller) from a weather application. At 1134, the control circuit may determine whether it is cloudy at the location of the motorized window treatment. If the control circuit determines that it is not cloudy, the procedure 1130 may end at 1136.

If the control circuit determines that it is cloudy at 1134, the control circuit may control the motor drive circuit to dock the bottom bar at 1135, before the procedure 1130 exits at 1136. For instance, the control circuit may control a motor drive circuit of the motor drive unit (e.g., the motor drive circuit 612) to dock the bottom bar (e.g., to adjust the present position P_{PRES} of the covering material to the raised position P_{RAISED}) at 1135, before the procedure 1130 ends at 1136. As such, if the control circuit determines that it is cloudy at the location of the motorized window treatment, the control circuit may dock the bottom bar because the solar cells of the bottom bar are unlikely to be receiving solar energy (e.g., or significant solar energy) from the sun at that moment in time. Therefore, docking the bottom bar when it is cloudy will allow the bottom bar to dock when there is a lower likelihood or probability that the solar cells would be missing out on collecting a relatively large amount of solar energy.

FIG. 22E is a flowchart of an example procedure 1140 for determining when to dock a bottom bar (e.g., the bottom bars 155, 240, 440, 540, 830) of a motorized window treatment (e.g., any of the motorized window treatments described herein). For example, the bottom bar may be connected to a bottom end of a covering material of the motorized window treatment. The procedure 1140 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motor drive unit may comprise a dock (e.g., the docks 280, 280b, 380, 480, 580a, 580b, 580c) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1140, the control circuit may determine whether or not to dock the bottom bar based on feedback from a photosensor (e.g., of the sensor circuits of the motor drive units 410, 510). For instance, in some examples, the motorized window treatment (e.g., the motor drive unit and/or the bottom bar) may include a photosensor that is configured to measure light and generate a signal indicating the amount of light. As such, the control circuit may receive an indication of the amount of light from the photosensor and determine a daylight level L_{DL}. The photosensor may be oriented such that it faces towards the window to measure the amount of light (e.g., sunlight) hitting the window (e.g., which may be an indicator of the amount of light directed towards the solar cells of the motorized window treatment). For example, the control circuit may determine to dock the bottom bar if there is less light, for instance, to take advance of instances where the solar cells are less likely to be missing out on collecting a relatively large amount of solar energy.

The procedure 1140 may start at 1141. At 1142, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1140 may end at 1146. In some examples, the determination of whether or not to dock at 1142 may be omitted.

If the control circuit determines that it is time to dock, the control circuit may measure the signal from the photosensor to determine the daylight level L_{DL} at 1143. For example, the photosensor may be oriented such that it faces towards the window, and as such, the daylight level L_{DL} may indicate the amount of light (e.g., sunlight) hitting the window (e.g., which may be an indicator of the amount of light directed towards the solar cells of the motorized window treatment). At 1144, the control circuit may determine whether the daylight level L_{DL} is greater than or equal to a threshold light level L_{TH}. If the control circuit determines that the daylight level L_{DL} is greater than or equal to the threshold light level L_{TH}, the procedure 1140 may end at 1146.

If the control circuit determines that the daylight level L_{DL} is less than the threshold light level L_{TH} at 1144, the control circuit may control the motor drive circuit to dock the bottom bar at 1145, before the procedure 1140 exits at 1146. For instance, the control circuit may control a motor drive circuit of the motor drive unit (e.g., the motor drive circuit 612) to dock the bottom bar (e.g., to adjust the present position P_{PRES} of the covering material to the raised position P_{RAISED}) at 1145, before the procedure 1140 ends at 1146. As such, if the control circuit determines that the daylight level L_{DL} is less than the threshold light level L_{TH}, the control circuit may dock the bottom bar because the solar cells of the bottom bar are unlikely to be receiving solar energy (e.g., or significant solar energy) from the sun at that moment in time. Therefore, docking the bottom bar when the photosensor measures lower light levels will allow the bottom bar to dock when there is a lower likelihood or probability that the solar cells would be missing out on collecting a relatively large amount of solar energy.

FIG. 22F is a flowchart of an example procedure 1150 for determining when to dock a bottom bar (e.g., the bottom bars 155, 240, 440, 540, 830) of a motorized window treatment (e.g., any of the motorized window treatments described herein). For example, the bottom bar may be connected to a bottom end of a covering material of the motorized window treatment. The procedure 1150 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motor drive unit may comprise a dock (e.g., the docks 280, 280b, 380, 480, 580a, 580b, 580c) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1150, the control circuit may determine whether or not to dock the bottom bar based on whether it is nighttime and/or the space is vacant. The control circuit may determine it is nighttime based on a timeclock (e.g., nighttime may be defined as between an hour range, such as between 9 μm and 5 am). The control circuit may determine the space is vacant based on feedback from one or more occupancy and/or vacancy sensors (e.g., directly or indirectly by way of a system controller). The control circuit may determine to dock the bottom bar if it is nighttime and the space is vacant, for instance, because nobody is in the space (e.g., it will cause less disruption to the user) and to take advance of instances where the solar cells are less likely to be missing out on collecting a relatively large amount of solar energy.

The procedure 1150 may start at 1151. At 1152, the control circuit may determine whether it is time to dock the bottom bar of the motorized window treatment. For example, the control circuit may determine whether it is time to dock the bottom bar using one or more of the methods described herein, such as based on the reception of an instruction to dock, a timeclock, a docking window or interval, the charge of the energy storage elements of the motor drive unit and/or the bottom bar, etc. If the control circuit determines that it is not time to dock, the procedure 1150 may end at 1156. In some examples, the determination of whether or not to dock at 1152 may be omitted.

If the control circuit determines that it is time to dock, the control circuit may determine whether it is nighttime at 1153. For example, the control circuit may determine that it is nighttime based on a timeclock and/or based on a message received from a system controller. In some examples, the control circuit may determine that it is nighttime when it is between an hour range, such as between 9 μm and 5 am, and/or based on times of sunset and sunrise for the location of the motorized window treatment and at the particular time of the year (e.g., when the timeclock is an astronomical timeclock). If the control circuit determines that it is not nighttime, the procedure 1150 may end at 1156.

If the control circuit determines that it is nighttime at 1153, the control circuit may determine whether the space is vacant at 1154. For example, the control circuit may receive an occupied command and/or a vacant command from an occupancy sensor (e.g., directly, or indirectly via a system controller). In some examples, the occupancy sensor may be located on the bottom bar. Alternatively or additionally, the control circuit may be configured to determine that the space is vacant based on data received from one or more calendar programs (e.g., no meeting is scheduled in the space at that time). If the control circuit determines that the space is not vacant, the procedure 1150 may end at 1156.

If the control circuit determines that the space is vacant at 1154, the control circuit may control the motor drive circuit to dock the bottom bar at 1155, before the procedure 1150 exits at 1156. For instance, the control circuit may control a motor drive circuit of the motor drive unit (e.g., the motor drive circuit 612) to dock the bottom bar (e.g., to adjust the present position P_{PRES} of the covering material to the raised position P_{RAISED}) at 1155, before the procedure 1150 ends at 1156. As such, if the control circuit determines that it is nighttime and that the space is vacant, the control circuit may dock the bottom bar because the movement of the bottom bar will not bother the user (e.g., in the case of a commercial building) and the solar cells of the bottom bar are unlikely to be receiving solar energy (e.g., or significant solar energy) from the sun at that moment in time.

FIG. 22G is a flowchart of an example procedure 1160 for determining when to dock a bottom bar (e.g., the bottom bars 155, 240, 440, 540, 830) of a motorized window treatment (e.g., any of the motorized window treatments described herein). For example, the bottom bar may be connected to a bottom end of a covering material of the motorized window treatment. The procedure 1160 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motor drive unit may comprise a dock (e.g., the docks 280, 280b, 380, 480, 580a, 580b, 580c) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}).

During the procedure 1160, the control circuit may determine whether or not to dock the bottom bar based on whether the motorized window treatment is in privacy mode. The motorized window treatment may be configured to enter a privacy mode where, for example, the covering material will remain in the lowered position P_{LOWERED}. The privacy mode may be defined by a timeclock schedule (e.g., the privacy mode may be activated and deactivated based on the timeclock schedule). For example, the control circuit may determine that it is nighttime based on a timeclock and/or based on a message received from a system controller. For instance, privacy mode may be defined by one or more time periods (e.g., a time period during the morning, such as between 6-8 am, and a time period at night, such as between 8-10 μm). In some examples, the time periods defined by the privacy mode may be based on sunrise and/or sunset times for the location of the motorized window treatment and at the particular time of the year (e.g., via an astronomical timeclock). When in the privacy mode, the control circuit may ensure that the covering material is in the lowered position P_{LOWERED} to ensure that the user has privacy. In some examples, during the privacy mode, the control circuit may disable certain docking movements and/or procedures to ensure that the covering material does not move from the lowered position P_{LOWERED} (e.g., unless a direct command from the user is received). The control circuit may determine not to dock the bottom bar if the motorized window treatment is in privacy mode to, for example, ensure that the covering material remains in the lowered position P_{LOWERED}.

The procedure 1160 may start at 1161. At 1162, the control circuit may determine whether it is time to dock the bottom bar of the motorized window treatment. For example, the control circuit may determine whether it is time to dock the bottom bar using one or more of the methods described herein, such as based on a timeclock, a docking window or interval, the charge of the energy storage elements of the motor drive unit and/or the bottom bar, etc. If the control circuit determines that it is not time to dock, the procedure 1160 may end at 1165. In some examples, the determination of whether or not to dock at 1162 may be omitted.

If the control circuit determines that it is time to dock, the control circuit may determine whether it is in privacy mode at 1163. The privacy mode may be defined by a timeclock schedule. For instance, privacy mode may be defined by one or more time periods (e.g., a time period during the morning, such as between 6-8 am, and a time period at night, such as between 8-10 pm). In some examples, the time periods defined by the privacy mode may be based on sunrise and/or sunset times for the location of the motorized window treatment and at the particular time of the year (e.g., via astronomical timeclock).

If the control circuit determines that it is not in privacy mode at 1163, the control the motor drive circuit to dock the bottom bar at 1164, before the procedure 1160 exits at 1165. For instance, the control circuit may control a motor drive circuit of the motor drive unit (e.g., the motor drive circuit 612) to dock the bottom bar (e.g., to adjust the present position P_{PRES} of the covering material to the raised position P_{RAISED}) at 1164, before the procedure 1160 ends at 1165. If the control circuit determines that it is in privacy mode at 1163, the procedure 1160 may end at 1165. As such, even though the control circuit determines that it is time to dock at 1162, the control circuit will not dock if the control circuit determines that it is in privacy mode at 1163.

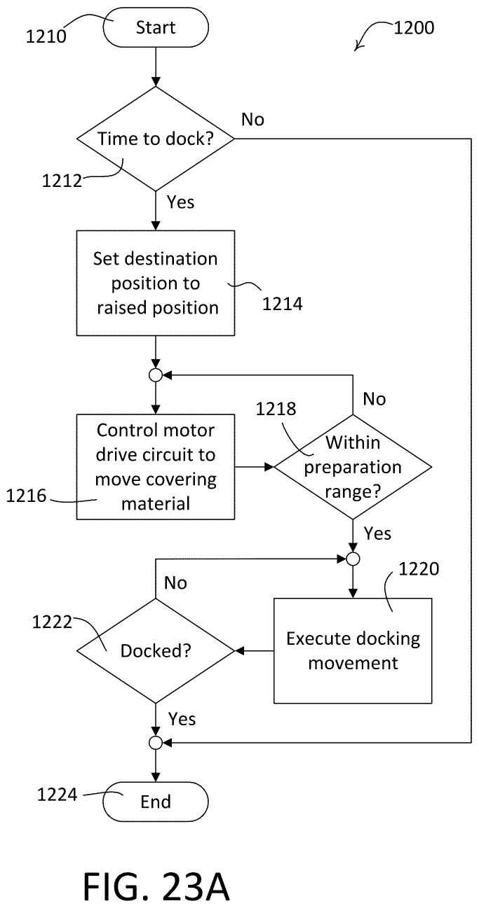

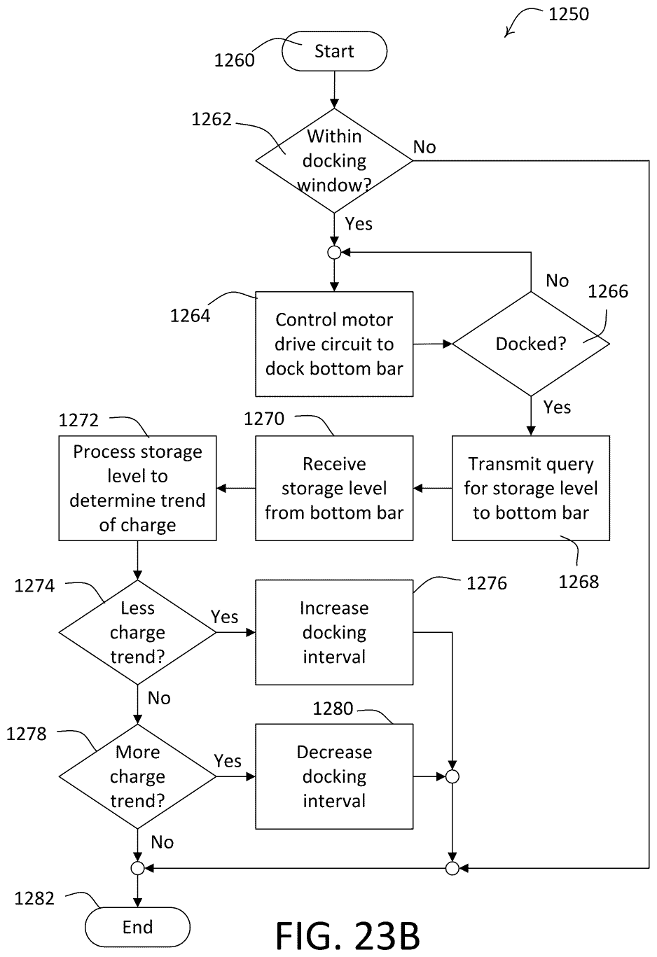

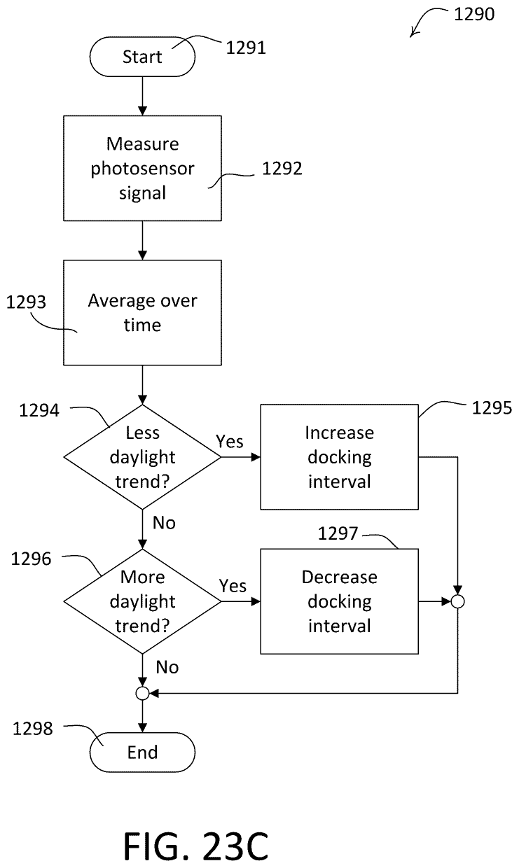

FIG. 23A is a flowchart of an example procedure 1200 for docking a bottom bar (e.g., the bottom bars 155, 240, 440, 540, 830) of a motorized window treatment (e.g., any of the motorized window treatments described herein). For example, the bottom bar may be connected to a bottom end of a covering material of the motorized window treatment. The procedure 1200 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motor drive unit may be configured to control a present position P_{PRES} of the covering material. The motor drive unit may comprise a dock (e.g., the docks 280, 280b, 380, 480, 580a, 580b, 580c) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}). For example, the control circuit may execute the procedure 1200 periodically at 1210 to determine if the bottom bar should be docked (e.g., should control the present position P_{PRES} of the covering material to the raised position P_{RAISED}).

At 1212, the control circuit may be configured to determine if the motor drive unit should presently dock the bottom bar. For example, the control circuit may be configured to determine that the bottom bar should be docked when the space in which the motorized window treatment is installed is vacant and the magnitude of a first storage voltage V_{S-A} produced across an energy storage element of the motor drive unit is less than a low-charge threshold V_{TH-LC}, and/or the space is occupied and the magnitude of the first storage voltage V_{S-A} produced across the energy storage element of the motor drive unit is less than a critical-charge threshold V_{TH-CRIT} (e.g., as shown in FIG. 21). In addition, the control circuit may determine to that the bottom bar should be docked when the magnitude of a second storage voltage V_{S-B} produced across an energy storage element of the bottom bar module is greater than a high-charge threshold V_{TH-HC} (e.g., as shown in FIG. 22A). Further, the control circuit of the motor may be configured to determine that the bottom bar should be docked in response to the present day of the week and/or the time of the day. When the control circuit determines that the motor drive unit should not presently dock the bottom bar at 1212, the procedure 1200 may end at 1224.

When the control circuit determines that the motor drive unit should presently dock the bottom bar at 1212, the control circuit may set a destination position P_{DEST} to the raised position P_{RAISED} at 1214 and control the motor drive circuit to rotate the motor to move the covering material at 1216. For example, the control circuit may be configured to generate at least one drive signal (e.g., the at least one drive signal VDR) for controlling the motor drive circuit to control the rotational speed and the direction of rotation of the motor at 1216.

In some examples, even if the control circuit determines that the motor drive unit should dock the bottom bar at 1212, the control circuit may skip the docking event. For example, the control circuit may skip the docking event if the magnitude of the first storage voltage V_{S-A} produced across the energy storage element of the motor drive unit is above a charge threshold (e.g., the energy storage element of the motor drive unit has sufficient charge). Further, in some examples, even if the control circuit determines that the motor drive unit should dock the bottom bar at 1212, the control circuit may send a message (e.g., via email, text, an alert via a mobile app, etc.) to a user, and wait to dock until a confirmation is received from the user that the motor drive unit should dock the bottom bar.

At 1218, the control circuit may determine if the present position P_{PRES} of is within a docking preparation range. For example, the docking preparation range may extend a predetermined distance from the raised position PRAISE. When the covering material is not within the docking preparation range 1218, the control circuit may continue to control the motor drive circuit to rotate the motor to move the covering material at 1216. When the covering material is within the docking preparation range at 1218, the control circuit may control the motor through a docking movement (e.g., a docking sequence) at 1220. For example, the control circuit may ramp down the rotational speed at which the motor is rotating as the bottom bar nears the dock as part of the docking movement.

At 1222, the control circuit may determine if the bottom bar is docked. For example, the control circuit may be configured to determine if the bottom bar is docked by determining if electrical connections of the dock of the motor drive unit are electrically connected to the electrical connections of the bottom bar module at 1222. For example, the control circuit may be configured to determine that the bottom bar is docked by detecting that the second storage voltage V_{S-B} is present at the electrical connection of the dock (e.g., the electrical connections 638). When the control circuit determines that the bottom bar is not presently docked at 1222, the control circuit may continue to control the motor through the docking movement at 1220. When the control circuit determines that the bottom bar is presently docked at 1222, the procedure 1200 may end at 1224.

FIG. 23B is a flowchart of an example procedure 1050 for docking a bottom bar (e.g., the bottom bars 155, 240, 440, 540, 830) of a motorized window treatment (e.g., any of the motorized window treatments described herein). For example, the bottom bar may be connected to a bottom end of a covering material of the motorized window treatment. The procedure 1250 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motor drive unit may be configured to control a present position P_{PRES} of the covering material. The motor drive unit may comprise a dock (e.g., the docks 280, 280b, 380, 480, 580a, 580b, 580c) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}). For example, the control circuit may execute the procedure 1250 periodically at 1260 to determine if a docking interval should be increased or decreased. The docking interval may indicate a scheduled time or interval of time at the conclusion of which the control circuit is configured to dock the bottom bar. In some examples, the docking interval may indicate the beginning of a docking window during which the window treatment may dock. The docking interval may be configured by the user and/or stored in memory of the motorized window treatment. The docking interval could be set to end on a periodic basis, such as at a particular time every day (e.g., every night at 3:00 am). The procedure 1250 may be used in embodiments where the there is no wireless communication between the motor drive unit and hembar, and docking is performed at a scheduled time (e.g., according to the docking interval). The procedure 1250 may be implemented to ensure that the energy storage elements of the bottom bar and/or of the motor drive unit do not overcharge (e.g., to extend the life of the energy storage elements).

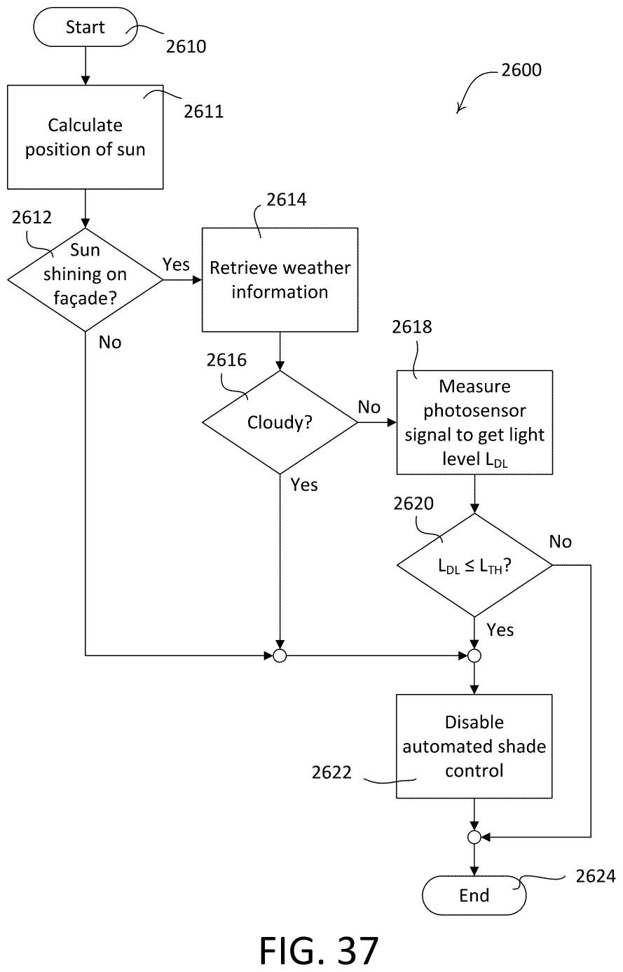

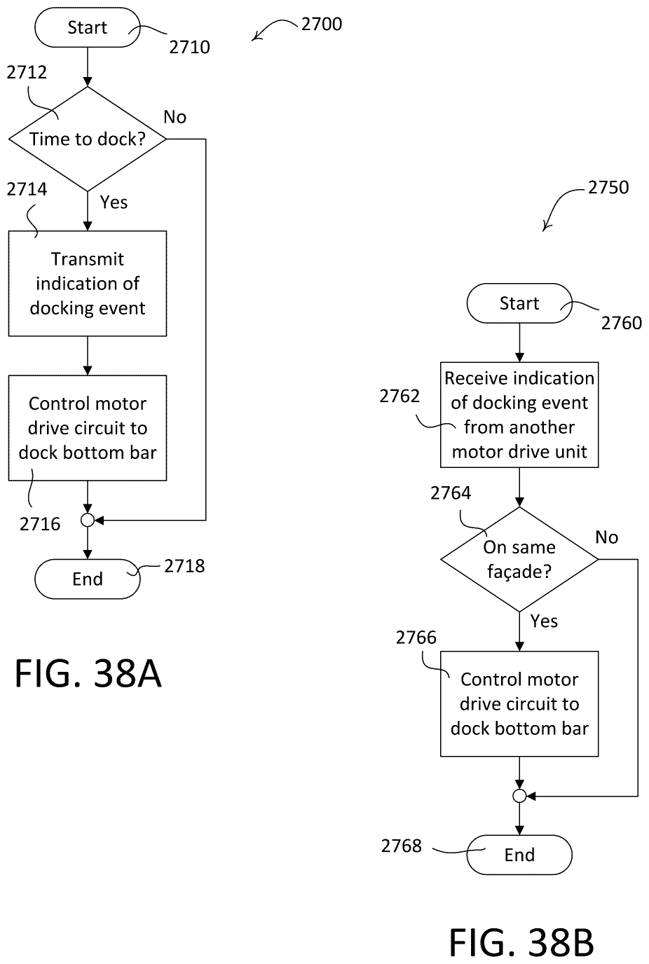

At 1262, the control circuit may be configured to determine whether it is the end of the docking interval based on a timeclock (e.g., whether it is time for the control circuit to dock the bottom bar). In some examples, the control circuit may consider other factors when determining whether to dock the bottom bar (e.g., as described with reference to FIGS. 37, 38A, and 38B). If the control circuit determines that it is not the end of the docking interval, the control circuit may return to 1262 and continue to monitor the timeclock to determine whether it is the end of the docking interval. If the control circuit determines that it is the end of the docking interval, the control circuit may control the motor drive circuit of the motor drive unit (e.g., the motor drive circuit 612) to dock the bottom bar (e.g., to adjust the present position P_{PRES} of the covering material to the raised position P_{RAISED}) at 1266.

At 1266, the control circuit may be configured to determine if the bottom bar is docked. When the control circuit determines that the bottom bar is not docked at 1266, the control circuit may continue to control the motor drive circuit to move the covering material towards the raised position P_{RAISED} to dock the bottom bar at 1264. When the control circuit determines that the bottom bar is docked at 1266, the control circuit may transmit a query message at 1268 that includes the magnitude of the second storage voltage V_{S-B} generated across the energy storage element of the bottom bar. The control circuit may transmit the query message via a wired communication link (e.g., via the electrical connections 638, 648 and/or via separate electrical connections on the dock). At 1270, the control circuit may receive the storage level of the energy storage element of the bottom bar (e.g., the magnitude of the second storage voltage V_{S-B}).

At 1272, the control circuit may process the storage level of the energy storage element of the bottom bar to determine a trend of any change in the storage level over time. For example, the control circuit may determine whether the storage level of the energy storage element of the bottom bar is greater than or less than the storage level the last time the bottom bar docked. Further, the control circuit may be configured to determine whether a rolling average of the storage level of a predetermined number of previous storage level measurements is increasing or decreasing to, for example, determine whether the motor drive unit would benefit from more frequent or less frequent docking events.

At 1274, the control circuit may determine whether the determined trend of the storage level indicates that the motor drive unit would benefit from less frequent charging at 1274. As an example, the control circuit may determine that the trend indicates that the motor drive unit would benefit from less frequent charging when the trend indicates that the storage level is decreasing as compared to prior docking events (e.g., the trend is a “less charge” trend). Since the storage level is decreasing, the control circuit (e.g., the motor drive unit) is not receiving as much charge for each docking event as it could if it were to dock less frequently. As such, if the control circuit determines that the trend indicates that the motor drive unit would benefit from less frequent charging at 1274, the control circuit may increase the docking interval at 1276, and the procedure 1250 may end at 1282.

If the control circuit determine that the trend does not indicate that the motor drive unit would benefit from less frequent charging at 1274, the control circuit may determine whether the trend indicates that the motor drive unit would benefit from more frequent charging at 1278. As an example, the control circuit may determine that the trend indicates that the motor drive unit would benefit from more frequent charging when the trend indicates that the storage level is increasing as compared to prior docking events (e.g., the trend is a “more charge” trend). Since the energy storage element of the bottom bar has a limit charge capacity and since the storage level is increasing, the control circuit (e.g., the motor drive unit) could be receiving charge more often if the bottom bar were to dock more frequently. As such, if the control circuit determines that the trend indicates that the motor drive unit would benefit from more frequent charging at 1278, the control circuit may decrease the docking interval at 1280, and the procedure 1250 may end at 1282.

FIG. 23C is a flowchart of an example procedure 1290 for docking a bottom bar (e.g., the bottom bars 155, 240, 440, 540, 830) of a motorized window treatment (e.g., any of the motorized window treatments described herein). For example, the bottom bar may be connected to a bottom end of a covering material of the motorized window treatment. The procedure 1290 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motor drive unit may be configured to control a present position P_{PRES} of the covering material. The motor drive unit may comprise a dock (e.g., the docks 280, 280b, 380, 480, 580a, 580b, 580c) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}). For example, the control circuit may execute the procedure 1290 periodically, at 1291, to determine if a docking interval should be increased or decreased. The docking interval may indicate a scheduled time or interval of time at the conclusion of which the control circuit is configured to dock the bottom bar (e.g., during the procedure 1110 of FIG. 22B and/or the procedure 1250 of FIG. 23B). The docking interval may be configured by the user and/or stored in memory of the motorized window treatment. The docking interval could be set to end on a periodic basis, such as at a particular time every day (e.g., every night at 3:00 am). The procedure 1290 may be used in embodiments where the there is no wireless communication between the motor drive unit and hembar, and docking is performed at a scheduled time (e.g., according to the docking interval).

The procedure 1290 may begin at 1291, At 1292, the control circuit may measure a photosensor signal. As described herein, the motor drive unit may include a photosensor circuit (e.g., the sensor circuit 654) coupled to the control circuit. For example, the photosensor circuit may be configured to generate a signal that indicates an ambient light level L_{AMB} in the space in which the motorized window treatment is located. The control circuit of the bottom bar module may be configured to transmit a message including the ambient light level L_{AMB} indicated by the sensor circuit to the motor drive unit (e.g., when docked). At 1293, the control circuit may be configured to determine an average amount of ambient light measurement by the photosensor circuit. For example, the control circuit may determine an average, a rolling average, etc.

At 1294, the control circuit may determine whether the trend indicates that the bottom bar (e.g., the solar cells coupled to the bottom bar) is exposed to less sunlight than before. As an example, the control circuit may determine that the trend indicates that the bottom bar is exposed to more sunlight when the average of the ambient light measurement of the photosensor circuit is increasing over time, and that the trend indicates that the bottom bar is exposed to less sunlight when the average of the ambient light measurement of the photosensor circuit is decreasing over time. If the control circuit determines that the trend indicates that the bottom bar is exposed to less sunlight at 1294, the control circuit may increase the docking interval at 1295, and the procedure 1290 may end at 1298.

If the control circuit determines that the trend does not indicate that the bottom bar is exposed to less sunlight at 1294, the control circuit may determine whether the trend indicates that the bottom bar is exposed to more sunlight at 1296. If the control circuit determines that the trend indicates that the bottom bar is not exposed to more sunlight at 1296 (e.g., the trend has not changed), the procedure 1290 may end at 1298. If the control circuit determines that the trend indicates that the bottom bar is exposed to more sunlight at 1296, the control circuit may decrease the docking interval at 1297, and the procedure 1290 may end at 1298. Accordingly, the control circuit may determine that the trend indicates that the bottom bar would benefit from less frequent docking when the trend indicates that the bottom bar is exposed to less sunlight than before (e.g., the trend is a “less daylight” trend). Since the solar cells of the bottom bar may be receiving less sunlight, the control circuit may control the bottom bar to dock less frequently. Conversely, the control circuit may determine that the trend indicates that the bottom bar would benefit from more frequent docking when the trend indicates that the bottom bar is exposed to more sunlight than before (e.g., the trend is a “more daylight” trend). Since the solar cells of the bottom bar may be receiving more sunlight, the control circuit may control the bottom bar to dock more frequently.

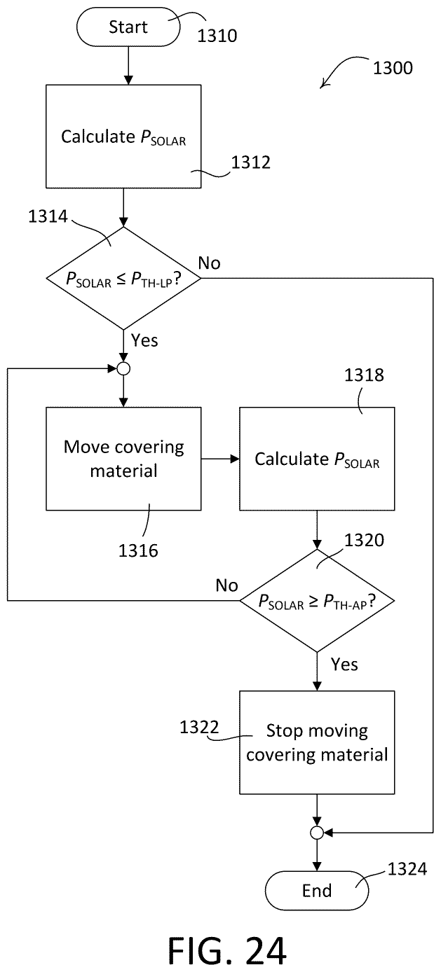

FIG. 24 is a flowchart of an example procedure 1300 for adjusting a present position P_{PRES} of a covering material of a motorized window treatment (e.g., any of the motorized window treatments described herein) in response to a solar power P_{SOLAR} being received by one or more solar cells (e.g., the solar cells 270, 370, 442, 542, 610) of the motorized window treatment. For example, the solar cells may be located on a bottom bar (e.g., the bottom bar 155, 240, 440, 540, 830) of the motorized window treatment, and the bottom bar may be connected to a bottom end of the covering material of the motorized window treatment. The bottom bar may comprise a bottom bar module having a solar cell management circuit configured to charge an energy storage element of the bottom bar (e.g., the energy storage element 646). The procedure 1300 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). For example, the control circuit may execute the procedure 1300 periodically at 1310 to monitor the solar power P_{SOLAR} being received by one or more solar cells.

At 1312, the control circuit may be configured to calculate the solar power P_{SOLAR} being received by one or more solar cells. For example, the control circuit may be configured to calculate the solar power P_{SOLAR} as a function of a magnitude of a photovoltaic output voltage V_{PV} of the one or more solar cells, a magnitude of a storage voltage of an energy storage element of the bottom bar (e.g., the second storage voltage V_{S-B}), and/or a duty cycle DC_{SCM} of the solar cell management circuit of the bottom bar (e.g., which may be received in one or more message from the bottom bar module). At 1314, the control circuit may determine if the magnitude of the solar power P_{SOLAR} is less than (e.g., less than or equal to) a low-power threshold P_{TH-LP}. When the magnitude of the solar power P_{SOLAR} is greater than the low-power threshold P_{TH-LP} at 1314, the procedure 1300 may end at 1324.

When the magnitude of the solar power P_{SOLAR} is less than (e.g., less than or equal to) the low-power threshold P_{T H-LP} at 1314, the control circuit may start moving the covering material at 1316 to adjust the present position P_{PRES} of the covering material. For example, the control circuit may be configured to adjust the present position P_{PRES} of the covering material in a direction (e.g., either raise or lower) that may move the bottom bar into direct sunlight, which may be determined from the solar data. At 1318, the control circuit may be configured to calculate the solar power P_{SOLAR} being received by one or more solar cells at the new present position P_{PRES} of the covering material (e.g., an adjusted position of the covering material as compared to when the solar power P_{SOLAR} was calculated at 1312). At 1320, the control circuit may determine if the magnitude of the solar power P_{SOLAR} is greater than (e.g., greater than or equal to) an acceptable-power threshold P_{TH-AP}. When the magnitude of the solar power P_{SOLAR} is less than the acceptable-power threshold P_{TH-AP} at 1320, the control circuit may continue to move the covering material at 1316 to adjust the present position P_{PRES} of the covering material and to calculate the solar power P_{SOLAR} being received by one or more solar cells at 1318. When the magnitude of the solar power P_{SOLAR} is greater than (e.g., greater than or equal to) the acceptable-power threshold P_{TH-AP} at 1320, the control circuit may stop moving the covering material at 1322 and the procedure 1300 may end at 1324.

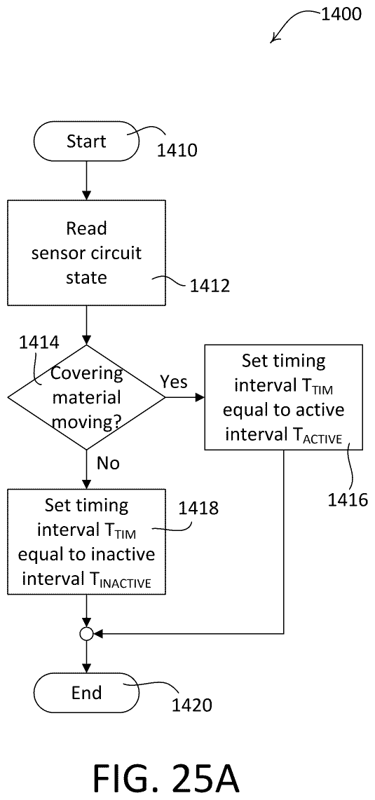

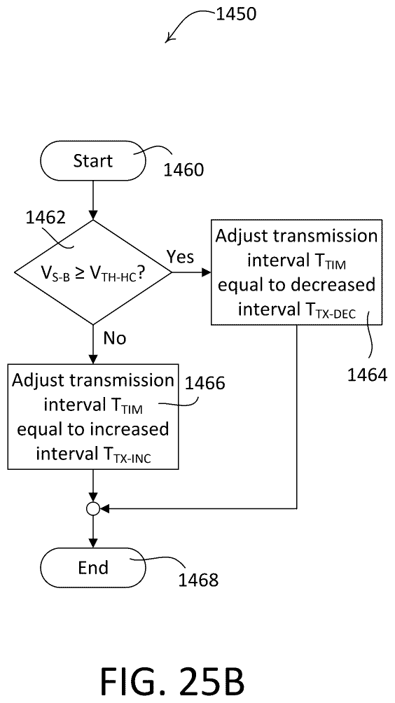

FIG. 25A is a flowchart of an example procedure 1400 for configuring a motorized window treatment (e.g., any of the motorized window treatments described herein). The procedure 1400 may be executed by a control circuit of a bottom bar module of a bottom bar of the motorized window treatment (e.g., the control circuit 450 of the bottom bar module 440 shown in FIG. 16A, the control circuit 550 of the bottom bar module 540 of the FIG. 16B, and/or control circuits of the bottom bars shown in FIG. 1-15B or 19). In some examples, the procedure 1400 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein).

The motorized window treatment may comprise a motor drive unit for adjusting a present position P_{PRES} of a covering material, and one or more solar cells located on the bottom bar. The bottom bar may be connected to a bottom end of the covering material of the motorized window treatment. For example, the control circuit may execute the procedure 1400 to adjust a timing interval T_{TIM} at which the control circuit may collect and/or transmit one or more measurements and/or operational characteristics of the bottom bar module to the motor drive unit of the motorized window treatment. The control circuit may be configured to adjust the timing interval T_{TIM} to one of two predetermined values based on whether the motor drive unit is adjusting the present position P_{PRES} of the covering material or not. The control circuit may be configured to adjust the timing interval T_{TIM} in response to a sensor circuit of the bottom bar (e.g., an accelerometer and/or a gyroscope) to determine if the covering material is moving (e.g., if the motor drive unit is presently adjusting the present position P_{PRES} of the covering material). For example, the control circuit may execute the procedure 1400 periodically at 1410.

At 1412, the control circuit may determine a state of an output of the sensor circuit (e.g., the accelerometer and/or the gyroscope) to determine if the covering material is moving. If the covering material is moving (e.g., if the motor drive unit is presently adjusting the present position P_{PRES} of the covering material) at 1414, the control circuit may set the timing interval T_{TIM} to an active interval value T_{ACTIVE} at 1416, before the procedure 1400 ends at 1420. If the covering material is not moving (e.g., if the motor drive unit is not presently adjusting the present position P_{PRES} of the covering material) at 1414, the control circuit may set the timing interval T_{TIM} to an inactive interval value T_{INACTIVE} at 1418, before the procedure 1400 ends at 1420. For example, the inactive interval value T_{INACTIVE} may be longer than the active interval value T_{ACTIVE}, such that the control circuit collects and/or transmits solar data at a lower rate when then covering material is not moving than when the covering material is moving (e.g., to conserve power).

FIG. 25B is a flowchart of an example procedure 1450 for configuring a motorized window treatment (e.g., the motorized window treatments of the embodiments shown in FIG. 1-15B or 19). The procedure 1450 may be executed by a control circuit of a bottom bar module of a bottom bar of the motorized window treatment (e.g., the control circuit 450 of the bottom bar module 440 shown in FIG. 16A, the control circuit 550 of the bottom bar module 540 of the FIG. 16B, and/or control circuits of the bottom bars shown in FIG. 1-15B or 19). In some examples, the procedure 1450 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein).

The motorized window treatment may comprise a motor drive unit for adjusting a present position P_{PRES} of a covering material, and one or more solar cells located on the bottom bar. The bottom bar may be connected to a bottom end of the covering material of the motorized window treatment. For example, the control circuit may execute the procedure 1450 to adjust a transmission interval T_{TX} at which the control circuit may transmit messages to the motor drive unit of the motorized window treatment. For example, the control circuit may be configured to transmit messages include one or more measurements and/or operational characteristics of the bottom bar module to the motor drive unit of the motorized window treatment. The control circuit may be configured to adjust the transmission interval T_{TX} to one of two predetermined values based on a magnitude of a supply voltage generated across the one or more storage elements of the bottom bar (e.g., the second storage voltage V_{S-B} produced across the energy storage element 446 of the bottom bar module 440). For example, the control circuit may execute the procedure 1450 periodically at 1460.

At 1462, the control circuit may determine if the magnitude of the second storage voltage V_{S-B} is greater than (e.g., greater than or equal to) a transmission threshold V_{TH-TX}. If the second storage voltage V_{S-B} is greater than (e.g., greater than or equal to) the transmission threshold V_{TH-TX} at 1462, the control circuit may decrease the transmission interval T_{TX} at 1464, before the procedure 1250 ends at 1468. For example, the control circuit may set the transmission interval T_{TX} to a decreased interval value T_{TX-DEC} at 1464. If the second storage voltage V_{S-B} is not greater than (e.g., greater than or equal to) the transmission threshold V_{TH-TX} (e.g., is less that the transmission threshold V_{TH-TX}) at 1462, the control circuit may increase the transmission interval T_{TX} at 1466, before the procedure 1400 ends at 1468. For example, the control circuit may set the transmission interval T_{TX} to an increased interval value T_{TX-INC} at 1466. For example, the decreased interval value T_{TX-DEC} may be shorter than the increased interval value T_{TX-INC}, such that the control circuit transmits solar data at a higher rate when the second storage voltage V_{S-B} is high than when the second storage voltage V_{S-B} is low.

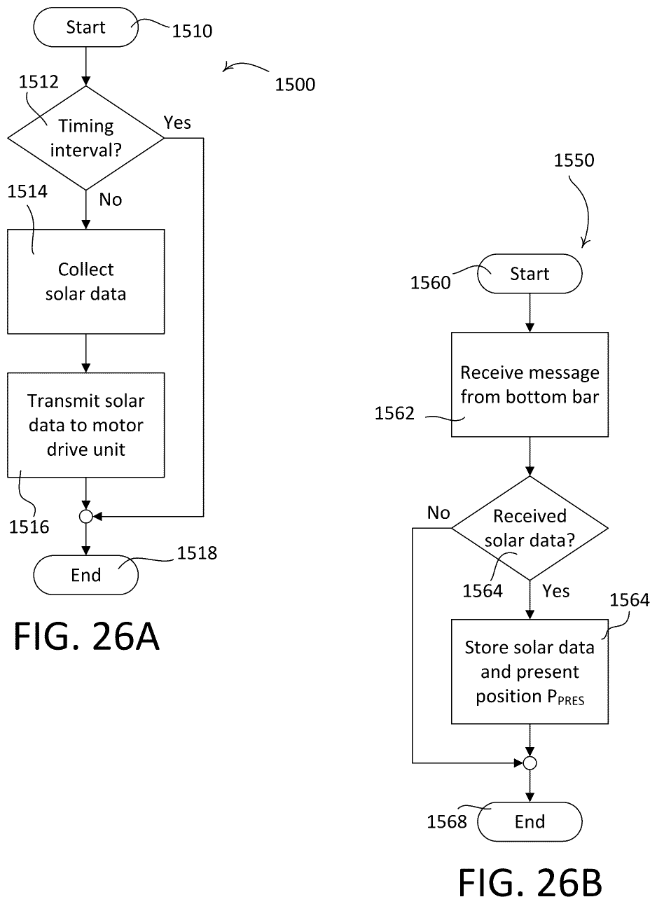

FIG. 26A is a flowchart of an example procedure 1500 for collecting solar data for a motorized window treatment (e.g., the motorized window treatments of the embodiments shown in FIG. 1-15B or 19). The procedure 1500 may be executed by a control circuit of a bottom bar module of a bottom bar of the motorized window treatment (e.g., the control circuit 450 of the bottom bar module 440 shown in FIG. 16A, the control circuit 550 of the bottom bar module 540 of the FIG. 16B, and/or control circuits of the bottom bars shown in FIG. 1-15B or 19). In some examples, the procedure 1500 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein).

The motorized window treatment may also comprise a motor drive unit for adjusting a present position P_{PRES} of a covering material, and one or more solar cells located on the bottom bar. The bottom bar may be connected to a bottom end of the covering material of the motorized window treatment. For example, the control circuit may execute the procedure 1500 to collect solar data, such as one or more measurements and/or operational characteristics of the bottom bar module of the bottom bar, at a plurality of intermediate positions of the covering material between a raised position P_{RAISED} and a lowered position P_{LOWERED}. The bottom bar module may be configured to communicate with the motor drive unit via a wireless communication link (e.g., via RF signals using a short-range wireless communication protocol). The control circuit bottom bar module may be configured to periodically collect and transmit the solar data to the motor drive unit (e.g., at the timing interval T_{TIM} set in the procedure 1400). For example, the control circuit may execute the procedure 1500 periodically at 1510.

The control circuit may be configured to collect and transmit the solar data at the timing interval T_{TIM} (e.g., at the active interval value T_{ACTIVE} or the inactive interval value T_{INACTIVE} as set in the procedure 1400). When the control circuit detects the end of the timing interval T_{TIM} at 1512, the control circuit may collect the solar data at 1514. For example, the solar data may comprise measurements, such as a magnitude of a photovoltaic output voltage of the solar cells (e.g., the photovoltaic output voltage V_{PV}) and/or a magnitude of a storage voltage of an energy storage element of the bottom bar module (e.g., the second storage voltage V_{S-B}). In addition, the solar data may comprise operational characteristics of the bottom bar module, such as a duty cycle of solar cell management circuit (e.g., the solar cell management circuit 644). For example, the control circuit may collect the solar data by sampling one or more sense signals of the bottom bar module (e.g., the sense signals V_{SNS} from the solar cell management circuit 644) and/or receiving one or more messages including measurements and/or operational characteristics of the bottom bar module (e.g., messages from the solar cell management circuit 644). At 1516, the control circuit may transmit messages including collected solar data to the motor drive unit in one or more wireless signals (e.g., via the communication circuit 652), before the procedure 1500 ends at 1518.

FIG. 26B is an example procedure 1550 for collecting solar data for a motorized window treatment (e.g., any of the motorized window treatments described herein). The procedure 1550 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a covering material, a bottom bar connected to a bottom end of the covering material, and one or more solar cells located on the bottom bar. The motor drive unit may be configured to control a present position P_{PRES} of the covering material. For example, the control circuit may execute the procedure 1550 to store solar data, such as one or more measurements and/or operational characteristics of the bottom bar module, at a plurality of intermediate positions of the covering material between a raised position P_{RAISED} and a lowered position P_{LOWERED}. The bottom bar module may be configured to communicate with the motor drive unit via a wireless communication link (e.g., via RF signals using a short-range wireless communication protocol). The bottom bar module may be configured to periodically collect and transmit the solar data to the motor drive unit (e.g., at the timing interval T_{TIM} set in the procedure 1400). For example, the control circuit may execute the procedure 1550 periodically at 1560. In addition, the control circuit may execute the procedure 1550 in response to receiving a message from the bottom bar module at 1560.

At 1562, the control circuit may receive a message from the bottom bar module. For example, the message may include solar data (e.g., one or more measurements and/or operational characteristics of the bottom bar module). If the received message does not include solar data at 1564, the procedure 1550 may end at 1568. When the received message includes solar data at 1564, the control circuit may at 1566 store the solar data in memory of the motor drive unit along with the present position P_{PRES} of the covering material at the time that the message was received. In some examples, the control circuit may also store the present time in memory along with the present position P_{PRES} of the covering material at 1566. For example, the control circuit may store the present position P_{PRES} of the covering material (e.g., and/or the present time) for each of the one or more measurements and/or operational characteristics of the solar data received from the bottom bar module. After the control circuit stores the solar data at 1566, the procedure 1550 may end at 1568.

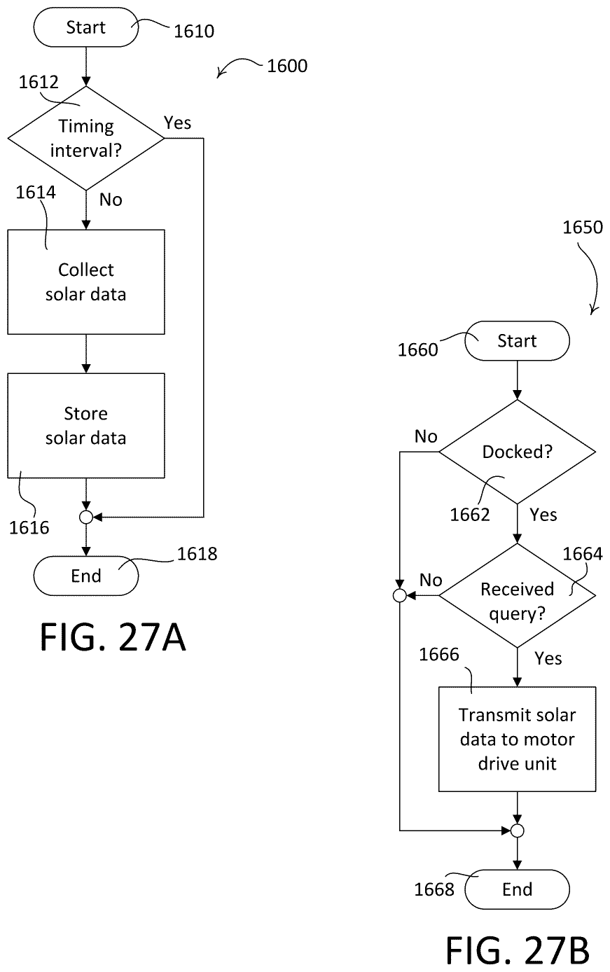

FIG. 27A is an example procedure 1600 for collecting solar data for a motorized window treatment (e.g., any of the motorized window treatments described herein). The procedure 1600 may be executed by a control circuit of a bottom bar module of a bottom bar of the motorized window treatment (e.g., the control circuit 450 of the bottom bar module 440 shown in FIG. 16A, the control circuit 550 of the bottom bar module 540 of the FIG. 16B, and/or control circuits of the bottom bars shown in FIG. 1-15B or 19). In some examples, the procedure 1600 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein).

The motorized window treatment may comprise a motor drive unit for adjusting a present position P_{PRES} of a covering material, and one or more solar cells located on the bottom bar. The bottom bar may be connected to a bottom end of the covering material of the motorized window treatment. For example, the control circuit may execute the procedure 1600 to collect solar data, such as one or more measurements and/or operational characteristics of a bottom bar module of the bottom bar, at a plurality of intermediate positions of the covering material between a raised position P_{RAISED} and a lowered position P_{LOWERED}. The bottom bar module may be configured to communicate with the motor drive unit via a wired communication link (e.g., via the electrical connections 638, 648) when the bottom bar is docked. The control circuit of the bottom bar module may be configured to collect and store the solar data in memory of the bottom bar module (e.g., at the timing interval T_{TIM} set in the procedure 1400), and then transmit the solar data to the motor drive unit via the wired communication link when the bottom bar is docked. For example, the control circuit may execute the procedure 1600 periodically at 1610.

The control circuit may be configured to collect the solar data at the timing interval T_{TIM} (e.g., at the active interval value T_{ACTIVE} or the inactive interval value T_{INACTIVE} as set in the procedure 1400). When the control circuit detects the end of the timing interval T_{TIM} at 1612, the control circuit may collect the solar data at 1614. For example, as noted herein, the solar data may comprise one or more performance values (e.g., measured and/or calculated values) recorded by the motor drive unit and/or the bottom bar module, and/or one or more operational characteristics (e.g., controlled settings and/or parameters) of the motor drive unit and/or the bottom bar module. For example, the control circuit and/or the control circuit of the bottom bar module may be configured to store in memory the performance values and/or the operational characteristics of the solar data periodically (e.g., at a timing interval T_{TIM}). The control circuit of the bottom bar module may be configured to transmit one or more of the performance values and/or operational characteristics of the solar data to the control circuit, and vice versa (e.g., as will be described in greater detail below).

At 1616, the control circuit may store the collected solar data in memory of the bottom bar module, before the procedure 1600 ends at 1618. For example, the control circuit may store each of the measurements and/or operational characteristics of the solar data in memory at 1616 along with timing information (e.g., a time stamp indicating a time at which the respective measurement and/or operational characteristic was recorded).

FIG. 27B is an example procedure 1650 for transmitting solar data of a motorized window treatment (e.g., any of the motorized window treatments described herein). The procedure 1650 may be executed by a control circuit of a bottom bar module of a bottom bar of the motorized window treatment (e.g., the control circuit 450 of the bottom bar module 440 shown in FIG. 16A, the control circuit 550 of the bottom bar module 540 of the FIG. 16B, and/or control circuits of the bottom bars shown in FIG. 1-15B or 19). In some examples, the procedure 1650 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein).

The motorized window treatment may comprise a motor drive unit for adjusting a present position P_{PRES} of a covering material, and one or more solar cells located on the bottom bar. The bottom bar may be connected to a bottom end of the covering material of the motorized window treatment. For example, the control circuit may execute the procedure 1650 to collect solar data, such as one or more measurements and/or operational characteristics of a bottom bar module of the bottom bar, at a plurality of intermediate positions of the covering material between a raised position P_{RAISED} and a lowered position P_{LOWERED}. The motor drive unit may comprise a dock (e.g., the docks 280, 280b, 380, 480, 580a, 580b, 580c) that is configured to facilitate discharging of one or more energy storage elements of the bottom bar into one or more energy storage elements of the motor drive unit, for example, when the bottom bar is located adjacent to the dock (e.g., when the covering material is in the raised position P_{RAISED}). The bottom bar module may be configured to communicate with the motor drive unit via a wired communication link (e.g., via the electrical connections 638, 648) when the bottom bar is docked. The control circuit of the bottom bar module may be configured to collect and store the solar data in memory of the bottom bar module at a timing interval (e.g., during the procedure 1600 shown in FIG. 27A), and then transmit the solar data to the motor drive unit via the wired communication link when the bottom bar is docked. For example, the control circuit may execute the procedure 1650 periodically at 1660.

At 1662, the control circuit may determine if the bottom bar is docked. For example, the control circuit may be configured to determine that the bottom bar is docked by detecting that the motor drive unit is drawing current from an energy storage element of the bottom bar module (e.g., from the energy storage element 646 via the electrical connections 638, 648). If the control circuit determines that the bottom bar is not docked, the procedure may end at 1668 (e.g., without transmitting solar data to the motor drive unit). Additionally and/or alternatively, the control circuit may be configured to determine that the bottom bar is docked in response to receiving a message from the motor drive unit. For example, at 1664 the control circuit may receive a query message from the motor drive unit via a wired communication link (e.g., via the electrical connections 638, 648 and/or via separate electrical connections on the dock) and/or via a wireless communication link (e.g., where the message may indicate that the bottom bar is docked). If the control circuit receives the query message at 1664, the control circuit may transmit solar data to the motor drive unit at 1666. The procedure may end at 1668. If the control circuit does not receive the query, the procedure may end at 1668 (e.g., without transmitting solar data to the motor drive unit).

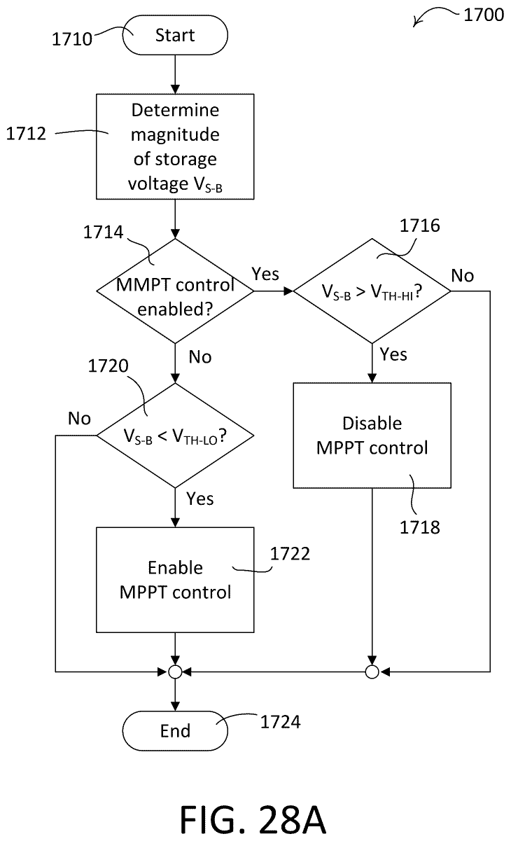

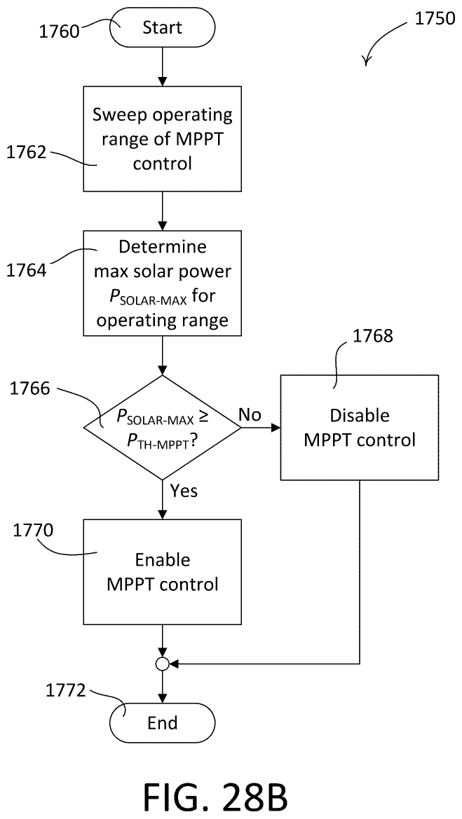

FIG. 28A is an example procedure 1700 for controlling a solar power system (e.g., the solar power systems 441, 541, 600, 710) of a bottom bar module of a bottom bar (e.g., the bottom bars 155, 240, 440, 540, 830) of a motorized window treatment (e.g., any of the motorized window treatments described herein). The procedure 1700 may be executed by a control circuit of the bottom bar module of the motorized window treatment (e.g., the control circuits 450, 550 of the bottom bar modules 440, 540, the control circuit 650 of the solar power system 600, and/or control circuits of the bottom bars shown in FIGS. 1-15B). In some examples, the procedure 1700 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein).

The motorized window treatment may comprise a motor drive unit for adjusting a present position P_{PRES} of the covering material and one or more solar cells located on the bottom bar. The bottom bar may be connected to a bottom end of the covering material of the motorized window treatment. For example, the control circuit may execute the procedure 1700 to enable and disable charging of an energy storage element of the bottom bar module. The control circuit of the bottom bar module may be configured to control a solar cell management circuit of the solar power system using, for example, a maximum power point tracking (MPPT) control technique to track a maximum power point for charging the energy storage element of the bottom bar module. For example, the control circuit may execute the procedure 1700 periodically at 1710.

At 1712, the control circuit may determine the magnitude of the storage voltage V_{S-B} across an energy storage element (e.g., the energy storage element 546) of the bottom bar module. For example, the control circuit may be configured to receive (e.g., from the solar management circuit) a storage voltage feedback signal V_{SB-FB}, which may indicate the magnitude of the storage voltage V_{S-B}.

At 1714, the control circuit may determine whether control of the solar cell management circuit using the MPPT control technique is presently enabled. For example, the control circuit may be configured to enable and disable control of the solar cell management circuit using the MPPT control technique to start and stop charging the energy storage element of the bottom bar module, respectively. The control circuit may be configured to start charging the energy storage element (e.g., enable control of the solar cell management circuit using the MPPT control technique) by generating (e.g., starting to generate) the one or more MPPT drive signals V_{MPPT-DR} for controlling the solar cell management circuit, and cease charging the energy storage element (e.g., disable control of the solar cell management circuit using the MPPT control technique) by not generating (e.g., ceasing to generate) the one or more MPPT drive signals V_{MPPT-DR}. At 1714, the control circuit may determine whether control of the solar cell management circuit using the MPPT control technique is presently enabled.

If control of the solar cell management circuit using the MPPT control technique is presently enabled at 1714, the control circuit may determine whether the magnitude of the storage voltage V_{S-B} (e.g., as indicated by the second storage voltage feedback signal V_{SB-FB}) rises above (e.g., becomes greater than) to a high storage voltage threshold V_{TH-HI} at 1716. If the magnitude of the storage voltage V_{S-B} is not greater than the high storage voltage threshold V_{TH-HI} at 1716, the procedure 1700 may end at 1724. However, if the magnitude of the storage voltage V_{S-B} is greater than the high storage voltage threshold V_{TH-HI} at 1716, the control circuit may disable control of the solar cell management circuit using the MPPT control technique at 1718 before the procedure 1700 exits at 1724. In some examples, the control circuit may be configured to determine whether the present charge Q_{PRES-B} of the energy storage element of the bottom bar module rises above (e.g., become greater than) a high storage charge threshold Q_{TH-HI} at 1716. If the present charge Q_{PRES-B} of the energy storage element of the bottom bar module is not greater than the high storage charge threshold Q_{TH-HI} at 1716, the procedure 1700 may end at 1724. However, if the present charge Q_{PRES-B} of the energy storage element of the bottom bar module is greater than the high storage charge threshold Q_{TH-HI} at 1716, the control circuit may disable control of the solar cell management circuit using the MPPT control technique at 1718 before the procedure 1700 exits at 1724.

If control of the solar cell management circuit using the MPPT control technique is presently disabled at 1714, the control circuit may determine whether the magnitude of the storage voltage V_{S-B} (e.g., as indicated by the second storage voltage feedback signal V_{SB-FB}) is below (e.g., becomes less than) a low storage voltage threshold V_{TH-LO} at 1720. If the magnitude of the storage voltage V_{S-B} is less than the low storage voltage threshold V_{TH-LO} at 1720, the procedure 1700 may end at 1724. However, if the magnitude of the storage voltage V_{S-B} is not less than the low storage voltage threshold V_{TH-LO} at 1720, the control circuit may configured enable control of the solar cell management circuit using the MPPT control technique at 1722 before the procedure 1700 exits at 1724. As such, the control circuit may be configured to enable and disable control of the solar cell management circuit using the MPPT control technique, for example, in response to the magnitude of the second storage voltage V_{S-B} across the energy storage element. In some examples, the control circuit may determine whether the present charge Q_{PRES-B} of the energy storage element of the bottom bar module is below (e.g., becomes less than) a low storage charge threshold Q_{TH-LO} at 1720. If the present charge Q_{PRES-B} of the energy storage element of the bottom bar module is less than the low storage charge threshold Q_{TH-LO} at 1720, the procedure 1700 may end at 1724. However, if the present charge Q_{PRES-B} of the energy storage element of the bottom bar module is not less than the low storage charge threshold Q_{TH-LO} at 1720, the control circuit may configured enable control of the solar cell management circuit using the MPPT control technique at 1722 before the procedure 1700 exits at 1724.

FIG. 28B is an example procedure 1750 for controlling a solar power system (e.g., the solar power systems 441, 541, 600, or 710) of a bottom bar module of a bottom bar (e.g., the bottom bars 155, 240, 440, 540, 830) of a motorized window treatment (e.g., any of the motorized window treatments described herein). The procedure 1750 may be executed by a control circuit of the bottom bar module of the motorized window treatment (e.g., the control circuits 450, 550 of the bottom bar modules 440, 540, the control circuit 650 of the solar power system 600, and/or control circuits of the bottom bars shown in FIGS. 1-15B). In some examples, the procedure 1750 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein).

The motorized window treatment may comprise a motor drive unit for adjusting a present position P_{PRES} of the covering material and one or more solar cells located on the bottom bar. The bottom bar may be connected to a bottom end of the covering material of the motorized window treatment. For example, the control circuit may execute the procedure 1750 to enable and disable charging of an energy storage element of the bottom bar module. The control circuit of the bottom bar module may be configured to control a solar cell management circuit of the solar power system using, for example, a maximum power point tracking (MPPT) control technique to track a maximum power point for charging the energy storage element of the bottom bar module. For example, the control circuit may execute the procedure 1750 periodically at 1760.

At 1762, the control circuit may be configured to sweep through the operating points of the solar cell management circuit (e.g., by adjusting the duty cycle DC_{MPPT} and/or the operating period T_{MPPT}). For example, the control circuit may be configured to sweep through all of the operating points of the solar cell management circuit (e.g., by adjusting the duty cycle DC_{MPPT} and/or the operating period T_{MPPT}), measure the magnitude of the photovoltaic output voltage V_{PV} (e.g., as indicated by the photovoltaic output voltage feedback signal V_{PV-FB}) and calculate the solar power P_{SOLAR} at each operating point. For example, the control circuit 550 may be configured to calculate the solar power P_{SOLAR} using the magnitudes of the photovoltaic output voltage V_{PV} measured during the sweep, the duty cycle DC_{MPPT}, and the operating period T_{MPPT} (e.g., and/or the operating frequency f_{MPPT}), for instance, as described herein.

At 1764, the control circuit may determine the maximum solar power P_{SOLAR-MAX} for an operating range of the solar cells. For example, the control circuit may determine the maximum solar power P_{SOLAR-MAX} that the solar cells are capable of providing from a maximum value of the magnitudes of the solar power P_{SOLAR} calculated during the sweep.

At 1766, the control circuit may be configured to determine whether the maximum solar power P_{SOLAR-MAX} that the solar cells are capable of providing (e.g., due to the present magnitude of the photovoltaic output current I_{PV}) is greater than or equal to an MPPT operating power threshold P_{TH-MPPT} (e.g., approximately 1 mW). For example, the MPPT operating power threshold P_{TH-MPPT} may represent the amount of power required by (e.g., consumed by) the control circuit and/or the solar management circuit when operating using the MPPT control technique.

If the maximum solar power P_{SOLAR-MAX} is greater than or equal to the MPPT operating power threshold P_{TH-MPPT} at 1770, the control circuit may enable control of the solar cell management circuit using the MPPT control technique at 1770 before the procedure 1750 exits at 1772. However, if the maximum solar power P_{SOLAR-MAX} is not greater than or equal to the MPPT operating power threshold P_{TH-MPPT} at 1770, the control circuit may disable control of the solar cell management circuit using the MPPT control technique at 1768 before the procedure exits at 1772. As such, the control circuit may be configured to enable and disable control of the solar cell management circuit using the MPPT control technique, for example, in response to an amount of sunlight presently being received by the solar cells (e.g., in response to the magnitude of the photovoltaic output current I_{PV}).

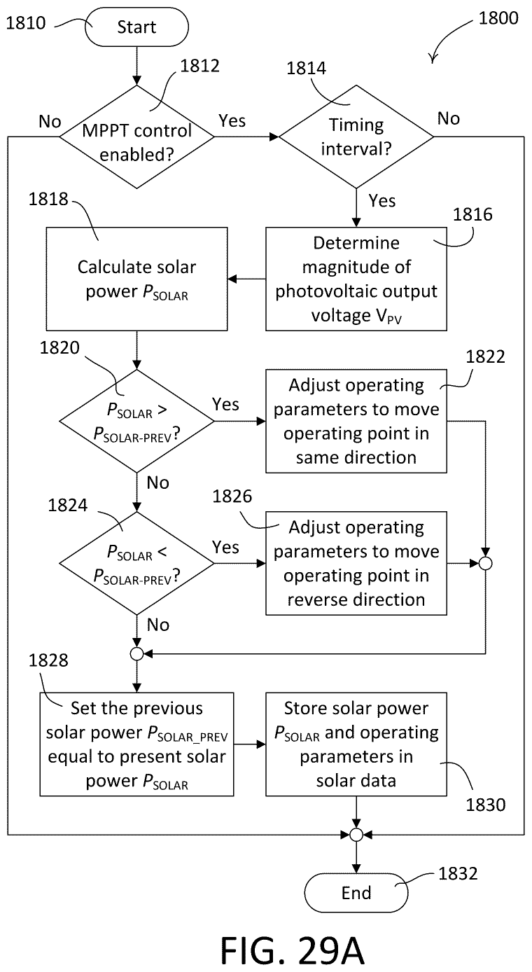

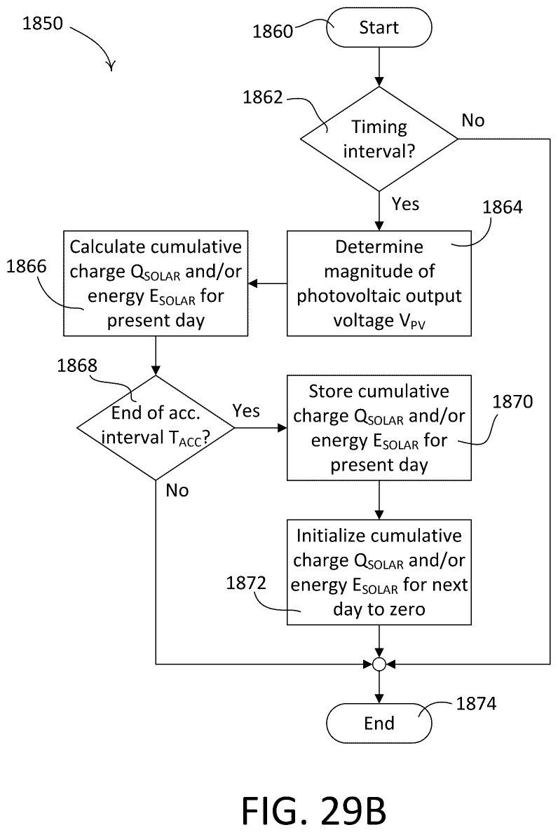

FIG. 29A is an example procedure 1800 for controlling a solar power system (e.g., the solar power systems 441, 541, 600, 710) of a bottom bar module of a bottom bar (e.g., the bottom bars 155, 240, 340) of a motorized window treatment (e.g., any of the motorized window treatments described herein). The procedure 1800 may be executed by a control circuit of the bottom bar module of the motorized window treatment (e.g., the control circuits 450, 550 of the bottom bar modules 440, 540, the control circuit 650 of the solar power system 600, and/or control circuits of the bottom bars shown in FIGS. 1-15B). In some examples, the procedure 1800 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein).

The motorized window treatment may comprise a motor drive unit for adjusting a present position P_{PRES} of the covering material and one or more solar cells located on the bottom bar. The bottom bar may be connected to a bottom end of the covering material of the motorized window treatment. For example, the control circuit may execute the procedure 1800 to control a solar cell management circuit of the solar power system using, for example, a maximum power point tracking (MPPT) control technique to track a maximum power point for charging the energy storage element of the bottom bar module. For example, the control circuit may execute the procedure 1800 periodically at 1810.

At 1812, the control circuit may determine whether control of the solar cell management circuit using the MPPT control technique is presently enabled. For example, the control circuit may be configured to enable and disable control of the solar cell management circuit using the MPPT control technique to start and stop charging the energy storage element of the bottom bar module, respectively. The control circuit may be configured to start charging the energy storage element (e.g., enable control of the solar cell management circuit using the MPPT control technique) by generating (e.g., starting to generate) the one or more MPPT drive signals V_{MPPT-DR} for controlling the solar cell management circuit, and cease charging the energy storage element (e.g., disable control of the solar cell management circuit using the MPPT control technique) by not generating (e.g., ceasing to generate) the one or more MPPT drive signals V_{MPPT-DR}. At 1812, the control circuit may determine whether control of the solar cell management circuit using the MPPT control technique is presently enabled.

If control of the solar cell management circuit using the MPPT control technique is not presently enabled at 1812, the procedure 1800 may end at 1832. However, if control of the solar cell management circuit using the MPPT control technique is presently enabled at 1812, the control circuit may determine whether a present timing interval (e.g., the timing interval T_{TIM1}, which may be approximately five seconds) has expired. If the present time interval has not expired at 1814, the procedure 1800 may end at 1832.

However, if the present time interval has expired at 1814, the control circuit may determine a magnitude of the photovoltaic output voltage V_{PV} produced by the solar cells of the bottom bar over the present time interval at 1816. In some examples, the control circuit may be configured to receive (e.g., from the solar management circuit) a photovoltaic output voltage feedback signal V_{PV-FB}, which may indicate the magnitude of the photovoltaic output voltage V_{PV}. Alternatively or additionally, the magnitude of the photovoltaic output voltage V_{PV} produced by the solar cells may be based on the magnitude of a photovoltaic output current I_{PV} (e.g., which may be dependent upon the amount sunlight presently being received by the solar cells) and the impedance Z_{MPPT} due to the operation of the solar cell management circuit at the duty cycle DC_{MPPT} and/or the operating period T_{MPPT} (e.g., V_{PV}=I_{PV}·Z_{MPPT}). For example, one or more sense signals V_{SCM-SNS} generated by the solar cell management circuit may comprise direct-current (DC) signals having magnitudes that indicate the magnitude of the photovoltaic output voltage V_{PV} and/or the one or more sense signals V_{SCM-SNS} generated by the solar cell management circuit may comprise messages (e.g., digital messages) including indications of the magnitude of the photovoltaic output voltage V_{PV}.

At 1818, the control circuit may calculate a present solar power P_{SOLAR} over the present time interval. In some examples, the control circuit may be configured to determine the present solar power P_{SOLAR} for the present time interval based on an average magnitude I_{PV-AVE} of a photovoltaic output current I_{PV} over the present time interval and the magnitude of the photovoltaic output voltage V_{PV}, e.g., as indicated by the photovoltaic output voltage feedback signal V_{PV-FB} (e.g., P_{SOLAR}=V_{PV}·I_{PV}). For example, the control circuit may be configured to calculate the present solar power P_{SOLAR} based on the operating period T_{MPPT} of the first MPPT drive signal V_{MPPT-DR1}, the first on time T_{MPPT-ON1} of the first MPPT drive signal V_{MPPT-DR1}, the magnitude of the photovoltaic output voltage V_{PV} (e.g., as indicated by the photovoltaic output voltage feedback signal V_{PV-FB}), and the primary magnetizing inductance L_{M} of the transformer of the solar cell management circuit, e.g.,

$${P}_{SOLAR} = {V}_{PV} \cdot {i}_{PV - AVEE} = {( {V}_{PV} \cdot {T}_{MPPT - ON 1} )}^{2} / ( 2 \cdot {L}_{M} \cdot {T}_{MPPT} ) .$$

Alternatively or additionally, the control circuit may be configured to calculate the present solar power P_{SOLAR} as a function of the magnitude of the photovoltaic output voltage V_{PV}, the magnitude of the storage voltage V_{S-B}, and/or the duty cycle D_{CSCM} of the solar cell management circuit (e.g., as received from the bottom bar module).

At 1820, the control circuit may determine whether the present solar power P_{SOLAR} is greater than a previous solar power P_{SOLAR-PREV}. The previous solar power P_{SOLAR-PREV} may be the solar power P_{SOLAR} associated with a previous (e.g., the immediately preceding) time interval. If the solar power P_{SOLAR} is greater than the previous solar power P_{SOLAR-PREV} at 1820, the control circuit may adjust one or more operating parameters to change the operating point of the solar cell management circuit in the same direction to attempt to increase the solar power P_{SOLAR} at 1822, and then proceed to 1828. For example, the control circuit may be configured to adjust the first MPPT drive signal V_{MPPT-DR1} and/or the second MPPT drive signal V_{MPPT-DR2} to change the solar cell management circuit from one of the operating points to the next at 1822. As such, at 1822, when a change from one of the operating points of the solar cell management circuit to the next results in an increase in the magnitude of the solar power P_{SOLAR}, the control circuit may continue to adjust the operating point of the solar cell management circuit in the same direction to attempt to further increase the solar power P_{SOLAR}.

If the solar power P_{SOLAR} is not greater than the previous solar power P_{SOLAR-PREV} at 1820, the control circuit may determine whether the solar power P_{SOLAR} is less than the previous solar power P_{SOLAR-PREV} at 1824. If the solar power P_{SOLAR} is less than the previous solar power P_{SOLAR-PREV} at 1824, the control circuit may adjust one or more operating parameters to change the operating point of the solar cell management circuit in an opposite direction to attempt to increase the solar power P_{SOLAR} at 1826, and then proceed to 1828. For example, the control circuit may be configured to adjust the first MPPT drive signal V_{MPPT-DR1} and/or the second MPPT drive signal V_{MPPT-DR2} to change the solar cell management circuit from one of the operating points to the next at 1826. As such, at 1826, when a change from one of the operating points of the solar cell management circuit to the next results in a decrease in the magnitude of the solar power P_{SOLAR}, the control circuit may continue to adjust the operating point of the solar cell management circuit in the opposite direction to attempt to increase the solar power P_{SOLAR} (e.g., prevent further decrease in the solar power P_{SOLAR}).

If the solar power P_{SOLAR} is not less than the previous solar power P_{SOLAR-PREV} at 1824 (e.g., the solar power P_{SOLAR} is equal to previous solar power P_{SOLAR-PREV}), the control circuit may set the previous solar power P_{SOLAR-PREV} equal to the present solar power P_{SOLAR} at 1828.

At 1828, the control circuit may be configured to set the previous solar power P_{SOLAR} PREV equal to present solar power P_{SOLAR}. At 1830, the control circuit may be configured to store in memory one or more operating parameters of the solar management circuit, such as, the operating frequency f_{MPPT}, the operating period T_{MPPT}, the first on time T_{MPPT-ON1}, the first off time T_{MPPT-OFF1}, the first duty cycle DC_{MPPT1} of the first MPPT drive signal V_{MPPT-DR1}, the second on time T_{MPPT-ON2}, the second off time T_{MPPT-OFF2}, and/or the second duty cycle DC_{MPPT2} of the second MPPT drive signal V_{MPPT-DR2}. In addition, the control circuit may be configured to store in memory one or more measured (e.g., sensed) operating characteristics (e.g., such as the magnitude of the photovoltaic output voltage V_{PV} and/or the magnitude of the second storage voltage V_{S-B}) and/or one or more calculated operating characteristics (e.g., such as the average magnitude I_{PV-AVE} of the photovoltaic output current I_{PV} and/or the solar power P_{SOLAR}). In some examples, the control circuit may be configured to store timing information when storing the one or more of control parameters and/or operating characteristics of the solar management circuit in memory. As such, each time that the control circuit periodically adjusts the first MPPT drive signal V_{MPPT-DR1} and/or the second MPPT drive signal V_{MPPT-DR2} (e.g., at the timing interval), the control circuit may be configured to store one or more of control parameters and/or operating characteristics of the solar management circuit in memory (e.g., the memory of the bottom bar modules).

FIG. 29B is an example procedure 1850 for collecting solar data for a solar power system (e.g., the solar power systems 441, 541, 660) of a motorized window treatment (e.g., any of the motorized window treatments described herein). The procedure 1850 may be executed by a control circuit of a bottom bar module of a bottom bar of the motorized window treatment (e.g., the control circuits 450, 550 of the bottom bar modules 440, 540, the control circuit 650 of the solar power system 600, and/or control circuits of the bottom bars shown in FIGS. 1-15B). In some examples, the procedure 1850 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a motor drive unit for adjusting a present position P_{PRES} of the covering material and one or more solar cells located on the bottom bar. The bottom bar may be connected to a bottom end of the covering material of the motorized window treatment. For example, the control circuit may execute the procedure 1850 periodically at 1860.

At 1862, the control circuit may determine whether a present timing interval (e.g., the timing interval T_{TIM}, which may be approximately five seconds) has expired. If the present time interval has not expired at 1862, the procedure 1850 may end at 1874.

However, if the present time interval has expired at 1862, the control circuit may determine a magnitude of the photovoltaic output voltage V_{PV} produced by the solar cells of the bottom bar over the present time interval at 1864. In some examples, the control circuit may be configured to receive (e.g., from the solar management circuit) a photovoltaic output voltage feedback signal V_{PV-FB}, which may indicate the magnitude of the photovoltaic output voltage V_{PV}. Alternatively or additionally, the magnitude of the photovoltaic output voltage V_{PV} produced by the solar cells may be based on the magnitude of a photovoltaic output current I_{PV} (e.g., which may be dependent upon the amount sunlight presently being received by the solar cells) and the impedance Z_{MPPT} due to the operation of the solar cell management circuit at the duty cycle DC_{MPPT} and/or the operating period T_{MPPT} (e.g., V_{PV}=I_{PV}·Z_{MPPT}). For example, one or more sense signals V_{SCM-SNS} generated by the solar cell management circuit may comprise direct-current (DC) signals having magnitudes that indicate the magnitude of the photovoltaic output voltage V_{PV} and/or the one or more sense signals V_{SCM-SNS} generated by the solar cell management circuit may comprise messages (e.g., digital messages) including indications of the magnitude of the photovoltaic output voltage V_{PV}.

At 1866, the control circuit of may be configured to calculate the charge Q_{SOLAR} and/or the solar energy E_{SOLAR} for the present day. For example, the control circuit of may be configured to calculate the charge Q_{SOLAR} and/or the solar energy E_{SOLAR} periodically at the timing interval (e.g., at the same time so that the average magnitude I_{PV-AVE} of the photovoltaic output current I_{PV} and/or the solar power P_{SOLAR} are calculated) throughout the present day.

For example, the control circuit may be configured to calculate the charge Q_{SOLAR} based on, for example, the present average magnitude I_{PV-AVE} of the photovoltaic output current I_{PV} and one or more present operational characteristics of the drive signal that controls the operation of the solar power management circuit (e.g., the MPPT drive signals V_{MPPT-DR}, V_{MPPT-DR1}). For example, the control circuit may be configured to calculate the charge Q_{SOLAR} received from the solar cells based on the average magnitude I_{PV-AVE} of the photovoltaic output current I_{PV} and the timing interval T_{TIM}, e.g.,

$${Q}_{SOLAR} = {Q}_{SOLAR} + ( {I}_{PV - AVE} \cdot {T}_{TIM} ) .$$

Further, and for example, the control circuit may be configured to calculate the solar energy E_{SOLAR} received from the solar cells based on, for example, one or more present operational characteristics of the drive signal that controls the operation of the solar power management circuit (e.g., the MPPT drive signals V_{MPPT-DR}, V_{MPPT-DR1}) and the present average magnitude I_{PV-AVE} of the photovoltaic output current I_{PV} and/or the present solar power P_{SOLAR}. For example, the control circuit may be configured to calculate the solar energy E_{SOLAR} received from the solar cells based on the magnitude of the photovoltaic output voltage V_{PV} (e.g., as indicated by the photovoltaic output voltage feedback signal V_{PV-FB}), the average magnitude I_{PV-AVE} of the photovoltaic output current I_{PV}, and the timing interval T_{TIM}, e.g.,

$${E}_{SOLAR} = {E}_{SOLAR} + ( {V}_{PV} \cdot {I}_{PV - AVE} \cdot {T}_{TIM} ) .$$

In addition, the control circuit may be configured to calculate the solar energy E_{SOLAR} received from the solar cells based on the solar power P_{SOLAR} and the timing interval T_{TIM}, e.g.,

$${E}_{SOLAR} = {E}_{SOLAR} + ( {P}_{SOLAR} \cdot {T}_{Tim} ) .$$

At 1868, the control circuit may determine whether it is the end of an accumulation interval T_{ACC} (e.g., such as a day). e.g., such as a day). In some examples, the accumulation interval T_{ACC} may be other time periods (e.g., multiple days, a week, multiple weeks, a month, etc.). If it is not at the end of the accumulation interval T_{ACC} at 1868, the procedure 1850 may end at 1874. However, if it is at the end of the accumulation interval T_{ACC} (e.g., it is at the end of the day), the control circuit may store the charge Q_{SOLAR} and/or energy E_{SOLAR} for the present day at 1870. As such, the control circuit may determine (e.g., calculate) a charge Q_{SOLAR} and/or a solar energy E_{SOLAR} received from the solar cells (e.g., accumulated by the energy storage element of the bottom bar module) over the accumulation interval T_{ACC} (e.g., such as a day), and at the end of the accumulation interval T_{ACC} (e.g., at the end of each day), the control circuit may be configured to store the charge Q_{SOLAR} and/or the solar energy E_{SOLAR} in the solar data (e.g., along with timing information that indicates the present date). Further, in some examples, the control circuit may be configured to add the charge Q_{SOLAR} received from the solar cells to the present charge Q_{PRES-B} (e.g., Q_{PRES-B}=Q_{PRES-B}+Q_{SOLAR}), for example, at the end of each accumulation interval T_{ACC}.

At 1872, the control circuit may be configured to initialize the charge Q_{SOLAR} and/or the solar energy E_{SOLAR} for the next accumulation interval T_{ACC} (e.g., for the next day). For example, the control circuit may be configured to reset the charge Q_{SOLAR} and/or the solar energy E_{SOLAR} to zero coulombs at the end of the present accumulation interval. Thereafter, the procedure 1850 may end at 1874.

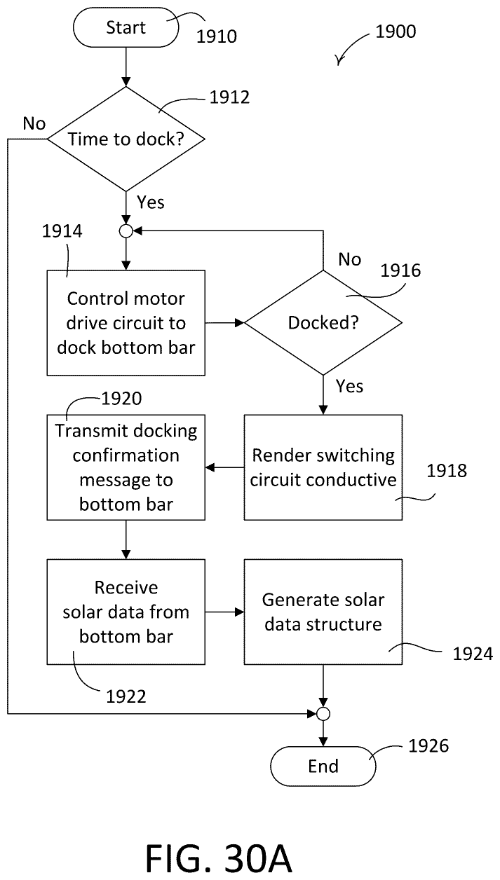

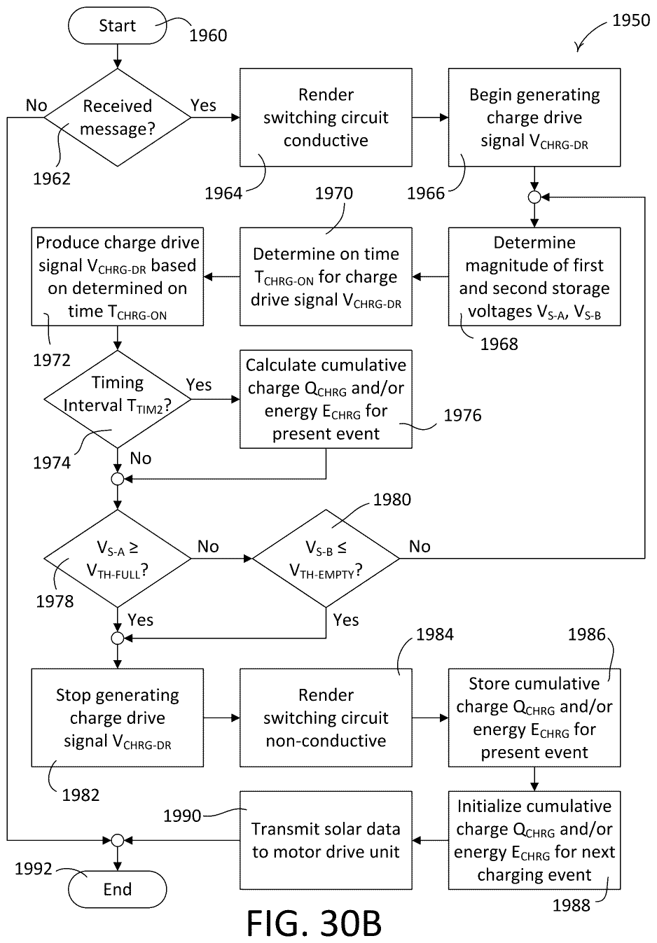

FIG. 30A is an example procedure 1900 for collecting solar data for a motorized window treatment (e.g., any of the motorized window treatments described herein). The procedure 1900 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a covering material, a bottom bar connected to a bottom end of the covering material, and one or more solar cells located on the bottom bar. The motor drive unit may be configured to control a present position P_{PRES} of the covering material. For example, the control circuit may execute the procedure 1900 to store solar data, such as one or more measurements and/or operational characteristics of the bottom bar module, at a plurality of intermediate positions of the covering material between a raised position P_{RAISED} and a lowered position P_{LOWERED}. The bottom bar module may be configured to communicate with the motor drive unit via a wireless communication link (e.g., via RF signals using a short-range wireless communication protocol). The bottom bar module may be configured to periodically collect and transmit the solar data to the motor drive unit (e.g., at the timing interval T_{TIM} set in the procedure 1400). For example, the control circuit may execute the procedure 1900 periodically at 1910.

At 1912, the control circuit of the base assembly may be configured to determine if the motor drive unit should presently dock the bottom bar. For example, the control circuit may be configured to determine that the bottom bar should be docked when the space in which the motorized window treatment is installed is vacant and the magnitude of a first storage voltage V_{S-A} produced across an energy storage element of the motor drive unit is less than a low-charge threshold V_{TH-LC}, and/or the space is occupied and the magnitude of the first storage voltage V_{S-A} produced across the energy storage element of the motor drive unit is less than a critical-charge threshold V_{TH-CRIT} (e.g., as shown in FIG. 21). In addition, the control circuit may determine that the bottom bar should be docked when the magnitude of a second storage voltage V_{S-B} produced across an energy storage element of the bottom bar module is greater than a high-charge threshold V_{TH-HC} (e.g., as shown in FIG. 22A). Further, the control circuit of the motor drive unit may be configured to determine that the bottom bar should be docked in response to the present day of the week and/or the time of the day. When the control circuit determines that the motor drive unit should not presently dock the bottom bar at 1912, the procedure 1900 may end at 1924.

When the control circuit determines that the motor drive unit should presently dock the bottom bar at 1912, the control circuit may control a motor drive circuit to control a motor of the motor drive unit to dock the bottom bar at 1914. For example, the control circuit may control the motor to adjust the present position P_{PRES} of the covering material to the raised position P_{RAISED} at 1914. In addition, the control circuit may control the covering material through a docking movement (e.g., a docking sequence) as the bottom bar nears the dock at 1914 (e.g., as shown in FIG. 23A). At 1916, the control circuit may be configured to determine if the bottom bar is docked. For example, the control circuit may be configured to determine if the bottom bar is docked by determining if electrical connections of the dock of the motor drive unit are electrically connected to the electrical connections of the bottom bar module at 1916. When the control circuit determines that the bottom bar is not presently docked at 1916, the control circuit may continue to control the motor to dock the bottom bar at 1914.

When the control circuit of the base assembly determines that the bottom bar is docked at 1916, the control circuit may transmit to the bottom bar module a query message that includes a request for solar data at 1918. At 1920, the control circuit of the base assembly may receive the solar data from the bottom bar module (e.g., as transmitted in response to the bottom bar module receiving the query message transmitted by the motor drive unit at 1918).

At 1922, the control circuit of the base assembly may be configured to match up each of the measurements and/or operational characteristics of the solar data with a respective position P_{DATA} of the covering material at the time that the measurement was made. For example, the solar data received from the bottom bar may include timing information (e.g., a time stamp indicating a time at which the respective measurement and/or operational characteristic was recorded) for each of the measurements and/or operational characteristics. The control circuit may be configured to generate a solar data structure (e.g., a table) from the solar data at 1922. For example, the control circuit may be configured to determine the respective position P_{DATA} of the covering material for each of the measurements and/or operational characteristics of the solar data by comparing the respective time stamp with the record of movements of the covering material that are stored in the memory of the motor drive unit, such that the control circuit may generate the solar data structure. Alternatively or additionally, the control circuit of the bottom bar module may be configured to wirelessly communicate the solar data while the covering material is moving (e.g., using a wireless communication link, such as an IR communication link) to the control circuit of the base assembly. At 1922, the control circuit of the base assembly may store the processed solar data by storing the respective position P_{DATA} of the covering material (e.g., as determined at 1922) along with each of the measurements and/or operational characteristics in the solar data, for example in the solar data structure before the procedure 1900 ends at 1924.

Further, in some examples, the control circuit may be configured to generate the solar data structure such that the fields of the solar data structure are an average of multiple fields over time. For instance, the solar power P_{SOLAR} in the solar power field of each record may be a rolling average (e.g., a seven-day rolling average) of solar power P_{SOLAR} at a particular position P_{S} of the bottom bar at a particular time of day (e.g., as determined from the time T_{S}). For example, the control circuit and/or the system controller may be configured to average multiple values of the solar power P_{SOLAR} over a period of time (e.g., multiple days) to generate a single value for the solar power P_{SOLAR} at a particular position P_{S} at a particular time of the day (e.g., 9 am). For example, period of time may be seven days (e.g., one week), such that the average is a seven-day rolling average. In such examples, the solar data structure that is stored at the motor drive unit may include records with solar power fields that indicate the solar power P_{SOLAR} over the period of time (e.g., by storing a rolling average of multiple solar powers associated with a particular position P_{S} of the bottom bar at a particular time of day) as compared to storing individual records for multiple days of the weeks and/or tables for multiple days of the week.

FIG. 30B is an example procedure 1950 for charging an energy storage element of a solar power system (e.g., the solar power systems 441, 541, 660) of a motorized window treatment (e.g., any of the motorized window treatments described herein). The procedure 1850 may be executed by a control circuit of a bottom bar module of a bottom bar of the motorized window treatment (e.g., the control circuits 450, 550 of the bottom bar modules 440, 540, the control circuit 650 of the solar power system 600, and/or control circuits of the bottom bars shown in FIGS. 1-15B). The motorized window treatment may comprise a motor drive unit for adjusting a present position P_{PRES} of the covering material and one or more solar cells located on the bottom bar. The motor drive unit may comprise the energy storage element that is charged using the procedure 1950. The bottom bar may be connected to a bottom end of the covering material of the motorized window treatment. The bottom bar module of the bottom bar may include the solar power system of the motorized window treatment. The control circuit of the bottom bar module may be configured to control a charging circuit of the solar power system to charge the energy storage element of the motor drive unit from an energy storage element of the solar power system (e.g., of the bottom bar module). The control circuit may be configured to execute the procedure 1950 to complete a charging event of the energy storage element of the motor drive unit. The control circuit may be configured to determine (e.g., calculate) a charge Q_{CHRG} and/or an energy E_{CHRG} transferred to the energy storage element of the motor drive unit during execution of the procedure 1950 (e.g., during the charging event). For example, the control circuit may execute the procedure 1950 at 1960 when the bottom bar is docked (e.g., in response to determining that the bottom bar is docked). Further, in some examples, such as if the motor drive unit includes a charging circuit, a control circuit of the base assembly may be configured to execute the procedure 1950.

At 1962, the control circuit may determine whether a message has been received. The message may confirm that the bottom bar has been successfully docked with the motor drive unit. For example, after controlling the bottom bar to the raised position P_{RAISED}, the motor drive unit may be configured to transmit a message (e.g., a docking confirmation message) to the control circuit of the bottom bar via a communication connection (e.g., the communication connection 606). In some examples, after receiving the message, the control circuit may transmit a response message to the motor drive unit to confirm that the message was received and docking is confirmed.

At 1964, the control circuit may render a switching circuit of the bottom bar module conductive. For example, the control circuit 650 of the solar power system 600 shown in FIG. 17A may be configured to control the charge enable control signal V_{CHRG-EN-B} to render the switching circuit 665 conductive.

At 1966, the control circuit may enable charging the energy storage element of the motor drive unit by generating (e.g., beginning to generate) a charge drive signal V_{CHRG-DR} for controlling the charging circuit. For example, the control circuit 650 of the solar power system 600 shown in FIG. 17A may generate the charge drive signal V_{CHRG-DR} that may be received by the gate drive circuit 674 of the charging circuit 660 for rendering the FET Q672 conductive and non-conductive. The charging event may begin when the control circuit begins to generate the charge drive signal V_{CHRG-DR} for controlling the charging circuit at 1966.

At 1968, the control circuit may determine the magnitude of the first storage voltage V_{S-A} across the energy storage element of the motor drive unit and the second storage voltage V_{S-B} across the energy storage element of the solar power system. The control circuit may receive a first source voltage feedback signal V_{SA-FB} that indicates the magnitude of the first storage voltage V_{S-A}. For instance, the charging circuit 660 shown in FIG. 17A may comprise a resistive divider circuit having a resistor R663 (e.g., having a resistance of approximately 47.5 kΩ in series with a resistor R664 (e.g., having a resistance of approximately 7.32 kΩ. The series combination of the resistors R663, R664 of the resistive divider circuit may be coupled in parallel with the output capacitor C662 for receiving the first storage voltage V_{S-A}, such that the first source voltage feedback signal V_{SA-FB} is generated at the junction of the resistors R663, R664 of the resistive divider circuit when the bottom bar is docked with the motor drive unit. For example, the first source voltage feedback signal V_{SA-FB} (e.g., the magnitude of the first source voltage feedback signal V_{SA-FB}) may indicate the magnitude of the first source voltage V_{S-A}. As such, the control circuit 650 of the solar power system 600 may receive the first source voltage feedback signal V_{SA-FB} and may be configured to determine the magnitude of the first source voltage V_{S-A} from the first source voltage feedback signal V_{SA-FB}.

Further, in some examples, the control circuit may receive a second source voltage feedback signal V_{SB-FB} that indicates the magnitude of the second storage voltage V_{S-B}. For instance, the solar cell management circuit 620 of the solar power system 600 shown in FIG. 17A may comprise a second resistive divider circuit having a resistor R625 (e.g., having a resistance of approximately 14.3 kΩ in series with a resistor R626 (e.g., having a resistance of approximately 7.32 kΩ. The series combination of the resistors R625, R626 of the second resistive divider circuit may be coupled in parallel with the output capacitor C622 for receiving the second storage voltage V_{S-B}, such that a second storage voltage feedback signal V_{SB-FB} may be generated at the junction of the resistors R625, R626 of the second resistive divider circuit. For example, the second storage voltage feedback signal V_{SB-FB} (e.g., the magnitude of the second storage voltage feedback signal V_{SB-FB}) may indicate the magnitude of the second storage voltage V_{S-B}. The control circuit 650 of the solar power system 600 may receive the second storage voltage feedback signal V_{SB-FB} and may be configured to determine the magnitude of the second storage voltage V_{S-B} from the second storage voltage feedback signal V_{SB-FB}.

At 1970, the control circuit may determine an on time T_{CHRG-ON} for a charge drive signal V_{CHRG-DR}. For example, the control circuit 650 of the solar power system 600 shown in FIG. 17A may be configured to adjust the on time T_{CHRG-ON} of the charge drive signal V_{CHRG-DR} to maintain an average magnitude I_{IN-AVE} of the input current I_{IN} (e.g., conducted by the charging circuit 660 from the energy storage element 640 of the solar power system) at a constant magnitude I_{IN-CNST} (e.g., approximately 250 milliamps). For example, the control circuit 650 may set the on time T_{CHRG-ON} of the charge drive signal V_{CHRG-DR} based on the operating period T_{CHRG}, the magnitude of the first storage voltage V_{S-A} (e.g., as indicated by the first storage voltage feedback signal V_{SA-FB}), the magnitude of the second storage voltage V_{S-B} (e.g., as indicated by the second storage voltage feedback signal V_{SB-FB}), the inductance LIND of the inductor L670, and the average magnitude I_{IN-AVE} of the input current I_{IN}, e.g.,

$${T}_{CHRG - ON} = Square Root [ ( {L}_{IND} \cdot {T}_{CHRG} \cdot {I}_{IN\_AVE} \cdot [ {V}_{S - A} - {V}_{S - B} ] ) / ( 2 \cdot {V}_{S - A} \cdot {V}_{S - B} ) ] .$$

The control circuit 650 may be configured to set the off time T_{CHRG-OFF} based on the determined on time T_{CHRG-ON} and the operating period T_{CHRG} (e.g., T_{CHRG-OFF}=T_{CHRG}−T_{CHRG-ON}).

At 1972, the control circuit may produce (e.g., adjust) the charge drive signal V_{CHRG-DR} based on the determined the on time T_{CHRG-ON}. For example, the control circuit 650 of the solar power system 600 shown in FIG. 17A may generate the charge drive signal V_{CHRG-DR} to control the FET Q672 on a periodic basis at an operating frequency f_{CHRG} (e.g., at an operating period T_{CHRG}). For example, the control circuit 650 may maintain the operating frequency f_{CHRG} constant (e.g., at approximately 35 kHz) and maintain the operating period T_{CHRG} constant (e.g., at approximately 29 microseconds) during operation of the charging circuit. The control circuit 650 may generate the charge drive signal V_{CHRG-DR} according to a duty cycle DC_{CHRG} to render the FET Q672 conductive for an on time T_{CHRG-ON} and non-conductive for an off time T_{CHRG-OFF} (e.g., DC_{CHRG}=T_{CHRG-ON}/[T_{CHRG-ON}+T_{CHRG-OFF}]). The control circuit 650 may control the on time T_{CHRG-ON} of the charge drive signal V_{CHRG-DR} down to, for example, the minimum on time T_{ON-MIN} (e.g., approximately 2 microseconds). The control circuit 650 may adjust the on time T_{CHRG-ON} of the charge drive signal V_{CHRG-DR} by, for example, the minimum step size ΔT_{ON} (e.g., approximately 0.5 microseconds). For example, the control circuit 650 may adjust the on time T_{CHRG-ON} of the charge drive signal V_{CHRG-DR} to multiples of the minimum step size ΔT_{ON} (e.g., discrete values separated by the minimum step size ΔT_{ON}).

At 1974, the control circuit may determine whether a timing interval (e.g., the interval T_{TIM2}) has expired. For example, the control circuit may be configured to update the charge Q_{CHRG} and/or the energy E_{CHRG} transferred to the energy storage element of the motor drive unit at the timing interval. If the timing interval (e.g., the timing interval T_{TIM2}) has not expired at 1974, the procedure may continue to 1978.

If the timing interval (e.g., the interval T_{TIM2}) has expired at 1974, the control circuit may update (e.g., calculate) the charge Q_{CHRG} and/or energy E_{CHRG} transferred to the energy storage element of the motor drive unit for the charging event (e.g., when the bottom bar is docked) at 1976, and the procedure 1950 may continue to 1978.

For example, the control circuit may determine (e.g., calculate) the charge Q_{CHRG} and/or the energy E_{CHRG} transferred to the energy storage element of the motor drive unit during the charging event (e.g., when the bottom bar is docked). The control circuit may be configured to update the calculation of the at the timing interval (e.g., the timing interval T_{TIM2}). For example, the control circuit 650 of the solar power system 600 may calculate the charge Q_{CHRG} transferred to the energy storage element of the motor drive unit based on the average magnitude I_{CHRG-AVE} of the charging current I_{CHRG} and the timing interval T_{TIM2}, e.g.,

$${Q}_{CHRG} = {Q}_{CHRG} + ( {I}_{CHRG - AVE} \cdot {T}_{TIM 2} ) .$$

In addition, the control circuit 650 may calculate the energy E_{CHRG} transferred to the energy storage element of the motor drive unit based on the magnitude of the first storage voltage V_{S-A} (e.g., as indicated by the second storage voltage feedback signal V_{SA-FB}), the average magnitude I_{CHRG-AVE} of the charging current I_{CHRG}, and the timing interval T_{TIM2}, e.g.,

$${E}_{CHRG} = {E}_{CHRG} + ( {V}_{S - A} \cdot {I}_{CHRG - AVE} \cdot {T}_{TIM 2} ) .$$

In some examples, the control circuit 650 may calculate the energy E_{CHRG} transferred to the energy storage element of the motor drive unit based on the charging power P_{CHRG} and the timing interval T_{TIM2}, e.g.,

$${E}_{CHRG} = {E}_{CHRG} + ( {P}_{CHRG} \cdot {T}_{TIM 2} ) .$$

The control circuit 650 may be configured to determine (e.g., calculate) the average magnitude I_{CHRG-AVE} of the charging current I_{CHRG} based on the operating period T_{CHRG}, the on time T_{ON} of the charge drive signal V_{CHRG-DR}, the magnitude of the first storage voltage V_{S-A} (e.g., as indicated by the first storage voltage feedback signal V_{SA-FB}), the magnitude of the second storage voltage V_{S-B} (e.g., as indicated by the second storage voltage feedback signal V_{SB-FB}), and the inductance LIND of the inductor L670, e.g.,

$${I}_{CHRG - AVE} = {( {V}_{SB} \cdot {T}_{CHRG} )}^{2} / ( 2 \cdot {L}_{IND} \cdot {T}_{CHRG} \cdot [ {V}_{SA} - {V}_{SB} ] ) .$$

At 1978, the control circuit may determine whether the magnitude of the first storage voltage V_{S-A} across the energy storage element of the motor drive unit is greater than (e.g., greater than or equal to) a full storage voltage threshold V_{TH-FULL} (e.g., approximately 6.5 volts) at 1978. For example, the control circuit 650 of the solar power system 600 may determine that the energy storage element of the motor drive unit is full in response to the magnitude of the first storage voltage V_{S-A} across the energy storage element of the motor drive unit (e.g., as indicated by the first storage voltage feedback signal V_{SA-FB}).

If the magnitude of the first storage voltage V_{S-A} across the energy storage element of the motor drive unit is greater than or equal to a full storage voltage threshold V_{TH-FULL} at 1978, the control circuit may disable charging of the energy storage element of the motor drive unit by ceasing the generation of the charge drive signal V_{CHRG-DR} at 1982. For example, the control circuit 650 of the solar power system 600 shown in FIG. 17A may stop generating the charge drive signal V_{CHRG-DR} that is received by the gate drive circuit 674 of the charging circuit 660 for rendering the FET Q672 conductive and non-conductive. The charging event may end when the control circuit stops generating the charge drive signal V_{CHRG-DR} for controlling the charging circuit at 1982.

At 1984, the control circuit may render the switching circuit of the bottom bar module non-conductive. For example, the control circuit 650 of the solar power system 600 shown in FIG. 17A may be configured to render the switching circuit 665 non-conductive by controlling the charge enable control signal V_{CHRG-EN-B}. As such, the control circuit may disable charging of the energy storage element of the motor drive unit, for example, when the energy storage element of the motor drive unit is full. Further, in some examples, the control circuit may transmit a message indicating that charging of the energy storage element is complete to the motor drive unit via the communication connection.

If the magnitude of the first storage voltage V_{S-A} across the energy storage element of the motor drive unit is less than the full storage voltage threshold V_{TH-FULL} at 1978, the control circuit may determine whether the magnitude of the second storage voltage V_{S-B} produced across the energy storage element of the bottom bar module is less than or equal to an empty storage voltage threshold V_{TH-EMPTY} at 1980. For example, the control circuit 650 of the solar power system 600 may determine that the energy storage element of the motor drive unit is empty in response to the magnitude of the second storage voltage V_{S-B} across the energy storage element 640 of the solar power system 600 (e.g., as indicated by the second storage voltage feedback signal V_{SB-FB}). If the magnitude of the second storage voltage V_{S-B} is greater than the empty storage voltage threshold V_{TH-EMPTY} at 1980, the procedure 1950 may return to 1968.

If the magnitude of the second storage voltage V_{S-B} is less than or equal to the empty storage voltage threshold V_{TH-EMPTY} at 1980, the control circuit may disable charging of the energy storage element of the motor drive unit by ceasing the generation of the charge drive signal V_{CHRG-DR} at 1982. For example, the control circuit 650 of the solar power system 600 shown in FIG. 17A may stop generating the charge drive signal V_{CHRG-DR} that is received by the gate drive circuit 674 of the charging circuit 660 for rendering the FET Q672 conductive and non-conductive. The charging event may end when the control circuit stops generating the charge drive signal V_{CHRG-DR} for controlling the charging circuit at 1982. At 1984, the control circuit may render the switching circuit of the bottom bar module non-conductive. For example, the control circuit 650 of the solar power system 600 shown in FIG. 17A may be configured to render the switching circuit 665 non-conductive by controlling the charge enable control signal V_{CHRG-EN-B}. As such, the control circuit may disable charging of the energy storage element of the motor drive unit, for example, when the energy storage element of the solar power system is empty. Further, during the charging event (e.g., from 1968 through 1980), the control circuit may calculate the cumulative charge Q_{CHRG} and/or the cumulative energy E_{CHRG} transferred to the energy storage element of the motor drive unit periodically at 1976 (e.g., based on the timing interval T_{TIM2}) until either the energy storage element of the motor drive unit is full at 1978 or the energy storage element of the solar power system is empty at 1980.

At 1986, the control circuit may store the charge Q_{CHRG} and/or the energy E_{CHRG} transferred to the energy storage element of the motor drive unit during the charging event (e.g., when the bottom bar is docked) in memory (e.g., along with timing information, such as the present date). The charge Q_{CHRG} and/or the energy E_{CHRG} may be calculated at 1976. Further, in some examples, the control circuit may be configured to add the charge Q_{CHRG} transferred to the energy storage element of the motor drive unit to the present charge Q_{PRES-A} (e.g., Q_{PRES-A}=Q_{PRES-A}+Q_{CHRG}), for example, periodically at the timing interval T_{TIM2} during each charging event. Alternatively or additionally, in some examples, the control circuit may be configured to subtract the charge Q_{CHRG} transferred to the energy storage element of the motor drive unit 510 from the present charge Q_{PRES-B} (e.g., Q_{PRES-B}=Q_{PRES-B}−Q_{CHRG}), for example, periodically at the timing interval T_{TIM2} during each charging event.

At 1988, the control circuit may initialize the charge Q_{CHRG} and/or energy E_{CHRG} for next charging event (e.g., the next time that the bottom bar is docked and the procedure 1950 is executed). For example, the control circuit may reset the charge Q_{CHRG} to zero coulombs and/or the solar energy E_{CHRG} to zero joules at the end of the charging event (e.g., after charging is disabled, such as based on the energy storage element of the motor drive unit being full or the energy storage element of the bottom bar being empty). As such, the control circuit may determine the charge Q_{CHRG} and/or the energy E_{CHRG} transferred to the energy storage element of the motor drive unit during the next charging event (e.g., the next time that the bottom bar is docked and the procedure 1950 is executed).

Finally, at 1990, the control circuit may transmit solar data to the motor drive unit. For example, as noted herein, the solar data may comprise one or more performance values (e.g., measured and/or calculated values, such as the charge Q_{CHRG} and/or the energy E_{CHRG} calculated at 1976) recorded by the bottom bar module, and/or one or more operational characteristics (e.g., controlled settings and/or parameters) of the bottom bar module. For example, the control circuit may transmit one or more of the performance values and/or operational characteristics of the solar data to the control circuit of the base assembly (e.g., and vice versa).

In some examples, the control circuit may be configured to disable charging of the energy storage element in response to the present charge Q_{PRES-A} of the energy storage element of the motor drive unit and/or the present charge Q_{PRES-B} of the energy storage element of the bottom bar module. For example, the control circuit may be configured to determine whether the present charge Q_{PRES-A} of the energy storage element of the motor drive unit is greater than (e.g., greater than or equal to) a full storage charge threshold Q_{TH-FULL} at 1978. When the present charge Q_{PRES-A} of the energy storage element of the motor drive unit is greater than (e.g., greater than or equal to) the full storage charge threshold Q_{TH-FULL} at 1978, the control circuit may disable charging of the energy storage element of the motor drive unit by ceasing the generation of the charge drive signal V_{CHRG-DR} at 1982. In addition, the control circuit may be configured to determine whether the present charge Q_{PRES-B} of the energy storage element of the bottom bar module is less than an empty storage charge threshold Q_{TH-EMPTY} at 1980. When the present charge Q_{PRES-B} of the energy storage element of the bottom bar module is less than the empty storage charge threshold Q_{TH-EMPTY} at 1980, the control circuit may disable charging of the energy storage element of the motor drive unit by ceasing the generation of the charge drive signal V_{CHRG-DR} at 1982.

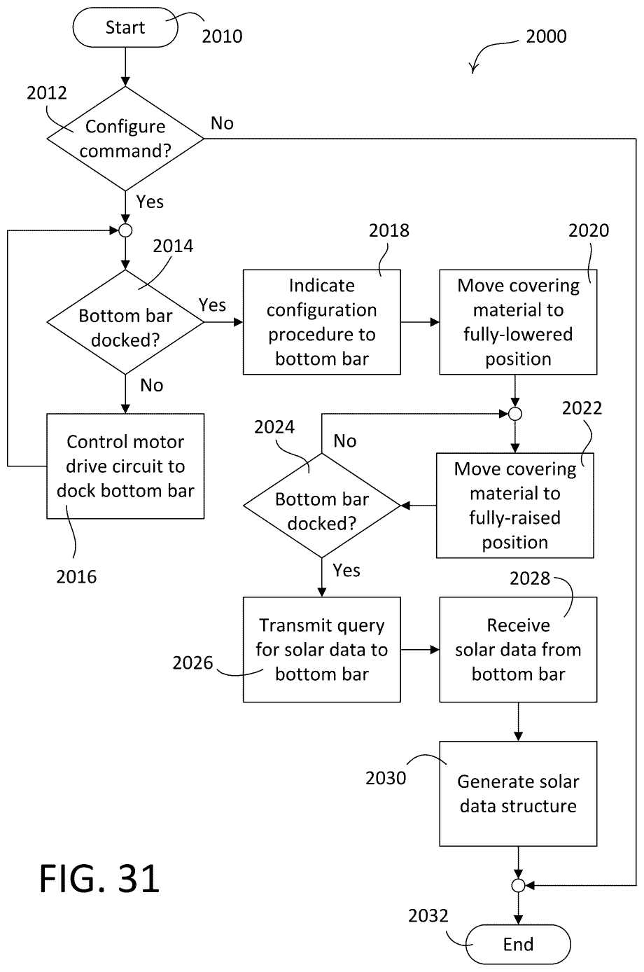

FIG. 31 is an example procedure 2000 for collecting solar data for a motorized window treatment (e.g., any of the motorized window treatments described herein). The procedure 2000 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a covering material, a bottom bar connected to a bottom end of the covering material, and one or more solar cells located on the bottom bar. The motor drive unit may be configured to control a present position P_{PRES} of the covering material.

The control circuit may be configured to execute the procedure 2000 as part of a configuration procedure of the motorized window treatment (e.g., at the time of installation of the motorized window treatment). For example, the control circuit may execute the procedure 2000 to store solar data, such as one or more measurements and/or operational characteristics of the bottom bar module, at a plurality of intermediate positions of the covering material between a raised position P_{RAISED} and a lowered position P_{LOWERED}. The bottom bar module may be configured to communicate with the motor drive unit via a wired communication link (e.g., via the electrical connections 638, 648) when the bottom bar is docked. The control circuit of the bottom bar module may be configured to collect and store the solar data in memory of the bottom bar module (e.g., at the timing interval T_{TIM} set in the procedure 1400), and then transmit the solar data to the motor drive unit via the wired communication link when the bottom bar is docked. For example, the control circuit may execute the procedure 2000 periodically at 2010. In addition, the control circuit may execute the procedure 2000 at 2010 in response to receiving a message from the bottom bar module and/or in response to detecting an actuation of a button of the motor drive unit.

At 2012, the control circuit may determine if a command to configure the motor drive unit has been received. For example, the control circuit may receive the command to configure the motor drive unit in a message received via the communication circuit and/or in response to an actuation of a button of the motor drive unit. When the control circuit determines that a command to configure the motor drive unit has not been received at 2012, the procedure 2000 may end at 2032. When the control circuit determines that a command to configure the motor drive unit has been received at 2012, the control circuit may be configured to determine if the bottom bar is docked at 2014. For example, the control circuit may be configured to determine if the bottom bar is docked by determining if electrical connections of the dock of the motor drive unit are electrically connected to the electrical connections of the bottom bar module at 2014. When the control circuit determines that the bottom bar is not presently docked at 2014, the control circuit may control a motor drive circuit to control a motor of the motor drive unit to dock the bottom bar at 2016. For example, the control circuit may control the motor to adjust the present position P_{PRES} of the covering material to the raised position P_{RAISED} at 2016. In addition, the control circuit may control the covering material through a docking movement (e.g., a docking sequence) as the bottom bar nears the dock at 2016 (e.g., as shown in FIG. 23A).

When the control circuit of the base assembly determines that the bottom bar is presently docked at 2014, the control circuit may indicate to the bottom bar module that the control circuit is going to be executing the configuration procedure at 2018. For example, the control circuit by transmit a message to the bottom bar module indicating the execution of the configuration procedure. At 2020, the control circuit may initialize the present position P_{PRES} of the covering material for the configuration procedure by adjusting the present position P_{PRES} of the covering material to the lowered position P_{LOWERED}. At 2022, the control circuit may control the motor drive circuit to adjust the present position P_{PRES} of the covering material from the raised position P_{RAISED} to the lowered position P_{LOWERED} so that the bottom bar module is able to record one or more measurements and/or operational characteristics of the bottom bar at the raised position P_{RAISED}, the lowered position P_{LOWERED}, and/or multiple intermediate positions between the raised position P_{RAISED} and the lowered position P_{LOWERED}. For example, the bottom bar module may be configured to record the one or more measurements and/or operational characteristics of the bottom bar in response to receiving the indication of the configuration procedure transmitted by the control circuit of the motor dive unit at 2018.

At 2024, the control circuit of the base assembly may determine if the bottom bar is docked. When the bottom bar is not docked at 2024, the control circuit may control the motor drive circuit at 2022 to adjust the present position P_{PRES} of the covering material from the lowered position P_{LOWERED} to the raised position P_{RAISED}, for example, to dock the bottom bar. In some examples, the bottom bar module may also record one or more measurements and/or operational characteristics of the bottom bar multiple intermediate positions between the lowered position P_{LOWERED} and the raised position P_{RAISED} while the control circuit is adjusting the present position P_{PRES} of the covering material from the lowered position P_{LOWERED} to the raised position P_{RAISED} at 2022.

When the control circuit determines that the bottom bar is docked at 2024, the control circuit may transmit to the bottom bar module a query message that includes a request for solar data at 2026. At 2028, the control circuit of the base assembly may receive the solar data from the bottom bar module (e.g., as transmitted in response to the bottom bar module receiving the query message transmitted by the motor drive unit at 2026). At 2030, the control circuit may generate a solar data structure (e.g., a table) from the solar data. The solar data structure may include a plurality of records (e.g., rows of the table), where each record may comprise a solar power P_{SOLAR} received by the one or more solar cells of the bottom bar, a position of the bottom bar when the one or more solar cells collected the respective solar power P_{SOLAR}, and a time (e.g., time of the day and/or day of the year) at which the one or more solar cells collected the respective solar power P_{SOLAR}. The generation of the solar data structure based on solar data is described in more detail below with reference to procedure 2900. The control circuit of the base assembly may store the solar data structure in memory of the motor drive unit before the procedure 2000 ends at 2032.

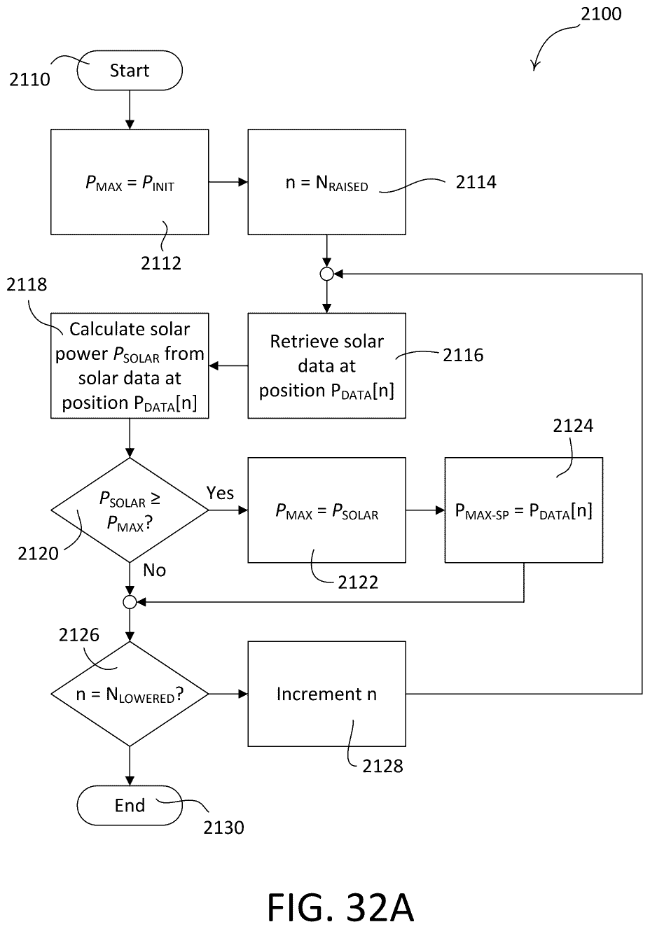

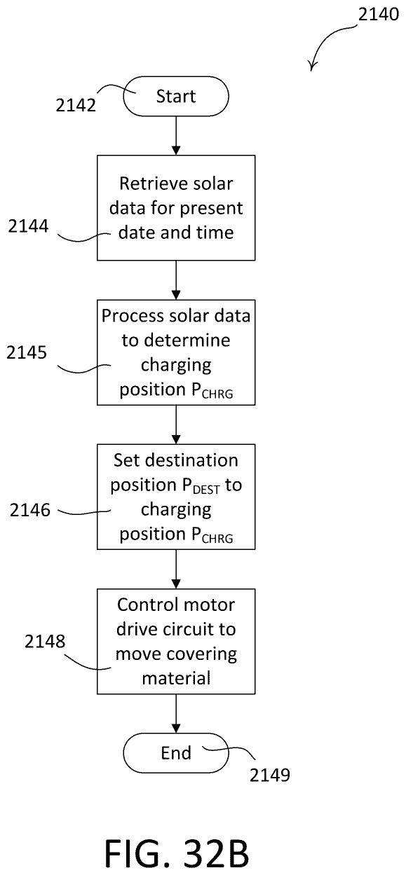

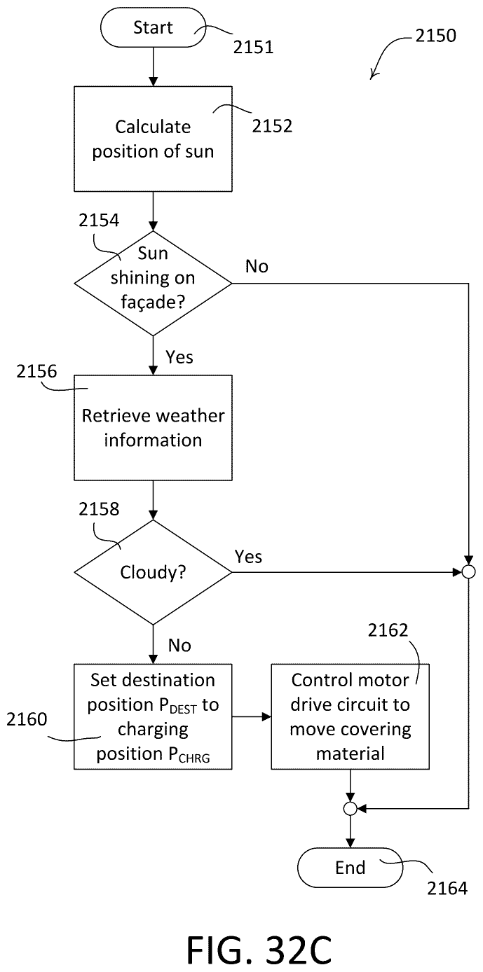

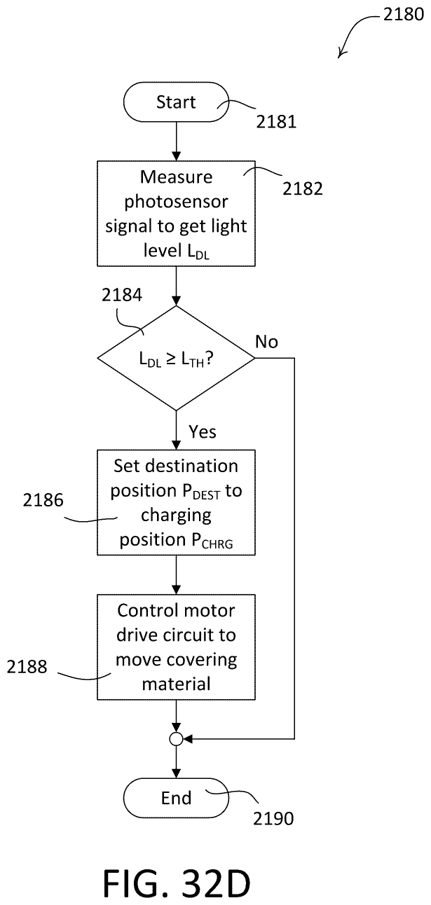

FIG. 32A is a flowchart of an example procedure 2100 for configuring a motorized window treatment (e.g., any of the motorized window treatments described herein). The procedure 2100 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a covering material, a bottom bar connected to a bottom end of the covering material, and one or more solar cells located on the bottom bar.

The motor drive unit may be configured to control a present position P_{PRES} of the covering material. The motor drive unit may have stored in memory solar data, such as one or more measurements and/or operational characteristics of a bottom bar module of the bottom bar at a plurality of intermediate positions of the covering material between a raised position P_{RAISED} and a lowered position P_{LOWERED} (e.g., as described above). For example, the control circuit may execute the procedure 2100 to determine a maximum magnitude P_{MAX} of solar power P_{SOLAR} that is received by the solar cells on the bottom bar as indicated by the solar data between the raised position P_{RAISED} and the lowered position P_{LOWERED}. The control circuit may also execute the procedure 2100 to determine a maximum-solar-power position P_{MAX-SP} at which the solar cells of the bottom bar may receive the maximum magnitude P_{MAX} of the solar power P_{SOLAR}. For example, the control circuit may execute the procedure 2100 periodically at 2110. In addition, the control circuit may execute the procedure 2100 at 2110 in response to receiving a message including a command to configure the motor drive unit.

At 2112, the control circuit may initialize the maximum magnitude P_{MAX} of the solar power P_{SOLAR} to an initial solar power P_{INIT} (e.g., zero Watts). At 2114, the control circuit may initialize a variable n to a raised-position value N_{RAISED}, which may identify measurements and/or operational characteristics of the solar data that are recorded at the raised position P_{RAISED}. At 2116, the control circuit may retrieve the solar data at the position P_{DATA}[n] (e.g., the measurements and/or operational characteristics recorded at the position P_{DATA}[n] during one or more of the procedures 1600, 1900, 2000). For example, the control circuit may retrieve a magnitude of a photovoltaic output voltage of the solar cells of the bottom bar (e.g., the photovoltaic output voltage V_{PV}), a magnitude of a storage voltage of the bottom bar module (e.g., the second storage voltage V_{S-B}), and/or a duty cycle of a solar cell management circuit of the bottom bar module (e.g., the duty cycle DC_{SCM} of the solar cell management circuit 644) that are recorded at the position P_{DATA}[n]. At 2118, the control circuit may calculate the magnitude of the solar power P_{SOLAR} at the position P_{DATA}[n]. For example, the control circuit may calculate the magnitude of the solar power P_{SOLAR} as a function of the magnitude of the photovoltaic output voltage of the solar cells of the bottom bar, the magnitude of the storage voltage of the bottom bar module, and/or the duty cycle of the solar cell management circuit of the bottom bar module. In some examples, the control circuit may calculate the magnitude of the solar power P_{SOLAR} at each of the positions between the raised position P_{RAISED} and the lowered position P_{LOWERED} and store the calculated solar power P_{SOLAR} in the solar data for each of the positions between the raised position P_{RAISED} and the lowered position P_{LOWERED}, so that during the procedure 2100, the control circuit needs to retrieve the solar power P_{SOLAR} at the position P_{DATA}[n] at 2116 (e.g., calculation of the solar power P_{SOLAR} at the position P_{DATA}[n] at 2118 may be omitted from the procedure 2100).

At 2120, the control circuit may determine if the magnitude of the solar power P_{SOLAR} at the position P_{DATA}[n] is greater than (e.g., greater than or equal to) the maximum magnitude P_{MAX}. When the magnitude of the solar power P_{SOLAR} at the position P_{DATA}[n] is greater than (e.g., greater than or equal to) the maximum magnitude P_{MAX} at 2120, the control circuit may update the maximum magnitude P_{MAX} to be equal to the magnitude of the solar power P_{SOLAR} at the position P_{DATA}[n] at 2122 and set the maximum-solar-power position P_{MAX-SP} to be equal to the position P_{DATA}[n] at 2124, before determining at 2126 if the variable n is equal to a lowered-position value N_{LOWERED}, which may identify measurements and/or operational characteristics of the solar data that recorded at the lowered position P_{LOWERED}. When the magnitude of the solar power P_{SOLAR} at the position P_{DATA}[n] is less than the maximum magnitude P_{MAX} at 2120, the control determine if the variable n is equal to the lowered-position value N_{LOWERED} at 2126 (e.g., without updating the maximum magnitude P_{MAX} at 2122 or setting the maximum-solar-power position P_{MAX-SP} at 2124). When the variable n is not equal to the lowered-position value N_{LOWERED} at 2126, the control circuit may increment the variable n at 2128 and calculate the magnitude of the solar power P_{SOLAR} at the next position P_{DATA}[n] at 2118. When the variable n is equal to the lowered-position value N_{LOWERED} at 2126, the procedure 2100 may end at 2130 (e.g., with the maximum magnitude P_{MAX} at last updated at 2122 and the maximum-solar-power position P_{MAX-SP} as last set at 2124).

FIG. 32B is a flowchart of an example procedure 2140 for controlling a motorized window treatment (e.g., any of the motorized window treatments described herein). The procedure 2140 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). Further, in some examples, the procedure 2140 could be performed (e.g., substantially or entirely) by a control circuit of a bottom bar module of the motorized window treatment). The motorized window treatment may comprise a covering material, a bottom bar connected to a bottom end of the covering material, and one or more solar cells located on the bottom bar. The control circuit may execute the procedure 2140 periodically.

The procedure 2140 may start at 2142. At 2144, the control circuit may retrieve solar data for the present date and/or time (e.g., and location of the motorized window treatment). For example, the control circuit may receive solar data from the bottom bar. For instance, the control circuit of the bottom bar module may be configured to collect and store the solar data in memory of the bottom bar module (e.g., at the timing interval T_{TIM} set in the procedure 1400), and then transmit the solar data to the motor drive unit via a wired or wireless communication link. When the control circuit receives the solar data from the bottom bar module, the control circuit may store the solar data in memory at that time, and then retrieve the solar data from memory at 2144.

At 2145, the control circuit may process the solar data to determine a charging position P_{CHRG} of the bottom bar based on the solar data. For example, the control circuit may determine the position of the bottom bar that is most likely to lead to the solar cells receiving the most sunlight and/or charge. In some examples, the control circuit may determine the charging position P_{CHRG} of the bottom bar using the procedure 2100. Alternatively or additionally, the control circuit may store the solar data from various positions (e.g., over a period of time, such as a year), and the control circuit may determine the charging position P_{CHRG} based on the saved solar data (e.g., and the present day and/or time).

At 2146, the control circuit may set the destination position P_{DEST} for the bottom bar to the charging position P_{CHRG}. For example, the control circuit may set the position of the bottom bar to be at the position where the solar cells are most likely to receive the most sunlight and/or charge. At 2148, the control circuit may control the motor drive circuit to move the covering material to the destination position P_{DEST}, and the procedure 2140 may end at 2149. For example, the control circuit may be configured to generate at least one drive signal (e.g., the at least one drive signal VDR) for controlling the motor drive circuit to control the rotational speed and the direction of rotation of the motor until the covering material is at the destination position P_{DEST}. As such, using the procedure 2140, the control circuit may determine the ideal charging position for the solar cells, and then move the bottom bar accordingly.

FIG. 32C is a flowchart of an example procedure 2150 for configuring a motorized window treatment (e.g., any of the motorized window treatments described herein). The procedure 2150 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a covering material, a bottom bar connected to a bottom end of the covering material, and one or more solar cells located on the bottom bar. The control circuit may execute the procedure 2150 periodically.

The procedure 2150 may start at 2151. At 2152, the control circuit may determine the position of the sun, for example, as described herein. The control circuit may calculate the position of the sun based on a predicted position of the sun. Alternatively, the control circuit may receive an indication of the predicted position of the sun from a system controller. At 2154, the control circuit may determine whether the sun may be shining on a façade of the building of which the motorized window treatment is installed. Since there may be cloud cover or another obstruction between the façade and the sun, the predicted position of the sun may indicate whether there is potentially sun shining on the façade of the building of which the motorized window treatment is installed, for instance, as described herein. For example, the control circuit may be configured to determine whether the sun may be shining on the façade of which the motorized window treatment is installed at 2152 by comparing the calculated solar altitude angle at and/or the calculated solar azimuth angle as to one or more thresholds to determine if the calculated solar altitude angle at and/or the calculated solar azimuth angle as are within ranges that indicate that the sun may be shining on the façade. If the control circuit determines that the sun is not shining on the façade, the procedure 2150 may end at 2164.

If the control circuit determines that the sun may be shining on the façade, the control circuit may retrieve weather information (e.g., temperature, cloud coverage, precipitation, barometric pressure, etc.) at 2156. For example, the control circuit may retrieve the weather information (e.g., directly or indirectly, via a system controller) from a weather service (e.g., via the Internet), a weather application, and/or a weather application programming interface (API). At 2158, the control circuit may determine whether it is cloudy at the location of the motorized window treatment based on the weather information. If the control circuit determines that it is cloudy at 2158, the procedure 2150 may end at 2164.

If the control circuit determines that it is not cloudy at 2158, the control circuit may set the destination position P_{DEST} for the bottom bar to the charging position P_{CHRG} at 2160. For example, the control circuit may set the position of the bottom bar to be at the position where the solar cells are most likely to receive the most sunlight and/or charge (e.g., as shown at 2144 and 2145 of procedure 2140 shown in FIG. 32B). At 2162, the control circuit may control the motor drive circuit to move the covering material to the destination position P_{DEST}, and the procedure 2150 may end at 2164. For example, the control circuit may be configured to generate at least one drive signal (e.g., the at least one drive signal VDR) for controlling the motor drive circuit to control the rotational speed and the direction of rotation of the motor until the covering material is at the destination position P_{DEST}. As such, using the procedure 2150, the control circuit may move the bottom bar (e.g., and solar cells) to the charging position P_{CHRG} if the sun is shining on the façade of the building and/or if there are no clouds. Accordingly, the control circuit may move the bottom bar (e.g., and solar cells) to the charging position P_{CHRG} if the solar cells are likely to receive a relatively high amount of sunlight.

FIG. 32D is a flowchart of an example procedure 2180 for configuring a motorized window treatment (e.g., any of the motorized window treatments described herein). The procedure 2180 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a covering material, a bottom bar connected to a bottom end of the covering material, and one or more solar cells located on the bottom bar. The control circuit may execute the procedure 2180 periodically.

The procedure 2180 may start at 2181. At 2182, the control circuit may measure a signal from a photosensor to determine a daylight level L_{DL}. As noted herein, in some examples, the motorized window treatment (e.g., the motor drive unit and/or the bottom bar) may include a photosensor that is configured to measure light and generate a signal indicating the amount of light. As such, the control circuit may receive an indication of the amount of light from the photosensor and determine a daylight level L_{DL}. The photosensor may be oriented such that it faces towards the window to measure the amount of light (e.g., sunlight) hitting the window (e.g., which may be an indicator of the amount of light directed towards the solar cells of the motorized window treatment).

At 2184, the control circuit may determine whether the daylight level L_{DL} is greater than or equal to a threshold light level L_{TH}. If the control circuit determines that the daylight level L_{DL} is less than the threshold light level L_{TH}, the procedure 2180 may end at 2190. If the control circuit determines that the daylight level L_{DL} is greater than or equal to the threshold light level L_{TH} at 2184, the control circuit may set the destination position P_{DEST} for the bottom bar to the charging position P_{CHRG} at 2186. For example, the control circuit may set the position of the bottom bar to be at the position where the solar cells are most likely to receive the most sunlight and/or charge (e.g., as shown at 2144 and 2145 of procedure 2140 shown in FIG. 32B). At 2188, the control circuit may control the motor drive circuit to move the covering material to the destination position P_{DEST}, and the procedure 2180 may end at 2190. For example, the control circuit may be configured to generate at least one drive signal (e.g., the at least one drive signal VDR) for controlling the motor drive circuit to control the rotational speed and the direction of rotation of the motor until the covering material is at the destination position P_{DEST}.

As such, if the control circuit determines that the daylight level L_{DL} is greater than or equal to the threshold light level L_{TH} (e.g., it is sunny out), the control circuit may move the bottom bar (e.g., and solar cells) to the charging position P_{CHRG}, for example, so that the solar cells are likely to receive a relatively high amount of sunlight.

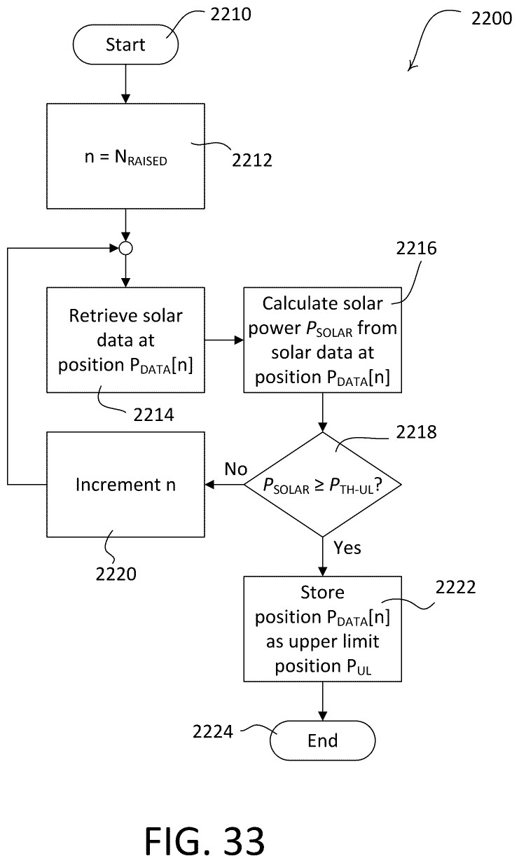

FIG. 33 is a flowchart of an example procedure 2200 for configuring a motorized window treatment (e.g., any of the motorized window treatments described herein). The procedure 2200 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a covering material, a bottom bar connected to a bottom end of the covering material, and one or more solar cells located on the bottom bar. The motor drive unit may be configured to control a present position P_{PRES} of the covering material. The motor drive unit may have stored in memory solar data, such as one or more measurements and/or operational characteristics of a bottom bar module of the bottom bar at a plurality of intermediate positions of the covering material between a raised position P_{RAISED} and a lowered position P_{LOWERED}. The control circuit may execute the procedure 2200 to, for example, set an upper limit position P_{UP-LIMIT} of the motorized window treatment. For example, the control circuit may execute the procedure 2200 periodically at 2210. In addition, the control circuit may execute the procedure 2200 at 2210 in response to receiving a message including a command to configure the motor drive unit.

At 2212, the control circuit may initialize a variable n to a raised-position value N_{RAISED}, which may identify measurements and/or operational characteristics of the solar data that recorded at the raised position P_{RAISED}. At 2214, the control circuit may retrieve the solar data at the position P_{DATA}[n] (e.g., the measurements and/or operational characteristics recorded at the position P_{DATA}[n]). For example, the control circuit may retrieve a magnitude of a photovoltaic output voltage of the solar cells of the bottom bar (e.g., the photovoltaic output voltage V_{PV}), a magnitude of a storage voltage of the bottom bar module (e.g., the second storage voltage V_{S-B}), and/or a duty cycle of a solar cell management circuit of the bottom bar module (e.g., the duty cycle DC_{SCM} of the solar cell management circuit 644) that are recorded at the position P_{DATA}[n].

At 2216, the control circuit may calculate the magnitude of the solar power P_{SOLAR} at the position P_{DATA} [n]. For example, the control circuit may calculate the magnitude of the solar power P_{SOLAR} as a function of the magnitude of the photovoltaic output voltage of the solar cells of the bottom bar, the magnitude of the storage voltage of the bottom bar module, and/or the duty cycle of the solar cell management circuit of the bottom bar module. In some examples, the control circuit may calculate the magnitude of the solar power P_{SOLAR} at each of the positions between the raised position P_{RAISED} and the lowered position P_{LOWERED} and store the calculated solar power P_{SOLAR} in the solar data for each of the positions between the raised position P_{RAISED} and the lowered position P_{LOWERED}, so that during the procedure 2200, the control circuit needs to (e.g., only needs to) retrieve the solar power P_{SOLAR} at the position P_{DATA}[n] at 2214 (e.g., calculation of the solar power P_{SOLAR} at the position P_{DATA}[n] at 2216 may be omitted from the procedure 2200).

At 2218, the control circuit may determine if the solar power P_{SOLAR} at the position P_{DATA}[n] is greater than (e.g., greater than or equal to) an upper-limit threshold P_{TH-UL}. For example, the upper-limit threshold P_{TH-UL} may be a predetermined value that represents an acceptable amount of solar power that is received by the solar cells of the bottom bar to allow for appropriate charging of the energy storage element of the bottom bar. When the solar power P_{SOLAR} at the position P_{DATA}[n] is less than the upper-limit threshold P_{TH-UL} at 2218, the control circuit may increment the variable n at 2220 and calculate the magnitude of the solar power P_{SOLAR} at the next position P_{DATA}[n] at 2016. When the solar power P_{SOLAR} at the position P_{DATA}[n] is greater than (e.g., greater than or equal to) the upper-limit threshold P_{TH-UL} at 2218, the control circuit may store the position P_{DATA}[n] as the upper limit position P_{UP-LIMIT} at 2222, and the procedure 2200 may end at 2224.

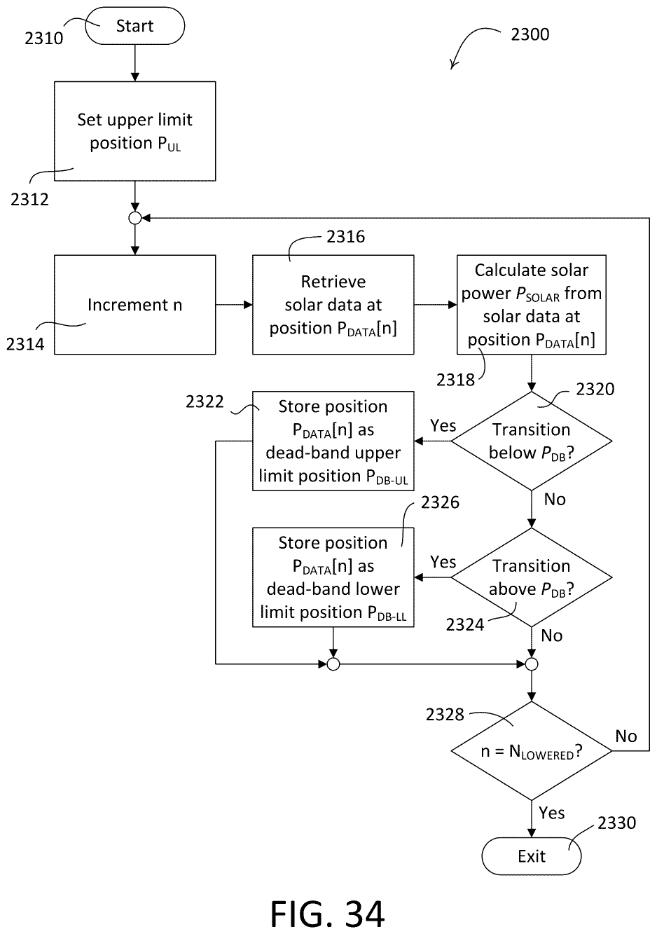

FIG. 34 is a flowchart of an example procedure 2300 for configuring a motorized window treatment (e.g., any of the motorized window treatments described herein). The procedure 2300 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a covering material, a bottom bar connected to a bottom end of the covering material, and one or more solar cells located on the bottom bar. The motor drive unit may be configured to control a present position P_{PRES} of the covering material. The motor drive unit may have stored in memory solar data, such as one or more measurements and/or operational characteristics of a bottom bar module of the bottom bar at a plurality of intermediate positions of the covering material between a raised position P_{RAISED} and a lowered position P_{LOWERED}. The control circuit may execute the procedure 2300 to, for example, configure one or more dead-bands (e.g., dead regions) between the lowered position P_{LOWER} and the raised position P_{RAISED}. The control circuit may be configured to store a dead-band upper limit position P_{DB-UL} and/or a dead-band lower limit position P_{DB-LL} for each of the dead-bands. For example, the control circuit may execute the procedure 2300 periodically at 2310. In addition, the control circuit may execute the procedure 2300 at 2310 in response to receiving a message including a command to configure the motor drive unit.

At 2312, the control circuit may set an upper-limit position P_{UL} for the covering material. For example, the control circuit may execute the procedure 2200 (e.g., as shown in FIG. 33) at 2312. At 2314, the control circuit may increment a variable n. For example, the variable n may be initialized and/or updated at 2312 (e.g., during the procedure 2200). At 2316, the control circuit may retrieve the solar data at the position P_{DATA}[n] (e.g., the measurements and/or operational characteristics recorded at the position P_{DATA}[n]). For example, the control circuit may retrieve a magnitude of a photovoltaic output voltage of the solar cells of the bottom bar (e.g., the photovoltaic output voltage V_{PV}), a magnitude of a storage voltage of the bottom bar module (e.g., the second storage voltage V_{S-B}), and/or a duty cycle of a solar cell management circuit of the bottom bar module (e.g., the duty cycle DC_{SCM} of the solar cell management circuit 644) that are recorded at the position P_{DATA}[n]. At 2318, the control circuit may calculate the magnitude of the solar power P_{SOLAR} at the position P_{DATA}[n]. For example, the control circuit may calculate the magnitude of the solar power P_{SOLAR} as a function of the magnitude of the photovoltaic output voltage of the solar cells of the bottom bar, the magnitude of the storage voltage of the bottom bar module, and/or the duty cycle of the solar cell management circuit of the bottom bar module. In some examples, the control circuit may calculate the magnitude of the solar power P_{SOLAR} at each of the positions between the raised position P_{RAISED} and the lowered position P_{LOWERED} and store the calculated solar power P_{SOLAR} in the solar data for each of the positions between the raised position P_{RAISED} and the lowered position P_{LOWERED}, so that during the procedure 2300, the control circuit needs to (e.g., only needs to) retrieve the solar power P_{SOLAR} at the position P_{DATA}[n] at 2316 (e.g., calculation of the solar power P_{SOLAR} at the position P_{DATA}[n] at 2318 may be omitted from the procedure 2300).

At 2320, the control circuit may determine if a transition below a dead-band power threshold P_{DB} has occurred. For example, the control circuit may be configured to determine that a transition below the dead-band power threshold P_{DB} has occurred when the solar power P_{SOLAR} at the position P_{DATA}[n] is less than the dead-band power threshold P_{DB} and the solar power P_{SOLAR} at the previous position P_{DATA}[n−1] is greater than the dead-band power threshold P_{DB}. For example, the dead-band power threshold P_{DB} may be a predetermined value that represents an acceptable amount of solar power that is received by the solar cells of the bottom bar to allow for appropriate charging of the energy storage element of the bottom bar (e.g., equal to and/or similar to the upper-limit threshold P_{TH-UL}). When the control circuit has determined that a transition below the dead-band power threshold P_{DB} has occurred at 2320, the control circuit may store the position P_{DATA}[n] as the dead-band upper limit position P_{DB-UL} for the present dead-band at 2322.

When the control circuit has determined that a transition below the dead-band power threshold P_{DB} has not occurred at 2320, the control circuit may determine if a transition above the dead-band power threshold P_{DB} has occurred at 2324. For example, the control circuit may be configured to determine that a transition above the dead-band power threshold P_{DB} has occurred when the solar power P_{SOLAR} at the position P_{DATA}[n] is greater than the dead-band power threshold P_{DB} and the solar power P_{SOLAR} at the previous position P_{DATA}[n−1] is less than the dead-band power threshold P_{DB}. When the control circuit has determined that a transition above the dead-band power threshold P_{DB} has occurred at 2324, the control circuit may store the position P_{DATA}[n] as the dead-band lower limit position P_{DB-LL} for the present dead-band at 2326.

When the control circuit has not determined that a transition below or above the dead-band power threshold P_{DB} has occurred at 2320 or 2324, respectively, or after setting the dead-band upper limit position P_{DB-UL} at 2322 or the dead-band lower limit position P_{DB-LL} at 2326, the control circuit may determine at 2328 if the variable n is equal to a lowered-position value N_{LOWERED}, which may identify measurements and/or operational characteristics of the solar data that recorded at the lowered position P_{LOWERED}. When the variable n is not equal to the lowered-position value N_{LOWERED} at 2328, the control circuit may increment the variable n at 2314 and calculate the magnitude of the solar power P_{SOLAR} at the next position P_{DATA}[n] at 2318. When the variable n is equal to the lowered-position value N_{LOWERED} at 2328, the procedure 2300 may end at 2330.

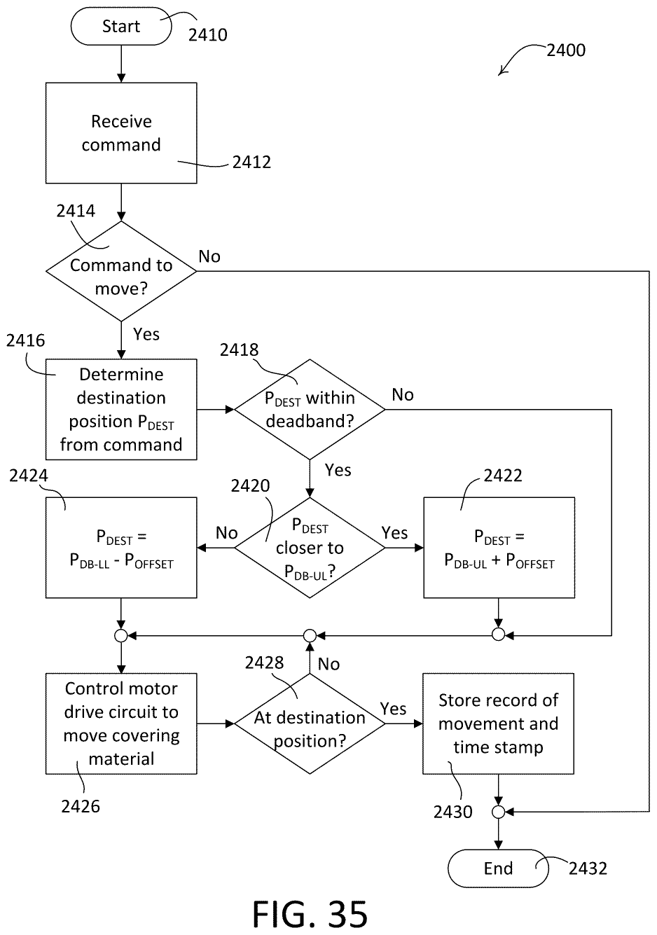

FIG. 35 is a flowchart of an example procedure 2400 for adjusting a present position P_{PRES} of a covering material of a motorized window treatment (e.g., any of the motorized window treatments described herein). The procedure 2400 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a bottom bar connected to a bottom end of the covering material and one or more solar cells located on the bottom bar. The motor drive unit may be configured to control a present position P_{PRES} of the covering material. The control circuit of the base assembly may execute the procedure 2400 to adjust the present position P_{PRES} of the covering material while avoiding one or more dead-bands (e.g., dead regions) between the lowered position P_{LOWER} and the raised position P_{RAISED}. For example, the control circuit may execute the procedure 2400 periodically at 2410. In addition, the control circuit may execute the procedure 2400 in response to receiving a message via a communication circuit at 2410.

At 2412, the control circuit may receive a command. For example, the control circuit may receive a message including a command via a communication circuit (e.g., the communication circuit 622). The command may be, for example, a command to move the covering material (e.g., a shade movement command to adjust the present position P_{PRES} of the covering material). For example, the command may include a commanded position P_{CMD} to which the control circuit of the base assembly should control the present position P_{PRES} of the covering material. In addition, the command may include a command to raise or lower the present position P_{PRES} of the covering material, and the control circuit may be configured to adjust the present position P_{PRES} of the covering material by a predetermined amount ΔP in response to receiving the command. In some examples, the control circuit may be configured to start raising or lowering the covering material in response to receiving a message including a raise command or a lower command, respectively, and may stop raising or lowering the present position P_{PRES} of the covering material in response to receiving a message including a stop command. Further, the command in the message received at 2412 may not be a command to move the covering material, but may be a command to enter a mode (e.g., a configuration mode), a command to transmit status information of the motor drive unit, and/or other commands that are not movement commands. Additionally or alternatively, the command may be received in response to an actuation of one or more of the buttons of the motor drive unit (e.g., the button of the user interface circuit 624). For example, the control circuit may be configured to raise or lower the present position P_{PRES} of the covering material by a predetermined amount ΔP in response to detecting an actuation of a first button or a second button, respectively, of the motor drive unit. In addition, the control circuit may be configured to start raising or lowering the covering material in response to detecting a first actuation of the first button or the second button, respectively, and may stop raising or lowering the present position P_{PRES} of the covering material in response to detecting a second subsequent actuation of the first button or the second button, respectively.

At 2414, the control circuit may be configured to determine if the command received at 2412 is a command to move the covering material (e.g., a shade movement command). When the command is not a command to move the covering material at 2414, the procedure 2400 may end at 2432. When the command is a command to move the covering material at 2414, the control circuit may at 2416 determine a destination position P_{DEST} for the covering material based on the command in the message received at 2412. For example, when the message includes a commanded position P_{CMD}, the control circuit may set the destination position P_{DEST} equal to the commanded position P_{CMD} at 2416. In addition, when the message includes a raise command or a lower command, the control circuit may set the destination position to be a predetermined amount ΔP from the present position P_{PRES} before movement of the covering material starts at 2416 (e.g., P_{DEST}=P_{PRES}+ΔP when the command is a raise command or P_{DEST}=P_{PRES}−ΔP when the command is a lower command).

At 2418, the control circuit may determine if the destination position P_{DEST} falls within a dead-band. For example, the control circuit may determine if the destination position P_{DEST} is less than (e.g., less than or equal to) a dead-band upper limit position P_{DB-UL} of one of the dead-bands and/or is greater than (e.g., greater than or equal to) a dead-band lower limit position P_{DB-LL} of that same dead-band at 2418. When the destination position P_{DEST} falls within a dead-band at 2418, the control circuit may determine if the destination position P_{DEST} is closer to the dead-band upper limit position P_{DB-UL} at 2420 (e.g., if the destination position P_{DEST} is closer to the dead-band upper limit position P_{DB-UL} than the dead-band lower limit position P_{DB-LL}). If so, the control circuit may set the destination position P_{DEST} equal to the dead-band upper limit position P_{DB-UL} plus an offset amount P_{OFFSET} at 2422. If the destination position P_{DEST} is closer to the dead-band lower limit position P_{DB-LL} than the dead-band upper limit position P_{DB-UL} at 2420, the control circuit may set the destination position P_{DEST} equal to the dead-band lower limit position P_{DB-LL} minus the offset amount P_{OFFSET} at 2424.

After updating the value of the destination position P_{DEST} at 2422 or 2424, or when the destination position P_{DEST} does not fall within a dead-band at 2418, the control circuit may control the motor drive circuit to rotate the motor to move the covering material towards the destination position P_{DEST} at 2426. For example, the control circuit may be configured to generate at least one drive signal (e.g., the at least one drive signal VDR) for controlling the motor drive circuit to control the rotational speed and the direction of rotation of the motor. At 2428, the control circuit of the base assembly may be configured to determine if the covering material is at the destination position P_{DEST}. When the control circuit determines that the covering material is not at the destination position P_{DEST} at 2428, the control circuit may continue to control the motor drive circuit to move the covering material towards the destination position P_{DEST} at 2426. When the control circuit determines that the covering material is the destination position P_{DEST} at 2428, the control circuit may stop controlling the motor drive circuit to move the covering material and store a movement record of the movement of the covering material along with timing information (e.g., a time stamp indicating a time at which the movement occurred) in a movement log (e.g., stored in memory) at 2430, before the procedure 2400 ends at 2432.

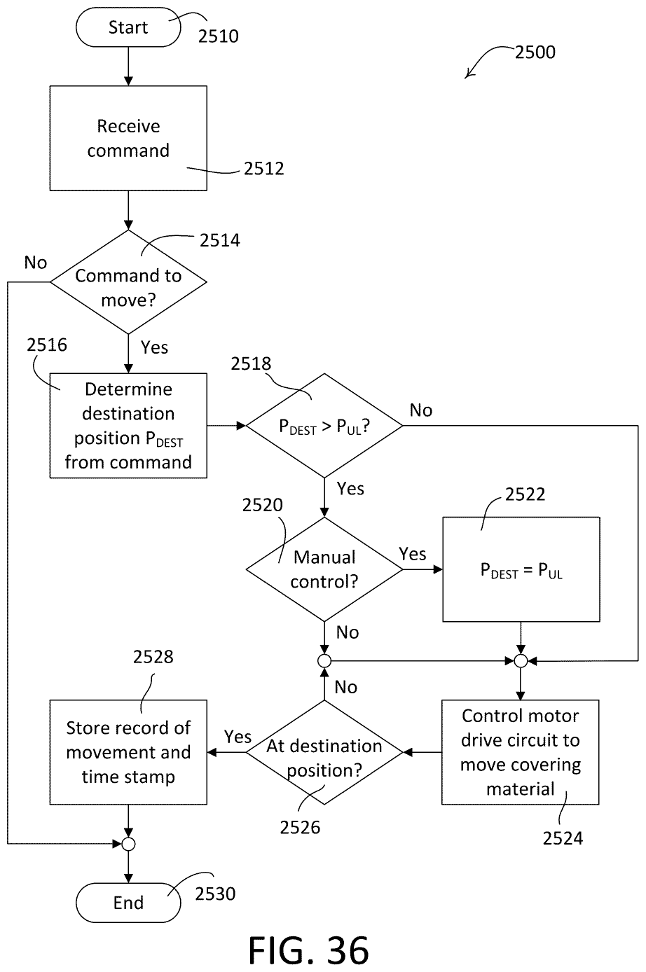

FIG. 36 is a flowchart of an example procedure 2500 for adjusting a present position P_{PRES} of a covering material of a motorized window treatment (e.g., any of the motorized window treatments described herein). The procedure 2500 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a bottom bar connected to a bottom end of the covering material and one or more solar cells located on the bottom bar. The motor drive unit may be configured to control a present position P_{PRES} of the covering material. The control circuit of the base assembly may execute the procedure 2500 to adjust the present position P_{PRES} of the covering material while allowing a user to manually adjust the covering material above an upper limit position P_{UP-LIMIT} of the motorized window treatment. For example, the control circuit may execute the procedure 2500 periodically at 2510. In addition, the control circuit may execute the procedure 2500 in response to receiving a message via a communication circuit at 2510.

At 2512, the control circuit may receive a command. For example, the control circuit may receive a message including a command via a communication circuit (e.g., the communication circuit 622). The command may be, for example, a command to move the covering material (e.g., a shade movement command to adjust the present position P_{PRES} of the covering material). For example, the command may include a commanded position P_{CMD} to which the control circuit of the base assembly should control the present position P_{PRES} of the covering material. In addition, the command may include a command to raise or lower the present position P_{PRES} of the covering material, and the control circuit may be configured to adjust the present position P_{PRES} of the covering material by a predetermined amount ΔP in response to receiving the command. In some examples, the control circuit may be configured to start raising or lowering the covering material in response to receiving a message including a raise command or a lower command, respectively, and may stop raising or lowering the present position P_{PRES} of the covering material in response to receiving a message including a stop command. Further, the command in the message received at 2512 may not be a command to move the covering material, but may be a command to enter a mode (e.g., a configuration mode), a command to transmit status information of the motor drive unit, and/or other commands that are not movement commands. Additionally or alternatively, the command may be received in response to an actuation of one or more of the buttons of the motor drive unit (e.g., the button of the user interface circuit 624). For example, the control circuit may be configured to raise or lower the present position P_{PRES} of the covering material by a predetermined amount ΔP in response to detecting an actuation of a first button or a second button, respectively, of the motor drive unit. In addition, the control circuit may be configured to start raising or lowering the covering material in response to detecting a first actuation of the first button or the second button, respectively, and may stop raising or lowering the present position P_{PRES} of the covering material in response to detecting a second subsequent actuation of the first button or the second button, respectively.

At 2514, the control circuit may be configured to determine if the command received at 2512 is a command to move the covering material (e.g., a shade movement command). When the command is not a command to move the covering material at 2514, the procedure 2500 may end at 2530. When the command is a command to move the covering material at 2514, the control circuit may at 2516 determine a destination position P_{DEST} for the covering material based on the command in the message received at 2512. For example, when the message includes a commanded position P_{CMD}, the control circuit may set the destination position P_{DEST} equal to the commanded position P_{CMD} at 2516. In addition, when the message includes a raise command or a lower command, the control circuit may set the destination position to be a predetermined amount ΔP from the present position P_{PRES} before movement of the covering material starts at 2516 (e.g., P_{DEST}=P_{PRES}+ΔP when the command is a raise command or P_{DEST}=P_{PRES}−ΔP when the command is a lower command).

At 2518, the control circuit may determine if the destination position P_{DEST} is above (e.g., is greater than) the upper limit position P_{UP-LIMIT}. When the destination position P_{DEST} is above (e.g., is greater than) the upper limit position P_{UP-LIMIT}, the control circuit may determine at 2520 if the command was received at 2512 via manual control (e.g., in response a manual input provided by a user of the motorized window treatment, such as a button press, rather than automated control). When the control circuit determines that the command was not received via manual control at 2520, the control circuit may limit the present position P_{PRES} of the covering material to be less than (e.g., less than or equal to) the upper limit position P_{UP-LIMIT} by setting the destination position P_{DEST} equal to the upper limit position P_{UP-LIMIT} at 2522. When the control circuit determines that the command was received via manual control at 2520, the control circuit maintains the destination position P_{DEST} as determined from the command at 2516.

After limiting the destination position P_{DEST} to the upper limit position P_{UP-LIMIT} at 2522 or maintaining the destination position P_{DEST} as determined from the command at 2516, the control circuit may control the motor drive circuit to rotate the motor to move the covering material towards the destination position P_{DEST} at 2524. For example, the control circuit may be configured to generate at least one drive signal (e.g., the at least one drive signal VDR) for controlling the motor drive circuit to control the rotational speed and the direction of rotation of the motor. At 2526, the control circuit of the base assembly may be configured to determine if the covering material is at the destination position P_{DEST}. When the control circuit determines that the covering material is not at the destination position P_{DEST} at 2526, the control circuit may continue to control the motor drive circuit to move the covering material towards the destination position P_{DEST} at 2524. When the control circuit determines that the covering material is the destination position P_{DEST} at 2526, the control circuit may stop controlling the motor drive circuit to move the covering material and store a movement record of the movement of the covering material along with timing information (e.g., a time stamp indicating a time at which the movement occurred) in a movement log (e.g., stored in memory) at 2528, before the procedure 2500 ends at 2530.

FIG. 37 is a flowchart of an example procedure 2600 that may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a bottom bar connected to a bottom end of the covering material and one or more solar cells located on the bottom bar. As described herein, in some examples, the motor drive unit of multiple the motorized window treatments may be coupled together via a power bus (e.g., a DC power bus). The control circuit may execute the procedure 2600 to disable automated shade control (e.g., disable automated movements of the bottom bar by the motor drive unit in response to, for example, timeclock schedules). The control circuit may execute the procedure 2600 periodically.

The procedure 2600 may start at 2610. At 2611, the control circuit may calculate the position of the sun, for example, as described herein. The control circuit may calculate the position of the sun based on a predicted position of the sun. Alternatively, the control circuit may receive an indication of the predicted position of the sun from a system controller. At 2612, the control circuit may determine whether the sun may be shining on a façade of the building of which the motorized window treatment is installed. Since there may be cloud cover or another obstruction between the façade and the sun, the predicted position of the sun may indicate whether there is potentially sun shining on the façade of the building of which the motorized window treatment is installed, for instance, as described herein. For example, the control circuit may be configured to determine whether the sun may be shining on the façade of which the motorized window treatment is installed at 2612 by comparing the calculated solar altitude angle at and/or the calculated solar azimuth angle as to one or more thresholds to determine if the calculated solar altitude angle at and/or the calculated solar azimuth angle as are within ranges that indicate that the sun may be shining on the façade.

If the control circuit determines that the sun is not shining on the façade, the control circuit may disable automated shade control at 2622, and the procedure 2600 may end at 2624. If the control circuit determines that the sun is not shining on the façade, the control circuit may ignore or disable any scheduled movements of the bottom bar (e.g., based on one or more timeclocks), for example, to allow the bottom bar to dock while it is not likely capturing much solar energy via the solar cells.

If the control circuit determines that the sun may be shining on the façade at 2612, the control circuit may retrieve weather information (e.g., temperature, cloud coverage, precipitation, barometric pressure, etc.) at 2614. For example, the control circuit may retrieve the weather information (e.g., directly or indirectly, via a system controller) from a weather service (e.g., via the Internet), a weather application, and/or a weather application programming interface (API). At 2616, the control circuit may determine whether it is cloudy at the location of the motorized window treatment based on the weather information. If the control circuit determines that it is cloudy at 2616, the control circuit may disable automated shade control at 2622, and the procedure 2600 may end at 2624.

If the control circuit determines that it is not cloudy at 2616, the control circuit may measure a photosensor signal to obtain the daylight level L_{DL} at 2618. The control circuit may determine whether the daylight level L_{DL} is less than or equal to a threshold light level L_{TH} at 2620 If the control circuit determines that the daylight level L_{DL} is greater than the threshold light level L_{TH}, the procedure 2600 may end at 2624. If the control circuit determines that the daylight level L_{DL} is less than or equal to the threshold light level L_{TH} at 2620, the control circuit may disable automated shade control at 2622, and the procedure 2600 may end at 2624.

As such, if the control circuit determines that the sun is not shining on the façade, it is cloudy, and/or the daylight level L_{DL} is less than or equal to the threshold light level L_{TH} (e.g., it is not sunny out), the control circuit may disable automated shade control, for example, so that the bottom bar can dock while it is not likely capturing much solar energy via the solar cells.

FIG. 38A is a flowchart of an example procedure 2700 that may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a bottom bar connected to a bottom end of the covering material and one or more solar cells located on the bottom bar. The motorized window treatment may be installed along a façade of a building with one or more other motorized window treatments. In such installations, it may be desirable to align the position of the covering materials of the motorized window treatments so that the bottom bars are aligned with each other along the façade of the building. Further, it might be beneficial for the motorized window treatments to all receive solar data at substantially the same position. The control circuit of the motorized window treatment may perform the procedure 2700 to communicate docking events to other motorized window treatments (e.g., other motorized window treatments that are along the same façade of a building and that have docks and solar cells). The control circuit may execute the control procedure 2700 periodically, in response to receiving a command to dock, and/or in response to a docking events, such as a timeclock event/schedule and/or in response to the energy storage element of a motor drive unit rising above or falling below a preconfigured level.

The procedure 2700 may start at 2710. At 2712, the control circuit may be configured to determine if the motor drive unit should presently dock the bottom bar. For example, the control circuit may be configured to determine that the bottom bar should be docked when the space in which the motorized window treatment is installed is vacant and the magnitude of a first storage voltage V_{S-A} produced across an energy storage element of the motor drive unit is less than a low-charge threshold V_{TH-LC}, and/or the space is occupied and the magnitude of the first storage voltage V_{S-A} produced across the energy storage element of the motor drive unit is less than a critical-charge threshold V_{TH-CRIT} (e.g., as shown in FIG. 21). In addition, the control circuit may determine to that the bottom bar should be docked when the magnitude of a second storage voltage V_{S-B} produced across an energy storage element of the bottom bar module is greater than a high-charge threshold V_{TH-HC} (e.g., as shown in FIG. 22A). Further, the control circuit may be configured to determine that the bottom bar should be docked in response to the present day of the week and/or the time of the day. In addition, the control circuit may be configured to determine when the bottom bar should be docked as shown in any of the procedures in FIGS. 38B-38G). When the control circuit determines that the motor drive unit should not presently dock the bottom bar at 2712, the procedure 2700 may end at 2718.

If the control circuit determines that the motor drive unit should presently dock the bottom bar at 2712, the control circuit may transmit (e.g., via the communication circuit) an indication of the docking event to one or more other motorized window treatments and/or a system controller at 2714. For example, the control circuit may transmit the indication, which may announce to other motorized window treatments that the control circuit is going to control the position of the covering material to dock the bottom bar. In some examples, in response to the reception of the indication of the docking event, other motorized window treatment may be configured to dock their respective bottom bars at the same time (e.g., if those motorized window treatments are along the same façade of the building as the motorized window treatment that transmitted the indication of the docking event). For instance, the motorized window treatments along the same façade of a building may be grouped together during a commissioning procedure (e.g., by a system controller) and, for example, may be assigned a façade number so that the grouped motorized window treatments may dock their respective bottom bars together. In some instances, the façade information could be entered when the motorized window treatments are installed (e.g., using a configuration application running on a mobile device, such as the mobile device 180).

At 2716, the control circuit may control a motor drive circuit of the motor drive unit (e.g., the motor drive circuit 612) to dock the bottom bar (e.g., to adjust the present position P_{PRES} of the covering material to the raised position P_{RAISED}), before the procedure 2700 ends at 2718.

FIG. 38B is a flowchart of an example procedure 2750 that may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a bottom bar connected to a bottom end of the covering material and one or more solar cells located on the bottom bar. The motorized window treatment may be installed along a façade of a building with one or more other motorized window treatments. As noted herein, in such installations, it may be desirable to align the position of the covering materials of the motorized window treatments so that they are aligned along the façade of the building. Further, it might be beneficial for the motorized window treatments to all receive solar data at substantially the same position. The control circuit of the motorized window treatment may perform the procedure 2750 to coordinate its docking event with the docking events of other motorized window treatments (e.g., other motorized window treatments that are along the same façade of a building and that have docks and solar cells). The control circuit may execute the control procedure 2750 in response to receiving an indication of a docking event of another motorized window treatment.

The procedure 2750 may start at 2760. At 2762, the control circuit may receive an indication of a docking event of another motorized window treatment. As described herein, another motorized window treatment may transmit an indication of a docking event to the motorized window treatment (e.g., directly, or indirectly via a system controller).

At 2764, the control circuit may determine whether it is on the same façade as the motorized window treatment that transmitted the indication of the docking event. For example, the indication may include a façade number, and the control circuit may determine whether the motorized window treatment is assigned the same façade number as the indication. As noted herein, in some examples, the motorized window treatments along the same façade of a building may be grouped together during a commissioning procedure (e.g., by a system controller) and, for example, may be assigned the same façade number so that the grouped motorized window treatments dock together. In some instances, the façade information could be entered when the motorized window treatments are installed.

If the control circuit determines that the motorized window treatment is not on the same façade as the motorized window treatment that transmitted the indication, the control circuit may exit the procedure 2750 at 2768. If the control circuit determines that the motorized window treatment is on the same façade as the motorized window treatment that transmitted the indication, the control circuit may control a motor drive circuit of the motor drive unit (e.g., the motor drive circuit 612) to dock the bottom bar at 2766 (e.g., to adjust the present position P_{PRES} of the covering material to the raised position P_{RAISED}), before the procedure 2750 ends at 2768.

In some examples, the system may include a façade manager that is configured to control (e.g., orchestrate) the docking (e.g., and/or other movements) of a plurality of motorized window treatments installed along the façade of a building. The façade manager may be a system controller, a dedicated façade controller, and/or one of the motorized window treatments may be assigned as the master device. The façade manager may be configured to receive and store the storage levels of the motor drive units of the motorized window treatments along the façade, and send messages to control the position of the bottom bars of the motorized window treatments along the façade based on the storage levels (e.g., dock the bottom bars of the motorized window treatments along the façade). Further, in some examples, the façade manager may be configured to receive and storage the solar data from all of the motorized window treatments along the façade, and determine the position of the bottom bars of the motorized window treatments along the façade based on the solar data such that the bottom bars of the motorized window treatments are aligned along the façade (e.g., at the same position along the façade). For instance, the façade manager could determine the position for the bottom bars of the motorized window treatments based on an average of the positions where each of the motorized window treatments collected the maximum solar data. The façade manager may be configured to perform one or more of the procedures described herein to control the position of the bottom bars of the motorized window treatments along the façade. For instance, the façade manager could perform the procedure 1000, 1100, 1110, 1120, 1130, 1140, 1150, 1160, 2140, 2150, 2180, 2200, 2300, and/or 3150 for a plurality of motorized window treatments along a façade, to list a few, non-limiting examples.

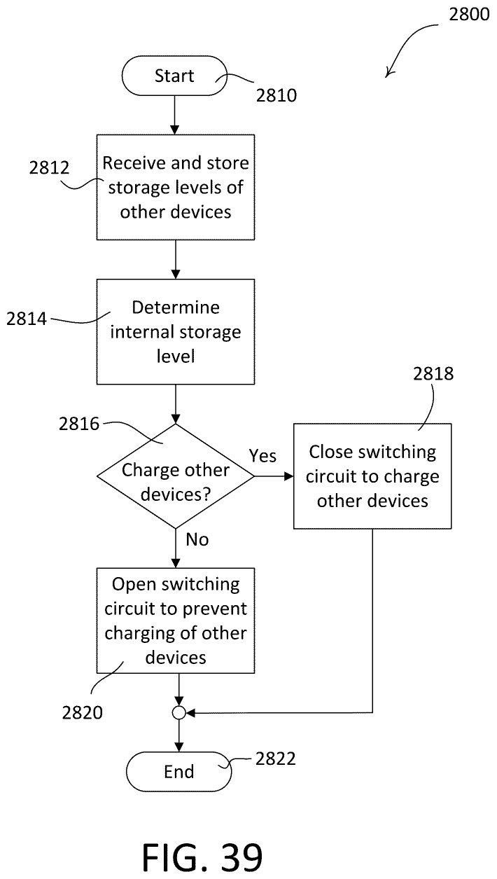

FIG. 39 is a flowchart of an example procedure 2800 that may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a bottom bar connected to a bottom end of the covering material and one or more solar cells located on the bottom bar. As described herein, in some examples, the motor drive unit of multiple the motorized window treatments may be coupled together via a power bus (e.g., a DC power bus). The motor drive units of the motorized window treatments may be configured to charge the energy storage elements of the motor drive unit of one or more of the other motorized window treatments via the power bus. The power bus may be electrically coupled to the motor drive units in a daisy-chain configuration (e.g., with the motor drive units coupled in parallel). The power bus may comprise two electrical conductors (e.g., wires) across which the storage voltage of the energy storage element of the motor drive unit of one or more of the motorized window treatments may be coupled for charging the energy storage elements of the motor drive units of the one or more other motorized window treatments. The control circuit may execute the procedure 2800 in response to receiving a message along the power bus. The control circuit may execute the control procedure 2800 periodically. In addition, the control circuit may start the control procedure 2800, for example, in response to a timeclock event/schedule and/or in response to the energy storage element of a motor drive unit reaching a preconfigured level.

The procedure 2800 may start at 2810. At 2812, the control circuit may receive and store the storage levels of one or more other motor drive units that are coupled to the power bus. At 2814, the control circuit may determine the storage level of the energy storage element of the motorized window treatment, for example, by sampling the first storage voltage V_{S-A} produced across the energy storage element of the motor drive unit.

At 2816, the control circuit may determine if the motorized window treatment should charge an energy storage element of another motorized window treatment coupled to the power bus. When determining whether to charge another motorized window treatment, the control circuit may, for example, consider any combination of the storage level of the other devices, which other device has the lowest storage level, a message received from the system controller, a message received from another device, whether another device is charging from the power bus, whether another device is in use (e.g., whether another device is experiencing a high-power demand event), a timeclock schedule, and/or a history of usage events of the other devices (e.g., whether another device has an upcoming energy usage event).

If the control circuit determines that the load control device should not charge an energy storage element of another motorized window treatment connected to the power bus, the control circuit may render controllable switching circuit non-conductive at 2820 and exit the control procedure 2800 at 2822.

If the control circuit determines that the load control device should charge another device in the DC power distribution system at 2816, the control circuit may render a controllable switching circuit (e.g., the switching circuit 636) of the motorized window treatment conductive at 2818 (e.g., for a predetermined amount of time). By rendering the controllable switching circuit conductive, the control circuit may bypass the charging circuit (e.g., the charging circuit 660 and the diode D634) and allow its internal energy storage element to charge energy storage element(s) of other devices coupled to the DC power bus. As described herein, the motorized window treatment may include a switching circuit coupled between the storage voltage V_{S-A} and one of the electrical connections, and the control circuit may be configured to generate a switch control signal V_{SW} for rendering the switching circuit conductive and non-conductive for controllably providing the storage voltage V_{S-A} the electrical connections. The control circuit may be configured to generate the switch control signal V_{SW} to render the switching circuit conductive to charge energy storage elements of one or more of the other motor drive units coupled to the power bus. After the control circuit renders the controllable switching circuit conductive at 2818, the control circuit may exit the control procedure 2800 at 2822.

As briefly noted above, the motorized window treatment may be configured to generate a solar data structure (e.g., such as a table) of solar power P_{SOLAR} received by the solar cells of the bottom bar. The solar data structure may include a plurality of records, where each record includes a solar power P_{SOLAR} received by the solar cells of the bottom bar, a position P_{S} of the bottom bar when the solar cells collected the respective solar power P_{SOLAR}, and a time T_{S} (e.g., time of the day and/or day of the year) at which the solar cells collected the respective solar power P_{SOLAR}. For example, the solar data structure may be a table including a plurality of records, such as a first record for the time T_{S} at which the solar cells collected the respective solar power P_{SOLAR} (e.g., the time as which the measurements and/or operational characteristics of the solar data that correspond to the respective solar power P_{SOLAR} were recorded), a second record for the position P_{S} of the bottom bar when the one or more solar cells collected the respective solar power P_{SOLAR} (e.g., when the measurements and/or operational characteristics of the solar data that correspond to the respective solar power P_{SOLAR} were recorded), and a third record for the respective solar power P_{SOLAR} (e.g., that is calculated from the measurements and/or operational characteristics of the solar data that were recorded at the respective position and time). Each record of the solar data structure may include the respective solar power P_{SOLAR}, the position P_{S} of the bottom bar when the solar cells collected the respective solar power P_{SOLAR}, and the time T_{S} at which the one or more solar cells collected the respective solar power P_{SOLAR}.

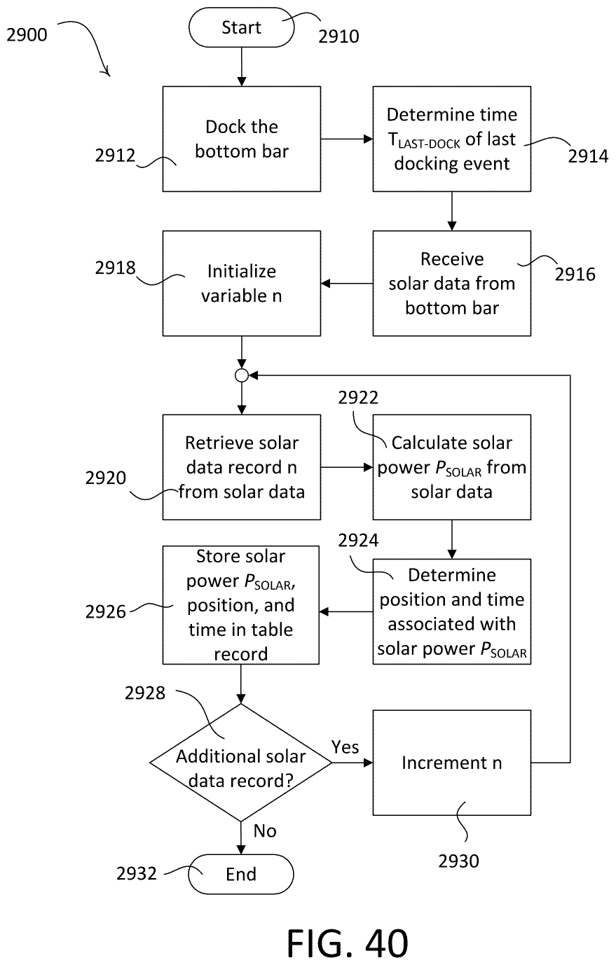

FIG. 40 is an example procedure 2900 for generating a solar data structure based on solar data for a motorized window treatment (e.g., any of the motorized window treatments described herein). The procedure 2900 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a covering material, a bottom bar connected to a bottom end of the covering material, and one or more solar cells located on the bottom bar. The control circuit of the base assembly may be configured to control a present position P_{PRES} of the covering material. For example, the control circuit may execute the procedure 2900 to generate a solar data structure based on the solar data. For example, the solar data structure may comprise a table including one or more rows (e.g., records of the solar data structure). Each record of the table may include a solar power P_{SOLAR} received by the solar cells of the bottom bar, a position of the bottom bar when the solar cells collected the respective solar power P_{SOLAR}, and a time (e.g., time of the day and/or day of the year) at which the solar cells collected the respective solar power P_{SOLAR}. The bottom bar module may be configured to communicate with the motor drive unit via a wired communication link, for example, when docked. The control circuit of the base assembly may generate the solar data structure based on the solar data, such that the solar data structure comprises one or more records. For example, the control circuit may execute the procedure 2900 periodically.

The procedure 2900 may start at 2910. The control circuit may control a motor drive circuit to control a motor of the motor drive unit to dock the bottom bar at 2912, for example, in response to a determination that the motor drive unit should dock the bottom bar. For example, the control circuit may control the motor to adjust the present position P_{PRES} of the covering material to the raised position P_{RAISED} at 2912. In addition, the control circuit may control the covering material through a docking movement (e.g., a docking sequence) as the bottom bar nears the dock at 2912 (e.g., as shown in FIG. 23A). The control circuit may be configured to determine if the bottom bar is docked. For example, the control circuit may be configured to determine if the bottom bar is docked by determining if electrical connections of the dock of the motor drive unit are electrically connected to the electrical connections of the bottom bar module. When the control circuit determines that the bottom bar is not docked, the control circuit may continue to control the motor to dock the bottom bar at 2912. The bottom bar may be docked such that one or more electrical contacts of the dock are electrically connected to one or more electrical contacts of the bottom bar.

When the control circuit determines that the bottom bar is docked, the control circuit may determine a time T_{LAST-DOCK} of a last docking event of the bottom bar at 2914. For example, the last docking event may be the last time (e.g., the previous time) that the motor drive unit docked the bottom bar and received solar data from the bottom bar. The control circuit may determine the last time that the motor drive unit docked the bottom bar and received solar data from the bottom bar by retrieving the time T_{LAST-DOCK} of the last docking event from memory. Solar data received prior to the time T_{LAST-DOCK} of the last docking event may have already been received by the motor drive unit and used to add records to the solar data structure.

At 2916, the control circuit may receive solar data from the bottom bar (e.g., bottom bar solar data). For example, the control circuit may transmit to the bottom bar module a query message that includes a request for solar data. Additionally or alternatively, the bottom bar may transmit solar data to the control circuit upon docking (e.g., upon the occurrence of a docking event). For example, the control circuit may store the solar data in memory. The solar data may include the solar power P_{SOLAR} of the solar cell and timing information (e.g., a time stamp) indicating a time at which the respective measurement was recorded by the bottom bar. The solar data received at 2916 may be associated with a plurality of solar data records, where each of the plurality solar data records may include an index number, timing information (e.g., a time stamp), and one or more measurements and/or operational characteristics recorded by the bottom bar. For example, the index number may be an integer value that starts at one and is incremented by one for each record in the solar data. The solar data may only include records having measurements and/or operational characteristics recorded since the time T_{LAST-DOCK} of the last docking event.

The control circuit may be configured to step through each record in the solar data received from the bottom bar and generate a corresponding record in the solar data structure. The control circuit may use a variable n to keep track of the record (e.g., the index number of the record) in the solar data that the control circuit is presently analyzing to create the record in the solar data structure. At 2918, the control circuit may initialize the variable n (e.g., to one). Further, the control circuit may retrieve a record that has an index number equal to the variable n at 2920. At 2922, the control circuit may calculate the magnitude of the solar power P_{SOLAR} based on the solar data from the record that has an index number equal to the variable n. For example, the control circuit may calculate the magnitude of the solar power P_{SOLAR} as a function of the magnitude of the photovoltaic output voltage of the solar cells of the bottom bar, the magnitude of the storage voltage of the bottom bar module, and/or the duty cycle of the solar cell management circuit of the bottom bar module.

At 2924, the control circuit may determine the position and the time associated with the solar power P_{SOLAR} calculated based on the solar data of the record that has an index number equal to the variable n. For example, the control circuit may be configured to determine a time T_{S} at which the solar cells collected the respective solar power P_{SOLAR} (e.g., as calculated at 2922 based on the solar data from the record that has an index number equal to the variable n) based on the time T_{LAST-DOCK} of the last docking event. The control circuit may be configured to calculate the time T_{S} associated with the solar power P_{SOLAR} by adding the time T_{LAST-DOCK} of the last docking event to an offset time T_{OFFSET} that is a function of the timing information of the record in the solar data (e.g., the record that has an index number equal to the variable n), e.g., T_{S}=T_{LAST-DOCK}+T_{OFFSET}. In some examples, the timing information that is part of the solar data may be an actual time, while in other examples, the timing information may be a count, and the control circuit may determine an actual time based on the count. In addition, the control circuit of the base assembly may be configured to identify a position Pₛ of the covering material at the time T_{S} associated with the solar power P_{SOLAR} based on movement records in a movement log stored in memory.

At 2926, the control circuit may store the solar power P_{SOLAR} (e.g., as determined at 2922), the time T_{S} associated with the solar power P_{SOLAR} (e.g., as determined at 2924), and the position P_{S} of the covering material at the time T_{S} (e.g., as determined at 2924) a new record in the solar data structure. For example, the control circuit may generate motor drive unit solar data at 2926 (e.g., the control circuit may add a new record to a solar data structure, such as the solar data structure 700 described herein).

At 2928, the control circuit may determine if there is at least one additional record in the solar data (e.g., as received from the bottom bar and stored in memory at 2916). For example, the control circuit may determine if the solar data of the bottom bar includes an additional record in the solar data (e.g., an additional magnitude of solar power P_{SOLAR}). If the solar data does not include an additional record, the procedure 2900 may end at 2932. If the solar data does include an additional record, the control circuit may increment the variable n at 2930 and the procedure 2900 may return to 2920. As such, using the procedure 2900, the control circuit may be configured to generate (e.g., update) a solar data structure based on the solar data that a plurality of records, where each record includes a solar power P_{SOLAR} received by the solar cells of the bottom bar, a position P_{S} of the bottom bar when the solar cells collected the respective solar power P_{SOLAR}, and a time T_{S} at which the solar cells collected the respective solar power P_{SOLAR}.

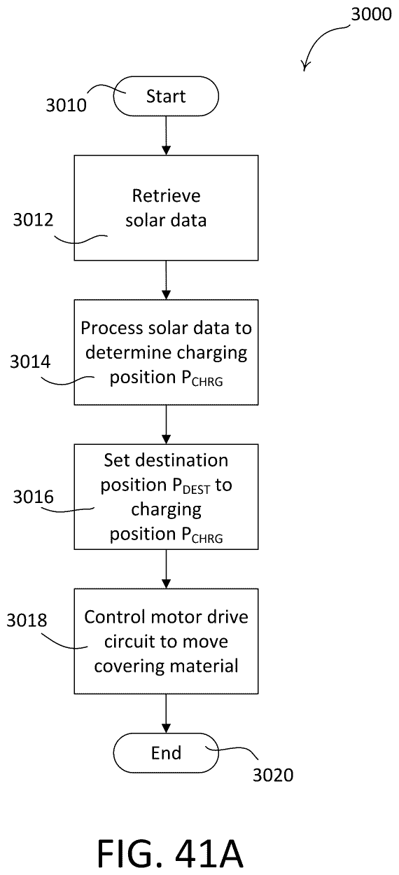

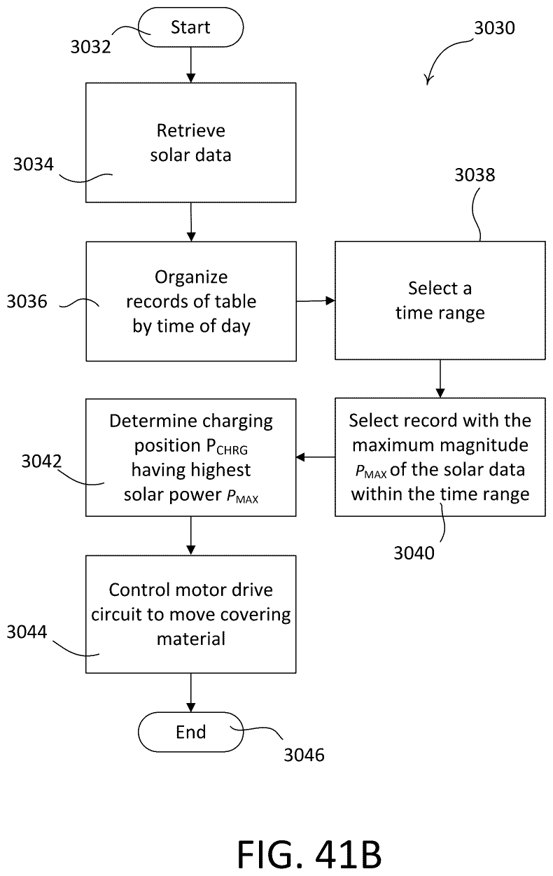

FIG. 41A is a flowchart of an example procedure 3000 for controlling a motorized window treatment (e.g., any of the motorized window treatments described herein) based solar data. The motorized window treatment may comprise a covering material, a bottom bar connected to a bottom end of the covering material, and one or more solar cells located on the bottom bar. The procedure 3000 may be executed by a control circuit of the base assembly of the motorized window treatment (e.g., the control circuits 420, 520, 720 of the motor drive units 410, 510, 710 shown in FIGS. 16A, 16B, and 17B, and/or control circuits of the motor drive units shown in FIG. 1-15B or 19). The motor drive unit of the motorized window treatment may comprise a memory for storing the solar data. The control circuit may execute the procedure 3000 periodically.

The procedure 3000 may start at 3010. At 3010, the control circuit may retrieve solar data from memory. For example, the control circuit may be configured to retrieve the solar data from a solar data structure, such as a table (e.g., the solar data structure 700), which may be stored in memory. As noted herein, the solar data structure may include a plurality of records, where each record includes a solar power P_{SOLAR} received by the solar cells of the bottom bar, a position Pₛ of the bottom bar when the solar cells collected the respective solar power P_{SOLAR}, and a time T_{S} at which the solar cells collected the respective solar power P_{SOLAR}.

At 3014, the control circuit may process the solar data (e.g., as retrieved at 3012, for example, from the solar data structure) to determine a charging position P_{CHRG} of the bottom bar based on the solar data. The solar data retrieved at 3012 may be motor drive unit solar data (e.g., in the form of the solar data structure 700, described herein). For example, the control circuit may determine the position of the bottom bar that is most likely to cause to the solar cells to receive the most sunlight. The control circuit may store the solar data from various positions (e.g., over a period of time, such as a week or year), and the control circuit may determine the charging position P_{CHRG} based on the saved solar data (e.g., and the present time of day).

At 3016, the control circuit may set the destination position P_{DEST} for the bottom bar to the charging position P_{CHRG}. For example, the control circuit may set the position of the bottom bar to be at the position where the solar cells are most likely to receive the most sunlight and/or charge. At 3018, the control circuit may control the motor drive circuit to move the covering material to the destination position P_{DEST}, and the procedure 3000 may end at 3020. For example, the control circuit may be configured to generate at least one drive signal (e.g., the at least one drive signal VDR) for controlling the motor drive circuit to control the rotational speed and the direction of rotation of the motor until the covering material is at the destination position P_{DEST}. As such, using the procedure 3000, the control circuit may determine the ideal charging position for the solar cells, and then move the bottom bar accordingly.

FIG. 41B is a flowchart of an example procedure 3030 for controlling a motorized window treatment (e.g., any of the motorized window treatments described herein) based solar data. The procedure 3030 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The motorized window treatment may comprise a covering material, a bottom bar connected to a bottom end of the covering material, and one or more solar cells located on the bottom bar. The motor drive unit of the motorized window treatment may comprise a memory for storing the solar data. The control circuit may execute the procedure 3030 periodically and/or at a particular time of day or day of the week (e.g., in response to a timeclock schedule). The control circuit may additionally or alternatively execute the procedure 3030 in response to a change in solar data. In addition, the control circuit may be triggered to execute the procedure 3030 in response to receiving, for example, weather information that indicates that it is sunny, such that the best possible time range may be selected to maximize charging.

The procedure 3030 may start at 3032. At 3034, the control circuit may retrieve solar data from memory. For example, the control circuit may be configured to retrieve the solar data from a solar data structure, such as a solar data structure (e.g., the solar data structure 700), which may be stored in memory. In addition, the control circuit may be configured to retrieve solar data from the solar data structure for the present date and/or time (e.g., and location of the motorized window treatment). As noted herein, the solar data structure may include a plurality of records, where each record includes a solar power P_{SOLAR} received by the solar cells of the bottom bar, a position P_{S} of the bottom bar when the solar cells collected the respective solar power P_{SOLAR}, and a time T_{S} at which the solar cells collected the respective solar power P_{SOLAR}

At 3036, the control circuit may sort solar data of the solar data structure based on the time associated with each record. For example, the control circuit may sort the solar data by one or more of a time of day, a day of a week, a month of a year, or a year. At 3038, the control circuit may select a time and/or a time range, for example a time of day range. In some examples, the control circuit may select the time range based on the present time. The time range may be associated with one record (e.g., a single row 716 of solar data structure 700) or of a plurality of records. For example, the solar data structure may not include a record for the present time, so the control circuit may select a time range to ensure that there is at least one record in the solar data structure that can be used for the procedure 3030.

At 3040, the control circuit may be configured to select a record with a maximum magnitude P_{MAX} of solar power P_{SOLAR} that is received by the solar cells on the bottom bar as indicated by the solar data in the solar data structure that is within the time range. For example, the time range may be associated with a plurality of records within the solar data structure where each record has a different solar power, and the control circuit may identify the solar power with maximum magnitude P_{MAX} in the time range. At 3042, the control circuit may determine a charging position P_{CHRG} of the bottom bar based on the solar power measurement with the highest solar power P_{MAX} in the time range. For example, the control circuit may determine the position of the bottom bar that is associated with the highest solar power P_{MAX} in the time range.

At 3044, the control circuit may control the motor drive circuit of the motorized window treatment to move the covering material to the determined charging position P_{CHRG} of the bottom bar, and the procedure 3030 may end at 3046. For example, the control circuit may set the destination position P_{DEST} for the bottom bar to the charging position P_{CHRG}. For example, the control circuit may be configured to generate at least one drive signal (e.g., the at least one drive signal VDR) for controlling the motor drive circuit to control the rotational speed and the direction of rotation of the motor until the covering material is at the destination position P_{DEST}. As such, using the procedure 3030, the control circuit may determine the ideal charging position for the solar cells within the time range using a solar data structure of solar data (e.g., historical solar measurements), and then move the bottom bar accordingly.

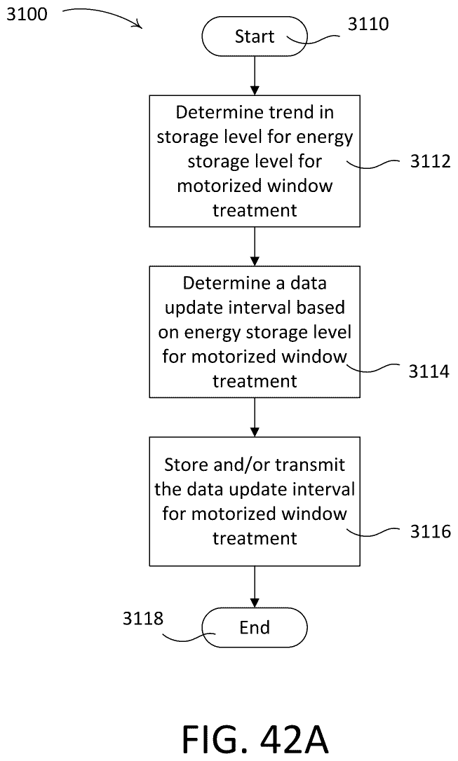

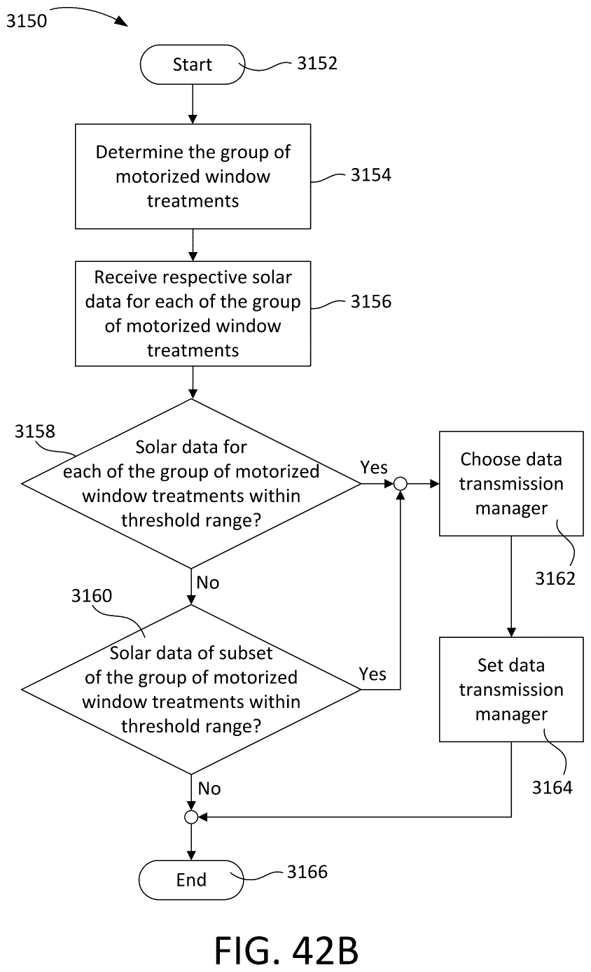

FIG. 42A is a flowchart of an example procedure 3100 that may be executed to determine a data update interval for transmitting updated solar data from a motor drive unit of a motorized window treatment (e.g., the motor drive units 410, 510, 710 shown in FIGS. 16A, 16B, and 17B, and/or the motor drive units shown in FIG. 1-15B or 19). For example, the procedure 3100 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein) and/or a control circuit of a system controller (e.g., the system controller 110 shown in FIG. 1) to adjust the data update interval. The motor drive unit may be configured to transmit data, such as solar data (e.g., as provided in a solar data structure, such as the solar data structure 700) to the system controller periodically, such as at the data update interval. For example, the control circuit of the base assembly and/or the control circuit of the system controller may perform the procedure 3100 to adjust the data update interval at which the motorized window treatment transmits the solar data (e.g., the solar data structure) based on available charge of an energy storage element of the motor drive unit (e.g., the energy storage element 630 of the solar power system 600). For example, the control circuit of the base assembly and/or the control circuit of the system controller may perform the procedure 3100 to adjust the data update interval to reduce the number of transmissions of the solar data from the motor drive unit to the system controller, for example, to minimize bandwidth on a wireless communication connection (e.g., link and/or network) between the motor drive unit and the system controller. In addition, the control circuit of the base assembly and/or the control circuit of the system controller may perform the procedure 3100 to adjust the data update interval to transmit more data when possible and/or to help prolong the life of the energy storage element of the motorized window treatment. The control circuit may execute the control procedure 3100 periodically. The control circuit may start the procedure 3100, for example, in response to an event of a timeclock schedule. The control circuit may be configured to repeat the procedure 3100 for the motor drive units of multiple motorized window treatments (e.g., when the procedure 3100 is executed by the control circuit of the system controller).

The procedure 3100 may start at 3110. At 3112, the control circuit may determine a trend in the storage level of the energy storage element of the motor drive unit (e.g., based on the magnitude of the first storage voltage V_{S-A} of the motor drive unit and/or the second storage voltage V_{S-B} of the bottom bar, as described herein). For instance, the motor drive unit may use the magnitude of the first storage voltage V_{S-A} of the energy storage element of the motor drive unit as an indication of the trend of a state of charge of the motor drive unit (e.g., of the energy storage element of the motor drive unit), for example by processing the storage level (e.g., the first storage voltage V_{S-A}) of the energy storage element of the motor drive unit to determine a trend of any change in the storage level over time. Additionally or alternatively, the motor drive unit may use the second storage voltage V_{S-B} of the bottom bar as an indication of the trend of a state of charge of the bottom bar (e.g., a trend of the solar cells of the bottom bar receiving power), for example by processing the storage level (e.g., the second storage voltage V_{S-B}) of the energy storage element of the bottom bar to determine a trend of any change in the storage level over time. In some examples, the control circuit may determine whether an (e.g., rolling) average of the storage level of a predetermined number of previous storage level measurements is increasing or decreasing to, to determine the trend.

At 3114, the control circuit may determine a data update interval based on the storage level (e.g., the trend in the storage level) of the energy storage element for the motor drive unit. For example, the control circuit may increase the data update interval when the state of charge of the energy storage element is less than a threshold (e.g., such that the solar data is transmitted less often), and decrease the data update interval when the state of charge of the energy storage element is greater than the threshold (e.g., such that the solar data is transmitted more often). In addition, the control circuit may increase the data update interval when the trend in the storage level of the energy storage element indicates a healthy status of the motor drive unit (e.g., such that the solar data is transmitted less often), and decrease the data update interval when the trend in the storage level of the energy storage element indicates a healthy status of the motor drive unit (e.g., such that the solar data is transmitted more often. For example, if the trend has a slope that is greater than a threshold (e.g., a negative threshold) the trend in the storage level of the energy storage element may indicate a healthy status of the motor drive unit. Additionally or alternatively, if the storage level of the energy storage element exceeds a threshold over time, the trend in the storage level of the energy storage element may indicate a healthy status of the motor drive unit.

Further, in some examples, the control circuit may determine the data update interval based on solar data received from one or more other motorized window treatments. For instance, as described herein, multiple motorized window treatments may be installed in the same building, for example, along one or more façades in the same building. And, in such examples, each of the motorized window treatment may comprise a bottom bar connected to a bottom end of the covering material and one or more solar cells located on the bottom bar, and the motor drive units of these motorized window treatments may be configured to communicate solar data to the system controller. As such, the system controller may receive solar data from a plurality of motorized window treatments, some of which may be on the same façade of the building. In such examples, the system controller may adjust the interval that each motorized window treatment communicates solar data to the system controller since motorized window treatments along the same façade of a building might record very similar solar data measurements.

At 3116, the control circuit may store the data update interval in memory, before the procedure 3100 ends at 3118. For example, when the control circuit of the base assembly is executing the procedure 3100, the motor drive unit may be configured to transmit the solar data (e.g., the solar data structure) to the system controller at the data update interval (e.g., that is stored in memory). In some examples (e.g., when the control circuit of the system controller is executing the procedure 3100), the control circuit may transmit the data update interval to the to the motor drive unit, such the motor drive unit may be configured transmit the solar data (e.g., the solar data structure) to the system controller at the data update interval.

FIG. 42B is a flowchart of an example procedure 3150 that may be executed to determine (e.g., choose) a data transmission manager from motor drive units of a plurality of motorized window treatments (e.g., a group of motorized window treatments). The data transmission manager may be configured to transmit solar data that is representative of solar data from the group of motorized window treatments. The procedure 3150 may be executed by a control circuit of one or more of a base assembly of a motorized window treatment (e.g., the control circuits 420, 520, 520a, 720 of the motor drive units 410, 510, 510′, 710, the control circuit 520b of the dock module 504, and/or control circuits of any of the motorized window treatment described herein) and/or by a control circuit of a system controller (e.g., the system controller 110 shown in FIG. 1). The control circuit may execute the procedure 3150 to choose the data transmission manager from the plurality of motorized window treatments.

As described in more detail herein, the data transmission manager is the motor drive unit of one of the motorized window treatments that is configured to transmit the solar data that is representative of the solar data from the motorized window treatments of the group. The solar data may comprise, for example, a solar data structure such as the solar data structure 700. For instance, multiple motorized window treatments may be installed in the same building, for example, along one or more façades in the same building. And, in such examples, each of the motorized window treatments may comprise a bottom bar connected to a bottom end of the covering material and one or more solar cells located on the bottom bar, and the motor drive units of these motorized window treatments may be configured to communicate solar data to the system controller. As such, the system controller may receive solar data from a plurality of motorized window treatments, some of which may be on the same façade of the building. In such examples, the control circuit (e.g., that is executing the procedure 3150) may determine that the solar data received from each of the group of motorized window treatments (e.g., those on the same façade of a building and/or a subset of those on the same façade of a building) is very similar in value, and as such, may assign one of the motorized window treatments as the data transmission manager, which may be responsible for transmitting the solar data to the system controller (e.g., exclusively). The system controller may perform the procedure 3150 periodically. The control circuit may be configured to repeat the procedure 3150 for the motor drive units of multiple motorized window treatments (e.g., when the procedure 3150 is executed by the control circuit of the system controller).

The procedure 3150 may start at 3152. At 3154, the control circuit may determine the group of motorized window treatments. For example, the plurality of motorized window treatments may be installed on the same façade of a building, such that the plurality of motorized window treatments may receive similar solar data (e.g., bottom bar solar data). In some examples, the control circuit may receive information (e.g., system configuration data) that indicates that a plurality of motorized window treatments are part of the group since the plurality of motorized window treatments are located on the same façade of the building. In addition, the control circuit may be configured to retrieve from memory (e.g., from the configuration data in memory) the group of motorized window treatments (e.g., unique identifiers for each of the motor drive units of the group of motorized window treatments). It should be appreciated that the group of motorized window treatments may not be located on the same façade, but for example, may be otherwise similarly situated (e.g., they may receive roughly the same amount of sunlight per day).

At 3156, the control circuit may receive and store the solar data from each of the plurality of motor drive units. The control circuit may receive solar data (e.g., magnitude of solar power P_{SOLAR}) for example, from respective motor drive units of the group of motorized window treatments. The solar data may include the solar data structure (e.g., a solar data structure having a plurality of records, with each record including a solar power, a time associated with that solar power, and a position associated with that solar power) for each motorized window treatment.

At 3158, the control circuit may determine whether the solar data for each of the group of motorized window treatments is within a threshold range. For example, the control circuit may determine that the solar data structure (e.g., the table) for each of the motorized window treatments of the group includes the same or similar data. For instance, the control circuit may determine that the solar data for each of the motorized window treatments in the group of motorized window treatments is within the threshold range of each other. For example, the control circuit may determine that the solar data for the group of motorized window treatments is within the threshold range of respective solar power values of the records for each of the group of motorized window treatments are within the threshold range for the same associated position and time. If the control circuit determines that the solar data for each of the group of motorized window treatments is not within the threshold range, the control circuit may determine whether the solar data for each of a subset of the group of motorized window treatments is within a threshold range (e.g., the threshold range) at 3160. For example, at 3160, the control circuit may determine that the solar data for each of the motorized window treatments in the subset of the group of motorized window treatments is within the threshold range of each other. If the control circuit determines that the solar data for each of the subset of the group of motorized window treatments is not within the threshold range, the procedure may end at 3166. For example, the control circuit may determine not to assign one of motor drive units of the group of motorized window treatments to be the data transmission manager, and each motorized window treatment may continue to send solar data (e.g., at the same data update interval). In some examples the determination of whether the solar data of the subset of the group of motorized window treatments is within a threshold range may be omitted. For example, if at 3158 the control circuit determines that the solar data for each of the group of motorized window treatments is not within the threshold range, the procedure 3150 may end at 3166 (e.g., without choosing a data transmission manager).

If the control circuit determines that the solar data for each of the group of motorized window treatments is within the threshold range at 3158, the control circuit may choose one of the motor drive units of the group of motorized window treatments to be the data transmission manager at 3162. Similarly, if the control circuit determines that the solar data for each of the subset of the group of motorized window treatments is within the threshold range at 3160, the control circuit may choose one of the motor drive units of the group of motorized window treatments to be the data transmission manager at 3162. The control circuit may randomly choose one of the motor drive units of the group of the motorized window treatments to be the data transmission manager. Additionally or alternatively, the motorized window treatment may choose one of the motor drive units of the group of motorized window treatments to be the data transmission manager based on proximity to the system controller.

At 3164, the control circuit may set the chosen motor drive unit of the group of motorized window treatments to be the data transmission manager. For example, the control circuit may send a message to the chosen motor drive unit of the group of motorized window treatments to configure the respective motor drive unit as the data transmission manager. The control circuit may configure the motor drive units of the group of motorized window treatments other than the data transmission manager to cease sending respective solar data, for example by sending a message disabling transmission of the solar data to the system controller for the motor drive units of the group of motorized window treatments other than the data transmission manager. In some examples, the control circuit may configure the data transmission manager to send solar data more often (e.g., at a shorter data update interval) than the other motor drive units of the group of motorized window treatments. For example, the message may indicate that the data transmission manager should decrease its data update interval. Additionally or alternatively, the data update interval of the motor drive units of the group of motorized window treatments other than the data transmission manager may be increased.

In some examples, the control circuit may generate a group solar data structure, such that the group solar data structure may be used by each of the plurality of motorized window treatments. The control circuit may generate the group solar data structure based on respective solar data from each of the plurality of motorized window treatments, for example by averaging the solar data (e.g., magnitude of solar power P_{SOLAR}) for the motorized window treatments at each associated time and position. After creation, the data transmission manager motorized window treatment may send solar data (e.g., updated solar data) to the control circuit, such that the control circuit may update the group solar data structure based on the solar data from the data transmission manager motorized window treatment. The procedure may end at 3166.

Additionally or alternatively, at 3154 the control circuit may determine a group or subset of a group to include motorized window treatments on the same façade, for example based on configuration data. At 3156, the control circuit may receive and store the solar data from each of the plurality of motor drive units. The control circuit may receive solar data (e.g., magnitude of solar power P_{SOLAR}) for example, from respective motor drive units of the group of motorized window treatments on the same façade. The solar data may include the solar data structure (e.g., a solar data structure having a plurality of records, with each record including a solar power, a time associated with that solar power, and a position associated with that solar power) for each motorized window treatment, for example the group solar data structure.

At 3158 the solar data from multiple motorized window treatments on the same façade may be analyzed to determine which motorized window treatments have similar data. For example, the control circuit may determine that the solar data for each of the motorized window treatments in the group of motorized window treatments on the same façade is within the threshold range of each other. If the control circuit determines that the solar data for each of the group of motorized window treatments on the same façade is within the threshold range, the control circuit may choose the façade manager (e.g., of the procedure 2750) as the data transmission manager at 3162. The control circuit may set the façade manager as the data transmission manager at 3164. The procedure may end at 3166.

If the control circuit determines that the solar data for each of the group of motorized window treatments on the façade is not within the threshold range, the control circuit may determine whether the solar data for each of a subset of the group of motorized window treatments is within a threshold range (e.g., the threshold range) at 3160. For example, at 3160, the control circuit may determine that the solar data for each of the motorized window treatments on the façade in the subset of the group of motorized window treatments is within the threshold range of each other. If the control circuit determines that the solar data for each of the subset of the group of motorized window treatments on the façade is not within the threshold range, the procedure may end at 3166. For example, the control circuit may determine not to assign one of motor drive units of the group of motorized window treatments on the façade to be the data transmission manager (e.g., façade manager), and each motorized window treatment on the façade may continue to send solar data (e.g., at the same data update interval). In some examples the determination of whether the solar data of the subset of the group of motorized window treatments on the façade is within a threshold range may be omitted. For example, if at 3158 the control circuit determines that the solar data for each of the group of motorized window treatments on the façade is not within the threshold range, the procedure 3150 may end at 3166 (e.g., without choosing a data transmission manager). Additionally or alternatively, the control circuit may assign the façade manager as the data transmission manager without analyzing solar data. For example, steps 3165, 3158, and 3160 may be omitted and the control circuit may determine the group of motorized window treatments (e.g., on the same façade) at 3154, may choose the façade manager as the data transmission manager at 3162, and may set the façade manager as the data transmission manager at 3164. The procedure may end at 3166.

As briefly noted above, the motorized window treatment may be configured with wake-up periods during which the motorized window treatment may receive a transmission. Wake-up periods may be preconfigured such that each wake-up period uses a predictable amount of power. Additionally, the motorized window treatment may be configured to determine movement power consumption, for example based on a table and/or measurements. The motorized window treatment may use the movement power consumption and a power consumption associated with the wake-up periods to determine a total power consumption. Total power consumption may be used to determine trends and/or a life (e.g., end of life) of the motorized window treatment, for example as extending the life of the energy storage elements is desirable. For example, the life of the energy storage elements may be extended by ensuring that the energy storage elements do not overcharge. Additionally, the life of the energy storage elements may be extended by avoiding a trend in energy storage element charge that may result in operation of the motorized window treatment being unreliable.

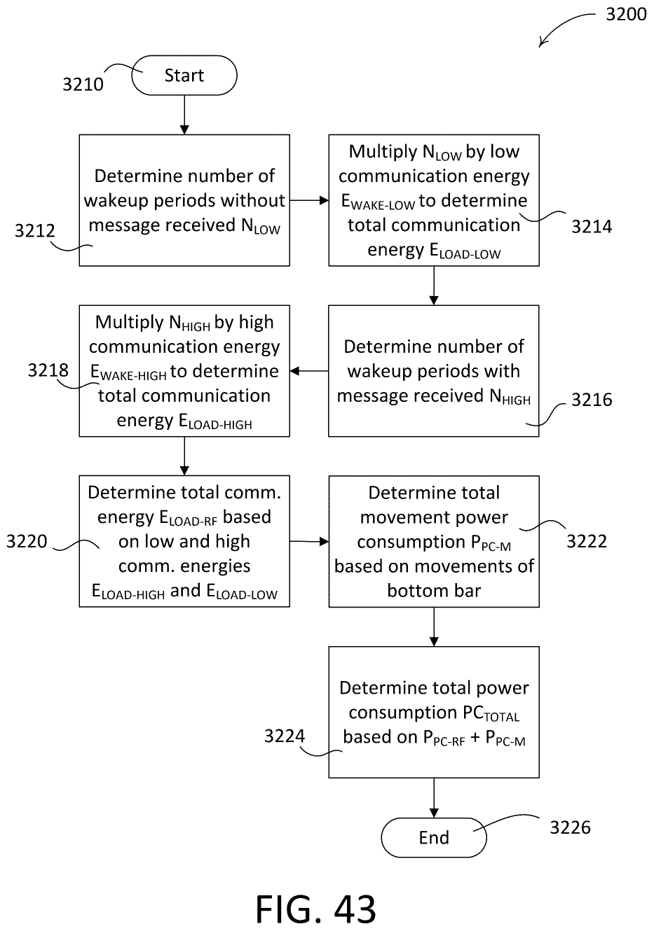

FIG. 43 is a flowchart of an example procedure 3200 for determining (e.g., estimate and/or calculate) a total energy E_{LOAD-TOTAL} consumed from an energy storage element by electrical loads of a motor drive unit. The procedure 3200 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein) to determine the total energy E_{LOAD-TOTAL} consumed from the energy storage element by the electrical loads of the motor drive unit. The control circuit may be configured to execute the procedure 3200 to calculate the total energy E_{LOAD-TOTAL} consumed from the energy storage element by the electrical loads of the motor drive unit, for example, based on energy consumed from the energy storage element of the motor drive unit to drive the motor and/or provide for wireless communication. The control circuit may be configured to execute the procedure 3200 periodically, for example, at the end of each of the accumulation intervals T_{ACC}.

The procedure may start at 3210. At 3212, the control circuit may determine a number N_{LOW} of wakeup events where no message was received N_{LOW}. For example, as described herein, the control circuit may be configured to periodically wake up from a sleep state (e.g., at a wake-up interval T_{WAKE-UP}) to determine if one of multiple messages of a transmission event is being transmitted (e.g., by the system controller 110 as in FIG. 1). In some examples, the wake-up interval T_{WAKE-UP} may be sized such that the motorized window treatment may not receive each of the multiple messages of a transmission event. During each of the accumulation intervals T_{ACC}, the control circuit may be configured to count the number N_{LOW} of wake-up events where a message was not received and store the number N_{LOW} in memory (e.g., in the consumption data). At 3212, the control circuit may be configured to retrieve the number N_{LOW} from memory.

At 3214, the control circuit may multiply the number N_{LOW} of wake-up events where no message was received by a low communication energy E_{WAKE-LOW} to determine a total low communication energy E_{LOAD-LOW} associated with all of the wake-up events where no message was received during the accumulation interval T_{ACC}. For example, the low communication energy E_{WAKE-LOW} may be a predetermined value that may indicate an average energy consumed from the energy storage element during a wake-up event where no message was received and may be stored in a memory. The control circuit may retrieve the low communication energy E_{WAKE-LOW} from memory at 3214.

At 3216, the control circuit may determine a number N_{HIGH} of wake-up events where a message was received. For example, as described herein, the control circuit may be configured to receive a message during one or more of the wake-up events. The message may include, for example, a command to adjust the position of the bottom bar. During each of the accumulation intervals T_{ACC}, the control circuit may be configured to count the number N_{HIGH} of wake-up events where a message was received and store the number N_{HIGH} in memory (e.g., in the consumption data). At 3216, the control circuit may be configured to retrieve the number N_{HIGH} from memory.

At 3218, the control circuit may multiply the number N_{HIGH} of a wake up events where a message was received by a high communication energy E_{WAKE-HIGH} to determine a total high communication energy E_{LOAD-HIGH} associated with all of the wake up events where a message was received. For example, the low communication energy E_{WAKE-LOW} may be a predetermined value that may indicate an average energy consumed from the energy storage element during a wake-up event where a message was received and may be stored in a memory. The control circuit may retrieve the high communication energy E_{WAKE-HIGH} from memory at 3218.

At 3220, the control circuit may determine a total communication energy E_{LOAD-RF} based on the total high communication energy E_{LOAD-HIGH} and the total low communication energy E_{LOAD-LOW}, for example by adding the total high energy E_{LOAD-HIGH} and the total low power communication energy E_{LOAD-LOW}. The total communication energy E_{LOAD-RF} may indicate the total power consumed by the control circuit and the communication circuit due to operation of the communication circuit.

At 3222, the control circuit may determine a total movement energy E_{LOAD-M} due to movements of bottom bar during the accumulation interval T_{ACC}. For example, the control circuit may determine the total movement energy E_{LOAD-M} based on a storage voltage of the energy storage element of the motor drive unit and a load current drawn by the motor drive circuit and/or the motor during movements of the bottom bar. For example, the control circuit of the base assembly may measure the load current drawn from the energy storage element of the motor drive unit during movements of the bottom bar.

Additionally or alternatively, at 3222, the control circuit may determine the total movement energy E_{LOAD-M} based on an estimated power consumption value associated with a movement distance of the bottom bar. For example, the control circuit may retrieve a power consumption value from a table that includes a plurality of power consumption values and associated movement distances. The control circuit may determine a distance P_{DIST} by determining the present position P_{PRES} of the covering material and the previous position P_{PREV} of the covering material. The control circuit may determine the absolute value of the distance between the present position P_{PRES} of the covering material and the previous position P_{PREV} of the covering material to determine the distance P_{DIST}, such that the control circuit may determine the power consumption value of the movement associated with the absolute value of the distance (e.g., from the table). Additionally or alternatively, the table may include predefined power consumption values for movements between predefined positions. For example, the table may include a power consumption value for a movement between a respective present position P_{PRES} of the covering material and a respective previous position P_{PREV} of the covering material such that the control circuit may determine the power consumption by reading the corresponding (e.g., to the movement) power consumption value from the table. The table may be generated prior to use by the end user, for example in a factory (e.g., end of line test).

In some examples, the control circuit of the base assembly may be configured determine (e.g., estimate) the total movement energy E_{LOAD-M} consumed from the energy storage element due to movements of bottom bar (e.g., the covering material) during the accumulation interval T_{ACC}. For example, the control circuit of the base assembly may be configured to estimate the total movement energy E_{LOAD-M} (e.g., an average amount of energy) due to movements of bottom bar based on stored records of movements of the bottom bar (e.g., a full raise and/or a full lower of the bottom bar). The memory of the motor drive unit may be configured to store, for example, a movement log including movement records of each movement of the bottom bar. The control circuit of the base assembly may be configured to determine a number of movements N_{MOVE} of the bottom bar during the accumulation interval T_{ACC} from the movement log stored in memory. In addition, the memory of the motor drive unit may be configured to store a predetermined energy E_{MOVE} that may indicate an average energy consumed from the energy storage element by the motor drive circuit and/or the motor during a single movement of the bottom bar. For example, the control circuit of the base assembly may be configured to estimate (e.g., calculate) the total movement energy E_{LOAD-M} consumed from the energy storage element due to movements of bottom bar during the accumulation interval T_{ACC} by multiplying the number of movements N_{MOVE} of the bottom bar during the accumulation interval by the predetermined energy E_{MOVE} (e.g., E_{LOAD-M}=N_{MOVE}·E_{MOVE}).

In some examples, the control circuit of the base assembly may be configured to estimate the total movement energy E_{LOAD-M} (e.g., an average amount of energy) due to movements of bottom bar during the accumulation interval T_{ACC} based on an amount of movement of the bottom bar indicated by the stored records of movements of the bottom bar in the movement log. For example, the memory of the motor drive unit may be configured to store a raise profile that indicates a relationship between a power P_{LOAD-M} that may be consumed from the energy storage element by the motor drive circuit and/or the motor with respect to the present position P_{PRES} of the bottom bar during a raise movement (e.g., a full raise of the bottom bar from the lowered position P_{LOWERED} to the raised position P_{RAISED}), and/or a lower profile that indicates a relationship between the power P_{LOAD-M} that may be consumed from the energy storage element by the motor drive circuit and/or the motor with respect to the present position P_{PRES} of the bottom bar during a lower movement (e.g., a full lower of the bottom bar from the raised position P_{RAISED} to the lowered position P_{LOWERED}).

For each movement during the accumulation interval T_{ACC}, the control circuit of the base assembly may be configured to determine a starting position P_{START}, an ending position PEND, and a time T_{MOVE} required for the movement. The control circuit of the base assembly may be configured to determine whether the movement was raising or lowering the bottom bar based on the starting position P_{START} and the ending position PEND. The control circuit of the base assembly may be configured to determine a starting power P_{START} and an ending power PEND based on the starting position P_{START} and the ending position PEND, respectively, by using the raise profile when the raising the bottom bar or the lower profile when lowering the bottom bar. The control circuit of the bottom bar module by be configured to determine an energy E_{LOAD-M} that was consumed from the energy storage element by the motor drive circuit and/or the motor during each of the movements within the accumulation interval T_{ACC} based on the starting power P_{START}, the ending power PEND, and the time T_{MOVE} required for the movement, e.g.,

$${E}_{LOAD - M} = {T}_{MOVE} \cdot ( {P}_{START} + {P}_{END} ) / 2.$$

The control circuit of the base assembly may be configured to estimate (e.g., calculate) the total movement energy E_{LOAD-M} consumed from the energy storage element due to movements of bottom bar during the accumulation interval T_{ACC} by summing the calculated energy E_{LOAD-M} that was consumed from the energy storage element during each of the movements of the bottom bar within the accumulation interval T_{ACC}.

At 3224, the control circuit may determine the total energy E_{LOAD-TOTAL} consumed from the energy storage element by the electrical loads of the motor drive unit based on the total communication energy E_{LOAD-RF} and the total movement energy E_{LOAD-M}, and the procedure 3300 may end at 3326. For example, the total power energy E_{LOAD-TOTAL} may be the sum of the total communication energy E_{LOAD-RF} and the total movement energy E_{LOAD-M}. As such, the total power consumption PC_{TOTAL} may be a combination of the power consumed due to wireless communication circuit and the power consumed due to movements of the bottom bar. Since these tend to be the most energy hungry operations of the motor drive unit, the total energy E_{LOAD-TOTAL} may provide an indication of the total energy consumed by the motor drive unit. The total energy consumption may be used to determine trends and/or a life (e.g., end of life) of the motor drive unit of the motorized window treatment.

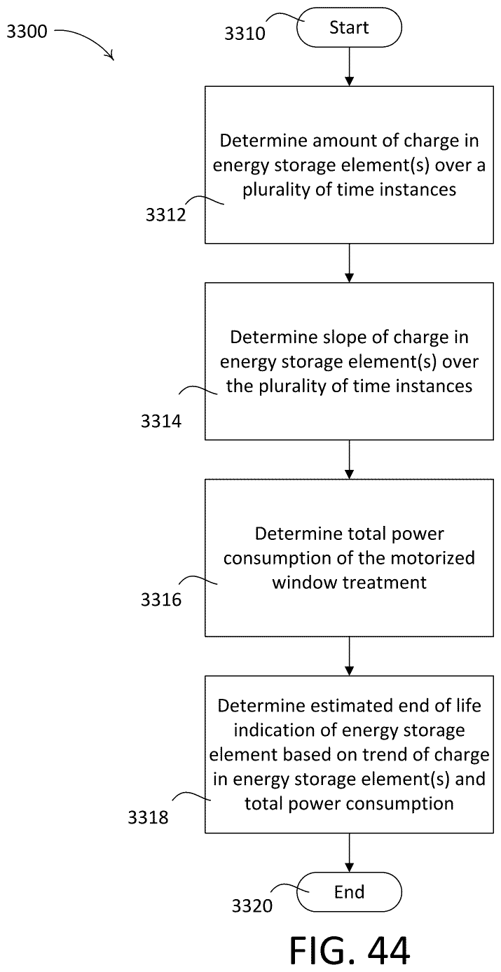

FIG. 44 is a flowchart of an example procedure 3300 that may be executed to determine a state of charge and/or an end of life indication of one or more energy storage elements of a motorized window treatment (e.g., the energy storage element 430, 530 of the motor drive unit 410, 510 and/or the energy storage element 446, 546 of the bottom bar module 440, 540). The procedure 3300 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein). The end of life indication of the energy storage element may indicate the time when the energy storage element is no longer capable of storing a charge that can support normal operation of the motor drive unit. When the energy storage element is at the end of its life, the motor drive unit may generate an alert or communication (e.g., send a message to a system controller) that indicates that its energy storage element needs to be replaced. By learning this information easily and in advance, the system controller can ensure that the motorized window treatments do not unexpectedly fail to operate correctly. Alternatively or additionally, the control circuit may move the covering material to the raised position P_{RAISED} and start to shut down some of the internal components of the motorized window treatment, for example the communication circuit. In response, a technician may change out the energy storage element, charge the energy storage element (e.g., via the electrical terminals using a USB connector), and/or connect the energy storage element to an external power source, such as an external power supply (e.g., DC power supply) and/or an external battery pack (e.g., via the electrical terminals using the USB connector). In some examples, the motor drive unit may include a plurality of energy storage elements, such that the control circuit may determine to use a first energy storage element to power the motor drive unit while a second energy storage element is charging (e.g., from the bottom bar). The control circuit may perform the procedure 3300 periodically.

The procedure 3300 may start at 3110. At 3312, the control circuit may determine an amount of charge of the energy storage element of the motor drive unit and/or an amount of charge of the energy storage element of the bottom bar over a plurality of times instances. For instance, the control circuit may determine the charge of the energy storage element of the motor drive unit based on based on a storage voltage of the energy storage element of the motor drive unit (e.g., the first storage voltage V_{S-A}). In addition, the control circuit may determine the charge of the energy storage element of the bottom bar based on based on a storage voltage of the energy storage element of the bottom bar (e.g., the second storage voltage V_{S-B}). For example, the control circuit may use the magnitude of the storage voltage of the energy storage element of the motor drive unit and/or the magnitude of the storage voltage of the energy storage element of the bottom bar as indications of the state of charge of the respective energy storage elements. The time instances may be a time range, such as a week, a month or a year's worth of data relating to the charge of the energy storage element.

At 3314, the control circuit may determine the trend of the charge C_{ESE} in the energy storage element over the time (e.g., over the time instances). The control circuit may determine the trend of the charge C_{ESE} in the energy storage element (e.g., the energy storage element 630) of the motor drive unit and/or of the charge in the energy storage element (e.g., the energy storage element 646) of the bottom bar module. For example, the control circuit may measure the change in the charge C_{ESE} over time to obtain a trend, such that the control circuit may determine the trend. The trend (e.g., slope of the charge C_{ESE} over time) may indicate an amount of charge C_{ESE} or storage voltage in the energy storage element over time, such that an estimated end of life of the motorized window treatment (e.g., the energy storage element of the motorized window treatment) may be indicated by a time when the charge or storage voltage of the energy storage element will fall below a threshold charge or storage level that results in unreliable operation of the motorized window treatment.

The control circuit may determine a trend of any change in the charge C_{ESE} of the energy storage element over time. For example, the control circuit may determine whether a charge C_{ESE} of the energy storage element of the bottom bar is greater than or less than the storage level the last time the bottom bar docked. Further, the control circuit may be configured to determine whether a rolling average of the amount of charge of a predetermined number of previous storage level measurements is increasing or decreasing to, for example, determine whether the motor drive unit would benefit from more frequent or less frequent docking events.

At 3316, the control circuit may determine the total power consumption of the motorized window treatment. For example, the control circuit may determine the total power consumption PC_{TOTAL} based on the total communication power consumption P_{PC-RF} and the total movement power consumption P_{PC-M} (e.g., using the procedure 3200), such that the total power consumption is the total communication power consumption and the total movement power consumption of the motorized window treatment. For example, the control circuit may calculate a total power consumption of the motor drive unit based on power consumed by a communication circuit of the motor drive unit and power consumed by movements of the motor of the motor drive unit. The control circuit may determine a number of wake up events where no message is received N_{LOW} and/or a number of wake up periods N_{LOW} where a message is not received. Based on a total low power consumption value P_{PC-LOW} associated with the wake up periods where no message is received a high power consumption value PRF-HIGH associated with the wake up periods where a message is received, the control circuit may determine the total high power consumption value P_{PC-HIGH} and the total low power consumption value P_{PC-LOW}. The control circuit may determine the total communication power consumption P_{PC-RF} based on the total high power consumption value PPC-HIGH and the total low power consumption value P_{PC-LOW}. The total communication power consumption P_{PC-RF} may indicate the total power consumed by the control circuit of the base assembly due to operation of its communication circuit. Additionally or alternatively, the control circuit may determine the total movement power consumption P_{PC-M} based on movements of bottom bar, for example based on the storage voltage of the energy storage element of the motor drive unit and the current drawn during movements of the bottom bar. In some examples, the control circuit may determine the total movement power consumption P_{PC-M} based on an estimated power consumption value associated with a movement distance of the bottom bar. For example, the control circuit may determine a distance P_{DIST} by determining the present position P_{PRES} of the covering material and the previous position P_{PREV} of the covering material and determine the power consumption value using the table. The control circuit may determine the total power consumption PC_{TOTAL} based on the total communication power consumption P_{PC-RF} and the total movement power consumption P_{PC-M}, for example by adding the total communication power consumption P_{PC-RF} and the total movement power consumption P_{PC-M}.

Based on the trend of the charge C_{ESE} in the energy storage element over time and the total power consumption of the motorized window treatment (e.g., over the same time), the control circuit may determine an estimated end of life indication of the energy storage element at 3318. For example, the control circuit may determine the estimated end of life as a predicted time when the charge C_{ESE} of the energy storage element will be zero (e.g., or below a threshold) or a predicted time when the energy storage element is no longer capable of storing a charge that can support normal operation of the motor drive unit. As such, the threshold may correspond to a charge C_{ESE} such that operation of the motorized window treatment will be unreliable. The procedure 3300 may end at 3320.

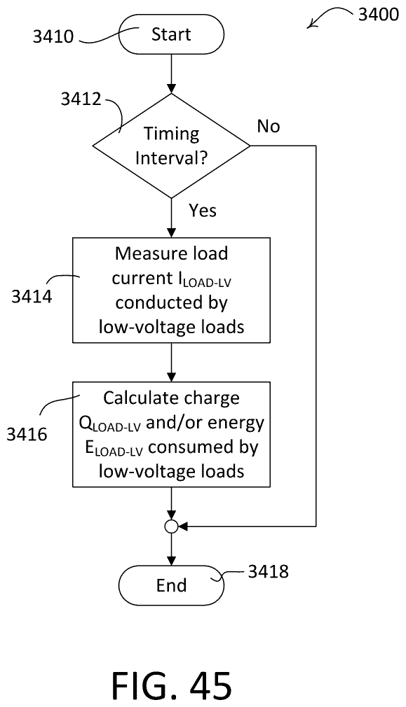

FIG. 45 is a flowchart of an example procedure 3400 for determining (e.g., estimate and/or calculate) a total low-voltage energy E_{LOAD-LV} consumed from an energy storage element by electrical loads (e.g., low-voltage electrical loads) of a motor drive unit. The procedure 3400 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein) to determine the total low-voltage energy E_{LOAD-LV} consumed from the energy storage element by the low-voltage electrical loads of the motor drive unit. The control circuit may be configured to execute the procedure 3400 to calculate the total low-voltage energy E_{LOAD-LV} consumed from the energy storage element by the low-voltage electrical loads of the motor drive unit, for example, based on energy consumed from the energy storage element of the motor drive unit to provide for wireless communication. The control circuit may be configured to execute the procedure 3400 periodically, for example, at the load measurement interval T_{LOAD2}.

At 3412, the control circuit may determine whether a timing interval (e.g., the load measurement interval T_{LOAD2}) has expired. If the timing interval has not expired at 3412, the procedure 3400 may end at 3418.

However, if the timing interval has expired at 3412, the control circuit may measure a load current I_{LOAD-LV} conducted by low-voltage loads of the motor drive unit (e.g., the second load current I_{LOAD2} shown in FIG. 17B) at 3414. For example, the motor drive unit may comprise a sense circuit (e.g., the second sense circuit 760) coupled between an energy storage element of the motor drive unit (e.g., the energy storage element 730) and a power supply of the motor drive unit (e.g., the power supply 732). The second sense circuit may be configured to sense a magnitude of the load current I_{LOAD-LV} conducted by the power supply to supply power to the electrical loads that are powered by a low-voltage supply voltage V_{CC-A} (e.g., the control circuit 720, the communication circuit 722, and other low-voltage circuitry of the motor drive unit 710), and generate a sense signal V_{I-SNS} (e.g., the second sense signal V_{I-SNS2}) that may be received by the control circuit. The sense signal V_{I-SNS} (e.g., the magnitude of the sense signal V_{I-SNS}) may indicate the magnitude of the load current I_{LOAD-LV}. For example, the motor drive unit may comprise a power supply that is configured to receive a storage voltage V_{S-A} from the energy storage element and generate one or more supply voltages for powering the electrical circuitry of the motor drive unit. For example, the power supply may be configured to generate a low-voltage supply voltage V_{CC-A} (e.g., having a magnitude of approximately 3.3 V) for powering the one or more low-voltage electrical loads of the motor drive unit, such as, the control circuit, the memory, the communication circuit, the user interface circuit, and/or other low-voltage circuitry of the motor drive unit. For example, the power supply may comprise a buck converter circuit for generating the low-voltage supply voltage V_{CC-A}.

At 3416, the control circuit may calculate a charge Q_{LOAD-LV} and/or an energy E_{LOAD-LV} (e.g., the second charge Q_{LOAD2} and/or a second energy E_{LOAD2}) consumed by the low-voltage loads, before the procedure 3400 exits at 3418. For example, the control circuit may be configured to update values of the charge Q_{LOAD-LV} and/or the energy E_{LOAD-LV} consumed from the energy storage element by the power supply and/or the low-voltage electrical loads that are powered by the low-voltage supply voltage V_{CC-A}, for example, at the time interval.

In some examples, the control circuit may be configured to calculate the charge Q_{LOAD-LV} and/or the energy E_{LOAD-LV} consumed from the energy storage element by the power supply and/or the low-voltage electrical loads, for example, periodically (e.g., at the load measurement interval T_{LOAD2}) during the length (e.g., the entire length) of a time period (e.g., the accumulation interval T_{ACC}). For example, the control circuit may be configured to calculate the charge Q_{LOAD-LV} consumed from the energy storage element by the power supply and/or the low-voltage electrical loads based on the load current I_{LOAD-LV} (e.g., as indicated by the second current sense signal V_{I-SNS2}) and the load measurement interval T_{LOAD2}, e.g.,

$${Q}_{LOAD - LV} = {Q}_{LOAD - LV} + ( {I}_{LOAD - LV} {T}_{LOAD 2} ) .$$

In addition, the control circuit may be configured to calculate the energy E_{LOAD-LV} consumed from the energy storage element by the power supply and/or the low-voltage electrical loads based on the magnitude of the first supply voltage V_{S-A}, the magnitude of the load current I_{LOAD-LV}, and the load measurement interval T_{LOAD2}, e.g.,

$${E}_{LOAD - LV} = {E}_{LOAD - LV} + ( {V}_{S - A} \cdot {I}_{LOAD - LV} \cdot {T}_{LOAD 2} ) .$$

Since the operation of the control circuit and/or the communication circuit to transmit wireless signals provides the greatest load on the energy storage element by the low-volage electrical loads of the motor drive unit, the charge Q_{LOAD-LV} and/or the energy E_{LOAD-LV} consumed from the energy storage element by the low-voltage electrical loads of the motor drive unit may represent the charge and/or energy required to operate transmit and receive wireless signals (e.g., provide RF communication) over the course of a day.

For example, in typical scenarios, the charge Q_{LOAD-LV} and/or the energy E_{LOAD-LV} consumed from the energy storage element by the low-voltage electrical loads of the motor drive unit may be substantially constant across the course of a day. For example, as noted herein, the control circuit may be configured to calculate a partial charge Q_{LOAD-LV} and/or a partial energy E_{LOAD-LV} (e.g., the partial second charge Q_{LOAD2-P} and/or the partial second energy E_{LOAD2-P}) consumed from the energy storage element by the power supply and/or the low-voltage electrical loads during (e.g., only during) a portion of the time interval, such during a measurement window T_{WIN} (e.g., approximately 1 hour), and apply the partial charge Q_{LOAD-LV} and/or the partial energy E_{LOAD-LV} over the rest of the day. The control circuit 720 may be configured to calculate the partial charge Q_{LOAD-LV} and/or the partial energy E_{LOAD-LV} consumed from the energy storage element by the power supply and/or the low-voltage electrical loads, for example, periodically (e.g., at the load measurement interval T_{LOAD2}) during the measurement window T_{WIN}.

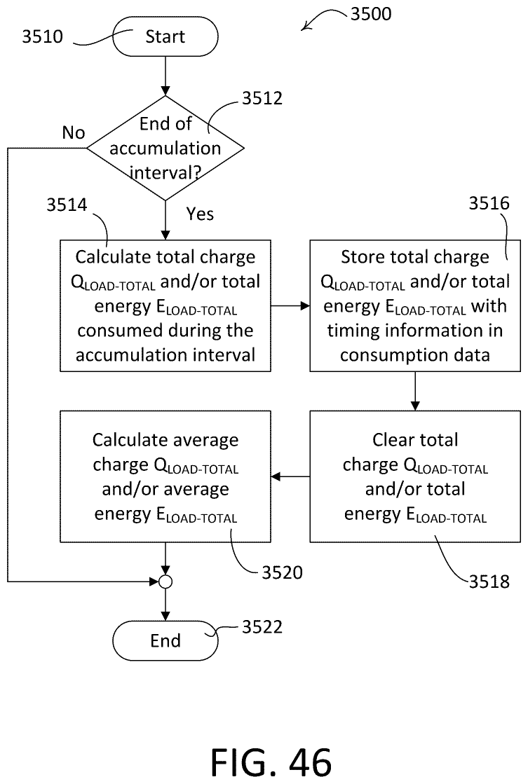

FIG. 46 is a flowchart of an example procedure 3500 for determining (e.g., estimate and/or calculate) a total energy E_{LOAD-TOTAL} consumed from an energy storage element by electrical loads of the motor drive unit. The procedure 3500 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein) to determine the total energy E_{LOAD-TOTAL} consumed from the energy storage element by the electrical loads of the motor drive unit. The control circuit may be configured to execute the procedure 3500 to calculate the total energy E_{LOAD-TOTAL} consumed from the energy storage element by the electrical loads of the motor drive unit, for example, based on energy consumed from the energy storage element of the motor drive unit to drive the motor and/or provide for wireless communication. The control circuit may be configured to execute the procedure 3500 periodically, for example, at the end of each of the accumulation intervals T_{ACC}.

At 3512, the control circuit may determine whether it is at the end of an accumulation interval (e.g., accumulation interval T_{ACC}, such as the end of the day). If it is not at the end of an accumulation interval at 3512, the procedure 3500 may end at 3522.

If it is at the end of an accumulation interval at 3512, the control circuit may calculate a total charge Q_{LOAD-TOTAL} and/or total energy E_{LOAD-TOTAL} consumed during the accumulation interval at 3514. For example, the control circuit may be configured to determine (e.g., calculate) the total charge Q_{LOAD-TOTAL} and/or the total energy E_{LOAD-TOTAL} consumed from the energy storage element by the electrical loads of the motor drive unit during the accumulation interval, for example, based the first charge Q_{LOAD1} (e.g., the charge Q_{LOAD-M} of FIG. 20C), the second charge Q_{LOAD2} (e.g., the energy E_{LOAD-M} of FIG. 20C), the second energy E_{LOAD2} (e.g., the charge Q_{LOAD-LV} of FIG. 45), and/or the second energy E_{LOAD2} (e.g., the energy E_{LOAD-LV} of FIG. 45). For example, the control circuit may calculate the total charge Q_{LOAD-TOTAL} consumed from the energy storage element during the accumulation interval by summing the first charge Q_{LOAD1} and the second charge Q_{LOAD2} (e.g., Q_{LOAD-TOTAL}=Q_{LOAD1}+Q_{LOAD2}). In addition, the control circuit may calculate the total energy E_{LOAD-TOTAL} consumed from the energy storage element during the accumulation interval by summing the first energy E_{LOAD1} and the second energy E_{LOAD2} (e.g., E_{LOAD-TOTAL}=E_{LOAD1}+E_{LOAD2}).

At 3516, the control circuit may store the total charge Q_{LOAD-TOTAL} and/or the total energy E_{TOTAL} consumed from the energy storage element 730 during the accumulation interval in the memory, for example, along with timing information (e.g., the present date). Further, in some examples, the control circuit may be configured to subtract the total charge Q_{LOAD-TOTAL} consumed from the energy storage element from the present charge Q_{PRES-A} (e.g., Q_{PRES-A}=Q_{PRES-A}−Q_{LOAD-TOTAL}), for example, at the end of each accumulation interval T_{ACC}.

At 3518, the control circuit may clear (e.g., reset) the total charge Q_{LOAD-TOTAL} to zero coulombs and/or the total energy E_{LOAD-TOTAL} to zero joules at the end of the accumulation interval. For example, the control circuit may reset the total charge Q_{LOAD-TOTAL} to zero coulombs and/or the total energy E_{LOAD-TOTAL}, such that the control circuit may determine the total charge Q_{LOAD-TOTAL} and/or the total energy E_{LOAD-TOTAL} consumed by the electrical loads of the motor drive unit during the next accumulation interval. In addition, the control circuit may clear (e.g., reset) the first charge Q_{LOAD1} (e.g., the charge Q_{LOAD-M} of FIG. 20C) and/or the second charge Q_{LOAD2} (e.g., the energy E_{LOAD-M} of FIG. 20C) to zero coulombs, and clear (e.g., reset) the second energy E_{LOAD2} (e.g., the charge Q_{LOAD-LV} of FIG. 45) and/or the second energy E_{LOAD2} (e.g., the energy E_{LOAD-LV} of FIG. 45) to zero joules.

At 3520, the control circuit may determine (e.g., calculate) an average (e.g., a running average) of the total charge Q_{LOAD-TOTAL} and/or the total energy E_{LOAD-TOTAL}, before the procedure 3500 may end at 3522. For example, the control circuit may determine the average of the total charge Q_{LOAD-TOTAL} and/or the total energy E_{LOAD-TOTAL} consumed from the energy storage element by the electrical loads of the motor drive unit during the accumulation interval over multiple instances of the accumulation interval. For example, at the end of the accumulation interval, the control circuit may be configured to calculate (e.g., update) an average charge Q_{LOAD-AVG} (e.g., consumed from the energy storage element by the electrical loads of the motor drive unit) based on total charge Q_{LOAD-TOTAL} for the present accumulation interval T_{ACC} and a previous value of the average charge Q_{LOAD-AVG}. In addition, at the end of the accumulation interval, the control circuit may be configured to calculate (e.g., update) an average consumed energy E_{LOAD-AVG} (e.g., consumed from the energy storage element by the electrical loads of the motor drive unit) based on total energy E_{LOAD-TOTAL} for the present accumulation interval T_{ACC} and a previous value of the average energy E_{LOAD-AVG}.

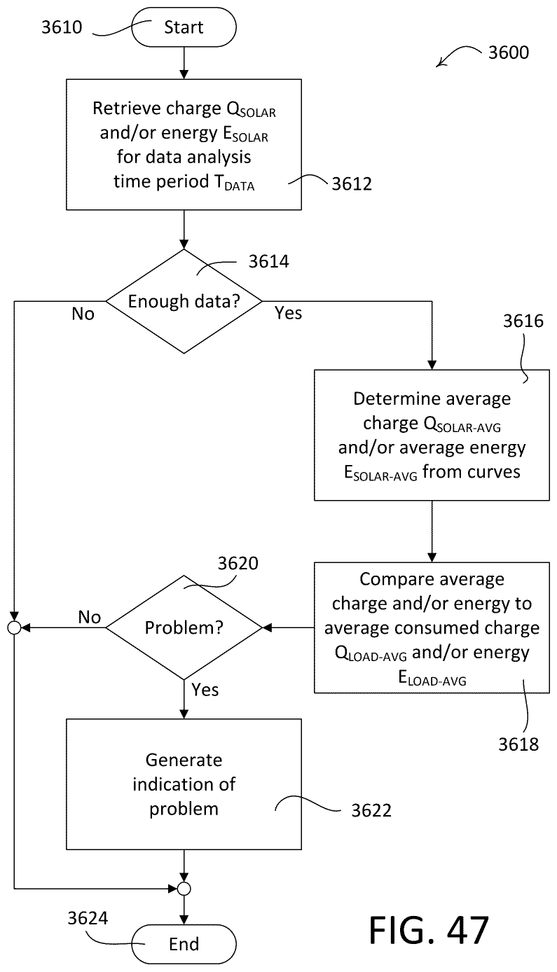

FIG. 47 is a flowchart of an example procedure 3600 for predicting whether a motorized window treatment having solar cells for powering a motor drive unit will run into a problem related to the ability to charge the energy storage elements of the motorized window treatment based on the solar cells. The procedure 3600 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein) to determine a trend in the charge Q_{SOLAR} and/or the solar energy E_{SOLAR} received from the solar cells over time through the course of a year to predict whether a problem with the lifetime of the motor drive unit is likely to occur (e.g., a short lifetime that may be undesirable to a user of the motorized window treatment). The control circuit may be configured to execute the procedure 3600 to compare an average daily received charge Q_{SOLAR-AVG} and/or an average daily received energy E_{SOLAR-AVG} to an average consumed charge Q_{LOAD-AVG} and/or an average consumed energy E_{LOAD-AVG} to, for example, determine whether a problem with the lifetime of the motor drive unit is likely to occur. The control circuit may be configured to execute the procedure 3600 periodically, for example, at the end of each of the accumulation intervals T_{ACC}.

At 3612, the control circuit may be configured to retrieve the charge Q_{SOLAR} and/or the solar energy E_{SOLAR} for a data analysis time period T_{DATA} from memory. For example, the data analysis time period T_{DATA} may include a number of the accumulation intervals T_{ACC} (e.g., all of the accumulation intervals T_{ACC}) during which the control circuit of the base assembly has collected the solar data (e.g., the charge Q_{SOLAR} and/or the solar energy E_{SOLAR}). For example, the control circuit may retrieve, from the solar data in memory, the charge Q_{SOLAR} and/or the solar energy E_{SOLAR} received from the solar cells during a data analysis time period T_{DATA} that may include the data analysis time period T_{DATA}.

At 3614, the control circuit may determine whether there is enough data (e.g., the charge Q_{SOLAR} and/or the solar energy E_{SOLAR}) to fit the data to a curve with respect to time. If the control circuit determines that there is not enough data at 3614, the procedure 3600 may end at 3624. As such, the control circuit of the base assembly may be configured to process the solar data when (e.g., only when) the control circuit has enough solar data to appropriately process the solar data. In some examples, the control circuit may have enough solar data to appropriately process the solar data when there is at least nine to twelve months of solar data collected by the control circuit (e.g., nine months equating to collection over the summer and winter months, and at least one of the spring or fall months).

If the control circuit determines that there is enough data at 3614, the control circuit may determine (e.g., calculate) an average charge Q_{SOLAR-AVG} and/or an average solar energy E_{SOLAR-AVG} for the motorized window treatment at 3616. For example, the control circuit may determine the average charge Q_{SOLAR-AVG} and/or the average solar energy E_{SOLAR-AVG} for the motorized window treatment by determining an average of a curve that represents a trend in the solar charge Q_{SOLAR} and/or the solar energy E_{SOLAR} received by the solar cells of the respective motorized window treatment with respect to time. For example, the average of the curve that represents the trend in the solar charge Q_{SOLAR} and/or the solar energy E_{SOLAR} may be an offset of the sinusoidal waveform of the curve. The control circuit may determine (e.g., calculate) the average charge Q_{SOLAR-AVG} as the average of the curve that represents the trend in the solar charge Q_{SOLAR} based on a high peak magnitude Q_{SOLAR-HI} and a low peak magnitude Q_{SOLAR-LO}, e.g., Q_{SOLAR-AVG}=(Q_{SOLAR-HI}+Q_{SOLAR-LO})/2. Similarly, the control circuit may determine (e.g., calculate) the average charge Q_{SOLAR-AVG} and/or the average solar energy E_{SOLAR-AVG} as the average of the curve that represents the trend in the solar charge Q_{SOLAR} and/or the solar energy E_{SOLAR}, respectively, based on a high peak magnitude E_{SOLAR-HI} and a low peak magnitude E_{SOLAR-LO}, e.g., E_{SOLAR-AVG}=(E_{SOLAR-HI}+E_{SOLAR-LO})/2.

For instance, in such examples, the control circuit may fit the charge Q_{SOLAR} and/or the solar energy E_{SOLAR} to a curve with respect to time. The control circuit may fit the data to the curve with respect to time to determine the trend in the charge Q_{SOLAR} and/or the solar energy E_{SOLAR} received from the solar cells over time through the course of a time period (e.g., a year). For example, the control circuit may fit the solar charge Q_{SOLAR} and/or the solar energy E_{SOLAR} to the curve by performing a least-squares fit procedure (e.g., to a sinusoidal waveform) on data representing the charge Q_{SOLAR} and/or the solar energy E_{SOLAR} with respect to time. The curve that represents the trend in the charge Q_{SOLAR} and/or the solar energy E_{SOLAR} received by the solar cells with respect to time may be, for example, a sinusoidal waveform (e.g., as shown in FIGS. 18A-18E). For example, the sinusoidal shape of each of curve may indicate higher exposure to sunlight in a portion of the year (e.g., the summer in the northern hemisphere) and lower exposure to sunlight in another portion of the year (e.g., the winter in the northern hemisphere). As such, the control circuit may be configured to process the solar data to determine the trend in the charge Q_{SOLAR}-AVG and/or the solar energy E_{SOLAR} received from the solar cells over time (e.g., through the course of a year). The control circuit may determine the average charge Q_{SOLAR}-AVG and/or the average solar energy E_{SOLAR-AVG} for the motorized window treatment by determining an average of a curve that represents a trend in the solar charge Q_{SOLAR} and/or the solar energy E_{SOLAR} received by the solar cells of the respective motorized window treatment with respect to time.

At 3618, the control circuit may compare the average charge Q_{SOLAR-AVG} and/or the average solar energy E_{SOLAR-AVG} to average consumed charge Q_{LOAD-AVG} and/or energy E_{LOAD-AVG}, respectively. For example, the control circuit calculate the average charge Q_{LOAD-AVG} (e.g., consumed from the energy storage element by the electrical loads of the motor drive unit) and/or the average consumed energy E_{LOAD-AVG} (e.g., consumed from the energy storage element by the electrical loads of the motor drive unit) using the procedure 3500.

At 3620, the control circuit may determine whether a problem with the lifetime of the motor drive unit is likely to occur based on the comparison performed at 3618. For example, the control circuit may determine that the problem with the lifetime of the motor drive unit is likely to occur when the comparison of the average charge Q_{SOLAR-AVG} and/or the average solar energy E_{SOLAR-AVG} to average consumed charge Q_{LOAD-AVG} and/or energy E_{LOAD-AVG}, respectively, indicates that that motorized window treatment is consuming more energy than is being captured by the solar cells (e.g., when the average charge Q_{SOLAR-AVG}<average consumed charge Q_{LOAD-AVG}, and/or when the average solar energy E_{SOLAR-AVG}<the E_{LOAD-AVG}). Further, in some examples, the control circuit may determine an estimated end of life indication of the motorized window treatment (e.g., as determined at 3318) based on the comparison performed at 3618. Further, in some examples, the control circuit may determine that a problem with the lifetime of the motor drive unit is likely to occur when the comparison indicates that the lifetime of the motor drive unit is less than a number of years (e.g., 20 years) or less than a number of months (e.g., the problem will occur within the next 12 months).

The control circuit may determine that a problem with the lifetime of the motor drive unit is likely to occur when the comparison indicates that that motorized window treatment is consuming more charge or energy than is being captured by the solar cells. For example, the control circuit may determine that a problem with the lifetime of the motor drive unit is likely to occur based on a comparison between the trend (e.g., or the slope) of the average charge Q_{SOLAR-AVG} and/or the average solar energy E_{SOLAR-AVG} to the trend (e.g., or the slope) of the average consumed charge Q_{LOAD-AVG} and/or energy E_{LOAD-AVG}, respectively. For example, the control circuit may determine that a problem with the lifetime of the motor drive unit is likely to occur when the slope is negative (e.g., the slope indicates that the average charge Q_{SOLAR-AVG} and/or the average solar energy E_{SOLAR-AVG} is less than, or decreasing, relative to the average consumed charge Q_{LOAD-AVG} and/or energy E_{LOAD-AVG}, respectively).

If the control circuit determines that it is unlikely that a problem with the lifetime of the motor drive unit will occur at 3620, the procedure 3600 may end at 3624. If the control circuit determines that it is likely that a problem with the lifetime of the motor drive unit will occur at 3620, the control circuit may generate an indication of the problem (e.g., an alert) at 3622. For example, when the control circuit determines that it is likely that a problem with the lifetime of the motor drive unit will occur, the control circuit may generate an alert that indicates the problem (e.g., that indicates that the motorized window treatment should be serviced). For example, the control circuit may send a message to a mobile device (e.g., the mobile device 180) and/or a system controller (e.g., the system controller 110) that indicates the problem (e.g., that indicates that the motorized window treatment should be serviced). Alternatively or additionally, the control circuit may send a message (e.g., a text message), an email, and/or a notification that is displayed on a dashboard for a technician that indicates the problem (e.g., where the dashboard is accessible via the system controller).

In some examples, the control circuit may illuminate an LED (e.g., located on the motor drive unit or the bottom bar of the motorized window treatment, located on an input device (e.g., the remote control device 170), and/or located at the system controller) to indicate the problem. Alternatively or additionally, the control circuit may move the covering material slowly or wiggle the covering material up and down (e.g., repeatedly move the bottom bar up and down) to indicate the problem, for example, in situations where the control circuit cannot communicate with a system controller and/or where no system controller exists. For instance, the control circuit may illuminate an LED and/or move the covering material slowly or wiggle the covering material up and down when, for example, the control circuit does not have the ability to communicate with the system controller or an input device.

As an alternative to and/or in addition to generating an alert that indicates the problem, the control circuit may take a proactive action(s) to resolve the problem. For example, the control circuit may determine an updated docking schedule or an updated position for the bottom bar that will resolve the problem, for example, by entering a calibration mode that adjusts the configuration of the motorized window treatment. The control circuit may generate and send a recommendation (e.g., to a system controller) that indicates the updated docking schedule or the updated position for the bottom bar that will resolve the problem and, in such examples, change the position or movement schedule of the motorized window treatment upon receipt of a confirmation to do so. For instance, the control circuit may recommend an updated docking schedule that configures the control circuit to dock the bottom bar more often when the space is vacant, such as on the weekends. Further, in some examples, the control circuit may update (e.g., autonomously update) the docking schedule or the present position of the bottom bar to resolve the problem. Further, in some examples, the control circuit may suggest a recommendation that applies to a plurality of motorized window treatments (e.g., a group of motorized window treatments that reside on the same façade of a building).

As such, the control circuit may be configured to process the solar data and/or the consumption data to predict a problem with the lifetime of the motor drive unit (e.g., a short lifetime that may be undesirable to a user of the motorized window treatment).

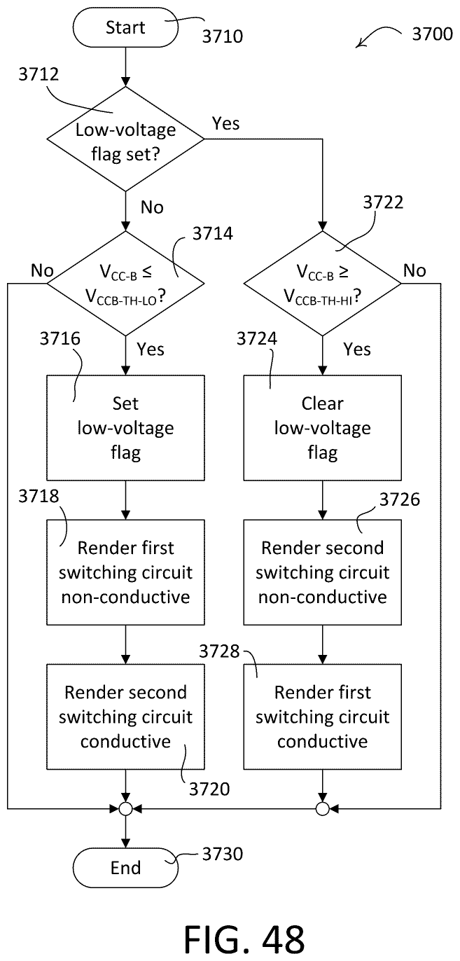

FIG. 48 is a flowchart of an example procedure 3700 for controlling a plurality of power supplies of a solar power system (e.g., the solar power systems 441, 541, 660) of a motorized window treatment (e.g., the motorized window treatments of the embodiments shown in FIGS. 1-15B). The procedure 3700 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein) to control the plurality power supplies of the solar power system of the motorized window treatment based on whether a flag (e.g., a low-voltage flag) is set. For instance, the control circuit may execute the procedure 3700 to control whether a first power supply (e.g., the first power supply 556) or a second power supply (e.g., the second power supply 558) is configured to generate a low-voltage supply voltage V_{CC-B} (e.g., from the second storage voltage V_{S-B}) for powering the one or more low-voltage electrical loads (e.g., of the bottom bar module), such the control circuit, the memory, the communication circuit, the sensor circuit, and/or other low-voltage circuitry of a bottom bar module of the motorized window treatment. The control circuit may be configured to execute the procedure 3700 periodically.

At 3712, the control circuit may determine whether a low-voltage flag is set (e.g., in memory of the motorized window treatment). The low-voltage flag may indicate whether the first power supply or the second power supply is generating a low-voltage supply voltage V_{CC-B}. For example, the low-voltage flag may indicate the states (e.g., conductive or non-conductive) of two switching circuits, as described more herein. For example, the first power supply may be configured to receive a second storage voltage V_{S-B} from an energy storage element and generate a low-voltage supply voltage V_{CC-B} (e.g., approximately 2.8 V) for powering one or more low-voltage electrical loads of the bottom bar module, and comprise the second power supply that is configured to receive a photovoltaic output voltage V_{PV} from solar cells and generate the low-voltage supply voltage V_{CC-B} for powering the one or more low-voltage electrical loads of the bottom bar module. The first power supply may comprise a low-dropout (LDO) linear regulator that may be characterized by a dropout voltage (e.g., approximately 140 mV).

In some examples, the low-voltage flag may be set when the bottom bar module is initially being powered up and/or if the energy storage element of the bottom bar module is depleted). For example, when the magnitude of the low-voltage supply voltage V_{CC-B} as generated by the second power supply becomes greater than (e.g., greater than or equal to) the rated supply voltage of the control circuit, the control circuit may become powered up and functional. At this time, the control circuit may generate the one or more MPPT drive signals V_{MPPT-DR} for controlling the solar cell management circuit to generate the second storage voltage V_{S-B} from the photovoltaic output voltage V_{PV}.

If the low-voltage flag is not set at 3712, the control circuit may determine whether the low-voltage supply voltage V_{CC-B} is less than (e.g., less than or equal to) a first low-voltage threshold voltage V_{CCB-TH-LO}. In some examples, the first low-voltage threshold voltage V_{CCB-TH-LO} may be greater than the magnitude of the low-voltage supply voltage V_{CC-B} plus the dropout voltage V_{DO} of the first power supply.

If the low-voltage supply voltage V_{CC-B} is greater than the first low-voltage threshold voltage V_{CCB-TH-LO} at 3714, the procedure 3700 may end at 3730. If the low-voltage supply voltage V_{CC-B} is less than (e.g., less than or equal to) the first low-voltage threshold voltage V_{CCB-TH-LO} at 3714, the control circuit may set the low-voltage flag at 3716, render a first switching circuit (e.g., the first switching circuit 557) non-conductive at 3718, and render a second switching circuit (e.g., the second switching circuit 559) conductive at 3720, before the procedure 3700 exits at 3730. As such, by rendering the first switching circuit non-conductive and the second switching circuit conductive, the second power supply may generate the low-voltage supply voltage V_{CC-B} from the photovoltaic output voltage V_{PV}. For example, the control circuit may generate one or more MPPT drive signals V_{MPPT-DR} for controlling a solar cell management circuit to generate the second storage voltage V_{S-B} from the photovoltaic output voltage V_{PV} until the magnitude of the low-voltage supply voltage V_{CC-B} rises above (e.g., becomes greater than) the first low-voltage threshold voltage V_{CCB-TH-LO} at which time the control circuit 550 may render the second switching circuit 559 non-conductive and render the first switching circuit 557 conductive.

If the low-voltage flag is set at 3712, the control circuit may determine whether the low-voltage supply voltage V_{CC-B} is greater than (e.g., greater than or equal to) a second low-voltage threshold voltage V_{CCB-TH-HI} at 3722. In some examples, the second low-voltage threshold voltage V_{CCB-TH-HI} may be greater than the first low-voltage threshold voltage V_{CCB-TH-LO}. For example, the second low-voltage threshold voltage V_{CCB-TH-HI} may be greater than the magnitude of the low-voltage supply voltage V_{CC-B} plus the dropout voltage V_{DO} of the first power supply. The control circuit may be configured to use the first low-voltage threshold V_{CCB-TH-LO} and the second low-voltage threshold voltage V_{CCB-TH-HI} to introduce hysteresis when comparing the magnitude of the low-voltage supply voltage V_{CC-B} to the low-voltage threshold voltage V_{CCB-TH} (e.g., to prevent rapid toggling of the first and second switching circuits).

If the low-voltage supply voltage V_{CC-B} is less than the second low-voltage threshold voltage V_{CCB-TH-HI} at 3722, the procedure 3700 may end at 3730. If the low-voltage supply voltage V_{CC-B} is greater than (e.g., greater than or equal to) the second low-voltage threshold voltage V_{CCB-TH-HI} at 3722, the control circuit may clear the low-voltage flag at 3724, render the second switching circuit non-conductive at 3726, and render the first switching circuit conductive at 3728, before the procedure 3700 may end at 3730. As such, by rendering the first switching circuit conductive and the second switching circuit non-conductive, the first power supply may be configured to generate the low-voltage supply voltage V_{CC-B} from the second storage voltage V_{S-B}.

Further, in alternate embodiments, the low-voltage flag may be omitted, and the control circuit may include a single threshold voltage V_{CCB-TH} when determining whether to generate the low-voltage supply voltage V_{CC-B} using the first power supply or the second power supply.

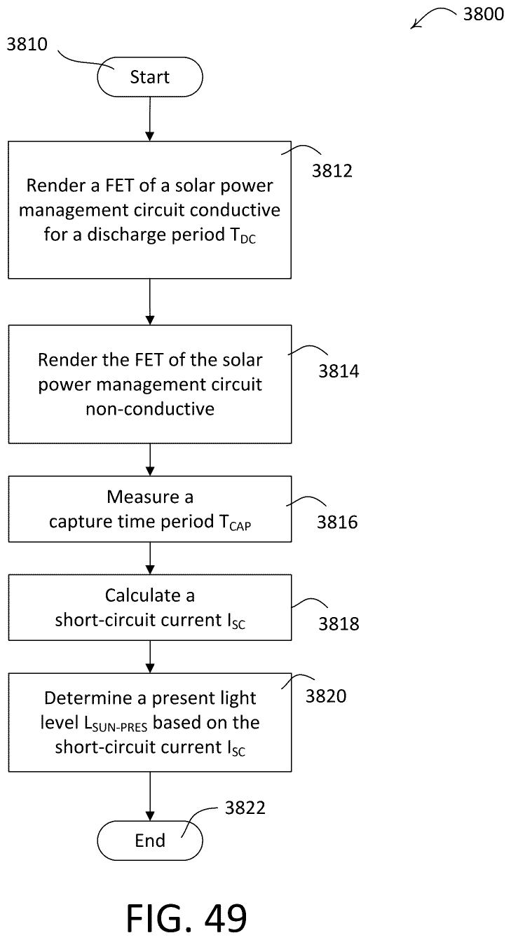

FIG. 49 is a flowchart of an example procedure 3800 for determining a present light level L_{SUN-PRES} of the sunlight shining onto solar cells of a motorized window treatment (e.g., in units of, for example, lux and/or foot-candles) based on a short-circuit current I_{SC} of the solar cells 610 of a motorized window treatment (e.g., any of the motorized window treatments described herein). The procedure 3800 may be executed by a control circuit of a base assembly of the motorized window treatment (e.g., the control circuits 420, 520, 520a, 720 of the motor drive units 410, 510, 510′, 710, the control circuit 520b of the dock module 504, and/or control circuits of any of the motorized window treatment described herein) to determine the present light level L_{SUN-PRES}. The control circuit may be configured to control a solar cell management circuit (e.g., the solar cell management circuit 620) using, for example, the MPPT control technique. The solar cell management circuit may include a semiconductor switch, such as a FET (e.g., the first FET Q631 of the solar cell management circuit 620) that is coupled in series with a primary winding (e.g., the primary winding 630a) of a transformer (e.g., the transformer 630). The control circuit may be configured to generate a drive signal (e.g., the first MPPT drive signal V_{MPPT-DR1}) for rendering the FET conductive and non-conductive. For example, the control circuit may be configured to monitor (e.g., sample) a magnitude of a photovoltaic output voltage V_{PV} generated by the solar cells across an input capacitor (e.g., the input capacitor C621). The control circuit may be configured to execute the procedure 3800 periodically (e.g., at a timing interval T_{TIM}).

The procedure 3800 may start at 3810. At 3812, the control circuit may control the drive signal to render the FET of the solar power management circuit conductive for a discharge period T_{DC}. For example, the control circuit 650 of the solar power system 600 may be configured to control the first MPPT drive signal V_{MPPT-DR1} to render the first FET Q631 of the solar power management circuit 620 conductive for the discharge period T_{DC}. While the first FET Q631 is conductive during the discharge period T_{DC}, the first FET Q631 may conduct a primary current I_{PRI} through the primary winding 630a of the transformer 630 and the magnitude of the photovoltaic output voltage V_{PV} generated across the input capacitor C621 may drop to approximately zero volts.

At 3814, the control circuit may control the drive signal to render the FET non-conductive, for example, at the end of the discharge period T_{DC}. For example, the control circuit 650 of the solar power system 600 may control the first MPPT drive signal V_{MPPT-DR1} to render the first FET Q631 non-conductive, such that the solar cells 610 may conduct the photovoltaic output current I_{PV} into the input capacitor C621 (e.g., which may appear as a short circuit to the solar cells 620 since the magnitude of the photovoltaic output voltage V_{PV} is approximately zero volts).

At 3816, the control circuit may measure a charging time period T_{CHARGE} from when the FET is rendered non-conductive until the magnitude of the photovoltaic output voltage V_{PV} generated by the solar cells exceeds a measurement threshold V_{TH-M} (e.g., approximately 0.05 V). For example, the control circuit 650 of the solar power system 600 may measure the charging time period T_{CHARGE} from when the first FET Q631 is rendered non-conductive (e.g., at 3814) until the magnitude of the photovoltaic output voltage V_{PV} generated by the solar cells (e.g., as determined from the photovoltaic output voltage feedback signal V_{PV-FB}) exceeds (e.g., is greater than) the measurement threshold V_{TH-M}. As such, the charging time period T_{CHARGE} may be calculated as the amount of time it takes for the photovoltaic output voltage V_{PV} generated by the solar cells 610 to exceed the measurement threshold V_{TH-M}. For example, the control circuit may sample the magnitude of the photovoltaic output voltage V_{PV} and perform the comparison of the photovoltaic output voltage V_{PV} and the measurement threshold V_{TH-M} in software. In some examples, the control circuit may perform the comparison of the photovoltaic output voltage V_{PV} and the measurement threshold V_{TH-M} using a hardware comparator circuit that, for example, receives as its inputs the photovoltaic output voltage V_{PV} (e.g., or the photovoltaic output voltage feedback signal V_{PV-FB}) and the measurement threshold V_{TH-M}. The control circuit may be configured to generate the measurement threshold V_{TH-M} as a DC voltage, for example, using a digital-to-analog converter and/or by generating a pulse-width modulated signal that is filtered by a filter circuit (e.g., resistor-capacitor filter circuit).

At 3818, the control circuit may calculate the short-circuit current I_{SC} of the solar cells based on the charging time period T_{CHARGE}. For example, the control circuit 650 of the solar power system 600 may calculate the short-circuit current I_{SC} of the solar cells 610 based on the charging time period T_{CHARGE}, the measurement threshold V_{TH-M}, and a capacitance CIN of the input capacitor, e.g.,

$${I}_{SC} = {C}_{IN} \cdot ( {V}_{TH - M} / {T}_{CAP} ) .$$

At 3820, the control circuit may determine a present light level L_{SUN-PRES} (e.g., in units of, for example, lux and/or foot-candles) of the sunlight shining onto the solar cells of the motorized window treatment based on the short-circuit current I_{SC}, before the procedure 3800 exits at 3822. In some examples, the control circuit may be configured to use a look-up table stored in memory to determine the present light level L_{SUN-PRES} (e.g., in units of, for example, lux and/or foot-candles) based on the short-circuit current I_{SC} of the solar cells. For instance, in some examples, the look-up tables comprise a plurality of present light level L_{SUN-PRES} values and a respective, plurality of short-circuit current values I_{SC}. Further, in some examples, the control circuit may be configured to measure the charging time period T_{CHARGE} multiple times using different values for the measurement threshold V_{TH-M}, and to determine the average value of the short-circuit current I_{SC} as calculated at the different values for the measurement threshold V_{TH-M}. Accordingly, using the procedure 3800, the control circuit may be configured to determine the present light level L_{SUN-PRES} of the sunlight shining onto the solar cells.

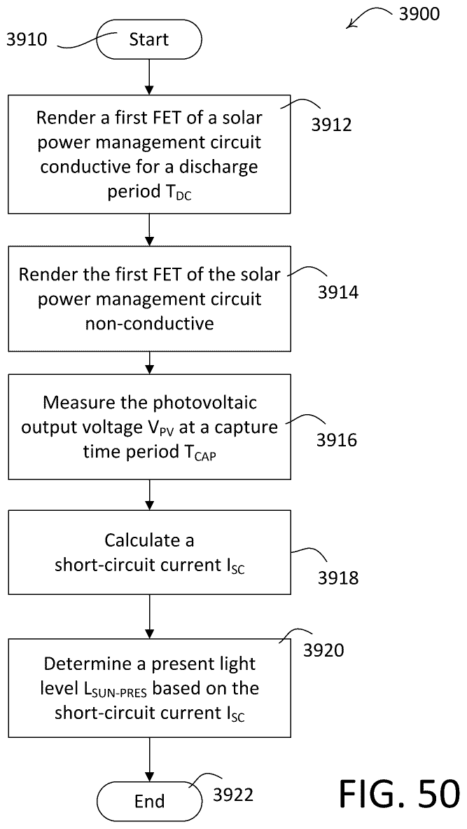

FIG. 50 is a flowchart of an example procedure 3900 for determining a present light level L_{SUN-PRES} of the sunlight shining onto solar cells of a motorized window treatment (e.g., in units of, for example, lux and/or foot-candles) based on a short-circuit current I_{SC} of the solar cells 610 of a motorized window treatment (e.g., the motorized window treatments of the embodiments shown in FIGS. 1-15B). The procedure 3900 may be executed by a control circuit (e.g., the control circuits 450, 550 of the bottom bar modules 440, 540, the control circuit 620 of the solar power system 600, and/or control circuits of the bottom bars of the motorized window treatments shown in FIGS. 1-15C) to determine the present light level L_{SUN-PRES}. The control circuit may be configured to control a solar cell management circuit (e.g., the solar cell management circuits 444, 544, 620) using, for example, the MPPT control technique. The solar cell management circuit may include a semiconductor switch, such as a FET (e.g., the first FET Q631 of the solar cell management circuit 620) that is coupled in series with a primary winding (e.g., the primary winding 630a) of a transformer (e.g., the transformer 630). The control circuit may be configured to generate a drive signal (e.g., the first MPPT drive signal V_{MPPT-DR1}) for rendering the FET conductive and non-conductive. For example, the control circuit may be configured to monitor (e.g., sample) a magnitude of a photovoltaic output voltage V_{PV} generated by the solar cells across an input capacitor (e.g., the input capacitor C621). The control circuit may perform the procedure 3900 as an alternative to the procedure 3800. The control circuit may be configured to execute the procedure 3900 periodically (e.g., at a timing interval T_{TIM}).

The procedure 3900 may start at 3910. At 3912, the control circuit may control the drive signal to render the FET of the solar power management circuit conductive for a discharge period T_{DC}. For example, the control circuit 650 of the solar power system 600 may be configured to control the first MPPT drive signal V_{MPPT-DR1} to render the first FET Q631 of the solar power management circuit 620 conductive for the discharge period T_{DC}. While the first FET Q631 is conductive during the discharge period T_{DC}, the first FET Q631 may conduct a primary current I_{PRI} through the primary winding 630a of the transformer 630 and the magnitude of the photovoltaic output voltage V_{PV} generated across the input capacitor C621 may drop to approximately zero volts.

At 3914, the control circuit may control the drive signal to render the FET non-conductive, for example, at the end of the discharge period T_{DC}. For example, the control circuit 650 of the solar power system 600 may control the first MPPT drive signal V_{MPPT-DR1} to render the first FET Q631 non-conductive, such that the solar cells 610 may conduct the photovoltaic output current I_{PV} into the input capacitor C621 (e.g., which may appear as a short circuit to the solar cells 610 since the magnitude of the photovoltaic output voltage V_{PV} is approximately zero volts).

At 3916, the control circuit may measure (e.g., sample) the magnitude of the photovoltaic output voltage V_{PV} generated by the solar cells (e.g., as determined from the photovoltaic output voltage feedback signal V_{PV-FB}) after a predetermined time period T_{PRE} from when the FET is rendered non-conductive (e.g., at 3914).

At 3918, the control circuit may calculate the short-circuit current I_{SC} of the solar cells based on a sampled magnitude of the photovoltaic output voltage V_{PV-S}. For example, the control circuit 650 of the solar power system 600 may calculate the short-circuit current I_{SC} of the solar cells 610 based on the predetermined time period T_{PRE}, the sampled magnitude of the photovoltaic output voltage V_{PV-S}, and the capacitance CIN of the input capacitor, e.g.,

$${I}_{SC} = {C}_{IN} \cdot ( {V}_{PV - S} / {T}_{PRE} ) .$$

At 3920, the control circuit may determine a present light level L_{SUN-PRES} (e.g., in units of, for example, lux and/or foot-candles) of the sunlight shining onto the solar cells of the motorized window treatment, before the procedure 3900 exits at 3922. In some examples, the control circuit may be configured to use a look-up table stored in memory to determine the present light level L_{SUN-PRES} (e.g., in units of, for example, lux and/or foot-candles) based on the short-circuit current I_{SC} of the solar cells. Further, in some examples, the control circuit may be configured to measure (e.g., sample) the photovoltaic output voltage V_{PV} multiple times using different values for predetermined time period T_{PRE}, and to determine the average value of the short-circuit current I_{SC} as calculated at the different values for the predetermined time period T_{PRE}. Accordingly, using the procedure 3900, the control circuit may be configured to determine the present light level L_{SUN-PRES} of the sunlight shining onto the solar cells.

Although features and elements may be described herein in particular combinations, each feature or element may be used alone or in any combination with the other features and elements. While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure.

While the motorized window treatment systems described herein have included window treatment assemblies having roller tubes and respective covering materials wrapped around the roller tubes, the features and elements may be described herein may be applied to other types of motorized window treatment systems, such as motorized cellular shade systems, Roman shade systems, and Venetian blind systems. For example, solar cells as described herein may be at a bottom of a Roman shade and/or Venetian blind. Additionally or alternatively, solar cells as described herein may be at a top of a Roman shade and/or Venetian blind, for example at a dock and/or a bracket.

Finally, although the motorized window treatment systems described herein are described with reference to the processing and/or procedures (e.g., the procedures described with reference to FIG. 18-50) being performed by the control circuit of the base assembly and/or the control circuit of the bottom bar of the motorized window treatment, in some examples, the processing and/or procedures may be performed by a system controller (e.g., the system controller 110). In such examples, the control circuit of the bottom bar may be configured to send one or more messages to the system controller that indicates solar data recorded by the bottom bar module and/or one or more operational characteristics of the bottom bar module (e.g., measurement of the magnitude of the photovoltaic output voltage V_{PV} generated by the solar cells of the bottom bar, measurement of the magnitude of the second storage voltage V_{S-B} generated across the energy storage element of the bottom bar, operational characteristic of the solar cell management circuit, such as the duty cycle DC_{SCM} of the solar cell management circuit, etc.).

What is claimed is:

1.-163. (canceled)

164. A motorized treatment configured to be mounted to a structure, the motorized treatment comprising:
a treatment assembly comprising a covering material that extends from a top end to a bottom end, the treatment assembly further comprising a bottom bar attached to the bottom end of the covering material;
at least one solar cell;
a motor drive unit comprising a motor configured to adjust a present position of the bottom bar; and
at least one control circuit, the at least one control circuit configured to:
control the motor drive unit to adjust the present position of the bottom bar to a plurality of positions;
determine magnitudes of power received by the at least one solar cell at associated positions of the plurality of positions at associated times;
store the magnitudes of power in memory with the associated positions and the associated times; and
control the present position of the bottom bar to one of the associated positions of the plurality of positions based on the associated magnitudes of power stored with the associated positions and the associated times.

165. The motorized treatment of claim 164, wherein the at least one control circuit is further configured to store, in memory, a solar data structure that comprises a plurality of records, wherein each record comprises one of the respective magnitudes of power, the respective time associated with the respective magnitude of power, and the respective position associated with the respective magnitude of power.

166. The motorized treatment of claim 165, wherein the at least one control circuit is further configured to:
retrieve solar data from the bottom bar, the solar data comprising the respective magnitudes of power received by the at least one solar cell at the respective positions and the respective times; and
generate the solar data structure from the solar data received from the bottom bar.

167. The motorized treatment of claim 166, wherein the bottom bar comprises a bottom bar module configured to collect solar data in response to the at least one solar cell.

168. The motorized treatment of claim 167, wherein the bottom bar module comprises a first energy storage element electrically coupled to the at least one solar cell, the first energy storage element configured to discharge into a second energy storage element that powers the motor drive unit.

169. The motorized treatment of claim 168, wherein the bottom bar module comprises a solar cell management circuit configured to charge the first energy storage element from a photovoltaic output voltage generated by the at least one solar cell for generating a storage voltage across the first energy storage element.

170. The motorized treatment of claim 169, wherein the bottom bar module is configured to determine the respective magnitude of power at each of the respective positions and respective times based on one or more operational characteristics of the bottom bar module.

171. The motorized treatment of claim 170, wherein the bottom bar module is configured to calculate the respective magnitude of power at each of the respective positions and respective times based on a magnitude of the photovoltaic output voltage generate by the at least one solar cell and a magnitude of the storage voltage across the first energy storage element of the bottom bar module.

172. The motorized treatment of claim 171, wherein the solar cell management circuit is characterized by a duty cycle required to generate the storage voltage across the first energy storage element of the bottom bar from the photovoltaic output voltage, and wherein the bottom bar module is configured to calculate the respective magnitude of power at each of the respective positions and respective times based on the magnitude of the photovoltaic output voltage generated by the at least one solar cell, the magnitude of the storage voltage across the first energy storage element of the bottom bar module, and the duty cycle of the solar cell management circuit.

173. The motorized treatment of claim 168, further comprising:
a dock electrically coupled to the second energy storage element that powers the motor drive unit;
wherein the bottom bar is configured to be positioned adjacent to the dock when the covering material is in a docking position, such that the first energy storage element of the bottom bar is configured to discharge through the dock into the second energy storage element.

174. The motorized treatment of claim 173, wherein the bottom bar module is configured to transmit messages to the at least one control circuit via a wired communication link when the bottom bar is positioned adjacent to the dock, the bottom bar module further configured to:
store the respective magnitude of power determined at each of the respective positions and respective times in the solar data in a memory of the bottom bar along with a time stamp defining the respective time at which the at least one of the respective magnitude of power was determined; and
transmit the solar data to the at least one control circuit when the bottom bar is positioned adjacent to the dock.

175. The motorized treatment of claim 174, wherein the at least one control circuit is configured to use the time stamp stored with each of the magnitudes of power in the solar data and a time of a last dock event to determine the respective time associated with the respective magnitude of power, and to store the respective time with the respective magnitude of power in one of the records of the solar data structure.

176. The motorized treatment of claim 175, wherein the motor drive unit is configured to store a record of a respective movement of the covering material when the motor drive unit controls the motor to adjust the present position of the covering material.

177. The motorized treatment of claim 176, wherein the at least one control circuit is configured to use the respective time associated with each of the magnitudes of power in the solar data and the records of the respective movements stored by the motor drive unit to determine the respective position of the covering material associated with the respective magnitude of power, and to store the respective position with the respective magnitude of power in the one of the records of the solar data structure.

178. The motorized treatment of claim 173, wherein the dock comprises first electrical contacts electrically coupled to the second energy storage element that powers the motor drive unit, and the bottom bar comprises second electrical contacts electrically coupled to the first energy storage element of the bottom bar module and configured to be electrically connected to the second electrical contacts when the bottom bar is positioned adjacent to the dock.

179. The motorized treatment of claim 168, wherein the bottom bar module is configured to transmit messages to the at least one control circuit via wireless signals, the bottom bar further configured to periodically transmit the solar data to the motor drive unit in one or more messages via the wireless signals.

180. The motorized treatment of claim 179, wherein the at least one control circuit is further configured to:
store each of the respective magnitudes of power in a respective record of the solar data structure;
store the present position of the covering material as the respective position associated with the respective magnitude of power in the respective record of the solar data structure; and
store the present time as the respective time associated with the respective magnitude of power in the respective record of the solar data structure.

181. The motorized treatment of claim 168, wherein the at least one control circuit is further configured to:
determine an average solar charge or an average solar energy received by the at least one solar cell over a time period;
determine an average consumed charge or an average consumed energy that is consumed from the second energy storage element over the time period; and
generate an indication of a problem with a lifetime of the motorized treatment based on (i) a comparison between the average solar charge received by the at least one solar cell to the average consumed charge that is consumed from the second energy storage element, or (ii) a comparison between the average solar energy received by the at least one solar cell to the average consumed energy that is consumed from the second energy storage element.

182. The motorized treatment of claim 168, wherein the at least one control circuit comprises at least two control circuits, and wherein the motor drive unit comprises a first control circuit and the dock comprises a second control circuit.

183. The motorized treatment of claim 165, wherein one or more records of the solar data structure indicate one or more dead-bands of the plurality of positions, and wherein the at least one control circuit is configured to control the position of the bottom bar to a position based on the one or more dead-bands.

184. The motorized treatment of claim 183, wherein the at least one control circuit is further configured to compare a magnitude of power associated with a position of the plurality of positions with a magnitude of power associated with an adjacent position of the plurality of positions to determine the one or more dead-bands.

185. The motorized treatment of claim 184, wherein the at least one control circuit is configured to determine the one or more dead-bands when a solar power at a position is less than a dead-band power threshold and a solar power at a previous position is greater than the dead-band power threshold.

186. The motorized treatment of claim 165, further comprising:
a communication circuit configured to transmit messages;
wherein the at least one control circuit is further configured to transmit, to an external device via the communication circuit, the solar data structure in one or more messages.

187. The motorized treatment of claim 186, wherein the at least one control circuit is configured to:
determine an amount of charge of an energy storage element that is configured to power the motor drive unit;
determine a data update interval based on the amount of charge of the energy storage element; and
transmit, to the external device via the communication circuit, the solar data structure at the data update interval.

188. The motorized treatment of claim 186, where in the solar data structure comprises a first solar data structure, and the at least one control circuit is configured to:
receive respective solar data structures from a plurality of other motorized treatments;
assign one of the plurality of motorized treatments as a data transmission manager based on the respective solar data structures received from a plurality of other motorized treatments, wherein the data transmission manager is configured to subsequently transmit the respective solar data structure to the external device; and
cease transmitting the first solar data structure to the external device based on the assignment of the one of the plurality of motorized treatments as the data transmission manager.

189. The motorized treatment of claim 165, wherein the at least one control circuit is further configured to:
determine a time range for a movement of the covering material;
select a record of the solar data structure that comprises a time within the time range, wherein the selection is based on the magnitude of power of one or more records that are within the time range; and
control the position of the bottom bar to the position associated with the selected record.

190. The motorized treatment of claim 189, wherein the time range is associated with a plurality of records of the solar data structure, and wherein the selected record includes a respective magnitude of power that is larger than each of the respective magnitudes of power of the other records of the plurality of records that are associated with the time range.
